(19) United States
(12) Patent Application Publication
(10) Pub. No.: US 2024/0419706 A1
(43) Pub. Date: Dec. 19, 2024

(54) METHODS TO CURATE DATA AND DELIVER RECOMMENDATIONS

(71) Applicant: COMAKE, INC., Los Angeles, CA (US)

(72) Inventor: Andres Eduardo Gutierrez, Los Angeles, CA (US)

(21) Appl. No.: 18/814,305

(22) Filed: Aug. 23, 2024

Related U.S. Application Data
(63) Continuation-in-part of application No. 17/965,650, filed on Oct. 13, 2022.
Application No. 17/965,650 is a continuation-in-part of application No. 17/707,888, filed on Mar. 29, 2022.
(63) Continuation-in-part of application No. 18/303,890, filed on Apr. 20, 2023.
Application No. 18/303,890 is a continuation of application No. 18/088,485, filed on Dec. 23, 2022, now abandoned.
Application No. 18/088,485 is a continuation-in-part of application No. 17/707,888, filed on Mar. 29, 2022.
(60) Provisional application No. 63/534,335, filed on Aug. 23, 2023.
(60) Provisional application No. 63/255,401, filed on Oct. 13, 2021.
(60) Provisional application No. 63/167,401, filed on Mar. 29, 2021.
(60) Provisional application No. 63/191,852, filed on May 21, 2021.
(60) Provisional application No. 63/293,600, filed on Dec. 23, 2021.
(60) Provisional application No. 63/308,305, filed on Feb. 9, 2022.
(60) Provisional application No. 63/351,690, filed on Jun. 13, 2022.
(60) Provisional application No. 63/354,563, filed on Jun. 22, 2022.
(60) Provisional application No. 63/167,401, filed on Mar. 29, 2021.
(60) Provisional application No. 63/191,852, filed on May 21, 2021.

(51) Int. Cl. G06F 16/33; G06F 16/335

(52) U.S. Cl. CPC G06F 16/3344; G06F 16/335

(57) ABSTRACT

Disclosed herein are methods and systems for providing individualized responses and recommendations based on a shared knowledge language. A method of receiving a user query for a personalized response associated with a profile; interpreting the query by executing a machine-learning model; generating a data query corresponding to the user query by executing the machine-learning model, the data query configured for execution in a computer model comprising one or more nodes having an identifier corresponding to a series of nouns and verbs generated in accordance with a schema associated with a shared knowledge language; receiving a first node of the computer model, wherein the first node is associated with the profile and generated based at least in part on an application accessed by the profile; presenting the personalized response, wherein the personalized response comprises an indication of the first node of the computer model.

### CROSS-REFERENCE TO RELATED APPLICATIONS

This application claims priority to U.S. Provisional Patent Application No. 63/534,335, filed Aug. 23, 2023, which is incorporated in its entirety by reference.

This application also claims priority under 35 U.S.C. § 120 as a continuation-in-part of U.S. patent application Ser. No. 17/965,650, filed Oct. 13, 2022, which claims priority as a continuation-in-part to U.S. patent application Ser. No. 17/707,888, filed Mar. 29, 2022, which claims priority to U.S. Provisional Patent Application 63/191,852, filed May 21, 2021, and U.S. Provisional Patent Application 63/167,401, filed on Mar. 29, 2021; and U.S. Provisional Patent Application No. 63/255,401, filed Oct. 13, 2021, all of which are incorporated herein by reference in its entirety for all purposes.

This application also claims priority under 35 U.S.C. § 120 as a continuation-in-part of U.S. patent application Ser. No. 18/303,890, filed Apr. 20, 2023, which claims priority to U.S. patent applicant Ser. No. 18/088,485, filed Dec. 23, 2022, which claims priority to U.S. Provisional Patent Application No. 63/308,305, filed Feb. 9, 2022; and U.S. Provisional Patent Application No. 63/293,600, filed Dec. 23, 2021; U.S. Provisional Patent Application No. 63/351,690, filed Jun. 13, 2022; and U.S. Provisional Patent Application No. 63/354,563, filed Jun. 22, 2022; and which is also a continuation-in-part of U.S. patent application Ser. No. 17/707,888, filed Mar. 29, 2022, which claims priority to U.S. Provisional Patent Application No. 63/191,852, filed May 21, 2021 and 63/167,401, filed Mar. 29, 2021, all of which are incorporated by reference herein for all purposes.

### TECHNICAL FIELD

This application relates generally to electronic data management and communication.

### BACKGROUND

Many engineering processes lack a universal standard for the accumulation, translation, and transformation of digital information across disparate end-user needs and work processes. An increase in connectivity among different computing device has led to large volume of data being created and relied upon across fragmented environments and domain areas. The more friction there is in connecting data and capabilities across and within any given set of software tools, the harder it is for data creators and for end users to draw value from the underlying information, and the easier it is for “middle-men” to monetize said data and data pipelines. As a result, entire secondary markets have emerged to try to connect data and capabilities across disparate software tools. This incompatibility of data fragments has led to many technical shortcomings. For instance, various computing infrastructure cannot efficiently communicate because they cannot freely exchange data.

Beyond the problems associated with the of incompatibility of data that is fragmented about disparate computing infrastructures, difficulties arise in presenting user-specific information to specific uses. With data about the user fragmented about disparate computing infrastructures, relevant contextual data about the user is inaccessible or difficult to collate, leading to shortcomings in the ability to generate personalized responses to a user's natural language query based on relevant user data, leading to generic or inaccurate responses that fail to meet user expectations.

Additionally, the fragmented nature of data has caused difficulties for entities to curate personal recommendations for users based on trusted sources. Rather, traditional approaches to data management and communication have resulted in providing generic recommendations from static databases and/or from untrusted sources of data.

Additionally, as the processing power of computers allow for greater computer functionality and the internet technology era allows for interconnectivity between computing systems, electronic content have become more ubiquitous. Content providers use various platforms, such as websites or other applications, to provide their content.

However, since the implementation of more sophisticated online tools, several shortcomings in these technologies have been identified and have created a new set of impediments. For example, electronic content for a given user or organization now tends to be highly fragmented across a variety of different tools and systems. The high level of fragmentation makes it more difficult to monitor the electronic content consumed by users, to extract knowledge from the content consumed by users, and to augment electronic content with other useful knowledge.

### SUMMARY

In contrast, ecosystems offer a more flexible framework that enhances coordination and leverages synergies among diverse components without sacrificing autonomy. This model fosters an integrated and adaptable approach, allowing teams to reinvent and vertically integrate components when necessary for innovation, while maintaining an interoperable framework throughout the ecosystem. Configuring themselves as ecosystems enables organizations to respond dynamically to changing market conditions, fostering an environment conducive to continuous innovation and growth. Additionally or alternatively, the systems and methods described herein provide for a front end user interface for providing contextualized and personalized data (e.g., recommendations) from the interposable framework of the ecosystem.

For the aforementioned reasons, there is also a desire for an efficient system and method to identify, extract, and improve access to knowledge and capabilities across fragmented systems by analyzing electronic content that has been, is being, or will be consumed by users (e.g., is presented to users). More specifically, there is a growing need for methods and systems that facilitate how users interact with computer systems in order to, for example, enable users to easily identify relevant actions for and perform relevant actions on any given piece of data across a variety of systems and interfaces, and facilitate users' access to relevant knowledge for any given piece of data. Methods and systems described herein can monitor and help manage electronic content, actions, and relationships between and across data and actions.

In some aspects, the techniques described herein relate to a computer-implemented method including: receiving, by one or more processors, a user query for a personalized response associated with a profile; interpreting, by the one or more processors, the user query by executing a machine-learning model; generating, by the one or more processors, a data query corresponding to the user query by executing the machine-learning model, the data query configured for execution in a computer model including one or more nodes, each node of the one or more nodes having an identifier corresponding to a series of nouns and verbs generated in accordance with a schema associated with a shared knowledge language; receiving, by the one or more processors, a first node of the computer model, wherein the first node is associated with the profile and generated based at least in part on an application accessed by the profile; and presenting, by the one or more processors, the personalized response, wherein the personalized response includes an indication of the first node of the computer model.

In some aspects, the techniques described herein relate to a computer-implemented method, further including: receiving, by the one or more processors, a second indication indicative of a context displayed by a computing device associated with the profile; determining, by the one or more processors, a second node of the computer model, the second node associated with the context displayed by the computing device; generating, by the one or more processors, a personalized prompt based on the second node, wherein the personalized prompt is a second output of the machine-learning model; and presenting, by the one or more processors, the personalized prompt.

In some aspects, the techniques described herein relate to a computer-implemented method, wherein the computer model further includes a nodal data structure of a set of nodes where each node corresponds to data identified as associated with each application within a set of applications accessed and used by each computing device, each node having an identifier corresponding to a series of nouns and verbs generated in accordance with the schema associated with the shared knowledge language, wherein the series of nouns define one or more types of data and the series of verbs define one or more software processes, the computer model transforming the data generated as a result of at least one computing device accessing and using one or more applications from the set of applications into a series of nouns and verbs using the schema.

In some aspects, the techniques described herein relate to a computer-implemented method, wherein the user query is provided in a natural language syntax.

In some aspects, the techniques described herein relate to a computer-implemented method, further including: executing, by the one or more processors, the machine-learning model to review one or more search results from the data query; and selecting, by the one or more processors, a search result from the one or more search results that satisfies a threshold.

In some aspects, the techniques described herein relate to a computer-implemented method, wherein generating the data query further includes: parsing, by the one or more processors, the user query into one or more search elements; and determining, by the one or more processors, one or more search parameters associated with the one or more search elements.

In some aspects, the techniques described herein relate to a computer-implemented method, further including: responsive to receiving a selection of the personalized response, generating, by the one or more processors, a second query based on the search result, wherein the second query is associated with the personalized response; querying, by the one or more processors, the computer model based at least on the second query; receiving, by the one or more processors, a second node linked to the first node of the computer model; and presenting, by the one or more processors, a second personalized response, the second personalized response corresponding to the second node.

In some aspects, the techniques described herein relate to a computer-implemented method, wherein at least one node of the one or more nodes represents contextual data associated with a previous response.

In some aspects, the techniques described herein relate to a system including: one or more processors; and a non-transitory computer-readable medium having a set of instructions that when executed, cause the one or more processors to: receive a user query for a personalized response associated with a profile; interpret the user query by executing a machine-learning model; generate a data query corresponding to the user query by executing the machine-learning model, the data query configured for execution in a computer model including one or more nodes, each node of the one or more nodes having an identifier corresponding to a series of nouns and verbs generated in accordance with a schema associated with a shared knowledge language; receive a first node of the computer model, wherein the first node is associated with the profile and generated based at least in part on an application accessed by the profile; and present the personalized response, wherein the personalized response includes an indication of the first node of the computer model.

In some aspects, the techniques described herein relate to a system, wherein the set of instructions further cause the one or more processors to: receive a second indication indicative of a context displayed by a computing device associated with the profile; determine a second node of the computer model, the second node associated with the context displayed by the computing device; generate a personalized prompt based on the second node, wherein the personalized prompt is a second output of the machine-learning model; and present the personalized prompt.

In some aspects, the techniques described herein relate to a system, wherein the computer model further includes a nodal data structure of a set of nodes where each node corresponds to data identified as associated with each application within a set of applications accessed and used by each computing device, each node having an identifier corresponding to a series of nouns and verbs generated in accordance with a schema associated with a shared knowledge language, wherein the series of nouns define one or more types of data and the series of verbs define one or more software processes, the computer model transforming the data generated as a result of at least one computing device accessing and using one or more applications from the set of applications into a series of nouns and verbs using the schema.

In some aspects, the techniques described herein relate to a system, wherein the user query is provided in a natural language syntax.

In some aspects, the techniques described herein relate to a system, wherein the set of instructions further cause the one or more processors to: execute the machine-learning model to review one or more search results from the data query; and select a search result from the one or more search results that satisfies a threshold.

In some aspects, the techniques described herein relate to a system, wherein the set of instructions further cause the one or more processors to: parse the user query into one or more search elements; and determine one or more search parameters associated with the one or more search elements.

In some aspects, the techniques described herein relate to a system, wherein the set of instructions further cause the one or more processors to: responsive to receiving a selection of the personalized response, generate a second query based on the search result, wherein the second query is associated with the personalized response; query the computer model based at least on the second query; receive a second node linked to the first node of the computer model; and present a second personalized response, the second personalized response corresponding to the second node.

In some aspects, the techniques described herein relate to a system including: one or more processors; and a non-transitory computer-readable medium having a set of instructions that when executed, cause the one or more processors to: receive a user query for a personalized response associated with a profile; interpret the user query by executing a machine-learning model; generate a data query corresponding to the user query by executing the machine-learning model, the data query configured for execution in a computer model including one or more nodes, each node of the one or more nodes having an identifier corresponding to a series of nouns and verbs generated in accordance with a schema associated with a shared knowledge language; receive a first node of the computer model, wherein the first node is associated with the profile and generated based at least in part on an application accessed by the profile; and present the personalized response, wherein the personalized response includes an indication of the first node of the computer model.

In some aspects, the techniques described herein relate to a system, wherein the set of instructions further cause the one or more processors to: receive a second indication indicative of a context displayed by a computing device associated with the profile; determine a second node of the computer model, the second node associated with the context displayed by the computing device; generate a personalized prompt based on the second node, wherein the personalized prompt is a second output of the machine-learning model; and present the personalized prompt.

In some aspects, the techniques described herein relate to a system, wherein the computer model further includes a nodal data structure of a set of nodes where each node corresponds to data identified as associated with each application within a set of applications accessed and used by each computing device, each node having an identifier corresponding to a series of nouns and verbs generated in accordance with a schema associated with the shared knowledge language, wherein the series of nouns define one or more types of data and the series of verbs define one or more software processes, the computer model transforming the data generated as a result of at least one computing device accessing and using one or more applications from the set of applications into a series of nouns and verbs using the schema.

In some aspects, the techniques described herein relate to a system, wherein the set of instructions further cause the one or more processors to: execute the machine-learning model to review one or more search results from the data query; and select a search result from the one or more search results that satisfies a threshold.

In some aspects, the techniques described herein relate to a system, wherein the set of instructions further cause the one or more processors to: responsive to receiving a selection of the personalized response, generate a second query based on the search result, wherein the second query is associated with the personalized response; query the computer model based at least on the second query; receive a second node linked to the first node of the computer model; and present a second personalized response, the second personalized response corresponding to the second node.

### BRIEF DESCRIPTION OF FIGURES

Non-limiting embodiments of the present disclosure are described by way of example with reference to the accompanying figures, which are Schematic and are not intended to be drawn to scale. Unless indicated as representing the background art, the figures represent aspects of the disclosure.

FIG. 1A is a graphical representation of using the methods and system described herein to generate a unified memory bank, in accordance with an embodiment.

FIG. 1B is a graphical representation of two methods for integrating various applications together, in accordance with an embodiment.

FIG. 1C is a graphical representation of two methods for integrating various applications together, in accordance with an embodiment.

FIG. 2 is a visual representation of storing data in a unified memory bank, in accordance with an embodiment.

FIG. 3 is a visual representation of an abstraction of data to integrate with various applications, in accordance with an embodiment.

FIG. 4 is a visual representation of using a unified standardization of data for various benefits, in accordance with an embodiment.

FIG. 5 is a visual representation of a developer's method of integrating data between various APIs, in accordance with an embodiment.

FIG. 6 is a visual representation of an application's method of integrating data between various APIs, in accordance with an embodiment.

FIG. 7 is a visual representation of a developer's method in using a Standard Knowledge Language, in accordance with an embodiment.

FIG. 8 is a visual representation of an application's method in using a Standard Knowledge Language to integrate data between various APIs, in accordance with an embodiment.

FIG. 9 is a visual representation of a Virtual Database with contents from various constituent databases, in accordance with an embodiment.

FIG. 10 is a visual representation of a Standard Knowledge Data Store following a Solid specification, including a Standard Syncer, in accordance with an embodiment.

FIG. 11 illustrates an architectural diagram, in accordance with an embodiment.

FIG. 12 illustrates an architectural diagram, in accordance with an embodiment.

FIG. 13 is a flow diagram of a process executed by a Standard SDK, in accordance with an embodiment.

FIG. 14 is a visual representation of an application that uses a Standard SDK together with Schemas to integrate with various different data sources, in accordance with an embodiment.

FIG. 15 is a flow diagram of a representation of a Shared Knowledge Language process, in accordance with an embodiment.

FIG. 16 is a illustrates a conceptual diagram of how a developer may leverage the concepts behind SKL to integrate with many different applications and/or accounts, in accordance with an embodiment.

FIG. 17 is a flow diagram of a Shared Knowledge Language framework using a Standard SDK, in accordance with an embodiment.

FIG. 18 depicts exploring the data inside a document through a natural-language query, in accordance with an embodiment.

FIG. 19 is a visual representation of various components that make up a Standard Knowledge Language framework, in accordance with an embodiment.

FIG. 20 is a visual representation of two different applications using a single Standard Knowledge Framework to access a single data source, in accordance with an embodiment.

FIG. 21 is a visual representation of three different applications using a single Standard Knowledge Framework to integrate with three distinct sources of data, in accordance with an embodiment.

FIG. 22 is a visual representation of Standard Syncer pulling data from three distinct data sources through the use of a single Standard SDK, in accordance with an embodiment.

FIG. 23 is a visual representation of a Persistent Database with contents from various constituent databases, using a Standard Syncer, in accordance with an embodiment.

FIG. 24 is a visual representation of several applications using a Standard SDK to access data from a data storage, in accordance with an embodiment.

FIG. 25 is a graphical user interface displayed by a rules engine, in accordance with an embodiment.

FIG. 26 is a graphical user interface displayed by a rules engine, in accordance with an embodiment.

FIG. 27 is a graphical user interface displayed by a rules engine, in accordance with an embodiment.

FIG. 28 is a graphical user interface displayed by a rules engine, in accordance with an embodiment.

FIG. 29 is a visual representation of a frontend application using a Standard SDK.

FIG. 30 is a visual representation of how a noun may be mapped to a variety of Interface Components, in accordance with an embodiment.

FIG. 31 is a visual representation of a graphical user interface using the methods of a Standard Knowledge Language, in accordance with an embodiment.

FIG. 32 illustrates a conceptual diagram of how the SKL Library may relate different SKL Attributes, in accordance with an embodiment.

FIG. 33 illustrates an Integration's profile on the Official Library, in accordance with an embodiment.

FIG. 34 illustrates a clustering of entities based on their properties and/or relationships to other Entities, in accordance with an embodiment.

FIG. 35 depicts a graphical user interface of an online word processor application, in accordance with an embodiment.

FIG. 36 illustrates some of the Nouns that an analytics server may automatically identify within electronic content, in accordance with an embodiment.

FIG. 37 depicts the composition the Official Library and some of the various SKL Artifacts and SKL Libraries that can compose it, in accordance with an embodiment.

FIG. 38 illustrates components of an electronic workflow management system, in accordance with an embodiment.

FIG. 39 illustrates a flow diagram of a process executed in an electronic workflow management system, in accordance with an embodiment.

FIG. 40 represent a nodal structure created based on a set of identified files and related nodes connected via different edges, in accordance with an embodiment.

FIG. 41 shows a series of graphical user interfaces where a SKApp may provide contextually useful information and capabilities to an end user based on electronic content and electronic context, in accordance with an embodiment.

FIG. 42a illustrate the graphical user interface of a SKApp, in accordance with an embodiment.

FIG. 42b illustrate the graphical user interface of a SKApp, in accordance with an embodiment.

FIG. 42c illustrate the graphical user interface of a SKApp, in accordance with an embodiment.

FIG. 43 illustrate the graphical user interface of a SKApp, in accordance with an embodiment.

FIG. 44 illustrate the graphical user interface of a SKApp, in accordance with an embodiment.

FIG. 45 is a graphical illustration of a system architecture, in accordance with an embodiment.

FIG. 46 depicts a nodal data structure, in accordance with an embodiment.

FIG. 47 illustrates a diagram of two Entities sharing similar properties and relationships in a nodal data structure, in accordance with an embodiment.

FIG. 48 illustrates a conceptual diagram of the Syncer SKApp, in accordance with an embodiment.

FIG. 49 illustrates a graphical user interface for SKApp, in accordance with an embodiment.

FIG. 50 illustrates a noun mapping system with a Syncer SKApp, in accordance with an embodiment, in accordance with an embodiment.

FIG. 51 shows a graphical user interface where a user is interacting with a large language model that is able to retrieve data, in accordance with an embodiment.

FIGS. 52-53 illustrate user interfaces displayed using the methods and systems discussed herein, in accordance with an embodiment.

FIG. 54 illustrates a series of steps that a SKApp may take in order to contextualize and then synthesize natural language summaries of notifications from various different data sources.

FIG. 55 illustrate user interface displayed using the methods and systems discussed herein, in accordance with an embodiment.

FIG. 56 shows a database including information about an activity, in accordance with an embodiment.

FIG. 57 illustrates a user interface for providing personalized recommendations to a user based on a SKL Platform, in accordance with an embodiment.

FIG. 58 illustrates a connection between a user's personal nodal data structure and an entity's nodal data structure.

FIG. 59A-67 illustrate user interfaces displayed using the methods and systems discussed herein, in accordance with an embodiment.

FIG. 68A-68D illustrate various entity interfaces displayed using the methods and systems discussed herein, in accordance with an embodiment.

FIG. 69 illustrates a flow diagram of a process executed in an electronic data management system, in accordance with an embodiment.

FIG. 70 illustrates a flow diagram of a process executed in an electronic data management system, in accordance with an embodiment.

FIG. 71 illustrates operational steps of a method for inferring content relationships, according to an embodiment.

FIGS. 72-74 illustrate various graphical user interfaces, according to various embodiments.

FIG. 75 illustrates operational steps of a method for inferring content relationships, according to an embodiment.

FIG. 76 illustrates a nodal data structure, according to an embodiment.

FIGS. 77-79 illustrate operational steps of methods for inferring content relationships, according to various embodiments.

FIG. 80 illustrates operational steps for an automated workflow between third-party productivity applications, according to an embodiment.

FIG. 81 illustrates a nodal data structure, according to an embodiment that corresponds with the automated workflow in FIG. 80.

FIG. 82 illustrates operational steps for two automated workflows between third-party productivity applications, according to an embodiment.

FIG. 83 illustrates a nodal data structure, according to an embodiment that corresponds with the automated workflow in FIG. 82.

FIG. 84 illustrates operational steps for an intelligently automated workflow over data regardless of source applications, according to an embodiment.

FIG. 85 illustrates operational steps of a method for triggering automations and inferring content relationships, according to an embodiment.

FIG. 86 illustrates operational steps of a method for inferring content relationships, according to an embodiment.

### DETAILED DESCRIPTION OF FIGURES

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The method, systems, and illustrated architectures are non-limiting to the concepts discussed herein. The SKL discussed herein may be understood as a methodology rather than a taxonomy.

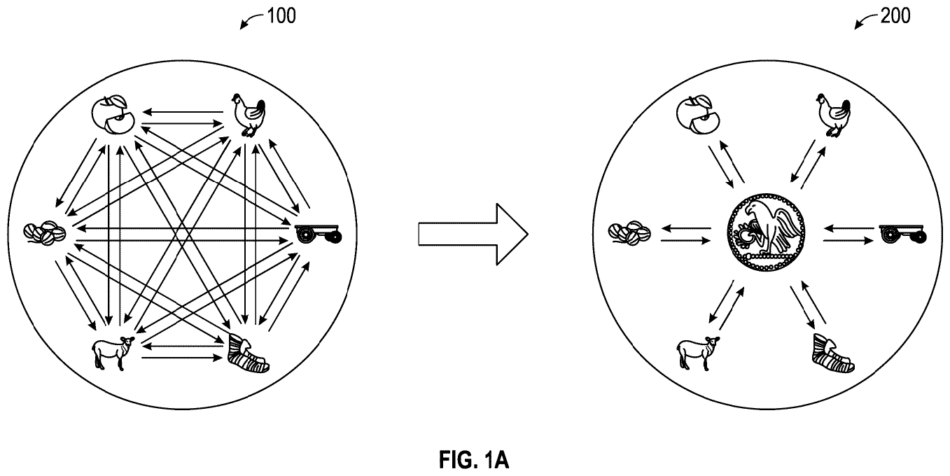

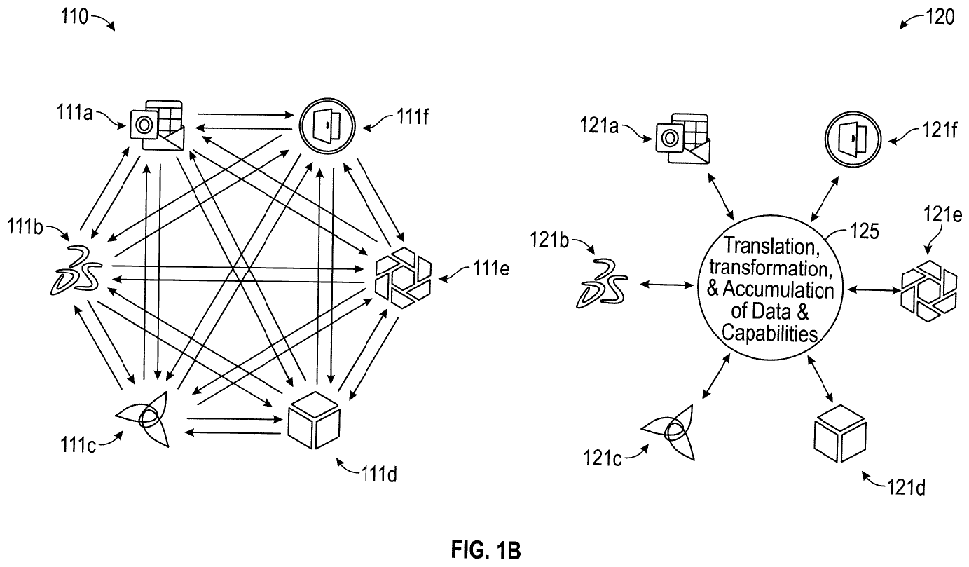

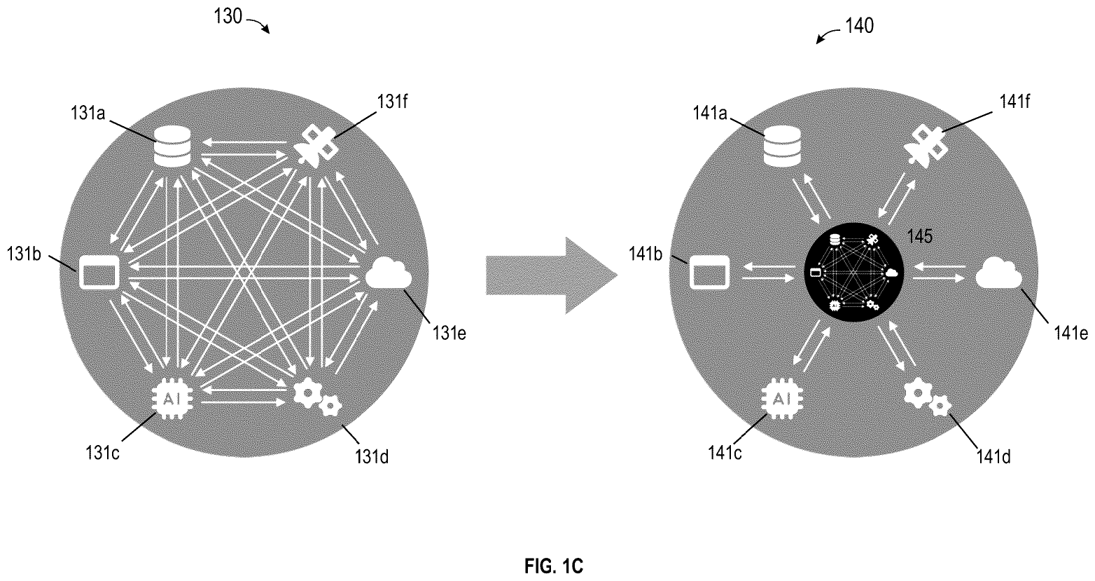

Turning now to FIG. 1A, which illustrates two different models for comparing attributes of different objects and being able to exchange and/or translate those objects. The way people integrate software today generally requires translation from one proprietary format to another (e.g., integrate Salesforce® with QuickBooks®). These one-to-one connections and translations are a sub optimal way to translate data across multiple workflows and processes. This is like society trying to trade goods and services before the standard of money as is shown in diagram 100. Before money, goods and services were bartered one-to-one and wealth was always understood in terms of a particular good (e.g., number of chickens, number of chickens produced per week, etc.).

Storing data in proprietary formats is not conducive to the accumulation of knowledge. Doing so has a higher risk of loss of, misunderstanding of, and/or incomplete data. For example, a software provider may get bought, go out of business, change some aspect of the software without your approval, etc. This is like people trying to accumulate wealth before the standard of money. Before money, people had to accumulate wealth in goods that were harder to trade with and had more inherent risks than money (e.g., all the chickens die, grain can grow stale, society decides a particular good is taboo, etc.) as is shown in diagram 102.

Turning now to FIG. 1B, two conceptual alternative embodiments for how a set of applications 111a-f (collectively applications 111) and applications 121a-f (collectively applications 121) may be integrated is illustrated. Applications 111 and 121 are to be considered the same applications, only represented as part of two different integrated networks of applications. The network of integrations 110 show an approach where each application 111 is directly integrated with every other application. In this embodiment, a developer creates, uses, and/or maintains custom software that translates the way data is represented between every pair of applications. Furthermore, the developer also creates, uses, and/or manages custom software that translates whatever capabilities (e.g., identity and access management) need to be programmatically accessed between any pair of software applications. In some embodiments, the developer of each application vendor tends to be responsible for connecting their application with as many other relevant applications as makes viable business sense.

Moreover, in some embodiments, these different connections and transformations between applications and systems tend to be created and managed in different programming languages, via different integration platforms using different technologies, and through other fragmented approaches. This makes it difficult for users, organizations, and developers to effectively manage rapidly changing ecosystems of integrated data sources, applications, digital solutions, and other integratable systems like artificial intelligence models, software, sensors, and technology products. FIG. 1C shows two conceptual alternative embodiments for how a set of databases 131a, software applications 131b, AI models 131c, processes 131d (e.g., analog or digital business processes), cloud services 131e, and other systems 131f (e.g., sensors, satellites, mainframes, etc.) (collectively applications 131) and applications and systems 141a-f (collectively applications 141) may be integrated. Applications 131 and 141 are to be considered the same applications, only represented as part of two different integrated networks of applications. The network of integrations 130 show an approach where each application 131 is directly integrated with every other application. In this embodiment, multiple different developers are likely responsible for each of the applications 131. These developers are likely to create, use, and/or maintain custom integrations and transformations between their application 131a-f and other relevant applications 131. This leads to fragmented ecosystems integrations, translations, and logic between applications 131 created using various technologies, systems, hardware, SDKs, and implementations strategies. These fragmented ecosystems are hard to manage, govern, understand, debug, improve, and generally work with.

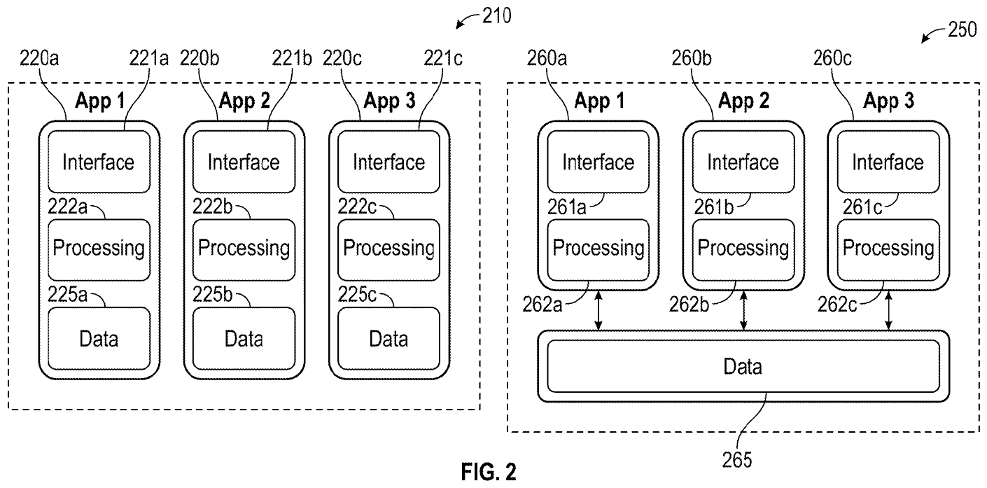

FIG. 2 illustrates two exemplary conceptual architectural diagrams for a set of software applications used by a given person or organization. Architecture diagram 210 is illustrative of a software architecture for applications where the software developer or vendor for each application bundles custom interfaces 221a-c, custom processing logic 222a-c, and custom data models 225a-c with the corresponding data storage (e.g., infrastructure, etc.) into their platform 220a-c. Integrating the various platforms 220a-c may be done according to the network of integration 110 of FIG. 1B. Each custom interface 221a-c may be built to only support the capabilities from its respective platform 220a-c, creating one-to-one integrations between each pair of platforms 220a-c.

Referring back to FIG. 1B, a schema-driven semantic integration network 120 provides an alternative embodiment wherein rather than integrating each application 121 with every other application 121, each application 121 is only integrated once through a common data and capabilities model 125 (i.e., a sematic layer). In some embodiments, this semantic network of integration 120 may shift the integration paradigm away from trying to integrate each application with other applications, and towards integrating each application through a relevant ontology or ontologies (e.g., the common data and capabilities model 125) that represent the necessary data types and software capabilities. In this embodiment, each application 121 may still expose a programmatic interface (e.g., an API) that facilitates integration.

Further, a developer may choose to translate the data and capabilities from at least two applications 121 into or through a common—or “standard”—ontology rather than trying to build an integration that translates the custom logic and data exposed via the programmatic interface of a first application 121 with the custom logic and data from a second application 121. In one illustrative embodiment, the semantic network of integration 120 may not require the data be stored in a standard ontology, but rather that it is translated through that standard ontology. In another embodiment, the semantic network of integration 120 may store a portion of the data in a standard ontology and translate another portion through the standard ontology.

This non-limiting alternative semantic network of integration 120 embodiment may encourage application developers to offer integrations to ontologies, rather than integrations to other applications. This semantic network of integration 120 may be more scalable as an application only has to be integrated once with a given ontology (and through it, connect to many different applications) rather than being integrated multiple times for every other relevant application. It encourages building, using, and maintaining integrations “to” use cases and domain areas (through the related ontologies) rather than simply trying to directly integrate every application within those use cases and domain areas. For example, developers of a healthcare application might offer a single integration to the FHIR ontology rather than trying to integrate directly with every other application. In industries, like productivity, where a standard ontology has been more historically elusive, developers could offer integrations to a variety of different ontologies in order to meet various the needs of their users.

In alternate embodiments where the likeness of a perfect unified abstraction that can suit all needs is low, FIG. 1C shows a schema-driven semantic mesh 140 that facilitates standardized integration of connections between various applications 141 using schemas. In this embodiment, schemas are used to represent the data and capabilities of each application 141 in their native formats without forcing all communication through common data model or “unified” semantic layer. This semantic mesh 145 allows both the use of connections with native data formats and endpoints through schemas well as interaction through a common data model or unified semantic layer. The schema-driven semantic mesh 145 facilitates the representation of interaction with the various native components (e.g., API endpoints, user interfaces, keyboard shortcuts, etc.) that make up applications 141 is provided in standard ways (e.g., using the schemas) regardless of the underlying technologies, APIs, and hardware systems, etc. It also facilitates the schema-driven representation of business logic, data transformations, governance and compliance policies, and more such that developers, users, and organizations can have a holistic understanding of their ecosystems.

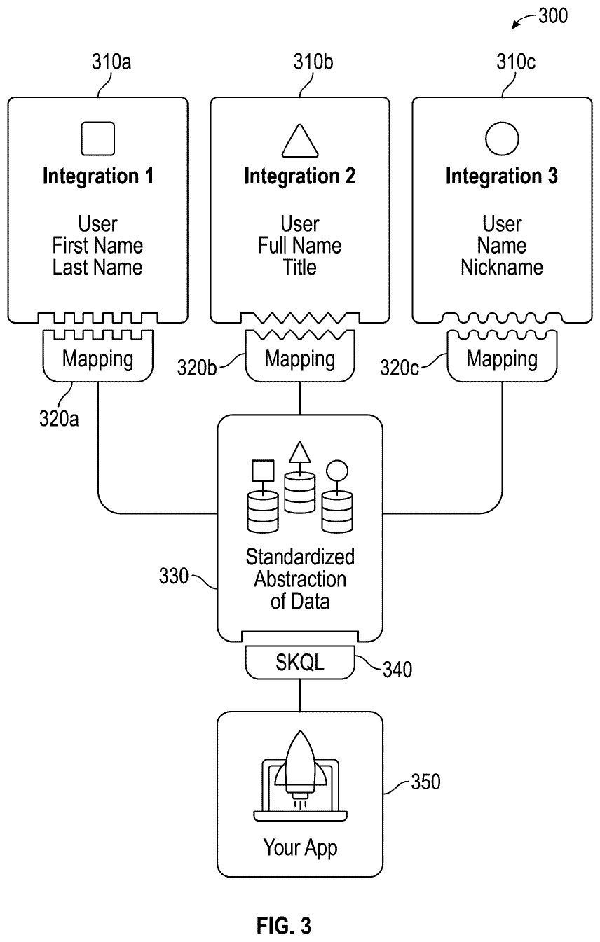

FIG. 3 illustrates a non-limiting embodiment of a data integration method 300 showing four different applications 310a-c and 350 that are semantically integrated through a standardized data Schema 330. Each application 310a, 310b, 310c, or 350 may choose to store and represent data in custom ways (e.g., according to custom Schemas). For instance, the developer(s) of application 310a may choose to represent to a user in a different way than how application 310b or application 310c represent users. Similarly, the developer(s) of application 350 may also choose to store a user's data according to a custom Schema or representation that is different from the other applications 310, and also different than the standardized data Schema 330. In other words, each application 310a-c or 350 may use unique representations of user data that follows custom Schemas with custom fields and properties.

In this embodiment, the standardized data Schema 330 establishes standardized fields or properties for the necessary data types, such as user data type. In this non-limiting example, these standardized data Schema 330 may be mapped, translated, and/or transformed with Mappings 320a-c to the custom Schemas for the integrated applications 310a-c. The business logic and associated processing for this embodiment may be invoked through application 350, which means that application 350 may use an interface 340 to call on data according to its standardized data Schema 330. The developers of application 350 may then determine the appropriate action to take with the returned data.

Referring back to FIG. 2, the software architecture 250 shows yet another non-limiting alternative embodiment wherein the software architecture allows the multiple applications 260a-c to access data in a standardized way, according to a standardized data model. This software architecture 250 may use the various data integration methods described through in FIG. 1B and FIG. 3. Regardless of whether the data from applications 260a-c are consolidated in a standardized way, each application 260 may be able to access the data in a standardized way. In this way, the applications 260a-c may collectively provide data through a single interface, which may be considered an authoritative source of truth (the “ASOT”). More than offering a standard interface for data access, alternate embodiments may also offer standard ways of accessing software capabilities, interfaces, infrastructure, AI-models, and more.

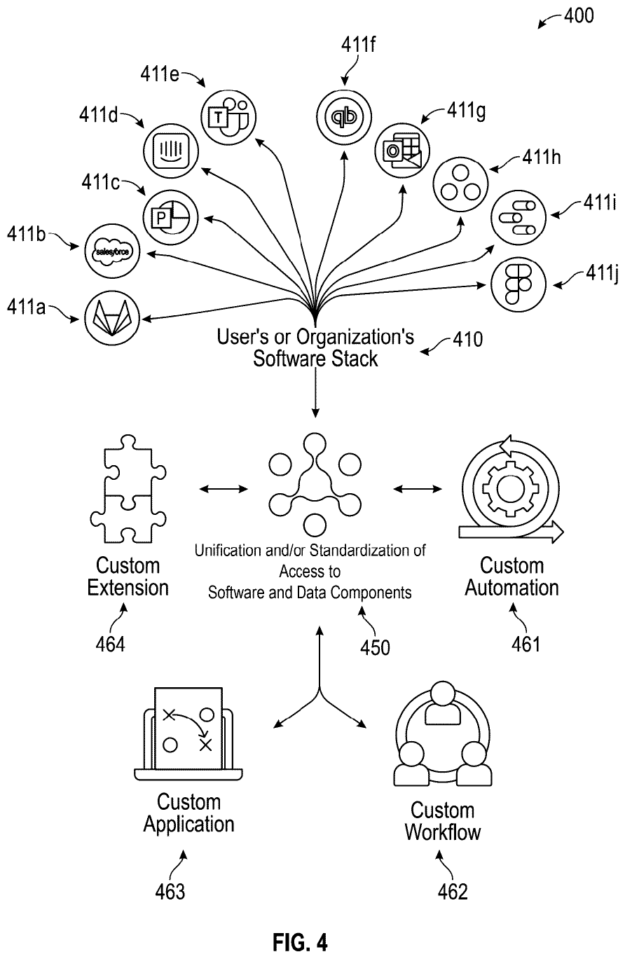

Turning now to FIG. 4, according to some embodiments, a standard knowledge language (“SKL”) framework 400 illustrates an embodiment wherein data and capabilities may be unified and shared across software applications 411a-j (e.g., applications, platforms, tools, extensions, etc.). By way of example, using the methods described herein, a user or an organization may establish a standardized and/or unified interface 450 to access all the data, capabilities, and software components they rely on. Applications 411a-j, like those from a user's or an organization's existing software stack 410, may be semantically integrated so that any software may independently interact with the data and software capabilities from the one or more of the various applications through a unified data and standardized and unified interface 450. In this way, the SKL framework 400 may provide a flexible methodology to transform a user's or an organization's fragmented software experience into a unified and parametrically configurable one that exposes all the relevant data and software capabilities pertaining to that user or organization. This, in turn, may allow the user or organization to easily build and manage custom automations 461, custom workflows 462, custom applications 463, custom extensions 464, and more. In other words, establishing a unified and standardized access point to software components such as data and software capabilities may significantly improve a user's or organization's capacity to innovate.

Developers may use software development kits (“SDK”) or other code packages to connect data and capabilities from each unique codebase with data and capabilities from other external software platforms. For example, a developer creating a new custom software application might use Apple's iOS® SDKs or Google's Android® SDKs to help the software exchange information with and leverage the capabilities of each third-party platform. Similarly a developer building an app that needs to interact with external file storage systems like Dropbox® and Box® might add the SDK for each platform into the app's codebase in order to facilitate interactions between the app's data and capabilities and those from Dropbox® and Box®. These SDKs may facilitate the communication between the app's codebase and the APIs offered by each platform, for example by including tools that handle HTTP requests, errors, and more.

In some configurations, the SKL framework 400 uses the SDKs, which may be written in a variety programming languages. Like the aforementioned SDKs (e.g., proprietary SDKs), a Standard SDK is a packaged collection of software development tools that may help developers connect their codebases with one or more external databases, software, platforms, etc. In one embodiment, the SKL framework 400 uses a Standard SDK to allow the developer to use one SDK to establish connections with a theoretically infinite number of external platforms rather than having to use a different SDK for each platform that the developer is trying to connect with however. However, in some configurations, the SKL framework 400 may use multiple software development kits.

In this configuration, developers need not rely on multiple different proprietary SDKs to offer core tools (e.g. that help handle HTTP requests, rate limits, errors, etc.), because a Standard SDK offers these as shared tooling that may be used to interact with many different external databases, platforms, APIs, etc. The differences between and across various external platforms APIs and/or their respective SDKs are represented through easily manageable configurations according to the SKL framework 400, such as Mappings from various data representations to a standardized data model. This may remove a significant amount of complexity from a codebase as well as the need for a given codebase to use many different SDKs. Moreover, because the customization necessary for a Standard SDK to support different platforms and use-cases is largely stored as configurations (e.g., the flexible and dynamic Schemas mentioned herein), these customizations may be shared across different applications and various Standard SDKs written in different programming languages (e.g., Standard SDK in JavaScript®, Standard SDK in Rust®, etc.).

The Schemas and configurations, for example, may be used to describe external databases, APIs, platform capabilities, etc. in a way that a Standard SDK may understand them. The Schemas and configurations may also be used to describe a codebase's data model and capabilities, as well as Mappings and translations between external platforms' data and capabilities models and those within the codebase using a Standard SDK.

Turning to FIG. 4, the SKL framework 400 is now described in various non-limiting embodiments herein to illustrate various alternative Schemas and configurations wherein a Standard SDK may be used.

A conceptual example aids in the understanding of the SKL framework: a developer 502 is building a workplace chat software application that brings teams together and empowers them deliver work more efficiently in an asynchronous way. The app does this by helping team members organize their communication into conversations with a dedicated purpose (e.g., a channel dedicated to a given project). Naturally, its users end up sharing and discussing relevant information, links to research, docs, presentations, and more with each other through the chat application.

Currently, when the users share a link to a file or a task with someone, the app has no way of knowing if the person the user sent the link to actually has access to the file or task. The sender of that link has no way of checking or controlling whether the receiver of the link may access its contents without leaving the app. The receiver often has to check their email for sharing notifications, which reduces the value of the app. Overall, this process may result in some back and forth between the sender and receiver trying to coordinate the shared element's permissions, which leads to lost productivity for the app's users, and which may ultimately hurt the app's chances at success in the market. The developer decides that a better, more integrated solution, is one that automatically checks the permissions of the shared element when a user sends it. If the app identifies that the receiver does not have access to the shared element, then the application immediately prompts the sender about modifying the permissions accordingly within its interface. In this way the sender and the receiver save time in achieving the desired result, the application is appreciated for streamlining that process, and the value of consolidating all related work in a contextual conversation is achieved.

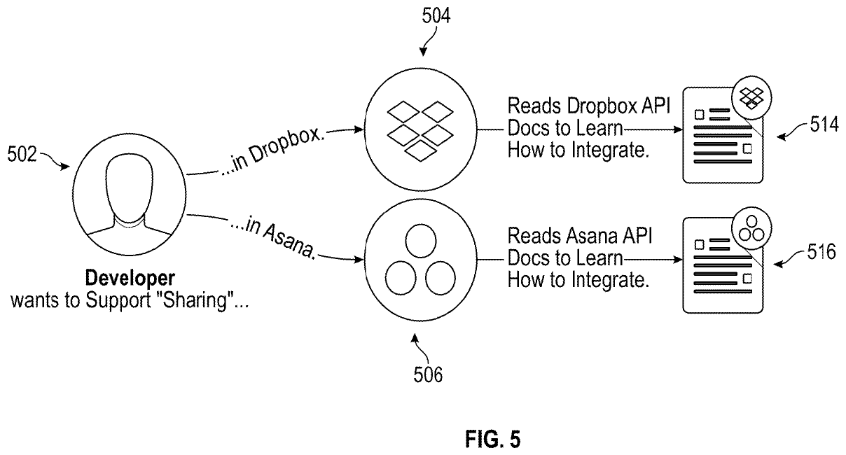

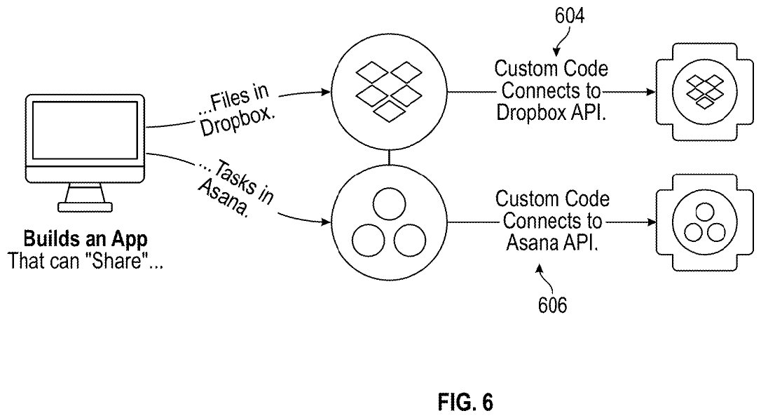

Solution Method 1—Solve the problem without the SKL framework 400 of FIG. 4 (in conjunction with FIGS. 5-6).

As the developer 502 plans for how to build this with their available resources, they likely need to decide which integrations are the most valuable and which to prioritize. They start to evaluate which tools are most prevalent amongst their users and identify Dropbox® 504 and Asana® 506 as the top two, so they decide to build those integrations first.

Their immediate next step is likely to look through the API documentation 514, 516 for each tool in order to understand if and how they support the functionality they want to offer. They find that Dropbox® 504 provides unique API endpoints with custom arguments to manage permissions and sharing, and that Asana® 506 similarly has its own custom API endpoints and formats. Ultimately, they confirm that the platforms both support the functionality they want, albeit in different ways.

As the developer 502 moves past research into planning and execution, they likely start to write out the logic 604, 606 for potential functions and processes in the app's code that may call the respective endpoints for each of these APIs. They look for and install SDKs for Asana® and Dropbox® that match the programming language the app is written in and start building out some methods to test. They try to architect their system with maximum modularity, but ultimately end up having to create different functions that call the respective SDKs and/or APIs for each integration they want to support. Finally, they have to test that each of these functions works well and debug each until it performs as desired.

Developer 502 of FIG. 5 then is ready to release their first two integrations, and the users enjoy the results. The users ask the developer to do the same type of integration for twenty other apps. The developer quickly realizes that their success has created a lot more work and they go back to thinking about how to build the next ones. Looking back, the developer recognizes how much more time integrating the first two took than they would have liked. In many cases, this process is measured in weeks or months (or even years in particular circumstances) from the start of research, through planning, execution, testing, and the final production-ready release. As the developer moves on to the next integrations they hope the process is faster and simpler than before, however, they still need to research each new tool's API and find SDKs that exist in their programming language, create new functions that call the SDKs or APIs in order to achieve a desired result, test them, maintain them, and so on.

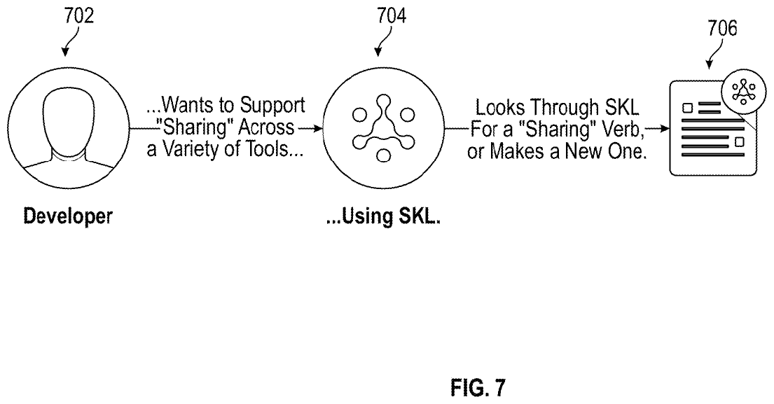

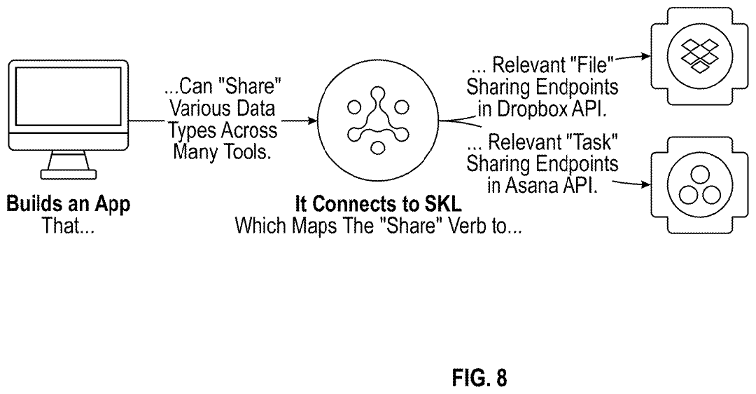

Solution Method 2—Solve the problem with the SKL framework 400 of FIG. 4 (in conjunction with FIGS. 7-8).

Turning now to FIG. 7, the moment that the developer 702 decides they want their users to be able to share work elements from other tools within the app's interface, they could instead decide to use the SKL framework 704 to integrate the various applications. Instead of choosing a few specific tools to build their first integrations with and researching each of their third-party APIs, now they simply have to install a Standard SDK and either find existing or create new Schemas that the Standard SDK may use to connect the codebase with the various external platforms.

In this case, the developer 702 wants their users to be able to “share” work elements from other platforms within the app, so they either find Schema 706, either existing (e.g., publicly available) or create their own to represent the “sharing” capability they want their app to support. Similarly the developer will add other Schemas (e.g., OpenAPI and OpenRPC Schemas) to the codebase that represent the APIs of the various platforms they want to integrate as well as Mappings that relate the “sharing” Schema with the capabilities in the various platform APIs.

By using the SKL framework 704, the developer 702 is then able to reference the “share” capability directly within their code. This means that they do not have to write out any unique code or logic for each third-party integration. Furthermore, the app's code does not need to have any custom code that deals with third party SDKs or APIs. Instead, the developer is now able to build all the application logic over the “share” capability represented through the Schema, which abstracts and standardizes the capabilities from a potentially infinite number of unique third-party “sharing” endpoints.

FIG. 8 further illustrates the extended benefits of SKL framework 704 of FIG. 7. Now no custom logic has to be rewritten as code every time a developer wants build a new integration. All that remains to be done is find or create a Mapping between the Schema for “share” and the sharing endpoint for each desired external platform's API. This enables the developer to now build each of their next twenty integrations in a matter of minutes or hours, rather than weeks or months. Moreover, because the “sharing” capability and the Mappings are represented as Schema and are therefore defined through configuration rather than some specific programming language, they are able to be shared across projects written in different programming languages (e.g., Python or JavaScript).

### Descriptions of Terms and Concepts

In some non-limiting embodiments, standard knowledge language (“SKL”) may define a protocol that empowers data sovereignty, software interoperability, and end-users' capacity to create and innovate through software. It may facilitate the abstraction of software into components and create a standard for semantic connection between software components and data. Through these abstractions, SKL may empower developers and end users to more easily create combine, customize, and maintain software components in order to build solutions that are tailored to their unique needs. Moreover, SKL may provide a way for developers and end-users to have more control of their data by storing data locally, on a cloud, or on other infrastructure of their choice. More than data, applications may also be deployed in a decentralized way as SKL enables anyone to contribute components (e.g., ontologies, interfaces, data stores, etc.) to the ecosystem, as well as develop components for use in private ecosystems.

### Schemas

According to some embodiments, the abstractions in an SKL framework that make up the components may be called Schemas. A “Schema” in a SKL framework may define the composition and configuration of a data type, software capability, interface component, Mapping, cron schedule, OpenAPI specification, and/or some other aspect of SKL-powered software function. SKL Schemas may be compatible with existing technologies such as the W3C Semantic Web technology stack (RDF/OWL/SPARQL) and existing libraries/dictionaries like Schema.org and FHIR that represent rich and complex knowledge about things, groups of things, and relations between things. Schemas in SKL may inherit from other Schemas. Schemas may be stored in a variety of ways such as, but not limited to, one or more files in a codebase, a set of triples in a graph database, one or more rows in a relational database, and data in decentralized blockchains or other networks. Schemas may similarly be accessed and/or referenced in a variety of different ways, including REST APIs, GraphQL APIs, SQL queries, SPARQL queries, and more.

### Entities

According to some embodiments, an “Entity” may be an instance of data conforming to a Schema, often corresponding to a thing or capability in the real world. Like Schemas, Entities may be stored in a multitude of ways, including one or more rows in a relational database, in multiple triples in a single RDF store, in multiple triples across multiple databases, and so on.

### Unique IDs

According to some embodiments, a SKL may support the demarcation of certain properties on an Entity as identifiers, including but not limited to uniform resource identifiers (“URIs”), contextually unique entity identifiers (“CueID”), universally unique entity identifiers (“Unique IDs” or “UIDs”), or universally unique identifiers (“UUIDs”). SKL Schemas may use these various identifiers extensively to access and/or compare Entities. Identifiers like CueIDs and UIDs may be used to de-duplicate Entities.

A CueID may be used to identify the uniqueness of a given Entity within a certain context. For example, if a given database contains two different Entities that represent the same thing and a user manually confirms that the two Entities are instances of same thing, then the two Entities may be given the same CueID (e.g., the URI of an Entity of type DEDUPLICATED ENTITY). In some embodiments, CueIDs may be automatically generated (e.g., through the creation of Relevance Scores). SKL may allow for a certain tolerance of uncertainty in determining the uniqueness of an Entity in order to create or use a corresponding CueIDs.

In some embodiments, a UID may be used to identify the uniqueness of a given Entity across all contexts. For example, take two entities that represent the same thing yet exist on two independent systems. If those entities are processed by a third system using SKL to generate UIDs, then they may each be given the same UID and subsequently identified as duplicates. Certain software processes may be used to generate UIDs for given Entities so that they may be compared across all contexts in which an Entity might exist (e.g., a SHA-3 hash for file contents, feature vectors built with the data within and/or related to an Entity, etc.). In an alternative embodiment, certain properties on a given Entity may be used to establish a UID (e.g., a social security number for Entities of type PERSON).

SKL Schemas may be used to indicate which fields may be used as UIDs with given types of data. Using the methods described elsewhere herein, the configuration necessary to do so may be recorded in any number of ways. For example, a PERSON data type could have a property that lists what fields are UIDs for PERSON Entities. In a separate example, a PROPERTYIDENTIFIER data type could be established. The Schema for the PROPERTYIDENTIFIER data type could specify that it is composed of the following properties: a URI, a SchemaEntity, a property, and an IDENTIFIERTYPE. An Entity of type PROPERTYIDENTIFIER could be instantiated as follows:
URI=HTTPS://EXAMPLE.COM/PERSONSOCIALISPROPERTYUID
SCHEMAENTITY=PERSON
PROPERTY=SOCIALSECURITY NUMBER
IDENTIFIERTYPE=UID.

This https://example.com/personSocialIsPropertyUID Entity could then be used by a software process (e.g., “Verb” as defined below) that looks for UIDs associated with given types of data (e.g., “Nouns” as defined below) in order to deduplicate the Entities of those types.

Schemas and Entities in the SKL may have URIs, including Nouns, Verbs, Integrations, SKDSs, Events, Code Packages, and the like (these terms are defined below). This increases the ability of SKL's linked data structure to semantically track provenance of data and the activity of users. Moreover, Interfaces may query and display any information associated with a given URI. For example, an Interface displaying the profile of a PATIENT Entity (according to FHIR ontology), may also display other information associated with that patient Entity's URI, including activity Events, related DOCTORS, MEDICATIONS, and so on. Similarly, provenance and activity may be queried and used by a software process to generate insights about data, deduplicate data from different Data Sources, or alert users of abnormal data or behaviors by their collaborators.

### Relevance Scores

According to some embodiments, a SKL may use “Relevance Scores” to establish likeliness of relatedness between any two Entities. Relevance Scores (sometimes referred to herein as confidence scores) may be used to de-duplicate data and Entities, to establish a likelihood that a given classification may be added to data, capabilities, and/or relationships between Entities, and for other reasons. There are many methods that may be used to establish Relevance Scores and that may be used for a variety of different use cases. Any pair of Entities may have one or more Relevance Scores that may be calculated In any number and/or combination of ways.

Non-limiting embodiments of methods to calculate Relevance Scores are described briefly here. Unique feature vectors of n-dimensions may be created for each Entity and the underlying data, properties, and relationships in order to compare them by, for example, calculating the L2 distance (Euclidean distance), cosine similarity, and inner product (dot product). Jaccard similarity coefficients may also be calculated to measure the similarity between two Entities and compare their underlying data, properties, and relationships. Pearson correlation coefficients may also be calculated in order to measure the linear correlation between two Entities and compare their underlying data, properties, and relationships. Machine-learning, computer vision, and/or natural language processing algorithms may also be used to train models that may establish one or more Relevance Scores between two Entities.

These and other various embodiments may use the data associated with an Entity to create CucIDs and/or UIDs, including but not limited to the Entities' properties, contents, related Entities, related activity and interaction data, related provenance data, etc.

### Nouns

According to some embodiments, Nouns may define the Metadata fields and properties which Entities that follow that Noun's Schema may include. These properties may include Primitives and relationships to other Nouns. “Primitives” include the standard primitives in most programming languages: NUMBER, BOOLEAN, STRING, ARRAY, etc. Relationships may be of any cardinality (one-to-one, one-to-many, or many-to-many), though they will likely be labeled (making cardinality obsolete) because implementations of persistence in SKL software may often be built using a graph model.

In yet another embodiment, a Noun may provide a “standardized” representation of a type of data structure used by one or more software tools (e.g., FILE, PERSON, TASK, PATIENT, etc.). Nouns may allow for those data types to be used by a Standard SDK. Many software tools use data structures with the same name but with slight differences. The data source Facebook® has a variety of different data types (e.g., PERSON, EVENT, PRODUCT, VIDEO, IMAGE, MESSAGE). Other versions of these data types may also be found in other data sources. Some version of the PERSON data type also exists in Gmail®, Dropbox®, LinkedIn®, Salesforce®, etc., as contacts, sender, user, social profiles, and more. Nouns may be used to represent the unique data representations from each data source, as well as to establish standardized data representations that facilitate the data access and manipulation across software tools.

In one non-limiting embodiment, Google Drive® and Dropbox® each use their own data structure FILE to represent files. Two copies of the exact same file that are stored in each service are likely to be stored, represented, and accessed differently across the two services. While Nouns may be used to represent the unique ways that FILE data types are represented in both tools, they also enable the creation of a standardized representation of a FILE data type which acts as a sort of shared middle ground that developers may write code to interact with. In other words, a standardized FILE Noun may be used by a developer along with Mappings to each software tool's unique data structures, and/or the interfaces that expose them, so that the developer may not have to integrate with and build custom logic for different representations of files provided by the two data sources. A standardized Noun may have fields that are not supported by every tool. For example, a FILE on a hard drive might not have sharing permissions, whereas a FILE on OneDrive® might. Both may be mapped to a standardized FILE Noun.

According to some embodiments, Nouns may be extendable and customizable, allowing developers to add or change data types and fields according to their unique needs. For example, a developer might start using the FHIR ontology and the representation of PATIENT it offers when building a custom application. This developer might realize that their custom application may need additional fields that FHIR does not offer. Using SKL, the developer may create a “fork” of the FHIR PATIENT Noun, in order to make whichever changes or add whichever fields they need for their use case. SKL's Schema manager may automatically create and manage the Mapping of fields between the Schema for FHIR PATIENT and the developer's custom PATIENT Schema. In this way, the developer may customize and extend Schemas without losing interoperability with other components that have been mapped to FHIR PATIENT.

As mentioned herein, in some embodiments, Nouns may have relationships with other Nouns. For example, one Noun may be a sub-type of another Noun, causing it to inherit properties and other attributes from their parent Noun or Nouns. Any particular Entity (e.g., an image of George Washington with a mountain in the background) may be associated multiple types of Nouns (e.g., FILE, PNG, embedded PERSON, and embedded MOUNTAIN). This means that the image Entity may contain or access properties and attributes from the various Nouns that are associated with it according the Schemas available. In this example, SKL may provide a way for the image Entity to add properties from the various associated Nouns, as well as make it easy to access actions and/or software processes (a.k.a. “Verbs” as defined below) associated with various related Nouns. For instance, the IMAGE Noun could help software applications automatically provide the image Entity with related capabilities such as COPY, RENAME, IMAGEOBJECTRECOGNITION, etc., and the PERSON Noun could help provide capabilities such as RUNFACIALRECOGNTION, CALL, etc.

Because a PERSON Noun may have been identified in the image Entity, SKL is able to help the application easily configure a process that automatically uses the RUNFACIALRECOGNTION capability on the image, thereby creating a Unique ID or CueID in order to link the image with a corresponding person Entity (e.g., an Entity of type PERSON for George Washington). In turn, linking the image with the George Washington Entity may establish connections to the data and capabilities that the George Washington Entity has associated with it. This means that the application could provide capabilities such as CALL or MESSAGE George Washington. Similarly, if the there is a process that may be used to identify a location based on the image of the mountain in the background, then the application may offer capabilities such as GETDIRECTIONS, GETWEATHER, and the like.

### Verbs

According to some embodiments, the types of Schemas that define extensible, and often standardized, abstractions of software capabilities in SKL may be called “Verbs.” In other words, a “Verb” may provide a “standardized” representation of a certain software process or capability offered by one or more software tools (e.g., SHARE, SEND, DOWNLOAD, LIKE, SUMMARIZETEXT, GENERATEIMAGE, etc.). Verbs may allow for those capabilities to be used by a Standard SDK. Like their unique data structures, many software tools expose similar capabilities that vary slightly in their inputs, outputs, and execution methods, even though they may have the same meaning or eventual effect.

A task management platform such as Asana® is likely to offer capabilities such as create task, assign task, and share project. Other software tools may also offer similar functionality, and expose those capabilities in very different ways. For example, the SHARE capability also exists in Egnyte®, Medium®, Polymail®, etc. However, the sharing that each of these tools offers may correspond to different data types, have different options for controlling permissions, and more. Verbs may be used to represent each software's unique capabilities, as well as to establish standardized representations for capabilities that may be used in conjunction with other Schema and configurations, such as Mappings, to be able to access capabilities across software tools.

In some embodiments, Verbs may use, act on, and process data (e.g., provided as Nouns or primitives), their relationships, and provenance in standardized ways. They may create a simplified way through which developers may use the capabilities of multiple software tools and services without having to know the distinct requirements of each. Verbs may be configured to be run at a specific time, upon a specific schedule, or in response to specific events, for example in response to an event from a webhook registered with the API of an Integration. Verbs may be composed together to form larger processes or other Verbs.

The Schema for a particular Noun may include configuration that specifies relevant Verbs for Entities of that data type. In some embodiments, certain Verbs may be listed under a DEFAULTACTIONS property for Entities of a given Noun. In this scenario the Schema for that type of Noun would define DEFAULTACTIONS.

For example, the Schema for a person Noun might define:
DEFAULTACTIONS=HTTPS://STANDARDKNOWLEDGE.COM/VERBS/CALL, HTTPS://STANDARDKNOWLEDGE.COM/VERBS/MESSAGE.

An application which uses that PERSON Noun may therefore easily provide the capabilities that correspond to the default Verbs listed on the Schema of that Noun. An application may also provide other capabilities that are not listed as DEFAULTACTIONS for in the Schema of that Noun. For example, the developer of the application could create custom functions that could be mapped to Verbs. The developer might choose do so in order to increase composability, and to facilitate the reuse of software functions across applications and use cases. In this way, that developer could upload their Verbs to a library and be able to semantically and contextually find them, and use them, at a future point in time.

In yet other embodiments, the Verbs available to an application using a Standard SDK (defined below), or to an end user of such an application, may be defined via Schemas. Each Verb Schema may define Metadata about the Verb such as its name and description, as well as its standard inputs and outputs. In addition to a Verb Schema, a Mapping (defined below) Schema may determine what will happen when a Verb is called, how the Verb's standard inputs will be translated into the inputs of the specific implementation referenced by the Mapping, and how that implementation's output will be translated into the standard outputs of the Verb.

Non-limiting examples of what may happen when a Verb is called include:
one or more web requests are sent to an external server in the form of: (i) HTTP requests to an API such as a REST API or GraphQL API, or (ii) a Remote Procedure Call (RPC) such as JSON RPC;
the execution of one or more functions or methods from a code package either: (i) included in the server, container, or other accessible infrastructure of the Standard SDK in any way, including as one or more files, as a variable stored in memory of a running software program which Standard SDK has access to, etc., (ii) downloaded from a remote address; or
one or more queries are sent to a database for example using a JDBC Driver, ODBC driver, or other connection manager or protocol which a database communicates with.

In an embodiment represented herein, Verbs may trigger processes that run on a different server, or a different network address, than the server, container, or infrastructure running Standard SDK. For example, there may be a process running on a server separate from the application that invoked a Verb which is built to run background jobs to parse the contents of files. In such a case, a Mapping may be used to specify how to translate the Verb and its inputs into the IP address, endpoints, and parameters to send in the form of a web request to the external service. The Mapping also may specify how to translate the response of the web request into the expected standard output of the Verb. In some embodiments, to perform these translations, SKL defines Integrations as an abstraction of tools, services, or data sources running externally to the application that invokes a Verb, such as the integrations discussed herein.

In an embodiment represented herein, Verbs may trigger the execution of code that is run within the same application, server, container, infrastructure, or environment as the application that invokes the Verb. This code may be run in either the same or a separate process or thread than the one which invoked the Verb. For example, a Mapping associated with a Verb may specify a translation in the RDF Mapping Language (see RML) which includes one or more functions to execute and as well as their parameters, identified via URIs. When the Verb is called, a Standard SDK may use an RML Mapping Engine, implemented in a specific programming language, to execute the RML Mapping.

The application or program running the Standard SDK may either supply the implementations of the functions identified via URI to the RML Mapping Engine, or they may be pre-packaged with the RML Mapping Engine. In another example, an SKL Mapping associated with a Verb being invoked, may specify one or more functions or methods exposed by a package of code to execute. In some embodiments, SKL may define an abstraction called a Code Package to represent these packages of code and the functions and methods they expose in a standard way (see Code Package). Code Packages may specify their required environments and dependencies and may only be used by an application, server, container, or other infrastructure running a Standard SDK if it adheres to those requirements.

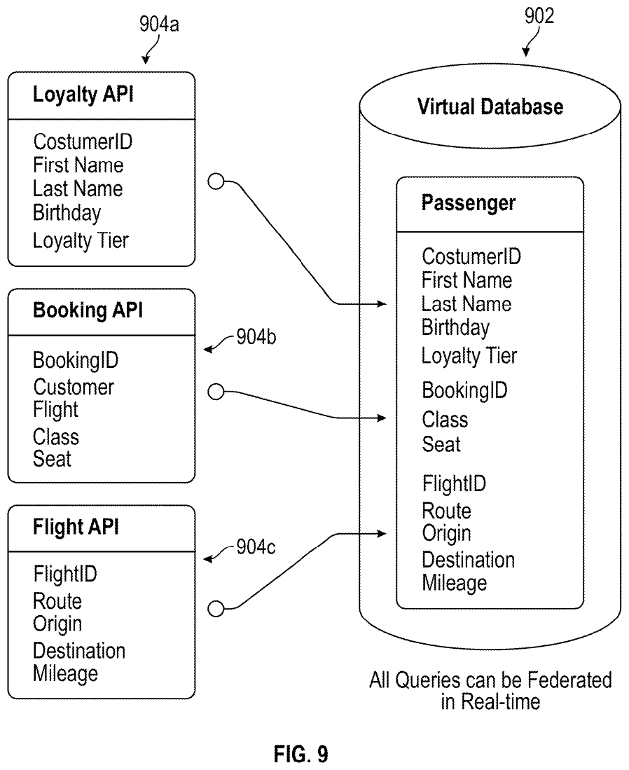

In an embodiment represented herein, and illustrated in FIG. 9, Verbs may trigger one or more queries to be sent to one or more databases. In one such embodiment, there may be an SKL Schema which serves as an abstraction of queries to the database. For example, the abstraction might include an operation called “getUsers.” This operation could be mapped to a hard-coded query to a database to select a subset of fields from all records in the “users” table of the database. This abstracted operation could be listed along with any expected parameters and/or return values. Alternatively, there may be an SKL Schema which serves as an abstraction on the structure of the database(s) so that queries may be submitted to the database(s) in a domain model more familiar with a developer. To do so, a Standard SDK might use a Virtual Database 902 technology which, when queried, federates requests to multiple databases and/or multiple tables of those databases to construct a complete response in the format of the domain model. Such a Virtual Database 902 may be used not only to federate queries to multiple databases but also to one or more web APIs 704a-c (e.g., REST, GraphQL, etc.), or files (e.g., JSON, CSV, etc.).

Verbs may also use as input a collection of Entities of one or more types of Nouns. For example, the Verb to send a file may require an Entity of type file to be sent, along with a list of one or more Entities of type person. Instead of using the full object representation of a piece of data, the Action could use an identifier or unique identifier to match the input with an existing node/record in the Data Store (e.g., a person's name, email, phone number, etc.

Verbs may also be configured to be contextually aware of the execution environments they work in and do not work in. For example, when working with cloud-based file storage tools, a download button may appear viewing a file. However, if a user of SKL uses a SKApp running locally on their computer, they may interact with local APIs like their computer's local file system API. Thus, the DOWNLOAD Verb may not be relevant and may not be displayed by an Interface querying for data with that local SKApp.

### AI Processor

According to some embodiments, Verbs may have a Mapping to an Integration or Code Package that runs some algorithm over input data to produce new or updates to data stored as Nouns or to relationships between data. Non limiting examples include:
1. an image recognition algorithm which accepts raw images and data of the Noun Person as input, processes them, identifies that there are people in the image, runs facial recognition to identify who the people are, and returns relationships between the images and the respective Person Noun entities; and
2. a named entity recognition algorithm that may locate and classify named entities mentioned in unstructured text through identifiers for Nouns such as person names, organizations, locations, medical codes, ISBN numbers, etc. Primitives and other data could also be identified and returned to be used to query and SKDS for relationships, such as time expressions, quantities, monetary values, percentages, etc.

### Data Encryption

According to some embodiments, Verbs may have a Mapping to an Integration or Code Package, which runs an encryption algorithm over input data to encrypt or decrypt data.

### Integrations

According to some embodiments, an “Integration” may be a type of Schema, and more specifically, a type of Noun that may represent the data, capabilities, and other aspects of an external software tool, application, platform, database, and the like. Integrations may represent software tools which may have data and capabilities accessible via an interface (e.g., REST, GraphQL, JSON RPC, OData, SQL, ODBC, etc.) that a Standard SDK may communicate with to query for, mutate, receive messages about, or otherwise access or perform actions over data.

In some embodiments, Integrations may provide data and events through an interface which may be accessed via a program or code in any code execution environment, not just the standard format of JSON APIs exposed by many popular web applications. The Schema that defines an Integration may, for example, detail the following:
1. Metadata about the Integration such as Name, domain, keyboard shortcuts, etc.;
2. descriptions of methods and their parameters which may be used to read raw data from the Integration;
3. descriptions of methods and their parameters which may be used to write data to the Integration; and
4. descriptions of methods which emit Events that an application may subscribe to.

According to some embodiments, the Schema for an Integration may reference, or is referenced by, a Schema that contains an abstraction of the API of the Integration. This may make it easier and more concise for Mappings to reference the capabilities the Integration exposed and their inputs, outputs, required credentials, etc. Examples of these abstractions of the capabilities offered by an Integration's API include OpenAPI specifications for REST APIs, OpenRPC specifications for JSON RPC APIs, and AsyncAPI specifications for event-driven APIs. If the integration offers other types of interfaces (e.g., SQL), similar abstractions of their data and capabilities may be represented through Schemas. A Mapping between a service such as Google Drive®, and the Verb download, may reference the operationID of the operation listed in an OpenAPI specification for Google Drive's® REST API which represents the endpoint to download a file. Subsequently, Standard SDK may execute the Mappings for the parameters of the Verb and may properly use them to construct a web request that will be sent to the Google Drive® API according to the OpenAPI specification.

Non-limiting examples of types of Integrations are described herein.

First, web applications such as Google Drive®, Slack®, Gmail®, or Evernote®. These web applications commonly expose a JSON REST API with methods to read and write raw data from and to the application. Many also consist of web pages (e.g., drive.google.com) which contain data that may be scraped by a Data Processor using CSS selectors or Javascript code (e.g., Schema.org information, email addresses on the page, etc.). Google Drive® is a file storage tool which has a REST API exposing capabilities to upload, delete, edit sharing permissions, and manage versions of files and folders. MedFusion is a healthcare IT company which has REST APIs built according to the FHIR standards exposing patients' medical data from John Hopkins Medicine;

Second, the scripts loaded by a browser extension or browser add-on. These scripts, particularly the background script or service worker, may access the Javascript Extension API. A browser extension could also use JavaScript to scrape data from websites a user visits.

Third, a computing device's operating system such as macOS, iOS, Microsoft Windows, Linux, or Android. An operating system typically exposes APIs in order to allow programs running on the operating system to interact with the input devices, sensors, and storage and memory systems, on the device on behalf of the user/owner of the device (e.g., File system API, video and image processing APIs, etc.). There are many packages which developers may develop or use to interact with these APIs in a simplified or more abstracted way. The term computing device does not only mean smart phones, laptops, and desktop personal computers, it may also be used to describe embedded systems or wearable computing devices such as virtual reality headsets, smart watches, or brain smayning devices. These other types of computing devices typically will gather some kind of biometric and/or environmental data and have an API for accessing that data through software on device or web requests. Sensors or trackers that provide access to a repository of data and recorded events (e.g., such as a digital camera with internal storage, or a heart monitor with internal storage)

Fourth, a program running on a computing device which has its own storage and/or processing and which exposes an API. Examples: (1) an application which records a user's computer screen, stores the video, runs processing to label key moments in the video, indexes it, and provides an API to search and access those key moments; (2) A program which tracks and stores a log of web requests originating from the computing device and exposes and API for querying or accessing those logs; and (3) An application installed on a smart fridge that track's the inventory of food within the fridge and exposes API to access the inventory data (via web request, Bluetooth, etc.).

Fifth, databases and data stores such as: Wikidata, World Bank Open Data, WHO (World Health Organization) —Open data repository, and European Union Open Data Portal.

Sixth, a blockchain such as the Ethereum blockchain. Data may be stored within Smart Contracts on a blockchain and read or written to using transactions. The data in a blockchain could also be indexed outside of the chain by systems like The Graph (https://thegraph.com/), which expose APIs to query data. For example, Go Ethereum is an open-source execution client for the Ethereum Protocol which has a JSON-RPC API exposing capabilities to get information about blocks, send transactions, and much more.

### Code Package

According to some embodiments, a Code Package may be a Schema that represent a package of code. Each Code Package Schema, like all other Schemas in SKL, may have a unique identifier in the form of a URI which allows it to be referenced in SKL. A Code Package Schema may serve as an abstraction of the interface that the Code Package exposes, similar to how an Integration has a Schema which abstracts its API so that its capabilities may be accessed and performed in a standard way using Verbs and Mappings. A Code Package may not be hosted or otherwise made available to SKL via some external interface. Instead, Code Packages may be run on the same server, container, or infrastructure that SKL is being used in. The SKL engine or application running an SKL engine may either have the Code Package included in its environment as one or more files or as a variable stored in memory, or may download it from an external source during runtime. In the same way that a VERBINTEGRATIONMAPPING (further defined below) relates a Verb to an Integration, a VERBCODEMAPPING (further defined below) relates a Verb to a Code Package. Thus, a user of SKL may have the option to execute a certain Verb using either an Integration or a Code Package.

Non-limiting examples of types of Code Package Schema are described herein.

First, the execution environments that the Code Package may be run in. Non-limiting examples include: (1) an operating system running on a personal computing device, (2) a Virtual Machine such as the Java Virtual Machine or a JavaScript Engine, and (3) container running a specific image such as a Docker Image.

Second, the dependencies of the Code Package.

Third, specifications of the functions, methods, or variables which the Code Package exposes and the data types and formats of the inputs and outputs of those methods and functions.

### Interfaces

According to some embodiments, an “Interface,” or “Interface Component” in SKL may be a type of Schema, and more specifically a type of Noun that represents a discrete component displayed on a webpage or other application with a graphical user interface, according to an embodiment. Interface Components may be to display, select, or edit particular types of Nouns to end users. Interface Components may be combined into sets, networks, or hierarchies to form a larger or more domain specific component (e.g., a Card component that includes a Table component specifically built to render previews of Excel spreadsheets).

Non-limiting examples of types of Interfaces are described herein.

First, an Interface may be the Schema representing a GUI and/or code of an application or program running on the operating system of a personal computing device.

Second, an Interface may be the Schema representing a GUI and/or code of a web application running in a web browser.

Third, an Interface may be the Schema representing a voice assistant software agent which may interpret human speech and run code in response to prompts or on a schedule.

Fourth, an Interface may be biometric tracking devices, which may be preprogrammed to respond to changes or events in their wearer's biometric signals.

Fifth, an Interface may be software running in an augmented or virtual reality environment. For example, a HAT Entity in a VR environment could be associated with the Nouns 3DMODEL, OBJFILE, CLOTHING, and HAT. Its associations to those Nouns could make at least some of the Entity's data accessible within, or at least translatable to different applications outside of the virtual reality environment, such as a spreadsheet, a file browser, a “clothing browser” (e.g., software that lets you browse and “try on” clothes with AR or mixed reality), etc. Similarly, the HAT could be understood as having certain distinguishing characteristics that could be described in a way that different virtual reality environments interpret and render differently.

The geometry could also be described via a mathematical representation that is not human readable/understandable (e.g., in a way similar to how an AI-based object recognition model represent HAT objects in order to recognize HATS in images), and it could use that representation to translate between different three-dimensional environments by first comparing other items in each environment and creating a mathematical model to represent the types of geometries that are acceptable in each environment.

### Interface Components

According to some embodiments, an SKL Interface Component may be a type of SKL Noun. Its SKL Schema may define the Metadata about the component and may either (a) define its implementation through declarative rules, or (b) link to its implementation defined in a specific package or repository of code. These interface components may be used to display, interact with, and/or edit data in any format, as long as an SKL Mapping(s) exist to translate between the data and the component.

In various embodiments, the Schema for an SKL Interface Component may include the following:

ID—the URI of the component (as is required by any named node within an RDF graph).

NAME (or label) —a textual label by which to refer to component.

DESCRIPTION—a textual description of the component.

PARAMETERS—a specification of the parameters that the component accepts. Each parameter should specify constraints if it is required or not, its data type, and its allowed cardinality.

PARAMETERSCONTEXT—a JSON-LD context object defining a more human readable format which each parameter may be supplied in if desired by application developers.

SOURCEURL—The location of the component's source code (likely stored on a CDN or other blob storage like AWS S3). May or may not be used in conjunction with the nodes field.

NODES—An ordered list of nodes that declaratively configure a tree of UI building blocks to render, each with a type, styling, a tree of sub nodes, and an optional properties Mapping (More on this below). May or may not be used in conjunction with the sourceUrl field.

In some embodiments of the SKL Interface Components, the Schema for a component may need to specify information about the author, organization, and/or version of the component as additional fields. This information may also be incorporated within the URI that makes up the component's id field.

Interface Components may be used to build interfaces using composable blocks without having to know exactly how those blocks work or what their contents are. An Interface Component may be nothing more than a representation and description of a component implemented in code using a language such as HTML or JavaScript®. Examples of JavaScript® components include those built using frameworks like React®, Vue®, Svelte®, etc. In such embodiments, the Schema for these components may a sourceUrl field to point to the location of an implementation of the described component. This location may be remote, meaning the component is hosted on a server, or local to the running application.

In addition to serving as a wrapper around components implemented in a specific programming language, Interface components which do not require complex logic defined through code may have their entire content specified through their Schema. SKL Interface Components Schemas may have a set of declarative configuration detailing the implementation of the component.

In some embodiments, this is done through the nodes field. The nodes field can contain an ordered list of nodes that declaratively configure a tree of UI building blocks to render, each with a type, styling, a tree of sub nodes, Examples of the UI building blocks this field would use are line, box, text, and image. Many UI frameworks include a set of built in herein “primitives.” For example, HTML has a set of standard tags which are expected to be implemented in the same way by any HTML rendering engine such as herein “div,” herein “p,” herein “h1,” “h2,” etc. Likewise. SKL expects Interface Engines or applications doing their own interface rendering to implement a standard set of primitive interface components including but not limited to:

CONTAINER—defines a section which can contain a sub tree of other components herein.

TEXT—defines a block which contains a text which may be styled.

IMAGE—defines a block which displays an image through a source URL.

According to an embodiment, these primitive components can be composed as a tree of RDF nodes in RDF serialization. A non-limiting example may include the following code in JSON-LD (context omitted for brevity):

```
    {
    . . .
    “https://skl.standard.storage/properties/nodes”: [
      {
      “@type”: “https://skl.standard.storage/interface/Container”,
      “https://skl.standard.storage/properties/styling”: { . . . },
      “https://skl.standard.storage/properties/nodes”: [
        {
          “@type”: “https://skl.standard.storage/interface/Text”,
          “https://skl.standard.storage/properties/styling”: { . . . },
          “https://skl.standard.storage/properties/propertiesMapping”: {
            “@type”: “rr:TriplesMap”,
            “rml:logicalSource”: { . . . ],
            “rr:subjectMap”: { . . . },
            “rr: predicateObjectMap”: [. . . ]
          }
        }
      ]
    }
  ],
  . . .
}
```

As shown herein, in addition to a tree of sub-nodes, a Node may include properties specifying styling, and a property Mapping. In this way, Interface Components can be an abstraction on certain structures and content which can be rendered by any (or most) application using that application's framework of choice.

In some embodiments, the Schemas for Interface Components can define the types of data they expect as inputs, properties, or available variables or values. This makes it so that an end-user can easily choose an entity of any Noun and be able see data from that entity without having to have preexisting Mappings. For instance, if a Card component has two fields, specified to accept data of type image and string respectively, then the first occurrence of each of those types of data in the Schema of the Noun of the Entity passed to the Interface Engine can be automatically loaded into the Card Interface Component. Alternatively and/or additionally, an end-user may be able to choose and/or change the fields of the entity that are used by the Card Interface Component from a list of compatible fields from the Noun Schema of the Entity.

### Interface Engine

According to some embodiments, interface components defined through configuration makes it so that the interfaces of applications may be controlled, configured, and customized without changing code. To enable this, a developer may use an SKL Interface Engine.

In some configurations, an SKL Interface Engine is a set of code, which takes as input (1) an SKL Interface Component Schema; (2) a set of data adhering to a specific SKL Noun to be rendered by that component; and, optionally, (3) the chosen theme styling to apply to the component. The Engine may then find and perform the Mappings necessary to translate the data, according to its Schema, into correctly formatted parameters for the component and renders the component. In some embodiments, the Engine may update in real time if any changes are made to (1) the input data, (2) the chosen component, or (3) the supplied theme (among various other alternatives). Additionally, the Engine may have the ability to perform such real-time updates by re-rendering the applicable section of an HTML DOM tree after a component's properties are changed.

In addition to supplying data to components, an SKL Interface Engine may need to supply callbacks, or bind event handlers to components in order to respond to user interaction with the components. According to some embodiments, there may be a general callback or bound event listener which may be used by any Interface Component rendered by an Engine. When a component calls the callback, or sends an event, the payload may include an identifier about the meaning of the event. Using this identifier, and the name of the component that executed the event or callback, the Engine may either find and perform a Mapping to translate the payload of the event or callback into a data format used by the application, or simply pass the payload as is to the application.

In yet another embodiment, there could be a pre-defined set of operations or “event types” which the SKL Interface Components may execute as callbacks or events to the Engine and/or embedding application. For example, this predefined set of operations may encompass all possible CRUD (Create, Read, Update, Destroy) operations on an individual, or collection, of SKL Entities or Schemas. As such, the components may offer the ability for users of applications to modify the entities in their SKDS through SKL Interface Components. This would also allow Interface Components to query for SKL entity data themselves.

In an alternate embodiment, the set of possible operations could include all the SKL Verbs a user or application has defined in its set of Schemas. This may allow SKL Interface Components to execute callbacks or send events with a payload containing the name of the Verb to be executed as well as the specified parameters for that Verb.

In an alternate embodiment, Engines or applications may define multiple “services,” “sets,” or “domains” of operations allowed. For example, such a scenario may allow Interface Components to use an “Entity” service to execute callbacks or events about CRUD operations on entities, and a “Verb” service to execute callbacks or events Mapping to SKL Verbs defined in a user or application's Schemas.

### Mappings

According to some embodiments, the types of Schemas that define how a program may translate data, capabilities, and more between SKL components may be called “Mappings.” Mappings specify, for example, how a Noun may be translated to or from a unique data format specific to an Integration or an Interface, or how a Verb may be translated to or from a unique capability of a software tool.

In some embodiments, each Schema representing a Noun, Verb, Integration, Code Package, Interface, and/or SKDS may have embedded within it the logic and translations for how it relates to, uses, or produces every other artifact. Alternatively, Mappings defined separately from the Schemas, configurations, or code of Nouns, Verbs, Integrations, Code Packages, or Interfaces, users or developers may compose components of the system together. This setup makes it so that the internal implementation of each component may be edited and updated independently. For example, the developer of an Interface Component could change the structure of the HTML code, and any Nouns and Verbs that have been Mapped to that Interface Component are able to continue working seamlessly. No other developer would have to alter their code or configuration as long as their data is mapped to the standard PERSON Noun, which has one or more Mappings to the Interface Component's inputs.

Mappings may be used to allow SKLs to interoperate. Each Mapping may consist of configurations specifying the name and type of the Mapping, and sets of declarative rules, code, or other logic that define how a data structure or API capability is transformed into another. In one embodiment, Mappings may scale across as many different programming languages and environments as possible. When written as code, either the Mappings may have to be manually translated into each programming language or infrastructure would have to be built to automatically compile them to each programming language (e.g., Javascript, Java, Python, etc.). Alternatively, Mappings may be written as declarative rules within JSON files, or other data-interchange formats or RDF serializations that may easily be translated to JSON (e.g., YAML, Terse RDF Triple Language (Turtle)). JSON is a data-interchange format that many programming languages may parse and generate. In this way, according to a non-limiting embodiment, people and systems may easily find related components and join them together.

### Mapping Language

According to some embodiments, SKL may use the RDF Mapping Language (RML) serialized in the JSON-LD format to encode the logic of Mappings as declarative rules. Using RML, a Mapping may: (1) reference any field within an input dataset (including nested data and iterations over lists); (2) use constant values such as strings, integers, booleans, etc.; and (3) use other ontologies including: (i) the Hydra Core Vocabulary (HYDRA) to load data from remote web APIs; (ii) D2RQ to access data in a remote database; and (iii) the Function Ontology (FNO) to execute control logic, conditional logic, and any other arbitrary function.

For example, in one non-limiting embodiment, when using or displaying files in their applications, many developers may want to know the mime type of the file, thus the Schema for a file Noun may include mimeType as a field. However, the Dropbox® API does not provide a mimeType field in its response when getting Metadata about a file stored in Dropbox®. Using an SKL Mapping which defines declarative rules and logic using RML and FNO, the Dropbox® representation of the file may be translated to be compliant with the file Noun's Schema. The Mapping may get the file's extension by referencing the Dropbox® file's filename field within the input data and uses it as input to a getMIMEType function executed by an RML execution library written in Java.

### Types of Mappings

According to some embodiments, the SKL Library may include multiple types of Mappings for translating between different types of artifacts. Non-limiting examples of these include:

### 1. NounDataMapping:

According to some embodiments, a NOUNDATAMAPPING may translates an Entity conforming to the Schema of a Noun into a unique data structure to be used as the input of an Integration capability, an Interface Component, or a Code Package, or it may translates a unique data structure output from an Integration capability, Interface Component, or Code Package, into the Schema of a Noun. NOUNDATAMAPPINGS may be used by VERBINTEGRATIONMAPPINGS by reference to avoid duplication of Mappings.

### 2. OntologyMapping:

According to some embodiments, an ONTOLOGYMAPPING is type of NOUNDATAMAPPING that may describe how to map the Schema and structure of a different Linked Data ontology to an SKL conformant Schema (e.g., Noun or Verb).

### 3. NounInterfaceMapping:

According to some embodiments, a NOUNINTERFACEMAPPING may translate an Entity conforming to the Schema of a Noun into a unique data structure to be used as the input of an Interface Component. It may reference one or more NOUNDATAMAPPINGS. This type of Mapping may be executed using an Interface Engine and the response is used to render the component.

### 4. VerbIntegrationMapping:

According to some embodiments, a VERBINTEGRATIONMAPPING may translate the inputs of a Verb to the unique inputs and correct capability (API endpoint, SDK function call, etc.) of an Integration to execute and perform the intent of the Verb using the Integration. The Mapping may also include a conversion of the outputs of the executed capability to the standard outputs of the Verb. It may reference one or more NOUNDATAMAPPINGS.

### 5. VerbCodeMapping:

According to some embodiments, a VERBCODEMAPPING may translate the inputs of a Standard Verb to the unique inputs and execution format of a Code Package to execute and perform the intent of the Verb using the Code Package. The Mapping may also include a conversion of the outputs of the executed code to the standard outputs of the Verb. It may reference one or more NOUNDATAMAPPINGS.

### 6. VerbNounMapping:

According to some embodiments, a VERBNOUNMAPPING may translate from one Verb into another Verb based on a Noun parameter supplied to the original verb called. For example, suppose a developer has created a Standard Knowledge Application which may sync data from any Integration a user has added to their SKL Schema. This syncer application may need to sync many types of Nouns such as FILES, MESSAGES, TASKS, etc. In some embodiments, the developer may have to write code to call specific Verbs to fetch each type of Noun in an Integration (e.g., GETFILESINFOLDER, GETMESSAGESININBOX, GETTASKS). In order to make their code more scalable, the developer may create a SYNC Verb which, when called with a noun parameter, uses a VERBNOUNMAPPING to determine a “noun-specific” Verb to execute. Thus, the developer writes one line of code through which many different types of data may be synced.

### 7. VerbQueryLanguageMapping:

According to some embodiments, a VERBQUERYLANGUAGEMAPPING may translate the inputs of a Verb into a query in a database language and the outputs of the query back to the standard outputs of the Verb. It may also reference one or more NOUNDATAMAPPINGS.

### Solid

According to an embodiment, SKL's decentralized ecosystem may adhere to the principles and interfaces defined in the Solid Protocol (https://solidproject.org/). Solid is a specification that lets people store their data securely in decentralized data stores called “Solid Pods.”

The Solid specification defines how applications may access and manage data from user's personal data stores, as summarized below:

First, Linked Data Solid supports storing Linked Data so that different applications may more easily work with the same data. Specifically, it uses the Linked Data Platform for accessing, updating, creating and deleting Linked Data resources.

Second, Solid-OIDC Authentication defines how the servers hosting personal data stores verify the identity of users and applications based on the authentication performed by an OpenID provider.

Third, Web Access Control Authorization is a decentralized cross-domain access control system providing a way for Linked Data systems to set authorization conditions on resources using access control lists.

Certain components of the SKL ecosystem may conform to Solid. According to an embodiment, Standard Knowledge Data Stores (“SKDS,” as defined below) are required to be compliant with Solid's concept of personal data stores called “Solid Pods.” As such, implementations of SKDSs may implement Solid-OIDC, Web Access Control, and the Linked Data Platform. In this embodiment, Standard Knowledge Applications (“SKApp,” as defined below) are also compliant with Solid's concept of “Solid Apps.” This means that any SKApp may expect to communicate with SKDSs using the Linked Data Platform and authenticate users using Solid-OIDC.

According to one non-limiting embodiment, the SKL specification may recommend that each user's SKDS store its own Schemas. In this way, end users may customize and extend SKL as they see fit. When using SKL Verbs, a SKApp may use a Standard SDK and set the Standard SDK's Schema source to the user's SKDS. In one non-limiting embodiment, SKApps may use a Standard SDK to query an SKDS. As described elsewhere herein, a Standard SDK may use a variety of methods to interact with data (e.g., create, read, update, and destroy) within an SKDS. The mediums for interaction with data in an SKDS may include the SKDS's native query language such as SPARQL or GraphQL, as well as the Standard Knowledge Query Language (“SKQL” as defined below) which is in effect an Object-Relational Mapping tool.

### Standard Knowledge Data Stores

According to some embodiments, a standard knowledge data store (“SKDS”) may be a nodal that is accessible to one or more users on one or more computing devices that may be manifested in any number of ways. For example, the nodal data structure may be represented as files on a user's local computer, data on a blockchain, data in one or more relational databases, data in a graph database, data in a distributed database system, etc. In some embodiments, an SKDS may follow the specification for a Solid Pod. Accordingly, an SKDS may be more than a Solid Pod. It could have other manifestations, similar to the nodal data structure described herein.

A Standard Knowledge Data Store or “SKDS” may be a type of Integration that stores Entities, and in some embodiments, also stores the Schemas that make up the Nouns, Verbs, and Mappings and/or other SKL components on behalf of a developer, end-user, and/or system. SKDSs may be referred to herein as standard data stores, data stores, Standard Storage, knowledge pods, and nodal data structures.

In order to use SKL according to some embodiments, a developer must first decide where they will store the desired SKL Schemas, Mappings, and the code their application will work with as well their end users' data, or how such artifacts will otherwise be accessed. One of the first decisions to make will be whether to use an SKL-compliant Standard Knowledge Data Store (SKDS), to store or reference the artifacts and configuration directly from other sources (e.g., schema.org, the SKL Dictionary as defined below, etc.), or to use their own method (hard-coding schemas into their code).

Any kind of information may be stored in an SKDS. Non-limiting examples of a data store that could serve as an SKDS include: (1) a server connected to the internet running a relational or graph database or a key-value store, (2) a web browser's IndexedDB store, (3) a database running on a personal computing device, (4) and a decentralized blockchain or decentralized file storage system like IPFS. Depending on the type of data storage available, the method or mechanism an SKDS uses to store data can be manifested in a number of ways including, but not limited to, as files on a computer, server, or container, as data on a blockchain, as data in one or more relational databases, graph databases, or key-value stores, as data stored by one or more machines in a distributed system, as data stored in memory by a program etc.

In some embodiments, an SKDS is similar to a secure personal web server for a user's SKL nodal data structure. In this scenario, users control access to the data in their SKDS. Users may decide what data to share and with whom to share it (be it individuals, organizations, or applications). Access may be revoked at any time. To store and access data in an SKDS, applications use standard, open, and interoperable data formats and protocols. In one embodiment, the data creator may be in full control of their data as shown in FIG. 2.

In some embodiments, a developer will have a predetermined set of SKL artifacts that they know their application will need. In such embodiments, the developer may download and bundle them along with their application's code or download the artifacts via the SKL Library API at runtime, as their use case necessitates. This situation may not need an SKDS, though it may still use one for the application itself. In other embodiments, a developer may choose to let the decision be made by end users. An application could choose to store SKL artifacts on behalf of end users in any format they choose. For example, the developer may store all SKL artifacts in a MongoDB® database with a key specifying which end user they are used for.

In one non-limiting exemplary embodiment, several criteria of an SKDS may be defined to do the following: (1) be compatible with the world of Linked Data by exposing APIs that accept formats such as Resource Description Framework (RDF) as input, (2) allow end users to choose from a market of database providers for storage of their data, (3) have robust authorization over data such as access control lists on each resource (each end user may be able to share and revoke third-party access to their data), (4) be able to verify the identity of agents (users or applications) accessing or modifying data, and (5) allow for the validation of any data written to the SKDS according to SKL Schemas.

One embodiment of a system which fulfills these criteria may be built using the Solid Protocol. Solid is a secure, robust, and highly configurable decentralized storage system. Solid uses Solid OIDC, an authentication protocol built on top of OpenID Connect 1.0, which allows for secure authentication between storage providers, identity providers, and applications. It uses Web Access Control to implement authorization via access control lists. It also utilizes Linked Data and mandates usage of the Linked Data Platform as a standard interface for reading and writing resources. Many implementations of the Solid Protocol are open source and architected in a way that makes it easy for developers to build off of, for example to add custom SKL Schema validation. Solid may also be seen as accessible to many developers because it does not specify constraints on the type of persistent storage used to store resources, developers may choose whatever works best for them. While Solid Protocol is used in this embodiment, it should be noted that the SKDS may be built using a variety of different methods.

In some embodiments, the specification of an SKDS need not to be compatible with Linked Data, and thus would not use Solid. Its REST APIs may be built to accept request bodies that are not a serialization of RDF such as JSON. In such embodiments, the embodiment may specify a distributed storage system—that uses the Oauth2.0 protocol, for example—for authorization between identity providers, storage providers, and applications.

In other embodiments, an SKDS may be a nodal data structure stored in a graph database hosted on a private cloud controlled by a private company. In this case, the SKDS would not necessarily implement the Solid specification but instead implement a proprietary interface unique to the company. According to the embodiment, any application, SKApp or not, would need to implement a data persistence strategy in accordance with the company's SKDS specifications. In addition, the specificities of the company's interfaces and security might make them unable to leverage open source Standard SDK and/or SKQL libraries.

In an alternate embodiment, an SKDS could be implemented using blockchain technologies. For example, there are several layer one chains that support smart contracts and that may be programmed such that only certain people are able to access and un-encrypt certain data stored on chain. This may, in a similar way to Solid, provide individuals with the ability to have more complete control over their data. In this scenario the SKDS could store its database on a chain in an encrypted way such that only a given user (or wallet) is able to control the data that is assigned to that wallet. The “owner” of such data could then choose to share any subset of their data with other users or wallets as desired. Furthermore, certain restrictions could be placed on data via a smart contract. For example, the data on chain could specify that it may only be accessed by components that meet certain qualifications, beyond simply other users, as described further herein in the operating environments section. Also similar to the Solid Protocol, a blockchain based system would also separate the user's identity from the data and from the applications which access said data.

In yet other embodiments, a mixture of the examples described herein could be used, ranging from semantic blockchains, to a Solid-based system that uses a blockchain-based wallet for authentication, to an SKDS that stores assets using a distributed peer-to-peer storage solution like IPFS, and more.

In some configurations, an end user may not be able to use the developer's application until they have installed or downloaded a specific SKL package or set of Schemas, Mappings and/or code. At least one embodiment includes an easy-to-use package for application developers to query and check against the user's SKDS whether the user has all necessary SKL artifacts installed.

An SKDS may have column, property names, or relationship names which differ slightly from the popular ontologies such as FHIR and Schema.org. For these cases, SKL may include Mappings between the popular ontologies and their altered representations in the Schema of the data store.

Developers of SKApps may be able to switch persistent storage types without altering (or at least with minimal alterations) functionality, support for features, or data structures.

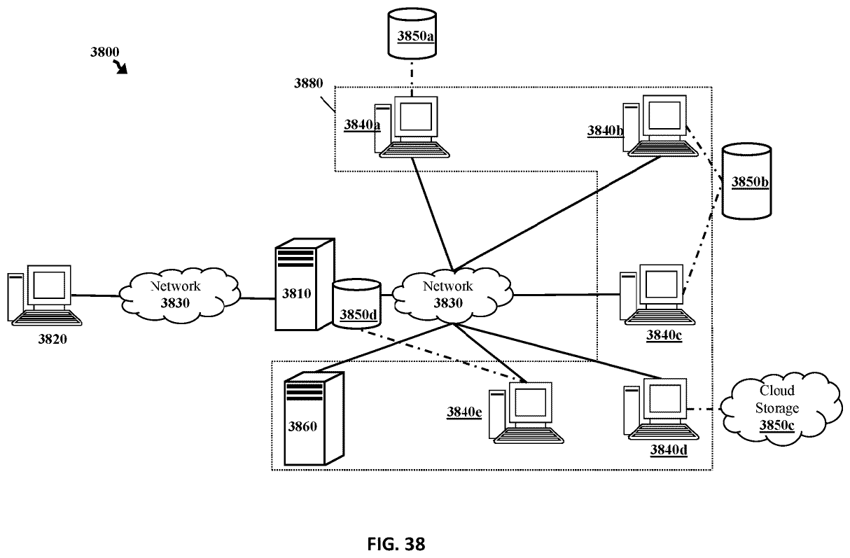

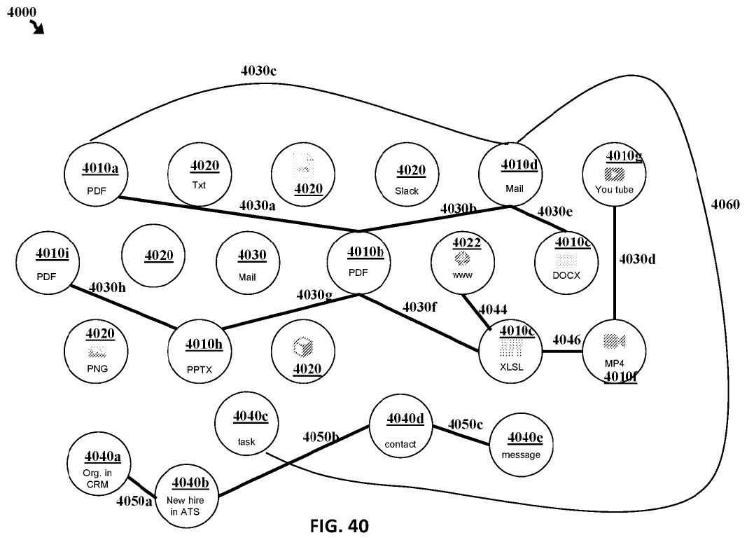

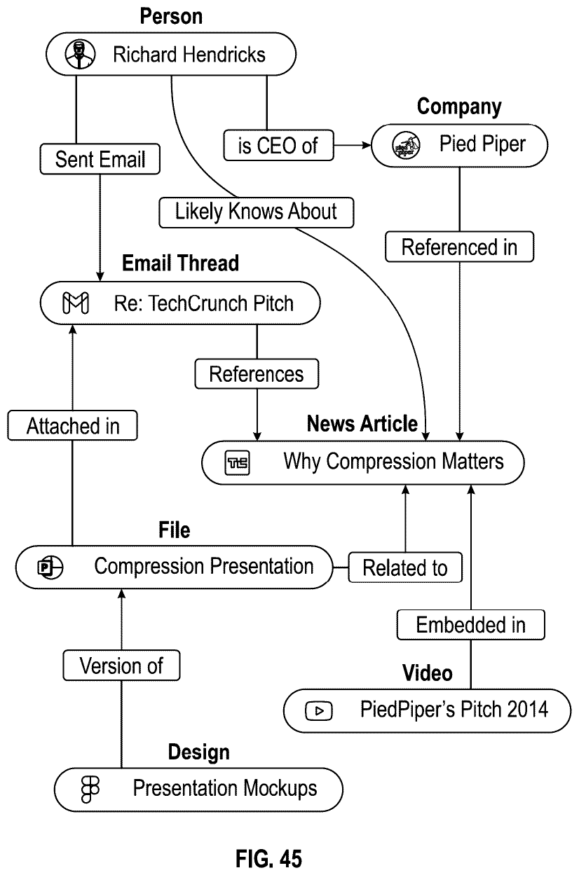

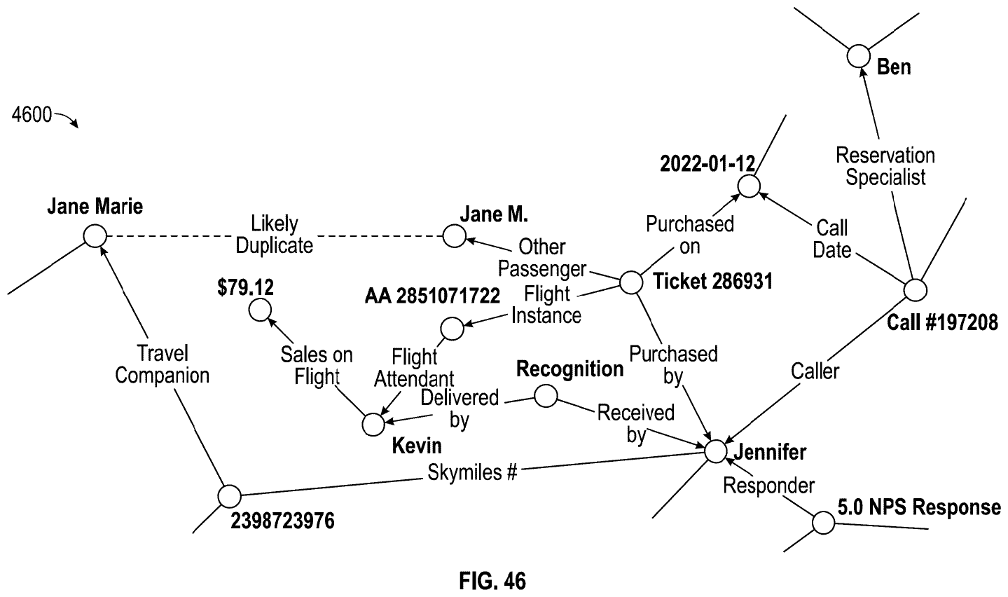

A Data Store (which in some embodiments may be called the nodal data structure) may be a location where standardized Data Types and their relationships are persisted. Non-limiting example of a system architecture and nodal data structures are illustrated in FIG. 38, FIG. 40, FIG. 45, and FIG. 46. SKDS enable developers of applications will be able to switch persistent storage types without altering, or at least with minimal alterations to functionality, support for features, or data structures.

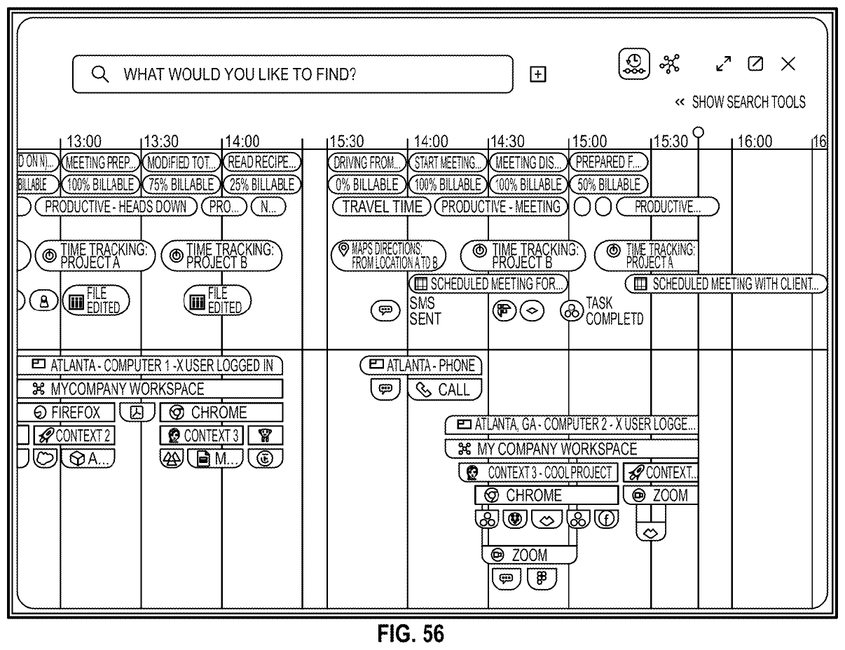

According to a non-limiting embodiment, an SKDS can be comprised of multiple databases such as a vector database, a graph database, and/or a relational database. For example, an SKDS may include a first database for Entities related productivity data, a second database for Entities related to health data, and a third database for information related to activity by the SKDS' user(s). In this case, the third database could include information about activity as shown in FIG. 56. The activity in this third database could follow Schemas related to activity (e.g., activityschema.com), could support activity spans (e.g., OpenTracing) to better track electronic content and electronic context, could track notifications sent from other sources, and more. In this way a single SKDS can be configured and optimized for a variety of criteria ranging from security needs, performance needs, case of analysis, to support privacy-conscious personalization and advertising capabilities, and more.

### Standard Knowledge Query Language

According to some embodiments, Standard Knowledge Query Language (“SKQL”) may be an abstraction that standardizes the interaction with different types of databases by providing a single interface for operations that may be performed using various database query languages. It may be designed to facilitate object-oriented interactions, as this is a common requirement of most application developers who use persistent databases. It may be described as either an Object Relational Mapping (ORM) or Object Graph Mapping (OGM), depending on if it is being used to query a relational database or a graph database. However, it may not go so far as “Active Record” style ORMs in that it may not tie the database implementation to models or classes and their business logic. Instead, it may works with the data structures provided in Schemas. SKQL may expose methods for basic operations such as create, read, update, destroy (CRUD) on data according to the Schema or ontology that a user is using.

Instead of manually constructing and sending web requests to an SKDS to query or modify Schemas or user data, a developer may set the SKDS as the source of SKQL and specify valid authentication credentials for SKQL to use and it may automatically send requests to the SKDS when needed. For example, if a developer's code needs to save a new blog post a user just submitted using a Standard Knowledge Application for blogging, the application code may call SKQL.save(blogPost) or blogPost.save( ). Subsequently, SKQL may communicate with the user's SKDS to save the blog post. If the user's SKDS is a Solid Pod, SKQL may send a web request compliant with the Linked Data Platform with the body being an RDF representation of all the blog post's attributes.

Given that SKQL may work with SKL Schemas, it may be extended by developers, systems, and/or end-users. For example, a Verb to move a file from one folder to another may use a specialized query to modify the file's relationship to its old and new parent folder in a single request instead of using the standard operation to delete the old relationship and create the new one. Likewise, an application attempting to uncover insights from a data store may need to perform a complex path traversal query using the native query language of a graph database (e.g., Cypher, SPARQL, etc.) which could be preconfigured with Schema. SKQL may also expose special methods to write queries in the native query language of databases which users have chosen to use.

In some embodiments, SKL Schemas may be used by an Integrated Development Environment (IDE) while a developer is programming to perform type checking of fields, variables, functions, and methods accessed and used. SKQL could have its own programming language which may be compiled either as a developer programs or at build time to a more well supported target programming language such as Python, Java, or JavaScript—similar to how TypeScript is typically type checked by an IDE as a developer writes code and is compiled into JavaScript when they build and/or package their application.

While this would result in less composable and less interoperable components, in other embodiments, SKL Schemas could be represented as classes in a programming language like Ruby® or Java®, type interfaces and/or classes in JavaScript® or Typescript®, etc.

SKQL may allow for high composability of databases and SKDSs to the point where an end-user, system, or developer may “swap out” a database or SKDS of one type for another type. This also enables seamless replication of databases in any format and enables applications to easily offer multiple database options to users. Mappings may include translations from SKQL queries into various native query languages and/or web requests or other API requests to third-party tools according to the Schema of the target data source.

In addition to the basic translation of operations to database query languages, SKQL may also include a suite to manage a connection pool with each database.

Different database types may have differing levels of support for SKQL features. For example, users would only be able to add custom properties/relationships to their Schemas if their database supports that. A relational database may require a database migration to be able to support the additional properties or relationships, while a graph database or other NoSQL database could theoretically support any arbitrary property or relationship.

According to some embodiments, SKQL may be used to allow developers or users to “program,” or define, logic in near-natural language. This natural language may be parsed into one or more search elements and compiled into a series of commands to run against databases and/or data sources. In an alternate embodiment, SKQL could be used to automatically generate migrations for relational databases based on changes to SKL Schemas. In an alternate embodiment, SKQL could be used to automatically generate Mappings between SKL Schemas and the Schemas of the databases that store Entities. In an alternate embodiment, SKQL may expose the ability for developers to supply a raw query or web request and any necessary connection details or credentials. In this case, SKQL would not do any transformation and would simply send the query or web request to a database. For example, SKQL could expose a sendSqlQuery function which, when supplied with a SQL query, database IP address, and credentials, will make the connection to the database, perform the query, and return the result. Similarly, SKQL could expose a function such as sendWebRequest, or fetch which would send a web request to a REST API based on a supplied endpoint/URL, required parameters or data, and necessary credentials. SKQL could then expose a function such as executeOpenApiOperation which takes as input an OpenApi operationID and the operation's required and/or optional parameters and credentials. These SKQL functions would allow developers to access functionality and perform queries which fall outside the boundaries of the standard CRUD operations.

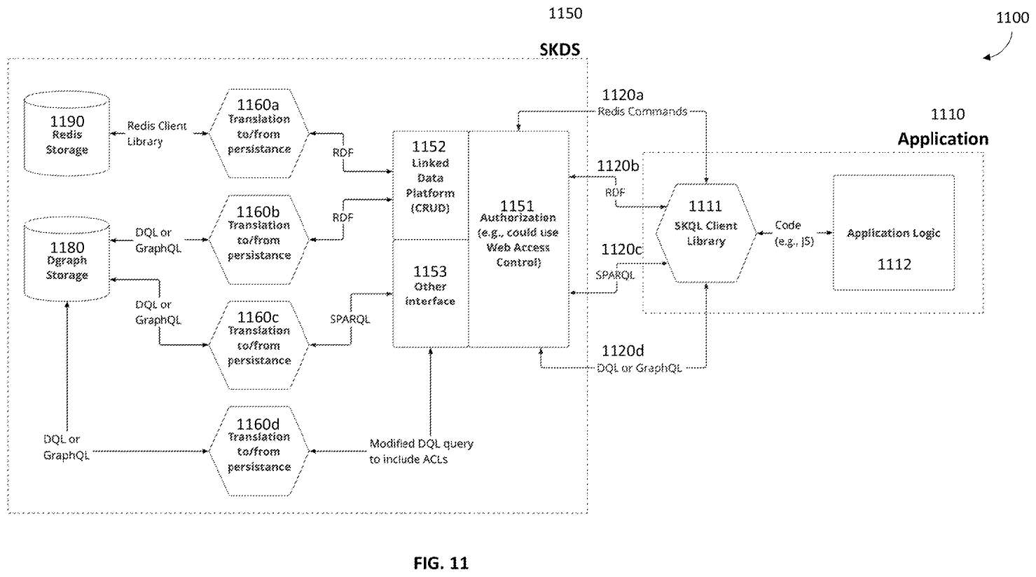

FIG. 11 illustrates a system architectural diagram (computer infrastructure) of how an application 1110 can use SKQL to query (or otherwise interact with) an SKDS 1150, according to an embodiment. In this example, the application 1110 uses an SKQL Client Library 1111, which may be included as part of a Standard SDK, as an ORM and/or OGM that the application's codebase 1112 can use to interact with the SKDS 1150.

The SKDS in this example could follow the Solid specification and send web requests according to the Linked Data Protocol 1152 to an SKDS 1150. In doing so, it would communicate about resources using the Resource Description Framework (RDF) 1120b. In this example, multiple and alternate means for the SKQL Client Library 1111 to communicate with the SKDS 1150 are presented. These mean Redis Commands 1120a, SPARQL 1120c, DQL or GraphQL 1120d. In each case, if any of these alternate communication formats are used, the SKDS 1150 may be required to implement an interface other than Linked Data Platform 1153. Regardless of communication format, the SKDS 1150 may perform authorization 1151 of the application making the request. In the case where the SKDS is conformant to the Solid specification, this authorization must be conformant to the Web Access Control specification. In some embodiments, the authorization step 1151 may require re-writing or re-building a query to include authorization information. This would likely happen if Redis Commands 1120a, SPARQL 1120c, DQL or GraphQL 1120d were used.

After re-writing a query to include authorization, the SKDS 1150 may translate the query into a format acceptable by its type or types of persistent storage. This example shows two examples of persistent storage used by the SKDS 1150, which may be used alone or in combination, a Redis key-value store 1190, and a Dgraph graph database 1180. In either case, the chosen communication format in 1120 may be translated and sent to the persistent storage 1160. Examples of the translations that may be required include but are not limited to, from RDF to commands executed using a Redis Client Library 1160a to send to a Redis key-value store 1190, from RDF to DQL or GraphQL queries 1160b to send to a Dgraph database 1180, from SPARQL to DQL or GraphQL queries 1160b to send to a Dgraph database 1180, and from DQL to GraphQL or kept as DQL 1160d to send to a Dgraph database 1180. Once the persistent store performs the request, any response may be translated back 1160 and returned to the Application's code 1112 via the SKQL Client Library 1111.

### Standard Knowledge Applications

According to some embodiments, a “Standard Knowledge Application” (also referred to herein as a “Knowledge App” or “SKApp”) is a software application, program, or any other set of code which downloads, bundles, or otherwise accesses SKL Schemas, configurations, and/or code and uses them to interact with Integrations, Code Packages, and/or Interface Components through a Standard SDK (e.g., Mapping the unique data structures and capabilities of those Integrations, Code Packages or Interfaces in and out of Noun and Verb Schemas according to the SKL protocol).

In some embodiments, a SKApp may be code which uses any aspect of the SKL framework to achieve a goal. The SKApp may be different from an Integration or Code Package because by not directly using any aspect of SKL internally; but is rather represented by SKL Schemas. In some embodiments, a SKApp may be represented by an SKL Schema, but it may also use SKL Schemas. Standard SDK, Standard UI, Standard API, etc. to perform its function.

Non-limiting examples of Standard Knowledge Applications include the following: (1) an application which integrates with other software using Standard SDK and/or SKL Schemas, (2) a script which uses Standard SDK and SKL Schemas to scrape data from websites, or (3) a mobile application which uses Schemas and an Interface Engine according to Standard UI to run it's user facing GUI.

In some embodiments, a SKApp may store and access data in SKDSs using the SKL protocol and the Solid specification. In this way, instead of every application using a separate data silo that it independently controls, different SKApps may interact with the same data stored in a given user's SKDSs. In other words, a user may give multiple SKApps access to read and/or write Schemas and data to/from a single SKDS.

In another embodiment, a SKApp may store and access data independently in its own database. In yet another embodiment, a SKApp may interact with data in multiple data stores, both public and private. In some embodiments the SKApp may be Solid compliant.

A data syncing application could be a non-limiting embodiment of a SKApp. This SKApp may periodically check for updates to, or subscribe to events about data in a data source, extract the new or updated data, standardize it according to the Schemas and then write those updates to a data store. Other non-limiting examples include the following: (1) an application that uses one or more servers to poll the Google Drive® API for changes to files and writes updates to a data store or (2) a Chrome extension that subscribes to web navigation events, classifies the corresponding website as a particular Noun, and writes data associated with that Noun to a data store.

A data-duplication application could also be an example of a SKApp. This SKApp may use data (e.g., Metadata, interaction data, etc.) from a data source in order to identify two or more Entities which represent the same data. For example, a data-duplication application may run code which calculates a unique hash with the contents of every file in a data source, in order to identify any duplicates. According to an embodiment, SKDSs could come pre-packaged with a data deduplication SKApp to help keep the data clean.

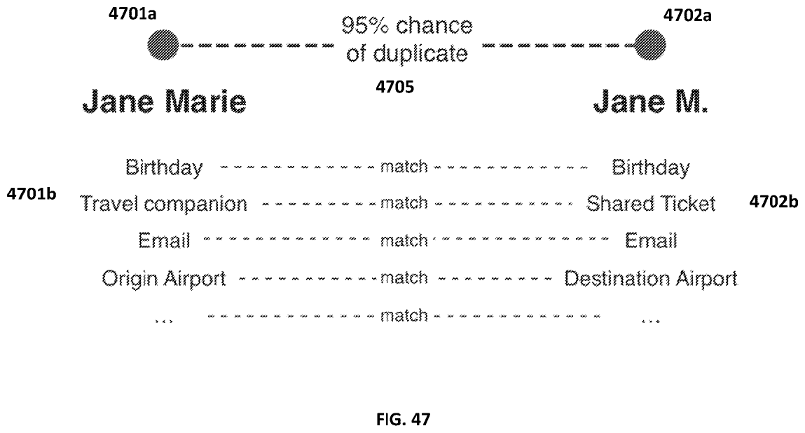

FIG. 47 illustrates a conceptual diagram where two Entities 4701a and 4702b share similar properties and relationships 4701b and 4702b in the nodal data structure 4600, according to a non-limiting embodiment. In this case, one or more of the methods described above could be used to establish a relevance score 4705 between both Entities in order to automatically deduplicate them or otherwise establish a recommendation for deduplication.

### Coordinator

In some embodiments, certain types of SKApps may be referred to as Coordinators. A Coordinator is a SKApp, which executes the settings of a developer or end-user. These settings and configurations may include, for instance, which Nouns, Verbs, Integrations, SKDSs, SKApps, etc. a given user is using. The data a Coordinator uses may be stored in an SKDS, and could include configuration of Verbs that specify the times or the frequency at which they are meant to be run, as well as any events from external systems that the Coordinator should subscribe to and pass along to a Verb, such as an Integration's webhook. Coordinators may be responsible for adhering to configurations that trigger Verbs to run at certain times. Coordinators may also responsible for maintaining connections to SKDSs which may need to be read from or written to by a Verb or to fulfill a request from an Interface Component. In some embodiments, the Coordinator is included on the same server as an SKDSs. In other embodiments the Coordinator may exist as a Standard Knowledge Application or in part between one or more SKDSs and/or Standard Knowledge Applications.

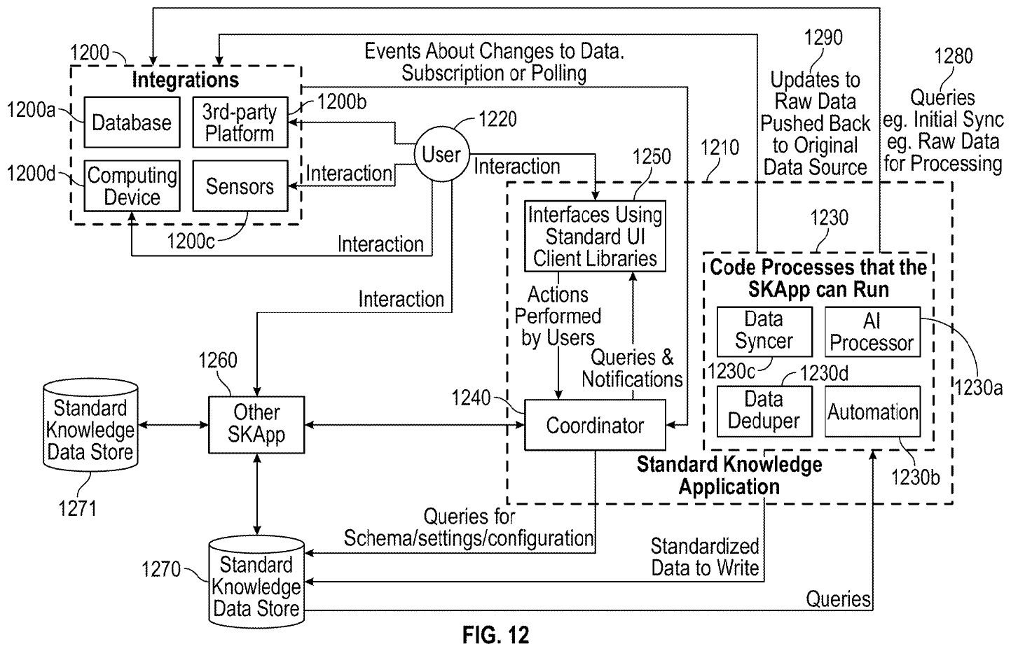

FIG. 12 illustrates an architectural diagram of the ecosystem in which a User 1220 separately interacts with one or more Integrations 1200 and Standard Knowledge Applications 1210 and 1260 while a Coordinator 1240 executes code processes 1230 in the background on their behalf. The user 1220 can use the interface 1250 of one of their SKApps 1210 in order to set settings for the processes 1230 they want to be run over their data in any Integration 1200. These settings get stored in their SKDS 1270. Non-limiting examples of processes a SKApp include AI Processing to generate text or images from data 1230a, workflow automation to move or update information in one Integration from another 1230b, data syncing to create a knowledge base in their SKDS 1230c, and data deduplication across Integrations 1230d. In some embodiments, these processes may be controlled by a Coordinator 1240. The Coordinator 1240, reads the Schema, settings and other configuration chosen by the User 1220 from their SKDS 1270, then periodically upon a schedule, or upon certain events, or at a certain time, runs any applicable code process 1230 to fulfil the User's 1220 settings. The user may also interact with other SKApps 1260 which do not have a Coordinator to run code processes in the background and only read or write data to or from one or more of a user's SKDSs 1271 or 1270. Importantly, each piece in the architecture can communicate with others via SKL Nouns and Verbs using Standard SDK. For example, the data syncer code process 1230c can use Standard SDK to send queries for data to an Integration 1200. Likewise, the Coordinator 1240 or a code process 1230, can use SKQL to read or write Nouns or Schemas to or from an SKDS 1270.

### Analytics Server

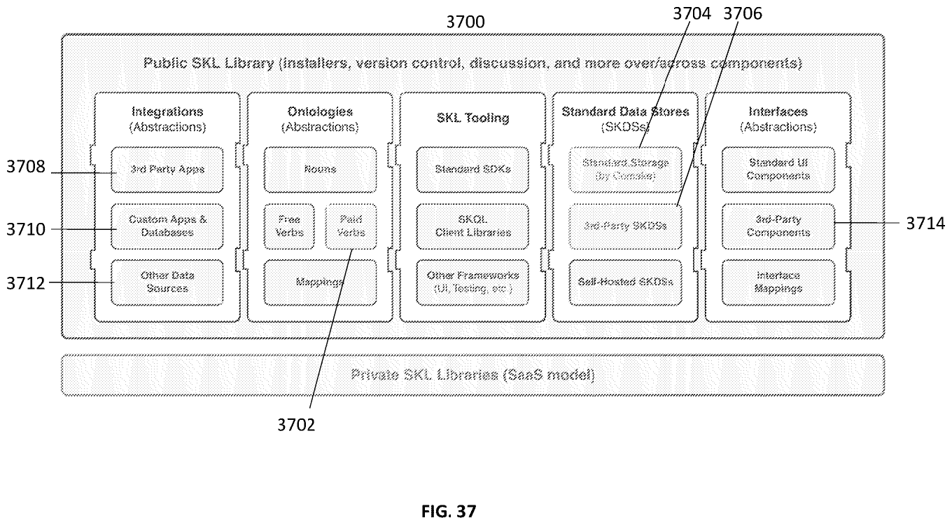

In some embodiments, an Analytics Server represents one or more computing devices which runs some aspect of the SKL ecosystem. As such, an Analytics Server may be made up of one or more computing devices such as a mobile phone, personal computer, virtual reality headset, server, blockchain infrastructure, browser, etc. Any of these pieces of hardware or environments may perform one or more operations that SKL defines including—but not limited to—the following: (1) running a SKApp that uses a Standard SDK to access data from an SKDS, (2) running an application that uses a Standard SDK to interact with an Integration, and (3) running an application that uses a Standard UI Engine to present and interface to a user, be it graphical, auditory, haptic, etc. An example of a system architecture is provided in FIG. 37 that includes an analytics server.

### Authentication Server

According to some embodiments, in SKL's decentralized embodiment, it may provide end users with control over their data, and in other embodiments, separate entity and Schema storage from authentication. As such, an Authentication Server is a service, program, server, or other interface which a user designates as the authority for their identity. An Authorization Server is responsible for allowing a user to sign up and create, or have automatically generated for them, a unique identifier such as a WebID, email address, username, a cryptographically signed key, etc. The Authorization Server may pair a unique identifier with a method of authentication and provide whatever interfaces are necessary for the user to authenticate themselves. Examples of these authentication methods include, but are in no way limited to, OpenID Connect (OIDC), Solid OpenID Connect (Solid OIDC), Oauth2.0, Public Key authentication such as RSA and DSA, username and password, LDAP, Kerberos, SAML or RADIUS.

In the embodiment wherein SKApps and SKDSs are conformant to the Solid specification, any request to an SKDS from a SKApp may either respond with a link to the user's Authorization Server if the request is unauthenticated or will verify the identity of the SKApp and/or end user based on the authentication performed by an Authorization Server. As such, an Authorization Server may be conformant to an OpenID Provider.

In order to authenticate users and provide an authorization code to a Solid Application, A Solid OpenID Provider may be required to have a web page wherein a user authenticates themselves. In such an embodiment, although a user is identified via a WebID and a WebID Profile document, the implementation of authentication of the user as that WebID may be up to the OpenID Provider. As such, the OpenID Provider could use, among other techniques, a username and password, public key authentication, Oauth2.0, etc. In this way, Solid OIDC and its WebIDs may serve as an Authorization wrapper for resources controlled by any Authentication method.

In other embodiments, an Authorization Server may consist of, or leverage third party or proprietary authentication services such as Okta® or Aikon.com to facilitate access to Data Sources.

In another embodiment, A Coordinator or SKDS running locally on a user's computer may not need authentication for interactions between locally running SKApps since it is running on a machine that the user owns and which the SKApp is also running on. However, some users may require their SKDS to be encrypted and access to it to be password or key protected. According to some embodiments, local SKDS APIs will not need any authentication if operating on a system with proper user permissions.

### Standard SDK

According to some embodiments, a Standard SDK may be a code package that may simplify the developer experience when building an application. It may execute Verbs by using Mappings to translate between Nouns and Verbs and the APIs of Integrations (e.g., REST, SQL, etc.) or the functions and methods of Code Packages. Standard SDKs are sometimes referred to herein as “SKL Engines.”

According to one decentralized embodiment of SKL, wherein an application does not need to have preexisting knowledge of what Schemas (e.g., Noun, Verb, and Mappings) a user has installed, Standard SDKs may dynamically respond to a developer's execution of a standard Verb. To do so, a Standard SDK may query for and read SKL Schemas from, for example, an SDKS. A Standard SDK may use SKQL as a convenient way to query for Schemas from a user's SKDS using its simplified ORM style interface. Alternatively, a Standard SDK may not use SKQL and instead submit queries in the native query language of the user's SKDS.

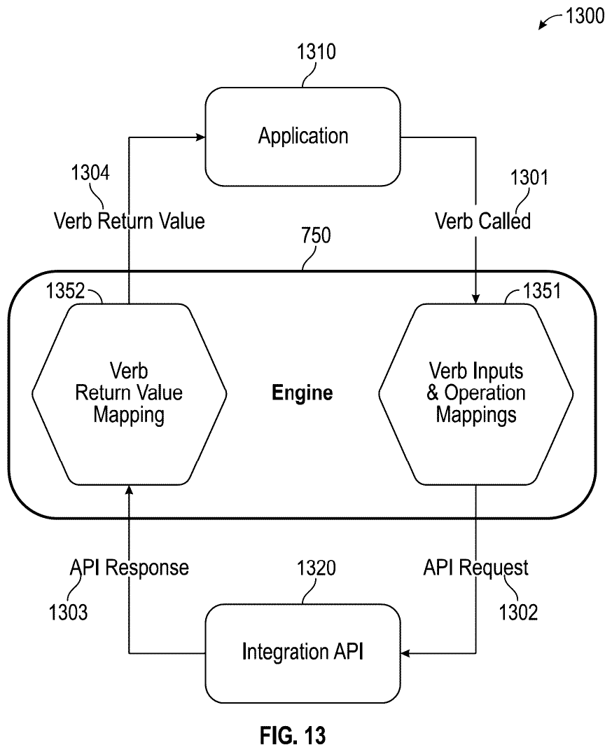

FIG. 13 is a conceptual diagram illustrating how an application may use a Standard SDK to interact with an Integration API, according to an embodiment. In this embodiment, an application 1310 needs to interact with an Integration API 1320 (e.g., to share a file, or otherwise change the permissions on a file hosted by the Integration). As described herein, the developer of application 1310 could choose to write custom code and logic to help interact with the custom functions provided by a proprietary SDK. Alternatively, as illustrated by SKL framework 1300, the developer may use a Standard SDK 1350, which has a standardized set of functions that facilitate interactions with a variety of Integration APIs and then use certain Schemas to determine exactly how to interact with a given Integration API 1320 in order to perform a certain operation, as represented by Verb 1301. The Standard SDK then uses the Verb 1301 and the corresponding Mapping or Mappings 1351 as configuration on its standardized functions in order to interact 1302 with the Integration API 1320. The Integration API 1320 then responds 1303 with data that may use a Mapping to transform 1352 according to the Schemas provided and thereby return the data 1304 to the application 1310 according to the Schemas and configuration provided.

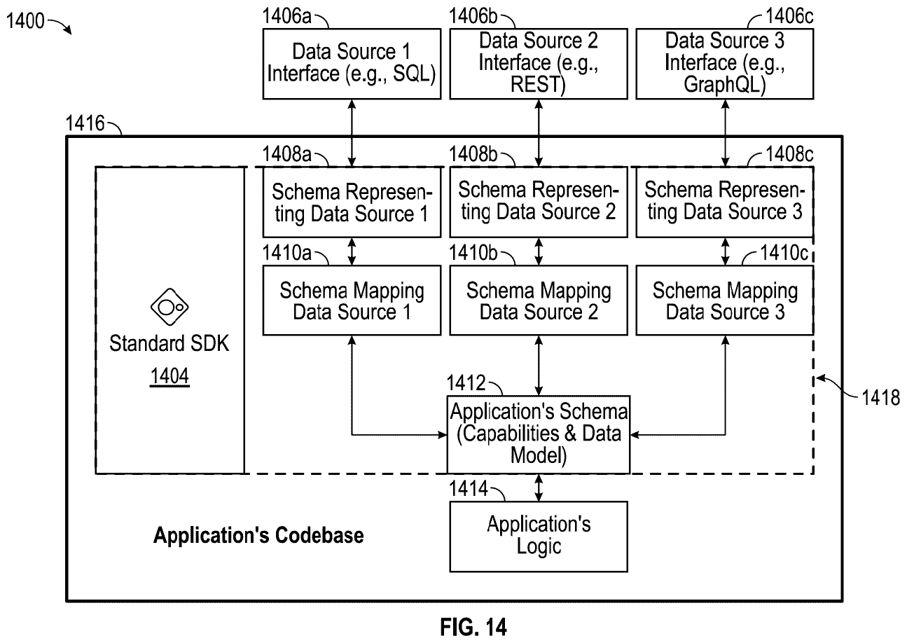

FIG. 14 illustrates a non-limiting embodiment of a composition of a software application 1400 that uses a Standard SDK 1404 together with a set of Schemas and configurations to integrate three different data sources 1406a-c. In this example, the software application 1400 aggregates data from multiple sources and includes hard-coded logic 1414 to allow users to interact with and manipulate the consolidated data, as well as to create new data. As described herein, rather than using multiple SDKs to connect to the three data sources 1406a-c, the application's codebase may only interact with the one Standard SDK 1404. The one Standard SDK then uses a set of Schemas 1418 included in the application's codebase 1416 to facilitate interactions between the application's logic 1414 and the data sources 1406a-c.

In this embodiment, the Schemas 1418 included in the application's codebase 1416 may represent data and capabilities 1412 according to the application's needs (e.g., the application might need a data type for a person, and it may therefore define the Schema for a person and include whatever fields are needed, or it could use a copy of a commonly used data model for a person such as FOAF:person). In a similar way, the Schemas 1418 may also describe the data and capabilities of the data sources 1406a-c (e.g., using OpenAPI or OpenRPC). In this example, the last set of Schemas 1410a-c then establish relationships or Mappings between the data source Schemas 1408a-c and the application's Schema 1418.

In other embodiments, the application may reference a Schema from a data source external to the codebase 1416, including but not limited to a database, another application, a website, a Solid Pod, etc. In this example, the application's Schema 1418 could reference an ontology managed and hosted by third parties such as FHIR or Schema.org. Similarly, the application's codebase could reference an externally hosted Schema representing Data Source 1 1406a, such as an OpenAPI Schema stored on a public website or an external repository of Schemas compatible with SKL (e.g., an SKL library). As mentioned, in the event that one or more Schemas are not included in the application's codebase 1416, they could be requested for use by the Standard SDK at a specific point in time, such as when a certain process requires them.

In some embodiments, the same schemas 1418 can be used by different Standard SDKs 1404 written in different programming languages and running in different runtime environments. In other words, a mobile application written in SWIFT, a webapp written in Ruby, and a windows application written in C or C# can all use the same schemas 1418 interact with integrations. This results in the schemas being treated as a type of cross-language type system that can be modified, “installed,” and used at runtime.

According to an embodiment, the procedure for Standard SDK 1350 to execute a Verb 1301 of FIG. 13 may proceed in the following manner:

First, the Standard SDK finds the configuration for the Verb called by its name from the currently set Schema source. The Schema source may, for example, be the SKL Library REST API, an object in memory of the application code being executed, or a remote SKDS. The Schemas may be accessed using SKQL or a custom method, for example by submitting queries in the native query language of the SKDS.

Second, the Standard SDK may assert the validity of the input arguments supplied according to the Verb's configuration. The Verb's configuration may specify for each parameter (1) what its name is, (2) if it is required or not, (3) if it is allowed to be null, and (4) its data type. Its data type may, for example, be either a scalar data type (e.g., String, Boolean, Integer, etc.), or a reference to a Noun. The Standard SDK may also return an error if the inputs are invalid.

Third, the Standard SDK may perform the Mapping(s) defined in the configuration of the Verb to obtain the inputs and operation to perform the Verb.

Fourth, the Standard SDK may perform the Verb's operation. Different types of Verbs and their associated Mappings may result in different types of operations. For example, a VerbIntegrationMapping may specify that the Verb should use an OpenApi description for the Integration's REST API endpoints to send an HTTP request and obtain the response. A VerbQueryLanguageMapping may specify that the Verb should execute a SQL request with inputted username and password credentials via an HTTP request to a specific server running PostgreSQL. A VerbCodeMapping may specify that the Verb should execute a certain function or method of a code package and obtain the response. In another embodiment, Standard SDK may perform operations via other methods such as a Remote Procedure Call (RPC) according to an OpenRPC specification.

Fifth, the Standard SDK may support one or more types of operations by the Standard SDK Code Package.

Sixth, the Standard SD may obtain the response from performing the Verb's operation.

Seventh, the Standard SDK may perform the Mapping defined in the configuration of the Verb to obtain the standardized output of the Verb.

Eighth, the Standard SDK may assert the validity of the outputs according to the Verb's configuration. Throw an error if the outputs are invalid.

Ninth, the Standard SDK may return the outputs of the Verb.

The foregoing process is provided merely as illustrative examples and is not intended to require or imply that the steps must be performed in the order presented. The steps in the foregoing embodiment may be performed in any order.

A conceptual example helps illustrate the Standard SDK procedure. A developer of a file management application needs to get the contents of a folder stored on Google Drive®. They may use the GETFILESINFOLDER Verb to do so, as long as the user has it installed. When calling STANDARDSDK.GETFILESINFOLDER(ARGUMENTS), a Standard SDK may first use SKQL to check the source SKDS if a Verb with such a name is “installed.” If not, an error may be returned to the developer, which may be presented to the end user telling them to install the necessary Verbs and/or Mappings. In some embodiments, the StandardSDK might automatically look for the Verb elsewhere (e.g., the SKL Library) and ask the user or developer if they want to use that Verb. If the Verb is installed, Standard SDK may search for the appropriate Mapping to translate the inputs of the standard GETFILESINFOLDER Verb to the specific inputs and URL of the Google Drive® API endpoint to obtain the contents of a folder. The Standard SDK code package may handle parsing Schemas and Mappings and the translation of the inputs and outputs of the Verb. In this way, a developer only interacts with the standards specified in their SKL Schemas.

In some embodiments, a Verb may be called as a function on the root Standard SDK object, or as an instance method on any instance of an SKL Noun. In other words a developer may call STANDARDSDK.SAVE(FILE) where StandardSDK is the “root StandardSDK object” or they may call FILE.SAVE( ) when FILE is an instance of an SKL Noun.

In other embodiments, the module or library could be called anything (e.g., SKQL.DO.SAVE(FILE) rather than STANDARDSDK.SAVE(FILE)) and Verbs can be called via any means, such as a top-level method or function, a nested method or function, as an argument to another method or function, etc.

In some embodiments, a Verb may be mapped to multiple operations and/or functions of one or more Integrations or Code Packages which may be executed in series or parallel. The responses of one or more of these operations or functions may be translated to the standard output of the Verb.

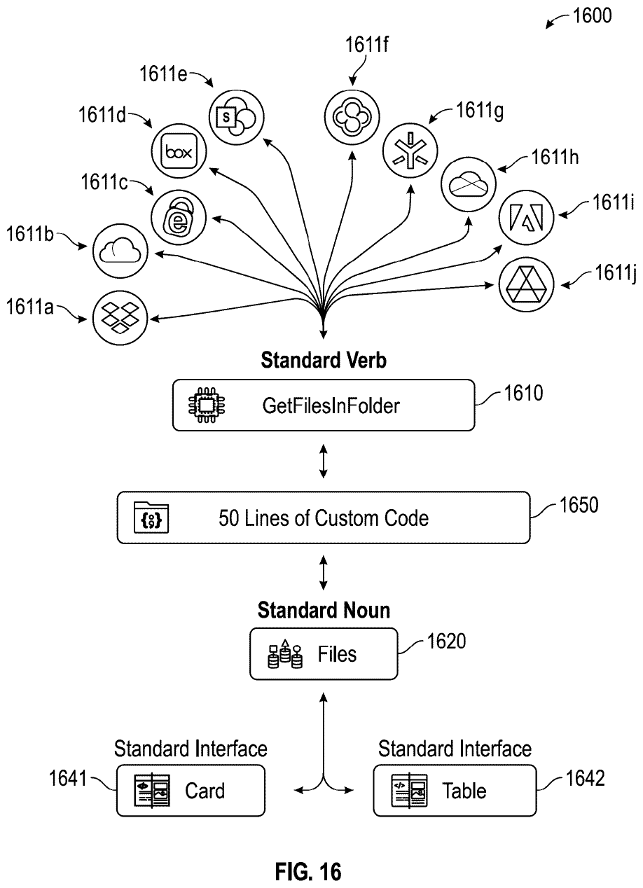

FIG. 16 illustrates a conceptual diagram 1600 of how the developer of the file management application above can leverage the concepts behind SKL to easily integrate with many different applications and/or accounts 1611a-j using the same GETFILESINFOLDER Verb 1610. In this example conceptual example, the developer above wrote custom logic 1650 in order to recursively call the GETFILESINFOLDER Verb 1610 over every nested FOLDER returned by GETFILESINFOLDER Verb 1610 the so that users of the file management application can sync all the FILES and FOLDERS they may have on a given Google Drive® account 1611j. In this case, the GETFILESINFOLDER Verb 1610 may accept a FOLDER and Google Drive® account 1611j as the arguments that the StandardSDK can use to query the data source API with. The StandardSDK using the GETFILESINFOLDER Verb 1610 automatically transforms the data according to the Schemas and provided to the application according to the FILE and FOLDER Nouns in the Schemas. This means that the custom logic described in the applications code base, only needs to interact with these Schemas and therefore no (or almost no) additional custom logic is needed to integrate with the other applications 1611a-i. All that the developer needs is to provide is the additional Schemas that correspond to each Integrations and the Mappings and the StandardSDK will be able to return the data according to the Schemas of FILE and FOLDER Nouns. Any additional capabilities provided by the developer as part of the application (e.g., card interface 1641 and table interface 1642) can be built to only interact with the Schemas of FILE and FOLDER Nouns, and can thereby also automatically work once the developer (or the users) provides the application with the necessary Schemas.

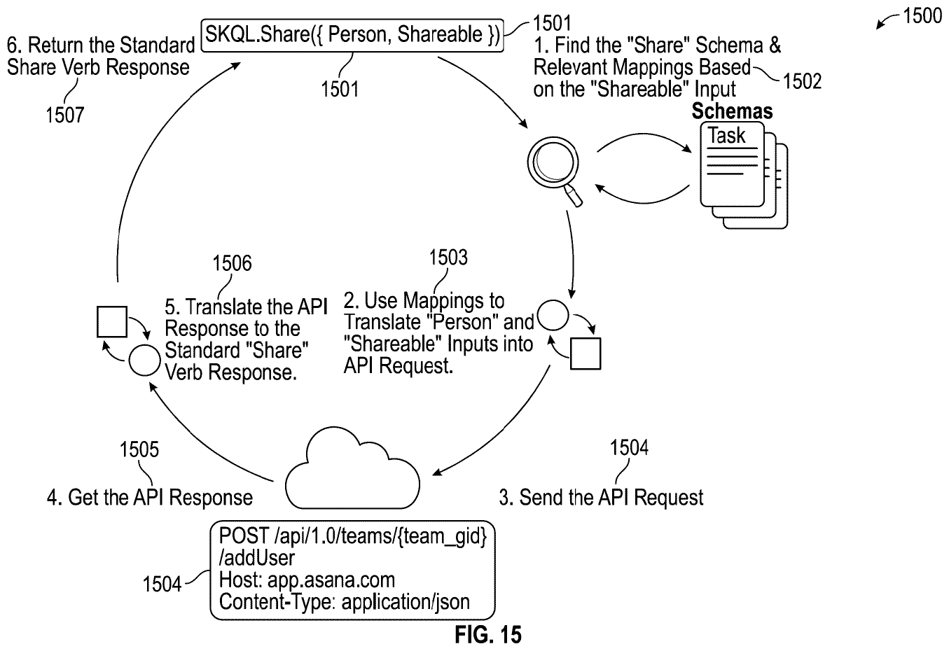

FIG. 15 illustrates a flow diagram of a representation of a Shared Knowledge Language process 1500, in accordance with an embodiment. At step 1501 an application uses a Standard SDK to call a SHARE Verb with shareable Entity (e.g., a task) and a PERSON Entity (or an ACCOUNT Entity if a person has more than one ACCOUNT). At step 1502 the Standard SDK find the Schemas and relevant Mappings for that correspond with the PERSON, the shareable Entity, and the Integration(s) associated with the PERSON and the sharable Entity (e.g., from the codebase, from an SKL Library, etc.). At step 1503 the Standard SDK uses the Schemas and Mappings to translate the arguments provided to the SHARE Verb (e.g., the PERSON Entity and the sharable Entity) into the formats expected by the Integration API. At step 1504 the Standard SDK uses its standard functions, such as EXECUTEOPENAPIOPERATION( ) to send a request to the corresponding Integration's API endpoint according to the API's specification (e.g., as defined through its OpenAPI spec). At step 1505 the Integration's API returns the data to the Standard SDK. At step 1506 the Standard SDK uses the Schemas and Mappings to transform the Integration API's response to the expected outputs of the SHARE Verb. At step 1507 the Standard SDK returns the standard response from the SHARE Verb to the application.

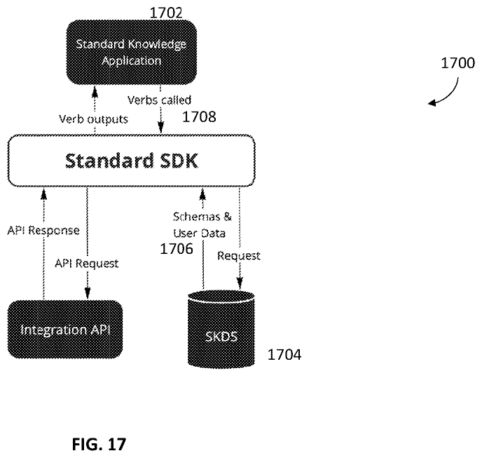

Turning now to FIG. 17, the flow of data in the SKL framework 1700 is shown. A Universal File Browser application 1702 which displays to users all their files and folders from multiple Integrations (e.g., Dropbox®, Google Drive®, OneDrive®, etc.) is shown. The application 1702 may contain code which uses Verbs to recursively request and copy the Metadata of all files and folders within a user's accounts regardless of what service they exist in so that it may display them to the user.

Instead of the developer storing the Metadata about files and folders in a siloed database they control, the developer may store the data in a user's SKDS. The SKL framework 1700 includes Schema 1706 and special Verbs 1708 for querying and saving data to SKDS 1704.

In the future, the user may use another SKApp for signing documents. This application, once authorized by the user to read data from their SKDS, may query for Entities conforming to the standard FILE Noun in the SKDS which the user may need to sign. In this way, the two applications may interoperate on the same data because they have a common understanding of its Schema.

Referring back now to FIG. 1B and FIG. 3, a non-limiting embodiment of a Standard SDK framework is shown. Application 121a-f of FIG. 1B may use a Standard SDK to integrate with all other applications 121a-f by only building one integration each. A first application 121a may be considered as application 350 of FIG. 3, and the other applications 121b-f that need to be integrated with the first application 121a may be thought of as applications 130 of FIG. 1b.

Application 121b-c may use a Standard SDK together with the Schemas and Mappings to integrate with each other, without requiring a central server to act as a “unified API” by having all interactions route through it. In this embodiment, the various applications may communicate with each other in a one-to-one manner, similar to network of integrations 110, but rather than translating information directly from the first application 121a to the other applications 121b-f, each application only needs to be integrated once with a given standardized ontology, and through that standardized ontology, they may be integrated with each other. This non-limiting embodiment demonstrates that a SKL framework may be a highly composable and customizable. Through the abstraction of software, and providing access through an ontology, SKL allows each independent software developer to reuse components such as Mappings for other integrations.

An SKL framework may enable the reuse of components across software applications, codebases, and more by providing composable Schemas to link components together. For example, in the process of creating an application, a developer may create Mappings between the FHIR ontology and twenty different healthcare platforms. Those twenty integrations may then be shared with other applications and developers (e.g., through the SKL Library). Over time, certain ontologies may emerge as “standards” in a given domain area and/or within a given industry. In this embodiment, developers and end users may remain in control of the Schemas and the Standard SDK so as to make changes to any standard according to a specific need.

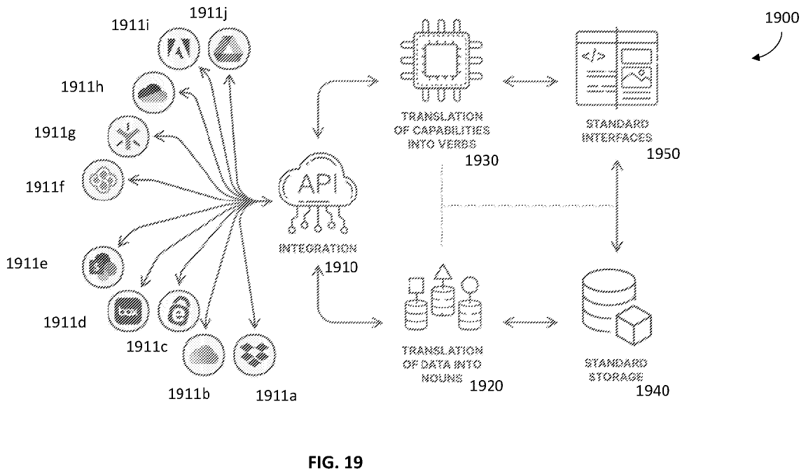

FIG. 19 illustrates a conceptual diagram of various components that make up Standard Knowledge Language framework 1900, according to an embodiment. In this embodiment, SKL is a protocol that may be built to work with a wide variety of software, regardless of whether that software was built according to an SKL specification or not. As such, in this embodiment, there may be an abstraction/translation of software and components (e.g., proprietary APIs and their data) into a universal language of data, capabilities, interface components, storage solutions, and more. As described herein, the various components are represented abstractly through Schemas which include Nouns 1920, Verbs 1930, Integrations 1911. Interfaces 1950, and the like.

According to this embodiment. Standard Storage 1940 may be an SKDS provider that offers various different types of SKDSs. Similar to how Integrations 1911a-j may each be represented by Schema such as an OpenAPI specification that SKL tooling may use, each SKDSs offered by Standard Storage 1940 may be represented through an SKDS Schema.

Abstractions that represent data as Nouns 1920, capabilities as Verbs 1930, interfaces as Interfaces 1950, and data stores as SKDS Schemas may assist the SKL framework 1900 to understand each piece deterministically in a standard way. By centering all software components around an ontology, and providing tooling to help build software semantically, each component may represent data based on what it is rather than where it comes from or how it is stored. Each component may access a capability in a standard way regardless of whether that capability is executed remotely or not. Each component may be able to access data from a data store regardless of whether they know the how that data store handles persistence, and so on. Furthermore, because these abstractions or Schema may be stored as a configuration, they may easily be shared across programming languages, execution environments, etc. In this way, these abstractions may be easily ported and/or shared between tools. Moreover, because SKL components may be connected through Mappings, and because their Schemas may specify their attributes as configuration, SKL systems may be able to evaluate which components are compatible with their needs in a standard way.

Due to the modular nature of the SKL ecosystem's components, in some embodiments each type of component may be used independently. According to some embodiments, every component need not be used together. For example, a developer of an existing application (e.g., Gmail®) could choose to use a Standard SDK to build integrations with other tools. Similarly, a developer could choose to build a SKApp that communicates with SKDSs without using other components. In yet another non-limiting example, a developer could choose to use SKApp with Standard Interfaces that connects to an Integration without using an SKDS.

According to some embodiments, as more Schemas are created for a wider variety of components and needs, and as those component Schemas are mapped to more ontologies, it may become increasingly easy for developers and users to develop solutions with SKL. In other words, because SKL is highly composable and parametric, it may have the ability to offer value to its users because any component for a solution may be able to be reused and repurposed for a second solution with ease. As more applications, platforms, and data sources are mapped to a given ontology, the easier it may be to integrate novel software into that industry or domain area. For example, in some embodiments, developers may be able to integrate with a given ontology to connect to a theoretically infinite number of applications. In this way, SKL technologies and methods may replace any closed and proprietary “unified API” service that restricts application developers from extending capabilities such as which integrations the unified API supports, that requires the application using the unified API to route all data through their the unified API company's servers, that charges high amounts per throughput, etc.

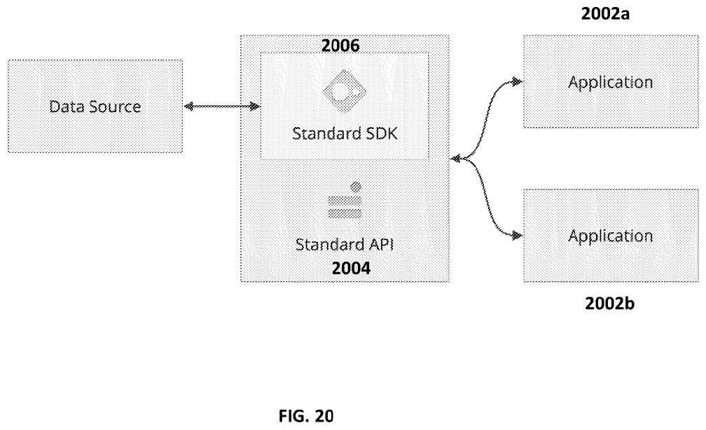

Turning now to FIG. 20, two different applications 2002a-b using a Standard API 2004 (as described herein) are shown. In this embodiment, the standard API 2004 may use Schemas to expose endpoints corresponding to Nouns and Verbs.

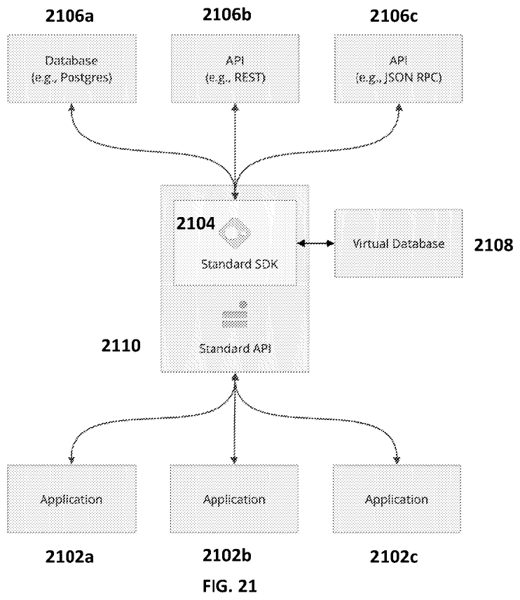

FIG. 21 shows an embodiment wherein multiple applications 2102a-c use a Standard API 2110 (as described herein) that may use Schemas to expose endpoints corresponding to Nouns and Verbs in order to interact with multiple Integrations. In one embodiment, a Standard SDK 2104 may use a Virtual Database 2108 technology which, when queried through the Standard API 2110, federates requests to multiple databases, multiple tables of those databases, and/or multiple Integrations to construct a complete response in the format of the domain model. Such a Virtual Database 2108 could be used not only to federate queries to multiple databases but also to one or more web APIs 2106b (e.g., REST, GraphQL, etc.), or files 2106c (e.g., JSON, CSV, etc.).

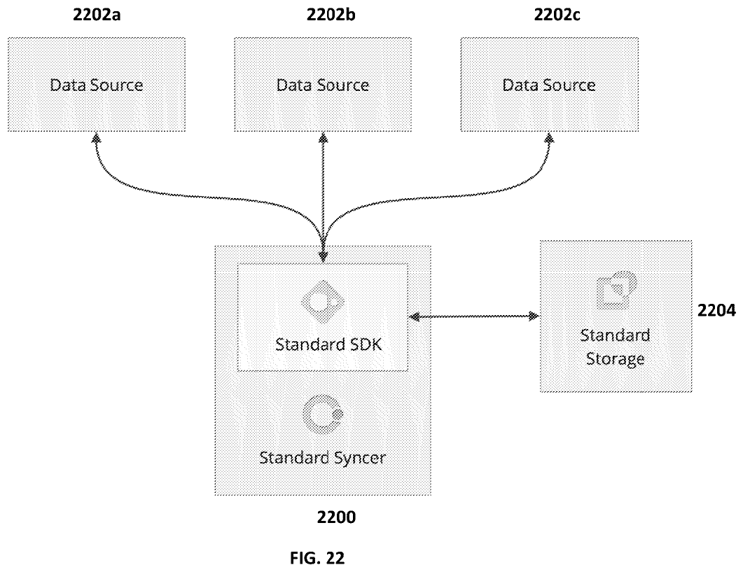

In yet another embodiment, FIG. 22 illustrates a single SKApp 2200 (in some embodiment called a “Standard Syncer”) which may be used to continuously sync information from multiple data sources, databases, and/or Integrations 2202a-c into a standard knowledge data storage (“SKDS”) 2204 that may be used by other applications (e.g., SKApps).

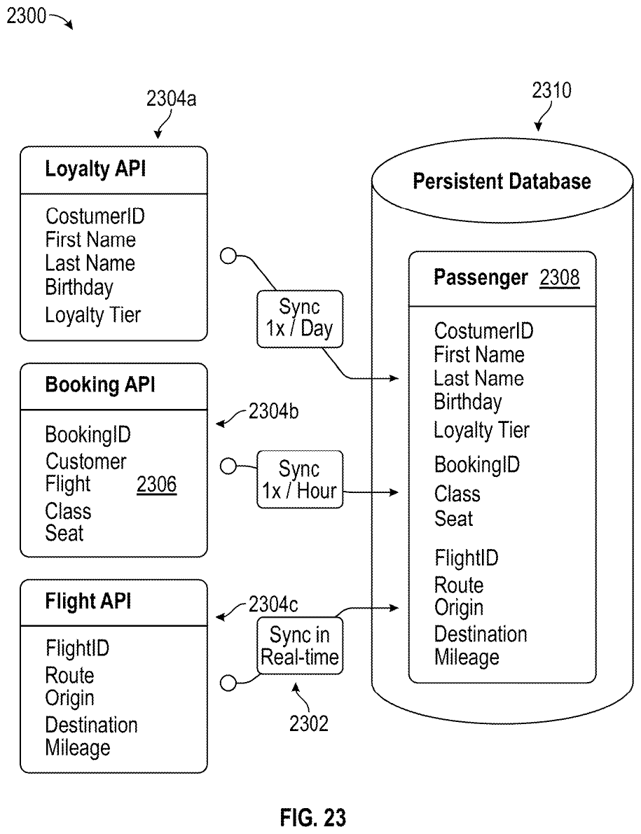

FIG. 23 illustrates how the Standard Syncer SKApp of FIG. 22 may be configured to “coordinate” syncing 2302 from the different data sources in custom ways (e.g., using a cron schedule). In this embodiment, the Standard Syncer SKApp 2300 may be considered a Coordinator. In this embodiment, the Standard Syncer SKApp may be used to consolidate data from multiple source into a unified data model which is described by Nouns. In this example, the unified data model (i.e., the ontology) includes FLIGHT 2306 and PASSENGER 2308 Nouns The Entities are stored on a persistent database or an SKDS 2310.

### Automations and Rules Engines

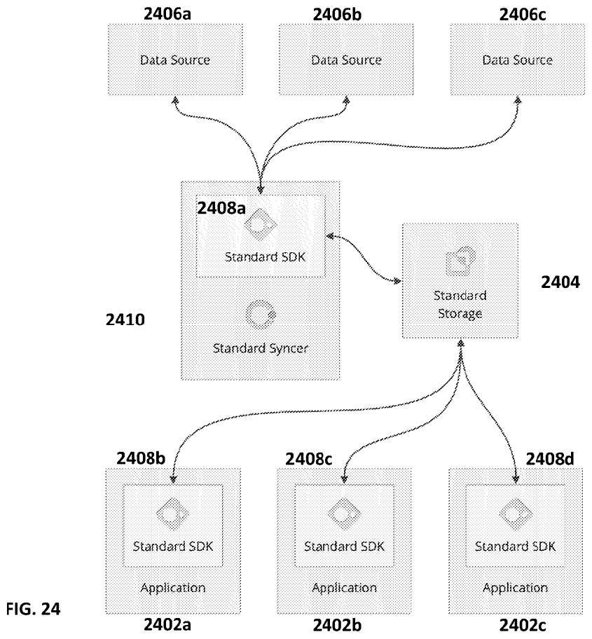

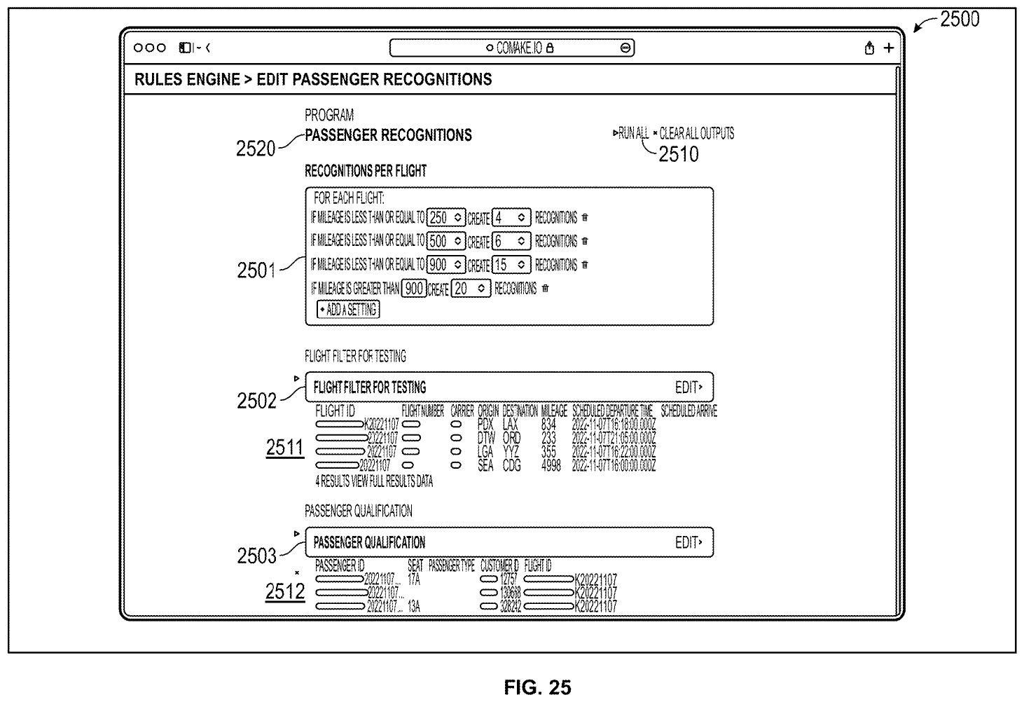

Turning now to FIG. 24. According to some embodiments, a process is shown in which applications 2402a-c may query an SKDS 2404 for data synced from multiple data sources 2406a-c using a Standard SDK 2408a. In this non-limiting embodiment, each SKApp 2402a-c may use a Standard SDK 2408b-d to access the SKDS's 2404 Schema to feed data into interfaces, such as those for a rules-engine SKApp illustrated in FIGS. 25-28. FIGS. 25-28 correspond various interfaces of the same rules-engine SKApp.

Considering the Standard Syncer SKApp of FIG. 23, the Standard Syncer SKApp 2410 may be used to consolidate data from multiple sources into a unified data model which is described by Nouns. In this example, the unified data model (i.e., the ontology) includes FLIGHT and PASSENGER Nouns. The unified data model may then be used by SKApps (e.g., 2402a-c) to create a filtered and ordered list of PASSENGERS for any given FLIGHT that meet certain criteria according to the values on the fields of the PASSENGER and FLIGHT Entities as illustrated in FIG. 25.

FIG. 25 show a non-limiting embodiment of the interface for a rules-engine SKApp 2500 that allows non-technical users to easily customize the parameters for how PASSENGERS are filtered on a given FLIGHT. In this example, interface component 2501 can be used by a non-technical user to determine variable numbers of PASSENGERS in each list of PASSENGERS according to certain parameters associated with a FLIGHT. As depicted, interface component 2501 can use the travel distance (e.g., the MILEAGE property) of a FLIGHT Entity in order to establish that: a list of 4 PASSENGERS should be generated for FLIGHTS with a travel distance of less than or equal to 250 miles; a list of 6 PASSENGERS should be generated for FLIGHTS with a travel distance greater than 250 and less than or equal to 500 miles; a list of 15 PASSENGERS should be generated for FLIGHTS with a travel distance greater than 500 and less than or equal to 900 miles; and a list of 20 PASSENGERS should be generated for FLIGHTS with a travel distance greater than 900. Interface component 2502 illustrates how non-technical users may create, modify, and use certain FLIGHT filters in order to facilitate the testing of a particular overall configuration for a program 2520 on the rules-engine 2500. Similarly, Interface component 2503 illustrates how non-technical users may create, modify, and use certain PASSENGER filters or qualifications that should be applied to all PASSENGERS that get added to any list generated by the program 2520.

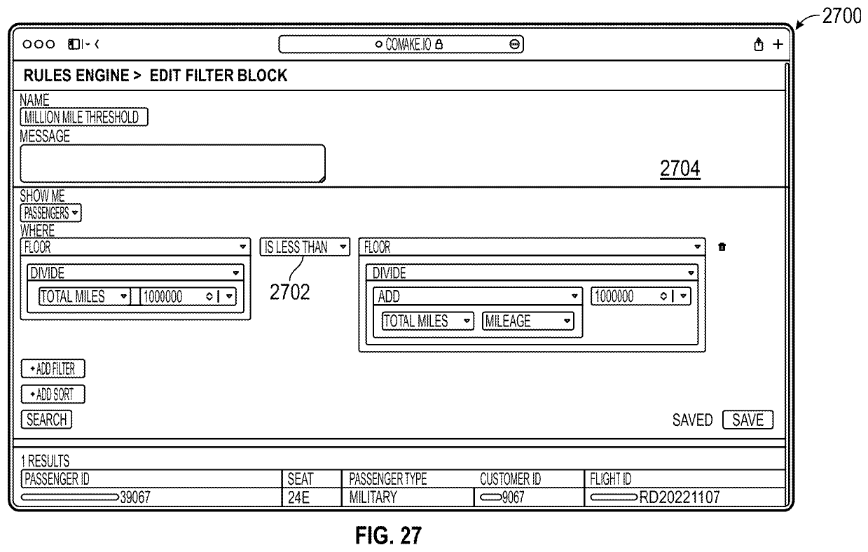

Non-technical users are able to test the program 2520 by using running it according to the configuration set through interface components 2501, 2502, and 2503. The interface component 2510 provides a simple way for non-technical users to click a button that will automatically query the SKDS 2404 for Entities that match the criteria established through interface components 2501, 2502, and 2503. The resulting data after each step can be seen contextually on the SKApp's interface 2500. Interface component 2511 shows that four FLIGHT Entities were identified in SKDS 2404 that match the configuration set through interface component 2502, and lists out certain fields associated with those flights as well as the ability to see more detail associated with the results. Interface component 2512 shows that at least three PASSENGER Entities were identified in SKDS 2404 that match the configuration set through interface component 2503. FIG. 27, described further below shows the continuation of the interface 2500 and how there are 198 PASSENGERS that meet the criteria determined through interface component 2503.

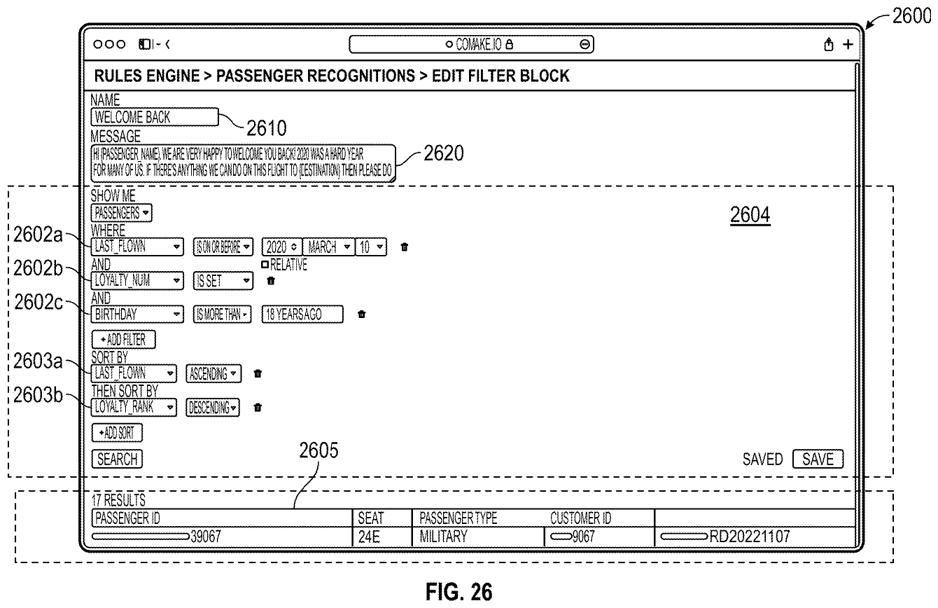

FIG. 26 shows a non-limiting embodiment of how the Schemas for the PASSENGER and FLIGHT Nouns shown in FIG. 23 may be used to populate information into the interfaces shown by the rules-engine SKApp 2600. According to this embodiment, exemplary fields include LAST_FLOWN 2602a, LOYALTY_NUM 2602b, and BIRTHDAY 2602c. The SKApp 2600 could use an Interface Component 2604 which accepts one or more Noun Schemas as inputs in order to provide filtering capabilities based on the properties associated with those Schema(s). Simple query logic, such as is EQUAL TO, is GREATER THAN, CONTAINS, etc. could then be used to evaluate whether a given Entity of that type of Noun in the SKDS matches the query provided. Interface Component 2605 could then provide a detailed list of Entities that match the filtering criteria provided in Interface Component 2604, similar to Interface Components 2511 and 2512. Additional capabilities, such as sorting may also be used as is shown on in Interface Components 2603a and 2603b. In this example, the PASSENGER Entities that match the filters 2602a-c should be sorted in ascending order by LAST_FLOWN (as shown in Interface Component 2603a) and any PASSENGERS with the same value on LAST_FLOWN should be consecutively sorted in descending order by the LAST_FLOWN parameter (as shown in Interface Component 2603b). The SKApp could then save these filters as a configuration (e.g., as an Entity of the RECOGNTIONCATEGORY Noun with a given name or ID shown as “Welcome Back” in Interface Component 2610) along with a related Entity of type MESSAGE as shown in Interface Component 2620.

FIG. 27 shows the configuration for a different Entity of the RECOGNTIONCATEGORY Noun (e.g., “Million Mile Threshold”) in the Interface Component 2700, which could expose more sophisticated filtering capabilities, such as using an equation 2702. The example below shows an Interface Component 2700 that may be used to build a query 2704 (e.g., using SKQL, or SQL: SELECT PASSENGER FROM FLIGHT WHERE FLOOR (TOTAL_MILES/1,000,000)< >FLOOR (TOTAL_MILES+MILES_TODAY/1,000,000)) that may be saved and/or sent directly to the SKDS. The different Entities of type RECOGNTIONCATEGORY could be used to save different configurations and/or filters that can be used to create different lists of PASSENGERS that match different criteria.

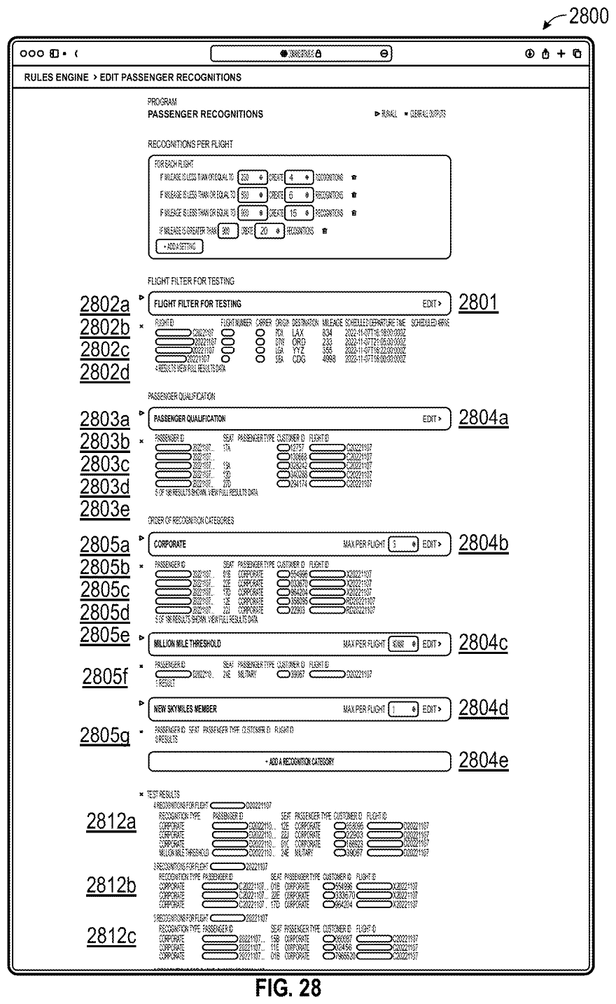

Turning now to FIG. 28, which shows the rest of the interface 2500, according to a non-limiting embodiment. Interface 2800 shows all the configuration and test results for steps of a the program 2520. In this example, a Verb GENERATERECOGNTIONS may be configured to create recognitions for one or more Entities of type FLIGHT. For example, the four flights 2802a-d could each be taken through a series of consecutive steps as may be defined in the GENERATERECOGNTIONS Verb. These steps may be defined in several ways, including by creating other Verbs such as GENERATERECOGNITIONSFORCATEGORY which could require an Entity of type RECOGNITIONCATEGORY to specify the configurations for the filtering that would be specified by an Entity of RECOGNITIONCATEGORY (e.g., Corporate, MillionMileThreshold, LoyaltyMember). In this example, the four flights 2802a-d are each run through the program 2520 by first filtering the passengers on those flights by the criteria set at step 2804a, which returns 198 passengers, of which the first five of which are shown in Interface Components 2803a-e. The program 2520 then filters the 198 passengers on those flights by the Entities of RECOGNITIONCATEGORY shown in interfaces 2804b-d. According to this embodiment, the steps 2804b-d are run on each flight in order starting with 2804b, then 2804c, and finally ending with 2804d. A use could edit the configuration for the “Million Mile Threshold” RECOGNITIONCATEGORY 2804c by clicking “Edit” which would bring up interface 2700.

According to this embodiment, a user could easily create new and/or add existing Entities of RECOGNITIONCATEGORY (e.g., such as the “Welcome Back” Entity shown in FIG. 26) by clicking the interface component 2804e. A user may also click and drag to change the order of RECOGNITIONCATEGORIES 2804b-d. Each of these changes could be saved as configuration in a different Entity of type RULESENGINEPROGRAM, where the configuration of number of passengers per flight 2501, the flight filters for testing 2801, the overall passenger qualifications 2804a, and the various recognition categories and their order 2804b-d (which may be stored as references to the RECOGNITIONCATEGORIES Entities 2804b-d) could be the information stored by the Entity. In this example, the GENERATERECOGNTIONS Verb could accept a given FLIGHT Entity as well as a RULESENGINEPROGRAM Entity (e.g., program 2520) and take the flight through all the steps of program 2520 in order to output the resulting data, which in this case is a list of passengers that should be recognized on the flight Entity provided to the Verb. For the sake of testing, the interface 2800 can show the user the resulting lists of passengers that should be recognized on each flight as shown in interface components 2812a-c, as well as the corresponding RECOGNITIONCATEGORY that resulted in that passenger being recognized on that flight.

In another embodiment, the Verb that runs the workflow according to the configuration set may be made accessible or exposed via a Standard API endpoint or simply called by a Standard SDK of another SKApp that is interacting with the SKDS. These other applications could trigger the workflow remotely through the GENERATERECOGNTIONS Verb for any given flight or set or flights.

According to another configuration, a different program of a rules-engine SKApp may use Verbs, which execute one or more other Verbs that include Triggers and Actions that may be connected together and run automatically. In one embodiment, a shared email account may receive an email. The receipt of this email may then trigger a Verb which finds named entities (e.g., FINDNAMEDENTITIES) in the email, followed by a second Verb to compare identified named entities to a predetermined list (e.g., project 1, client 2, deal 3). If there is a match, the Verb may then find the person that is associated as a lead on that project/deal/client/etc. in a data source. Once the person is found, the Verb may then (1) create a task that references the email, the project/deal/client/etc., (2) assign it to the lead, and (3) forward that person the email and include a reference to the task in the forwarded email.

In this way, SKL abstractions may make it easier to interact with data from multiple sources and Integrations. Tools such as IFTTT®, Zapier®, Tray.io®, and Mulesoft® offer workflow automation builders by offering connectors and easy drag/drop interfaces to workflows between specific Integrations. However, because of SKL, a SKApp which utilizes rule engines of FIGS. 25-28 may easily build automations and workflows by leveraging the full power and range of capabilities that Nouns and Verbs offer.

In another embodiment, a SKApp can use programs, business processes, automations, process workflows, etc. like these to establish links between nodes within a nodal data structure. For instance, when a user copies & pastes information from one place to another, the analytics server may automatically create a link between the Entity that corresponds to the copied data and the Entity corresponding to the pasted data and label that link between those Entities (e.g., managing the Metadata to that relationship) accordingly such as labeling that one Entity is a source for the other. In another example, automations like those done with popular automation tools may create links between content and may add Metadata to the edges/relationships. In another example, a user (or system) that navigates to a certain website or piece of information from a different piece of information may establish a relationship between both of those nodes and add the appropriate Metadata to the edge (e.g. a user accessing a website by clicking a link in a particular text message, and then navigating to another webpage may establish and/or alter the links, relationships, and metadata about and/or between the nodes). Specifically, the analytics server may also score a variety of aspects related to this system, such as: the potential relevance of relationships being established between nodes that a user interacts with, the confidence on the potential labels and metadata established on and/or between nodes, etc.

### Connecting SKL to Interfaces

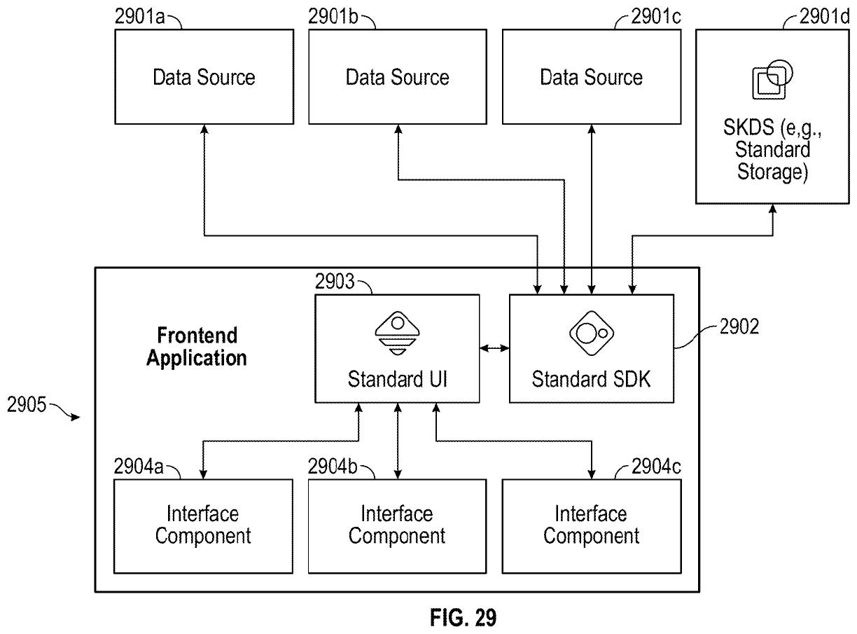

FIG. 29 illustrates a conceptual diagram of how an SKApp 2905 can use a Standard SDK 2902 to retrieve data from various data sources 2901a-d according to the Schemas of Nouns and then use a Standard UI Engine 2903 to provide the data to various different Interface Components 2904a-c, according to an embodiment. In this example, the SKApp 2905 can execute Standard SDK 2902 requests in order to feed data to or respond to events from Standard UI Engine 2903. In some embodiments, in order to do this the SKApp 2905 can have one or more top-level Interface Components 2904a-c or files which import or have access to both the Standard SDK 2902 and the Standard UI Engine 2903.

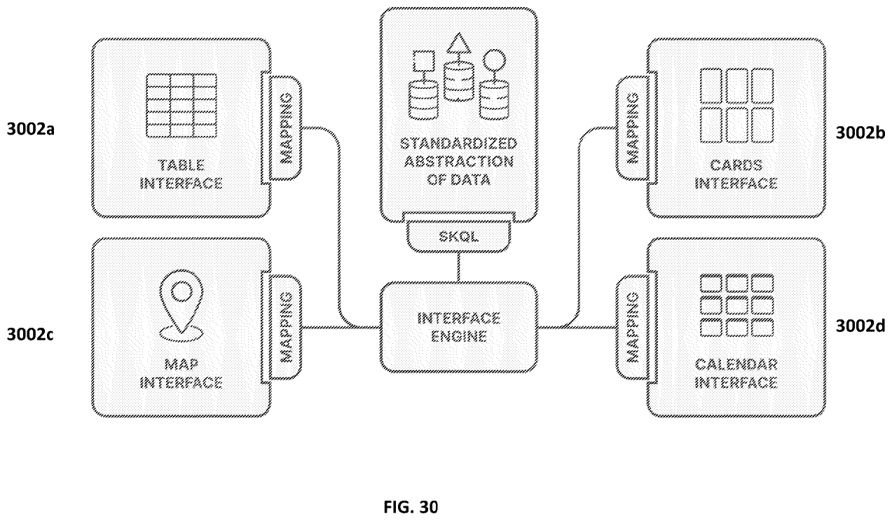

According to some embodiments, an SKL framework may provide a frontend engine (e.g., Standard UI Engine) that applies similar concepts as the Standard SDK, but to Interface Components. By using NOUNINTERFACEMAPPINGS, a developer may create a relationship between certain parameters of a Noun's Schema and certain fields of an Interface's Schema. The fields of an Interface's Schema might in turn correspond to the props for a React component. For example, FIG. 30 shows how a certain Noun may be mapped, according to an embodiment, to a variety of Interface Components. In other words, a Noun like SCHEMA.ORG:EVENT could be mapped to four different Interface Components: TABLE 3002a, CARD 3002b, MAP 3002c, and CALENDAR 3002d. The various properties of the SCHEMA.ORG:EVENT such as TITLE, DATE, etc. could then be mapped to the inputs of the various Interface Components.

In some embodiments, if relationships exist between different Noun Schemas—such as a CONCERT being (1) mapped to, (2) a subtype of, or otherwise (3) has a relationship to the SCHEMA.ORG:EVENT Noun—then CONCERT may automatically work with any Interface Component that is mapped to SCHEMA.ORG:EVENT.

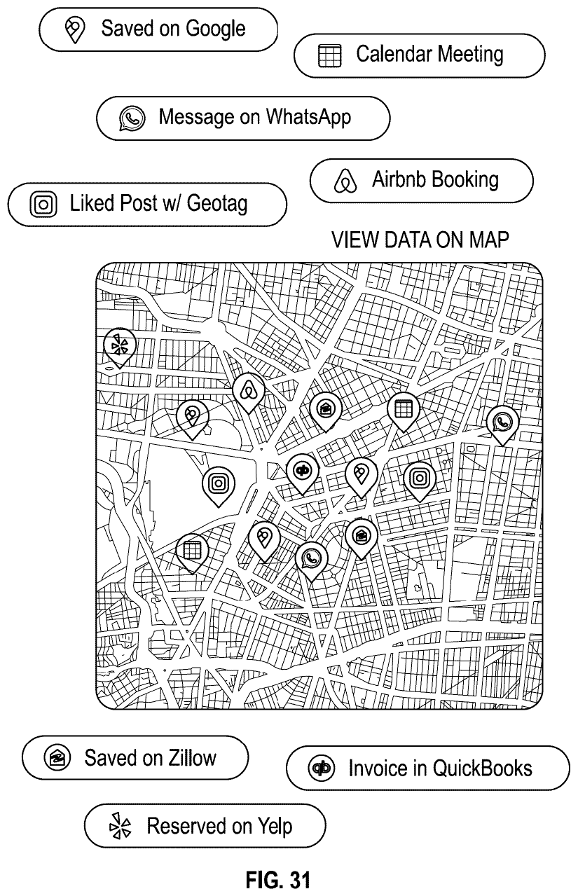

FIG. 31 shows, according to some embodiments, how the methods of the various embodiments of SKL as described herein (including the abstraction of Integrations, the Mappings to standardized Nouns, and the Mappings to Interface Components) may be used to show data from multiple sources in a standard way on a map Interface. Because of how SKL works, the Interface could be swapped out at any time with relative ease. In some embodiments, the Schemas for Interface Components may be used to represent components from different frameworks (e.g., React, Standard Interfaces, etc.).

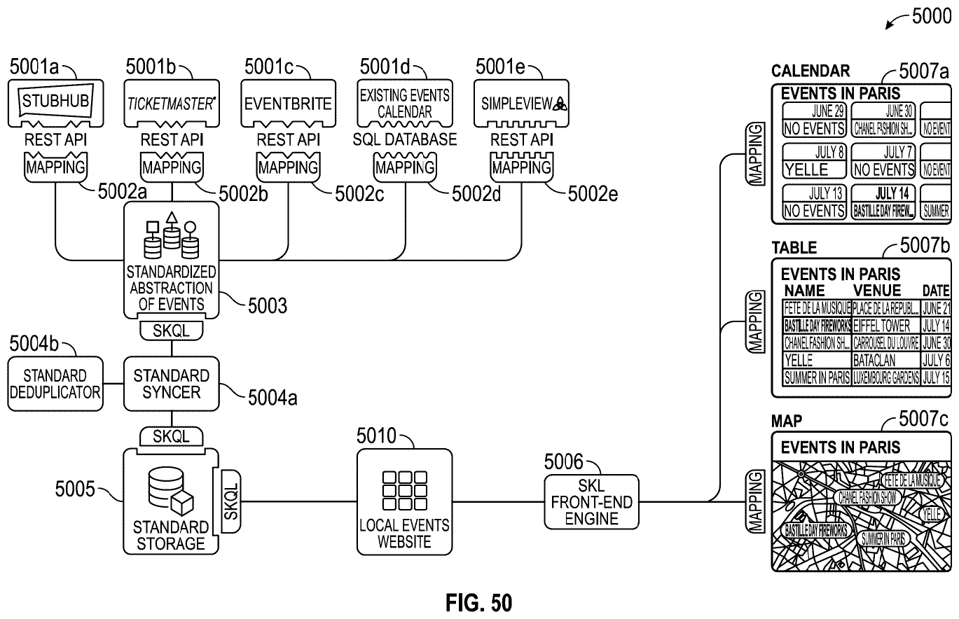

FIG. 50 shows a conceptual diagram 5000 that combines the concepts from FIG. 30 and FIG. 31, according to an embodiment. In this example several Integrations 5001a-e are connected to a Syncing SKApp 5004a, that includes a deduplication process 5004b. As with other examples, the Syncing SKApp 5004a-b may use Schemas to represent each Integration 5001a-e, the standardized Nouns 5003 and Verbs that are used to interact with the various Integrations 5001a-e, and the Mappings 5002a-e that translate the various data formats and capabilities offered by each Integration 5001a-e into their standardized representation(s) 5003. Using the methods described herein, the Syncer SKApp also reads and writes Entities from and to the SKDS 5005 which a third-party website 5010 is able to query directly. In this example, the website may also use a Standard UI Engine 5006 to help various Interface Components 5007a-c access and interact with the standardized Nouns and Verbs that are stored in SKDS 5005.

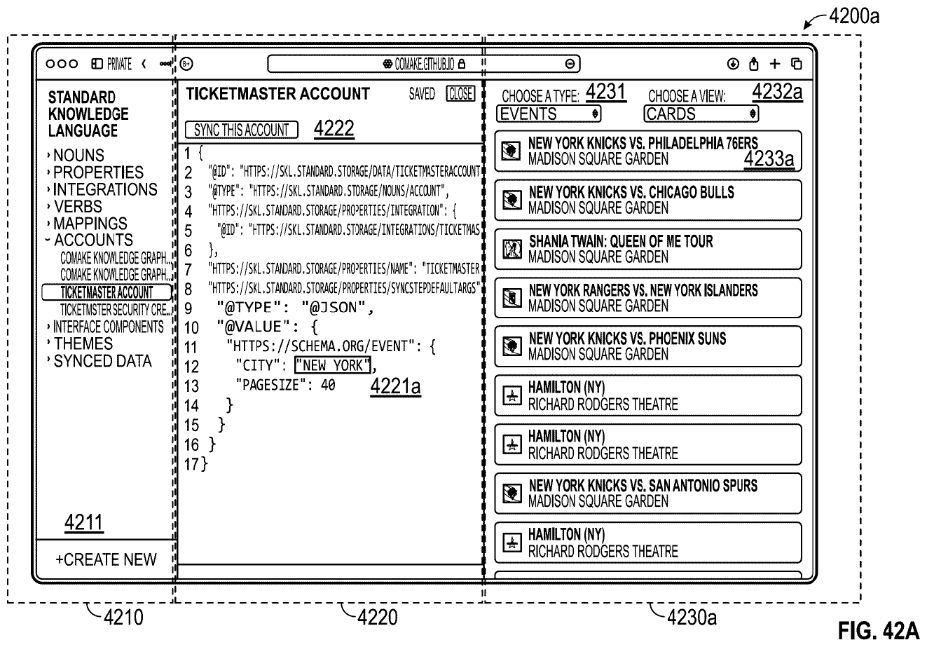

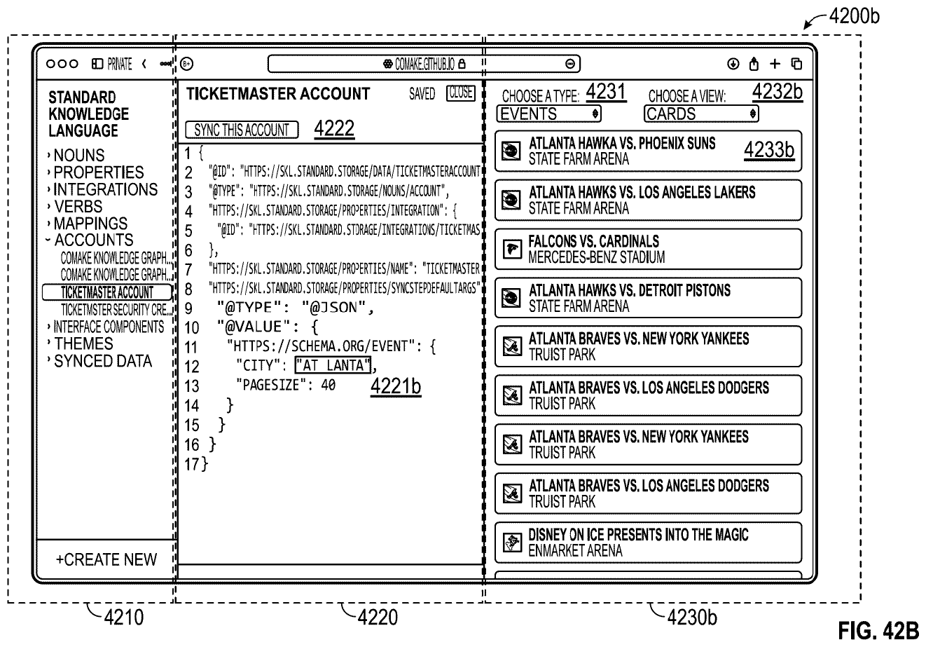

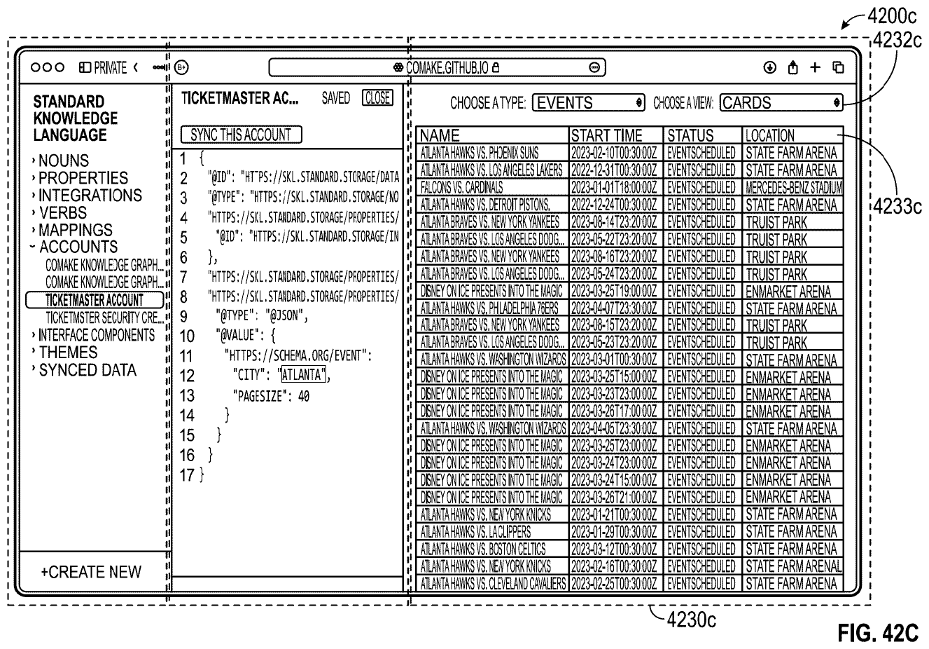

FIGS. 42-49 illustrate the graphical user interface of SKApp 5010 that lets end users easily and dynamically modify Schemas in order to customize almost any part of the SKApp, according to an embodiment. Referring first to FIG. 42a, graphical user interface 4200 shows three main panes: a Schema navigator 4210 that lets users easily view and modify all the Schemas, as well as create new and/or load in other existing Schemas from other sources (e.g., the SKL Library) using interface component 4211; a Schema inspector and editor 4220 which may let users easily open SKL Schemas and modify any of the embedded and/or related configuration, and a section 4230a that uses the Standard UI Engine to render Entities of a given type according to a chosen Interface Component Schema. In this example, the user has chosen to add a Tickemaster® account 5001b, and then selected that account from the Schema navigator 4210. In this example, the purpose of the SKApp 5010 is to sync and deduplicate Events (e.g., sports matches, concerts, festivals, etc.) from various data sources and to show them in in a unified interace.

According to this embodiment, the configuration for a given Tickemaster® account 5001b is represented through two Schema files, one for the security credentials (e.g. API token) and one for the configuration of syncing of data from that integration. The Schemas to represent the Ticketmaster® API (e.g., the Ticketmaster® OpenAPI spec), standardized Events, and the Verbs and Mappings necessary to get them are all within their own subsection in panel 4210.

This example provides a manual trigger for syncing 4222 and a couple syncing parameters that can be changed for the Ticketmaster® account such as the number of results to grab and a given city to get Events for 4221a. For the sake of simplicity this example has been limited to a couple editable parameters but other embodiments can allow users to edit other parameters, as well as to use automatic triggers and syncing schedules as described elsewhere herein. Given that the relevant “city” parameter 4221a in this example is set to New York, the EVENT Entities shown in panel 4230a are events that take place in in New York City. Referring now to FIG. 42b, changing the “city” parameter 4221b to Atlanta and resyncing adds events that take place in the city of Atlanta as is shown in panel 4230b. In this way, SKL is able to abstract away a significant amount of complexity and make it accessible via parametric configuration files.

Referring back to FIG. 42a for a moment, interface component 4231 can be used to specify how what types of Entities returned by the syncer should be displayed in panel 4030a. Since the syncer is likely to return multiple types of Entities like LOCATIONS, PERFORMERS, and EVENTS from a data source like Ticketmaster®, a user may want to filter them down by a given type of Entity. Similarly, interface component 4232a can be used to specify how the EVENT Entities returned by the syncer should be displayed within panel 4030a. In this case, a user has specified that the EVENT Entities should be displayed in Interface Components of type CARD. Entities synced with the New York parameter 4221a and Entities synced with the Atlanta parameter 4221b both can be displayed in cards as shown in interface components 4233a and 4233b respectively. Referring now to FIG. 42c, because Interface Components in SKL may be easily mapped to Noun Schemas as explained herein, any Interface Component previously mapped to the standardized EVENT Noun (e.g., SCHEMA.ORG:EVENT Noun) may be loaded into this SKApp 5010 and used to display EVENT Entities. For instance, a user can choose to change the CARD component 4232a for a TABLE Interface Component 4232c that has been appropriately mapped in order to easily view the EVENT Entities according to their varied needs.

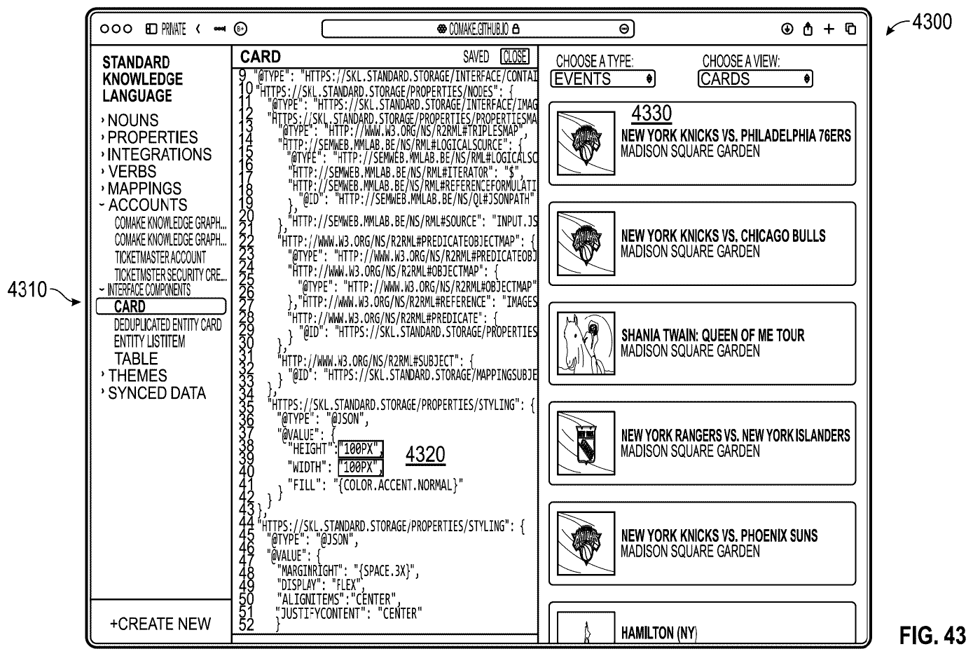

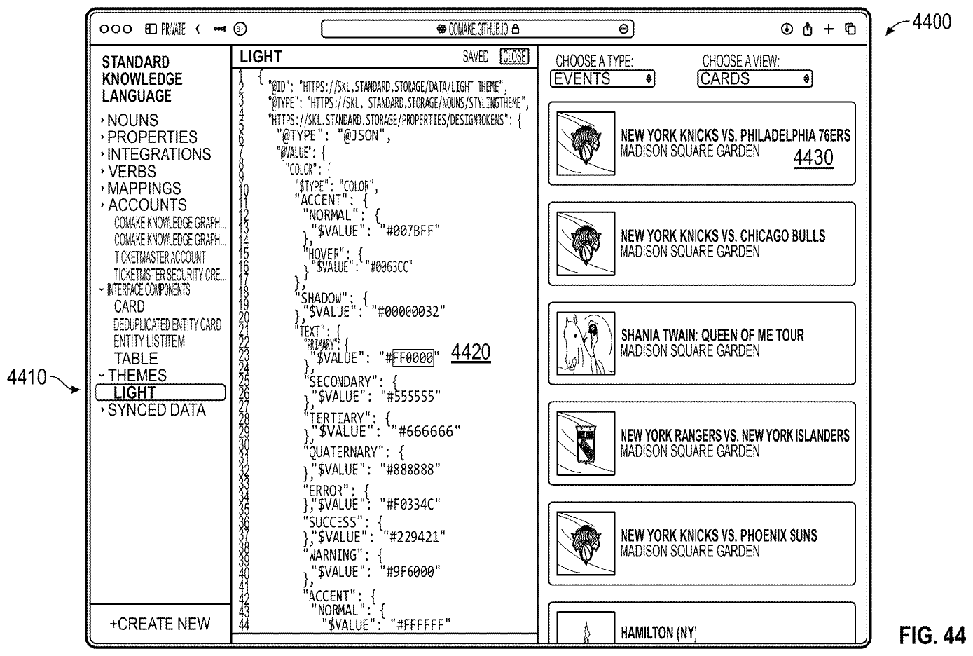

Referring now to FIGS. 43-44, in a similar way to how users may change the syncing parameters for an Integration, they may also choose to parametrically edit Interface Components, their styling, spacing, and more. For instance, FIG. 43 shows how a user might select to view the Schema 4310 for the CARD component and change certain parameters like the size of the image 4320 from 30 px in FIGS. 42a-c to 100 px, according to an embodiment. Similarly, as described elsewhere herein, certain shared styles (e.g., design tokens, CSS classes, etc.) could be applied to multiple Interface Components in order to facilitate the customization of multiple Interface Components simultaneously. FIG. 44 shows how a particular theme 4410 has its own Schema that can be easily and parametrically modified to change the styles of any Interface Components whose properties reference the Style Schema's parameters, according to an embodiment. In this example, the CARD component's 4430 Schema says that some of the text in the CARD component should be colored according to a theme's primary text color value 4420. In this way, changing the value of the primary text color 4420 in the theme's Schema will result in a change to the color of some of the text in the CARD component 4430.

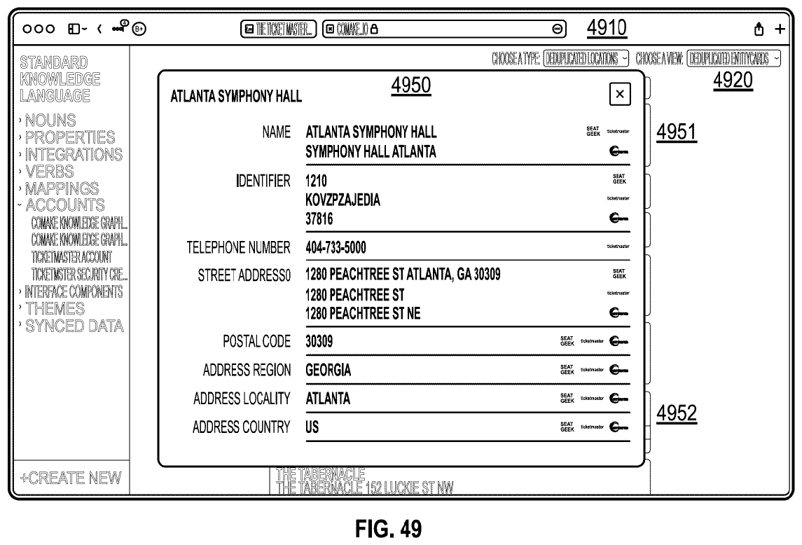

FIG. 49 illustrates a graphical user interface for SKApp 5010 that shows deduplicated Entities from multiple data sources for events and venues, according to an embodiment. In this example, a user chose to view Entities of type DEDUPLICATEDLOCATION (e.g., venues) through Interface Component 4910 and to view them with the DEDPLICATEDENTITYCARD through Interface Component 4920. The DEDPLICATEDENTITYCARD Interface Component 4950 shows how different fields from various data sources can be combined into one deduplicated Entity stored in an SKDS 5005. For instance, some fields like the NAME field 4951 of the DEDUPLICATEDLOCATION Entity shows how two data sources share the name “Atlanta Symphony Hall” and a third data source has a different name “Symphony Hall Atlanta”. This is in contrast to the ADDRESSLOCALITY field, for which all three data sources share the same value.

In some embodiments, if a deduplicated Entity has the same value from all sources but one, it could be used to suggest to the one outlier that the data is wrong. In other embodiments, certain data sources can be given a higher authority than other data sources. In these ways, deduplication of Entities can actually be used to clean up data across one or more sources.

### SKL Library

According to some embodiments, an “SKL Library” may document and allow for the discovery, creation, editing, and management of Schemas, configurations (e.g., ontologies, Nouns, Verbs, Interfaces, Mappings, Code Packages, AI models, etc.), SKApps, Authentication Servers, Standard SDKs, Standard UI Client Libraries, and/or any other SKL artifacts and SKL-compatible components (the “Artifacts”). Other types of Artifacts in the SKL Library may also include elements related to open-source contributions (e.g., notes, bugs, feature requests, pull request, sample data, etc.) and collaboration (e.g., messages, posts, threads, tasks, etc.). An SKL Library may be sometimes referred to herein as “The Library,” “SKL Dictionary,” “The Dictionary,” and the like.

In some embodiments, any Artifact may be related to any other Artifact. As such, each Artifact (e.g., an Entity) may provide, for example, contextual access to other related Artifacts such as comment threads, version histories, bugs, change requests, and/or any other Artifacts. According to a non-limiting embodiment, the SKL Library may use Linked Data to allow each Artifact to reference other Artifacts. This may be similar to how a nodal data structure (e.g., an “SKDS”) might be used to record relationships between different Entities (e.g., files and messages) and to surface related Entities (e.g., through search, contextually through relationships in nodal data structure, through Relevance Scores, using other machine-learning techniques, using other natural language processing techniques, etc.). In some embodiments, given a Verb Schema, SKL Libraries may be used to access Noun Schemas which are related to that Verb as inputs or outputs. SKL Libraries may link and/or provide access to Entities through Mappings (e.g., any Mappings that specify relationships between Artifacts such as an Integration endpoint and a Verb, a Noun and a Verb, a Noun and an Interface, etc.), and/or other means such as edges between nodes, Relevance Scores, and more.

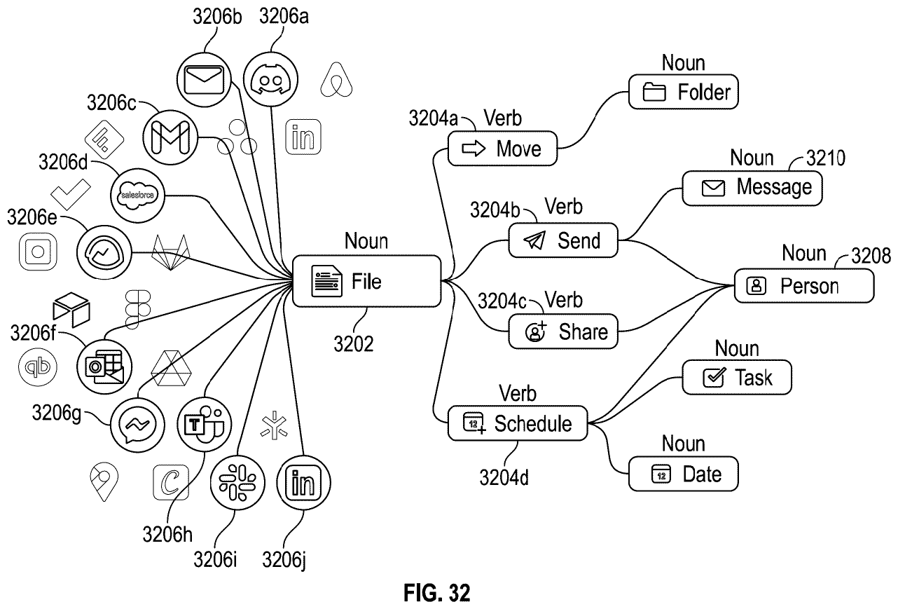

FIG. 32 illustrates a conceptual diagram, according to one embodiment, of how the SKL Library may relate different SKL Attributes. The Noun 3202 in the SKL Library SKDS in this example represents a FILE Schema. Since this FILE Noun 3202 has been mapped to a variety of Verbs such as MOVE 3204a, SEND 3204b (or SENDINMESSAGE), SHARE 3204c, SCHEDULE 3204d, and more (e.g., GETFILESINFOLDER, GETATTACHMENTSINEMAIL, GETFILECONTENTSASSTRING, GETNAMEDENTITIESINFILE, etc. which could be used by a syncing SKApp), an SKL Library may present them as capabilities for files. Different embodiments or processes for a Verb that is meant to send a file may include a sending a file in a message, sending a file through Bluetooth®, sending a file through AirDrop®, and other means.

These various capabilities may be abstracted away through a single SEND Verb, that will use different Schemas like Mappings and Nouns and/or combinations of different Schemas, to parametrically and/or intelligently determine which specific process should be used. In other embodiments, an SKL Library may help a developer trying to use a FILE Noun 3202 together with a SEND Verb 3204b to automatically determine what Integrations 3206a-j may be used to send the file, what other Schemas may be needed (e.g., a PERSON Noun 3208 to send the file to, a MESSAGE Noun 3210 to send with the file, and more. These relationships and various other Schemas could be accessed through a variety of methods, including but limited to, by browsing, searching, and interacting with a website, by referencing one of the Schemas in an Integrated Development Environment (an “IDE”) and seeing suggestions, by querying to an API, by interacting with a file inside a SKApp that helps a non-technical user centralize their health information, and more. As such, when a developer, or any other user of software that leverages SKL, interacts with any SKL Artifact (e.g., in the SKL Library, within a SKApp), they may easily access the documentation for that Artifact and they may easily view all related other Artifacts (e.g., organized by category, by relevance, etc.). In other embodiments, the developer may filter by some criteria like Operating Environment, pre-approved by an organization, etc.).

An SKL Library may hold this information in an SKDS, but in some embodiments the information may be stored in other ways, such as files in a codebase, on a blockchain, across multiple data stores and Integrations, etc. An SKL Library may have one or more corresponding SKApps, such as website, webapp, local application, dapp, etc. to help users create, find, interact with, or otherwise manage Artifacts. Users may also interface with an SKL Library in sever ways in order to interact with Artifacts (e.g., code, SKQL, web requests (e.g, to a REST API), etc.)

### Display & Search

At least one embodiment of an SKL Library may be considered “Official SKL Library” (sometimes called the “Official Library,” “Official Dictionary,” and the like). The Official Library may serve as the main public distribution of Attributes. Other SKL Libraries may exist simultaneously, such as private SKL Libraries, or other domain-specific SKL Libraries which may be considered to be part of the Official Library. In some embodiments, an organization may also choose to have an Official SKL Library for their organization while keeping some Attributes private and publishing some Attributes to the public Official Library.

The Official Library may serve as the official public library/dictionary for a SKL to allow individuals and companies to learn about, discover, contribute, and use any aspect of it in a composable way. The Official Library may be organized by various methods such as relational data, indexing and search, and more. The Official Library may implement one or more SKDSs and SKApps to store and serve the data.

FIG. 37 depicts the composition the Official Library 3700, and some of the various SKL Artifacts and SKL Libraries that can compose it, according to an embodiment. In this example, the Official Library includes all of the Schemas, configuration files, code, infrastructure templates, documentation and anything else necessary to: find, use, create, and modify SKApps; find, use, create, and modify Nouns; find, use, create, and modify Verbs; find, use, create, and modify Integrations; find, use, create, and modify Interfaces; find, use create, and modify any other configurations, code, or documentation a user or developer may need to interact with SKL; and so on. The Official Library may also include an index of all registered SKApps and their details; different Interfaces and Verbs that can be used to interact with the data inside SKL Libraries including all the users who choose to have a profile on the Official Dictionary and their contributions, discussions, etc.; information related to APIs and other interfaces (e.g., SKQL) that can be used to programmatically interact the data in the Official Dictionary, and so on. Certain components can require payment by users 3702-3706 and certain other components can be originally developed to follow other protocols and programming standards (e.g., that are not related SKL) but that are able to be abstracted and represented through SKL Schemas and thereby made interoperable and composable with the SKL ecosystem 3708-3714.

In some embodiments, a user of the Official Library may search for, view, interact, and create new SKL Artifacts, as well as relationships to other resources. In other words, Artifacts in the Official Library may be full-text searchable and filterable, for example via any of its Metadata, Schema, or relationships. Upon selection of an Artifact (e.g., an Integration, an SKDS, a Verb, a Noun, a SKApp, an Interface Component, a message, a task, etc.) the SKApp for the Official Library may generate and/or display a “profile” for that Artifact.

According to some embodiments, the profile for an Integration in an Official Library SKApp might include various information. For example, the profile might include the following: Metadata about the Integration (e.g., name, domain, developer, provider, execution environments, pricing, reviews, keyboard shortcuts, related API endpoints, URL structures, whether it may be used to train AI models or in conjunction with AI models, etc.); information related to how the Integration and data, capabilities, instances, Artifacts, etc. related to the Integration may be automatically identified by software; the Schemas which detail how a Verb may read and write data to and from the Integration and how data from the Integration may be converted to Nouns; any Nouns, Verbs, Interfaces, and SKApps which work with the Integration or which could potentially be easily configured to work with the Integration; information about Integration usage (e.g., any users that have used, interacted with, etc. the Integration, according to the privacy settings of those users); any relationships to other Integrations, contributors, developers, etc.; the edit history, versions, etc. of the Integration; and the like.

In some embodiments, SKL Libraries can facilitate access to “dummy data” and/or public/non-confidential data that can be provided when the API endpoints of an Integration are queried with certain special parameters (e.g., queryAsTest). These example responses may be used within a code testing suite to mock the responses of endpoints and test other components of the system without sending real HTTP requests.

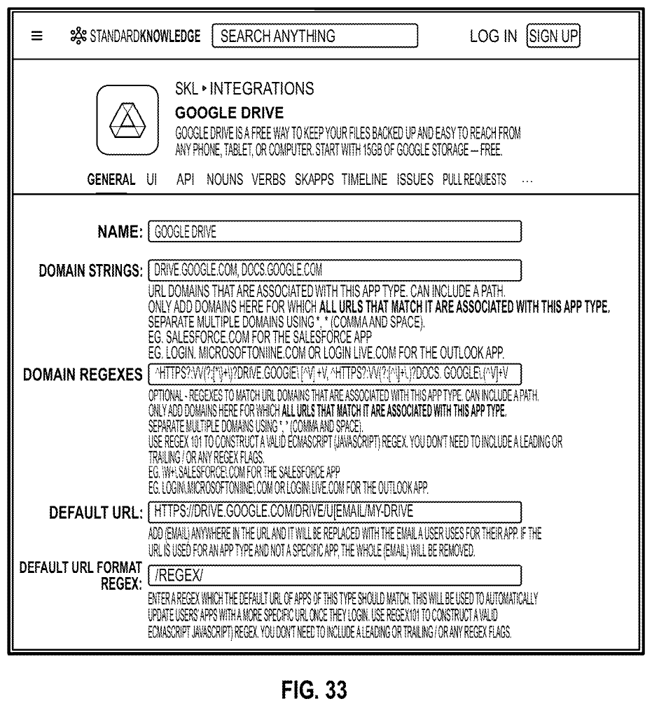

FIG. 33 is a non-limiting example of how an Integration's profile on the Official Library (and/or another SKL Library) may appear. This particular embodiment shows what the profile for Google Drive® Integration might look like, including: general information about the Integration, its developer and/or provider, pricing, privacy practices, performance, persistence type, terms & conditions, how to access it and/or use, reviews, etc.; different relevant UI components including icons, Interface Components which may work with the Integration; Schemas, documentation, and any other information representing or relevant to the API; relevant ontologies that have or could be integrated including Nouns and Verbs SKApps which work or could work with the Integration; a timeline of contributions, changes, edits, usage, etc.; issues, bug reports, feature requests, forks, pull requests, and other capabilities to help with the management of Schemas; and more.

According to a non-limiting embodiment, an SKDS's profile on the Official Library (and/or another SKL Library) might include: general information and Metadata about the SKDS (e.g., developer and/or provider, pricing, security and privacy certifications and practices, performance, persistence type, terms and conditions, how to access it and/or use, reviews, execution environments, whether it may be used to train AI models or in conjunction with AI models, etc.); information related to how the SKDS and data, capabilities, instances, Artifacts, etc. related to the SKDS may be automatically identified by software; the Schemas which detail how data may be read and written to and from the SKDS; information related to which SKApps and Interfaces may work with the SKDS or which could potentially be easily configured to work with the SKDS; information about SKDS usage (e.g., usage and performance metrics, any users that have used, interacted with, etc. the SKDS, according to the privacy settings of those users); any relationships to other SKDSs, icons, images, contributors, developers, etc.; the edit history, versions, other Artifacts, etc. of the SKDS; and the like. Each SKDS may also include custom adapters that help map SKQL functionality (e.g., via the SKQL ORM) to whatever the language the database or databases offered by SKDSs natively offer (e.g., SQL, DQL, GraphQL, etc.).

According to a non-limiting embodiment, a Verb's profile on the Official Library (and/or another SKL Library) might include: general information and Metadata about the Verb (e.g., developer and/or provider, pricing, security and privacy certifications and practices, performance, terms & conditions, how to access it and/or use, reviews, execution environments, whether it may be used to train AI models or in conjunction with AI models, etc.); information related to how the Verb and data, AI models, capabilities, instances, Artifacts, etc. related to the Verb that may be automatically identified by software; the Schemas which detail when the Verb may or should be run, what its inputs and outputs are including the Nouns and possible SKDSs and Integrations it works with; information related to which SKApps and Interfaces use the Verb or which could potentially be easily configured to work with the Verb; information about the Verb's usage (e.g., usage and performance metrics, any users that have used, interacted with, etc. the Verb, according to the privacy settings of those users); any relationships to other Verbs, icons, images, contributors, developers, other Artifacts, etc.; the edit history, versions, etc. of the Verb; and the like.

In some embodiments, and in a similar fashion to Integrations (and sometimes in conjunction with the dummy data associated with an Integration), SKL Libraries may facilitate access to “dummy responses” for a given Verb, enabling developers, SKApps, users, etc. to more easily run tests and determine if a given SKApp is working properly (e.g., executing Verbs at the right time, with the right parameters, and correctly handling the responses and/or emitted events).

According to a non-limiting embodiment, a Noun's profile on the Official Library (and/or another SKL Library) might include: general information and Metadata about the Noun (e.g., developer and/or provider, pricing, security and privacy certifications and practices, performance, terms and conditions, how to access it and/or use, reviews, execution environments, whether it may be used to train AI models or in conjunction with AI models, etc.); information related to how the Noun and data, AI models, capabilities, instances, Artifacts, etc. related to the Noun may be automatically identified by software; other criteria for identifying, deduplicating, and/or processing Entities of that type of Noun; the Schemas which detail the Noun's larger ontology, properties, fields, actions, and possible Verbs, SKDSs, and Integrations (e.g., Integrations that emit events which may be translated into data of the Noun) it works with; information related to which SKApps and Interfaces use the Noun or which could potentially be easily configured to work with the Noun; information about the Noun's usage (e.g., usage and performance metrics, any users that have used, interacted with, etc. the Noun, according to the privacy settings of those users); any relationships to other Nouns, icons, images, contributors, developers, other Artifacts etc.; the edit history, versions, etc. of the Noun; and the like.

In some embodiments, and in a similar fashion to other types of Schemas (and sometimes in conjunction with the dummy data and responses from those other Schema Entities), SKL Libraries may facilitate access to “dummy data”, publicly accessible data, non-confidential data, etc. for a given Noun. In other words, each Noun can provide access to a large number of examples of Entities that correspond to that Noun from a variety of sources (e.g., from Integrations, from SKDSs, from the Library itself, automatically generated Entities, etc.) that can be used in a variety of different ways, ranging from testing software (e.g., running test suites), training AI models, and more. In other words, beyond helping with test data, certain machine-learning and artificial intelligence models (e.g., classification of data types) could be trained using the “dummy data” that is made accessible through a given Noun (e.g., CAT, IMAGE, FILE, MESSAGE, ARTICLE, LOGO, SPORTSEVENT, SVGICON,etc.). For example, as the Official Library grows, it could help provide the training data for a model that can classify types of Nouns as a variety of different data is encountered by users in SKApps (“in the wild” so to speak).

In some embodiments, multiple methods and criteria can be made available through SKL Libraries to help with the recognition, identification, and/or classification of certain types of Nouns. For instance a PDF may be identified by its mime type, a PERSON referenced in an online news article may be identified by the metadata in the websites header. (e.g., schema.org), a CAT (or a representation of a “CAT”) may be identified in a 3D model, a video, and/or an image by using computer vision techniques such as object recognition, etc.

According to a non-limiting embodiment, an Interface's profile on the Official Library (and/or another SKL Library) might include: general information and Metadata about the Interface (e.g., developer and/or provider, pricing, security and privacy certifications and practices, performance, terms & conditions, how to access it and/or use, reviews, execution environments, whether it may be used to train AI, etc.); information related to how the Interface may be automatically identified by software; the Schemas which detail the Interfaces' inputs and outputs are, including the Nouns, Verbs, and other SKL components it works with; information related to which SKApps and SKDSs use the Interface or which could potentially be easily configured to work with the Interface; information about the Interface's usage (e.g., usage and performance metrics, any users that have used, interacted with, etc. the Interface, according to the privacy settings of those users); any relationships to other Interfaces, contributors, developers, other Artifacts, etc.; the edit history, versions, etc. of the Verb; and the like.

According to a non-limiting embodiment, a SKApp's profile on the Official Library (and/or another SKL Library) might include: general information and Metadata about the SKApp (e.g., developer and/or provider, pricing, security and privacy certifications and practices, performance, terms & conditions, how to access it and/or use, reviews, execution environments, whether it was generated with AI, etc.); information related to how the SKApp may be automatically identified by software; the Schemas which detail what Nouns, Verbs, Interfaces, SKDSs, etc. the SKApps works with, and which others it could be configured to work with; information related to other SKL components which use the SKApp or which could potentially be easily configured to work with the Interface; information about the SKApps's usage (e.g., usage and performance metrics, any users that have used, interacted with, etc. the Interface, according to the privacy settings of those users); any relationships to other SKApps, contributors, developers, other Artifacts, etc.; the edit history, versions, etc. of the Verb; and the like.

According to some embodiments, in addition to the lists herein, each profile for a resource on the Official Library could include discussion about the resource, and contributions of developers to the configuration, code, or anything else about the resource.

According to a non-limiting embodiment, the Official Library may also include profiles for each user displaying the Integrations, Verbs, Nouns, SKApps, SKDSs, Interfaces, etc. they use (e.g., if they allow this information to be public) as well as their contributions, reviews, comments, discussions, etc. around each.

In some embodiments, the Official Library (and/or another SKL Library) Dictionary of Standard Knowledge (including private or branched instances of the dictionary) may incorporate sample data following the Schemas of Nouns that may be manually created or automatically generated. As the SKL Libraries grow, they may provide these data examples (e.g., through hosting the data and/or Mappings to trusted data sources with Entities of those types of Nouns) in order to test easily. This sample data may be used in test cases to test the functionality of different parts for the SKApps (e.g., without having to hard code them into the SKApp).

### Interface Libraries

According to some embodiments, the SKL Library may include a registry of Interface Components which developers may use to build Interfaces for users (e.g., for graphical interfaces which use the React JavaScript® library). Interface Components may follow the Standard UI Framework or simply use Schemas to represent the Metadata, properties, design tokens, etc. that components written in other frameworks (e.g., React, VueJS, Angular, etc.). Moreover SKL Libraries may include Artifacts like colors, themes, design tokens, icons, and more which may each be related to—and used by—the various other relevant SKL components (e.g., Interfaces, SKApps, etc.). In addition, SKL UI Libraries may include utility Interface Components for keyboard navigable lists, forms, form inputs, buttons, dropdowns, search bars, views for Metadata, graphs, charts, maps, etc. In some embodiments, developers may “plug and play” these different interfaces in no-code (i.e., without having to write code) or low-code environments through the use of a GUI. This would empower the average person to be able to develop sophisticated software that meets their needs exactly, without sacrificing the interoperability or longevity of data.

The system also allows for interface libraries focused non-graphical Interfaces. For example, developers of voice assistant software agents could access components that help translate speech into usable commands. Similarly, other Interface Components could be used to represent brain interfaces, haptic controls, and other forms of human-computer interaction.

SKL Libraries may also include other types of Artifacts related to UI, such as scraping scripts or Verbs for certain Interfaces, Integrations, Nouns, and/or combinations thereof. For example, developers using SKL could share or publish a library of code for scraping the profile information on a social media site in order to enrich a user's contacts.

### Packages

According to some embodiments, artifacts within the Official Library may be exposed for use via an SKDS interface such as an API. A developer wanting to use certain SKL artifacts in a SKApp may specify that they want to work with certain Integrations, Nouns and Verbs and the Official Library may find or help the user create the necessary Mappings and Schemas in order to combine them into an easily installable package in the SKApp (e.g., similar to NPM modules). For example, a developer or user may specify that they want their application to work with FILES, PEOPLE, TASKS, and MESSAGES and support Integrations like Google Drive®, Dropbox®, Gmail®, Slack®, and Asana®. The Dictionary could then provide them with a downloadable package that includes the necessary configurations between the specified and/or related Nouns, Verbs, Interfaces, Integrations, etc. Should the developer and/or user decide to support a new Interface or Integration (e.g., Sharepoint®) at some point in the future, they would be able to specify that and get the additional configurations added to their package.

In an alternate embodiment, the SKL Library may include common ontologies and their relationships to whichever other Artifacts a given user desires to “package” in order to facilitate the combination of Schemas. This may allow developers or end users to pick and choose certain functionality they wish to obtain from the SKL Libraries without having to download more than they need. For example, a developer wanting to integrate data from many file storage tools may choose the GENERAL FILE MANAGEMENT package which includes the Schema for FILE, FOLDER, PEOPLE, and FILEPERMISSION Nouns, the GETFILESINFOLDER, MOVE, COPY, and DOWNLOAD Verbs, and Mappings between those Nouns and Verbs to the most popular Integrations like Dropbox®, Google Drive®, and OneDrive®.

In an alternate configuration, developers could simply reference Artifacts and then SKApps could access individual Artifacts directly from the Official Library at runtime (e.g., via a REST API). In this way, developers may not have to download the configurations from the Library, but rather simply access the right version of each of configuration stored directly in the Official Library.

In yet another configuration, the Official Library may provide additional tooling to help developers download Artifacts in alternate ways that might make most sense for their specific needs. For example, the Official Library could help translate Noun Schemas into SQL in order to serve as the Schema relational databases, classes in a programming language like Ruby® or Java®, type interfaces and/or classes in JavaScript® or Typescript®, etc.

### Schema Manager

According to some embodiments, SKL Libraries may include tooling to facilitate the installing, uninstalling, editing, and otherwise managing versions for SKL Schemas in a similar way to popular methods and tooling like Git push, Ruby Gems, npm install, etc. Different embodiments of SKL Libraries may help manage Schemas in other codebases, databases, SKDSs, through SKApps' user interfaces, within the SKL Library itself, etc. In other embodiments, SKL Libraries may also provide or integrate with graphical user interfaces that may facilitate Schema management. SKL Libraries may also include other interfaces like a command line interface and REST interface.

In a non-limiting, SKL Libraries may automatically different Schemas in a way similar to Git in order to help see changes between Schemas. In one embodiment, a user may work with an SKDS that uses a Noun called FILE version 1 and then they want to install a SKApp that uses expects FILE v2. When installing the SKApp on the SKDS, the SKApp may show the user a diff of what is different between both Schemas and ask the user if they want to migrate their Entities of FILE from v1 to v2. In another embodiment, the SKApp could show the user the diff of what is different between both Schema versions and ask the user to either install or create a Mapping to address those changes so that the user's SKDS is able to work with SKApps that expect v1 and v2. In this way, if a given SKApp installs/uses a new Noun that is a synonym or a different version to/of another Noun already in use within an SKDS, then the Schema manager (which may be embedded in the SKDS, the SKL Library, the SKApp, etc.) could look for one or more Mapping between both (from one or more SKL Libraries) and install that Mapping(s) in the SKDS in order to enable the different Nouns to be translated.

### Branching & Versioning

According to some embodiments, Artifacts and Schemas in SKL Libraries may each have a URI. Each of these Artifacts may also have version identifier that allows the collaborative editing and management of Schemas. This version identifier could for example be in the URI, in the Schema as its own field, in related Mappings.

According to an embodiment, the Official Library may simply need to index and reference the locations and versions for other ontologies' Schemas. In another embodiment, the Schemas may be cloned to the Official Library. In yet another embodiment, the Schemas may be cloned to locally hosted SKL Libraries. Any changes to Schemas cloned from the Official Library may be proposed as changes back to the Schemas hosted by the Official Library. The Official Library may provide discussion and collaboration features in order for the person responsible for changing the ontology to explain and discuss the proposed changes. If the Schemas' maintainers do not want to make the changes, or the Schemas in the SKL Library are references to ontologies managed elsewhere, their respective Schemas may be forked into a different ontology.

According to some embodiments, version and release management for each Schema may be done according to the Semantic Versioning specification.

An embodiment of a SKApp is one that may clone a local copy of Schemas for some of the most popular Integrations from the Official Library. In some embodiments, this SKApp may be termed KnowledgeOS. In order to support custom KnowledgeOS features, these Schemas may be unique customizations or extensions of the normal Schemas that the Official Library shares publicly and that other SKApps use for the same Integrations. For example, KnowledgeOS, or any other SKApp, might use the Schemas for an Integration which detail the Integration's keyboard shortcuts to display as a reminder for users. The SKApp may also provide additional keyboard shortcuts whenever a user is looking at content from that Integration. To do so, it can modify, and thus use a custom version of, the Schema for each Integration to include the additional keyboard shortcuts

According to some embodiments, when using KnowledgeOS, if a user visits a website (e.g., an Integration) which is not represented in the Official Library, the SKApp may create an Integration from the Schema for the INTEGRATION data type and include as much information it may about the website (e.g., via the DOM, the Browser API, etc.) and upload this to the Official Library as a “suggested” Integration. The process until this point may be entirely automated. The maintainers of the Official Library may then choose to manually review, edit, accept, or reject the changes to the public repository. In some embodiments, the creation and/or the review and acceptance of changes may also be automated. For example, a heuristic or artificial intelligence could be used to automatically review, edit, accept, or reject the changes. Similarly, web scrapers, web crawlers, and other methods and processes could be employed to automate the generation of Integration profiles, including Schemas, Metadata, configs, etc. The same may be done for other aspects of SKL, such as the collection of data, creation, review, and approval of Schemas (e.g., Nouns, Verbs, Interfaces, etc.).

In a non-limiting embodiment, updates to Schemas are versioned using a standard versioning scheme (e.g., SemVer). SKApps and other components may have the ability to choose both which branch of the Artifacts they prefer to use (e.g., main vs. a custom branch vs. a branch with suggested changes), as well as the version they use if on the main branch.

In another non-limiting embodiment, SKApps and SKDSs also have the option of subscribing to a branch for a given Schema or set of Schemas in order to automatically receive notifications about changes to the resources as they are suggested or edited.

According to some embodiments, a SKApp or an SKDS may use and store alternate versions of any Artifacts, as this may enable non-standard or custom implementations. For example, an organization might use a custom, proprietary, and confidential data ontology, including custom Nouns, Verbs, etc. In this embodiment, the Schemas and Artifacts corresponding to this confidential ontology are in a locally hosted SKL Library that is not accessible to anyone outside the organization. The Schemas and Artifacts could even be totally disconnected from the Internet so that the Official SKL Library may not be aware of them. If the organization decides to make a Mapping from their proprietary Schemas to one or more popular and public ontologies with Mappings to other components in the Official Library, then that company's proprietary Schemas, and the SKL components that work with the proprietary Schema, may now also be able to work with several of the components that previously only worked with the public ontology.

### Registry

In yet another embodiment, Artifacts in the SKL Library are able to be viewed and downloaded publicly, in an open source way. However, attribution and control of changes and versioning may be given to individuals and organizations by listing certain Schemas, configurations, code or other Artifacts under the profile page of the individual or organization that first introduced said Artifact to the Library. Such individuals or organizations may maintain ownership over those Artifacts and control the approval of requested changes and versioning. They may also choose to give such permissions to other individuals or organizations to help manage and maintain the Artifacts, including but not limited to restricting the training of AI models and/or the use of the artifact by AI models in composing software. In this embodiment, the SKL Library forms a registry wherein developers upload contributions to be shared with the community.

In some embodiments, the record of such contributions by individuals and organizations to the Library of Artifacts and Mappings could be maintained using blockchain technologies. In the event that money flows through the SKL Library to pay for specific Verbs, Interfaces, and more, the SKL Library may distribute payments or micropayments for every transaction according to the contributions made by various individuals/organizations, which could be stored on a blockchain.

According to some embodiments, smart contracts could be considered types of Verbs that get executed when certain conditions are met, such as a payment for a SKApp or a Verb that uses certain other components contributed by other people. Using SKL in conjunction with smart contracts, those payments could automatically be distributed to the people that created or contributed to the one or more components that make up the Knowledge App receiving payment. In some embodiments, an app store provider takes a percentage of the payments that are made through the platform. In this embodiment, people may be properly incentivized to make components in exchange for payments, micropayments or otherwise pre-programmed value that would be distributed through the use of the components and Mappings they created.

### Private SKL Libraries

According to some embodiments, the system may support the hosting and management of private SKL Libraries that may either be connected to the Official Library or hosted in isolation. In this way, organizations and/or individuals may choose to create private Schemas, configurations, code, etc. following the SKL protocol. According to at least one embodiment, these private Artifacts could be hosted privately on the Official Library, in a separate private library such as a private SKDS, or in some combination of the concepts discussed herein. In an embodiment, a bank may want to build applications that integrate with a proprietary database technology which they do not want external individuals or companies to discover. The bank may build Mappings in accordance with the SKL protocol which it uploads to the SKL Library (via the API or website interface) with a field marking them as private to their organization. Only developers that are members of that bank's organization or applications with security keys authenticating them with the organization may be able to download and use the Mappings to the proprietary database technology.

Similarly, in yet another embodiment, an organization (e.g., the U.S. Navy) may want to create and manage a custom private ontology that may be represented via custom standard Nouns and/or Verbs that abstract away endpoints from a variety of Integrations. These custom Artifacts could exist in isolation such that they are only mapped to each other privately. Alternatively, they could be related to the Artifacts in the public Library such that they are able to make use of the total capabilities that are publicly available. In other words, the U.S. Navy could make a custom representation of a “Contractor” and only relate it to Nouns, Verbs, Interfaces, and other Artifacts within their private library. Alternatively, they could relate CONTRACTOR to the public representation of CONTRACTOR, if it exists, or ORGANIZATION and thereby make many of the public Noun ORGANIZATION'S public capabilities and relationships also available via their private Noun CONTRACTOR. For example, the public Noun ORGANIZATION may have an associated Verb that may help keep track of public news mentions (e.g., TRACKNEWSMENTIONS). By relating the necessary fields of the private Noun CONTRACTOR to the public Noun ORGANIZATION, and further classifying it as a child of ORGANIZATION, the public Verb TRACKNEWSMENTIONS could automatically work with any instance of the private Noun contractor even though the public Verb and the private Noun were never directly mapped to each other.

In some embodiments, users may be able to create custom Verbs without having to upload them to any Dictionary; public or private. Since Verbs may follow a certain Schema, their configuration may be easily created, customized, or otherwise altered directly within an SKDS, the code for a given application, or wherever they are defined. In other words, since Verbs may be composed of a configuration that does not actually contain the processing logic within it, but rather what logic to call and when. This may enable the simple creation of Verbs that may call other Verbs according to specified configuration and triggers, such as a specific schedule or trigger(s). In this embodiment, users and developers may be able to use custom Verbs to create automations that may in turn be composed of, or otherwise reference, standard Nouns and Verbs. The benefit of this approach is that an automation may be easily made to run over all Messages regardless of which Integration that message is actually sent through. The user may be able to easily determine what to do with every Message, such as check for customers' PII (personally identifiable information) or other sensitive information that should not be shared externally, regardless of the messaging service.

### Operating Environments

According to some embodiments, SKL components may have Metadata to suggest which ecosystem and/or platforms they may run on. For example, certain components may only be able to work on a blockchain such as Ethereum®, while others may only be able to work on a device that runs iOS® (such as an iPhone®). In other embodiments, users may only want to connect components that meet certain security and/or privacy requirements for compliance (e.g., SOC 2, HIPAA, etc.). The configurations that determine the operating environment for a given set of connected SKL components may be automatically managed or manually specified. In various embodiments, these configurations may be held within the SKDS, as part of the Coordinator, and/or within Knowledge Apps.

In some embodiments, when configurations are held by an SKDS, that SKDS may restrict which Verbs, Interfaces, and Knowledge Apps are able to interact with data within that SKDS. For example, an organization might manually create a whitelist of acceptable components and/or Knowledge Apps that may be connected to their SKDS. Alternatively, they might simply specify that only HIPAA certified components and/or Knowledge Apps are able to be connected. In yet another embodiment, the SKDS may exist on a device that is not connected to the internet and is therefore only able to work with other components that may be run on device or otherwise within its network without having to connect to the internet. In another embodiment, an SKDS that only stores data in a decentralized way may specify that all data must be stored on IPFS (InterPlanetary File System) and that all processing must be documented via transactions stored on the Ethereum® blockchain (or for example, other layer 1 chains that might support smart contracts). Similarly, certain SKL Artifacts might only work in virtual or augmented environments.

In some embodiments, SKDSs may restrict which processors/interfaces/etc. are used together. This may, for example, be embedded into the SKDS configuration in the Library. This is a way for enterprise customers (e.g., the U.S. Navy) to ensure that only approved software components are used with their data.

### Managing Libraries

According to a non-limiting embodiment, SKL Libraries may provide a variety of systems and methods that can deduplicate, correlate, interrelate, and provide recommendations of Entities. Since, according to the embodiment, an SKL Library is an SKDS that primarily hold the SKL Schemas in and of themselves (e.g., the Schema for a FILE Noun, a SHARE Verb, a CARD Interface, etc.), the SKL Library's nodal data structure and the methods and processes used to build and maintain it can therefore applied to the Schemas and other Artifacts.

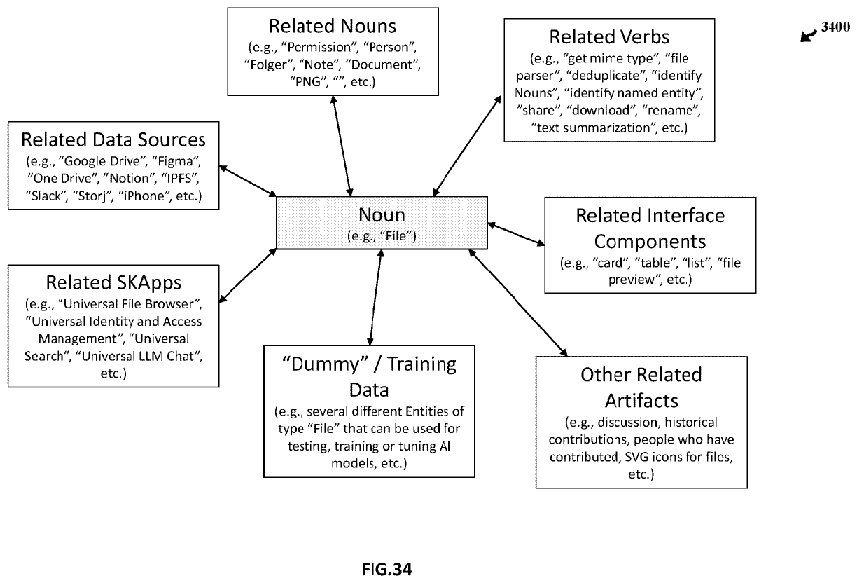

In other words, the Official Library can store or otherwise index or represent Entities in an SKDS that can be deduplicated, interlinked, and contextualized. For example, an SKL Library may establish that the Google Drive® API and Google Drive® website are both two different representations of a broader Google Drive® Integration Entity. This association can be made by, for example, automatically comparing metadata and establishing CueIDs and/or Unique IDs associated with each Entity, how that Entity is used, what common relationships any two given Entities may have, and more. Similarly, Entities can be clustered based on their properties and/or relationships to other Entities (e.g., both Google Drive® API and Google Drive® website have relationships to a FILE Noun, a FOLDER Noun, etc.), as depicted in FIG. 34. Machine-learning algorithms, such as k-means clustering, and/or some of the other methods described herein can also be used to find similar Entities within SKL Libraries. In another non-limiting example, semantic similarity between words can be established (e.g., Google Drive® API and Google Drive® website use many similar words). In yet another example, users can establish and classify links manually across Entities.

Several types of relationships between Entities and/or Artifacts can be established and managed automatically, semi-automatically, and/or manually. For example, any type of Schemas and Artifacts, not just Integrations, can be linked, classified, and/or otherwise have a relationship with one or more Entities in the nodal data structure change. This includes not just the deduplication of Nouns, Verbs, Interfaces, SKDSs, SKApps, and the data they represent, but also other types of relationship-building and relationship-management.

For example, SKL Libraries may let users upload OpenAPI® specifications for given Integrations in order to help facilitate the creation and management of Schemas and Mappings related to the Integration. The SKL Library may then automatically parse the contents of the OpenAPI® specification and compare the methods, inputs, outputs, and any other information provided or otherwise available (e.g., the Integration's website, the Integration API's website documenting the API, other third-party information such as Wikidata®, etc.) in order to gather information, automatically or semi-automatically build Schemas, create or modify CueIDs and/or UniqueIDs related to that Integration (e.g., for each API endpoint) such that they can be automatically compared to other existing Schemas that may each also have one or more CueIDs and/or UniqueIDs, and so on. In this way an SKL Library may use the methods described herein in order to automatically and/or semi-automatically help establish relationships and recommendations, such as deduplication, Noun, Verb, and Mapping recommendations, between related Entities (e.g., Schemas, components, Artifacts, etc.).

In an alternate embodiment, various Schemas (e.g., Nouns and Verbs) can be automatically created that are unique to each Integration. For instance, each Integration's representation of Nouns and Verbs (such as PERSON, ORGANIZATION, SHARE, etc.) can be created as Schema and then deduplicated. In some embodiments, this may create redundancies between the Integration Schema and the Integration-specific Verbs and Nouns (e.g., because the Verbs may are already defined as Schema through OpenAPI®), however, doing so may be helpful with the automated and/or semi-automated management of various Schemas in SKL Libraries by being able to more effectively compare specific Schemas in discrete ways. Similar results may be otherwise achieved through the use of natural language processing techniques such as tokenization.

### Recommendations of SKL Library Artifacts

According to a non-limiting embodiment, SKL Libraries can provide automatically, semi-automatically, and/or manually generated and/or recommended relationships and/or classifications between SKL Artifacts (e.g., and the data the Schemas represent) to users in a variety of ways. For instance, administrators of the SKL Libraries trying to manage Artifacts in an SKL Library may manually link two or more Noun nodes as being related (or manually create a Mapping between at least one Verb and a Noun, etc.). In the process of manually linking two Nouns (e.g., as synonyms, or some other type of relationship) the administrators may use a graphical user interface showing the profile of a Noun, similar to the Integration profile shown in FIG. 33, in order to access a button to “add a relationship” (not shown in FIG. 33) between that Noun and some other Entity. This can reveal a list of other Artifacts (e.g., Nouns) that have been or are being suggested (e.g., automatically, by another user, etc.) as related to the current Noun. The administrators may choose to establish a link with any Artifact in that list, or they may alternatively search for a different Artifacts. In either case, the SKL Library may employ one or more different algorithms to rank the results presented (e.g., based on existing linkages, based on semantic similarity, based on CueIDs and/or UniqueIDs, etc.).

In another example, as a user or developer searches for, creates, modifies, and/or otherwise interacts with the Library of SKL Artifacts, the SKL Library may provide and/or recommend other related SKL Artifacts that may be relevant. In other words, a user or developer creating a new Noun called HUMAN can be presented with other existing Nouns which are synonyms or which may otherwise be relevant to his/her work such as PERSON, MAN, WOMAN, INDIVIDUAL, etc. The SKL Library might similarly provide other relevant SKL Artifacts including related Interfaces, Verbs, and more. This can help the user or developer avoid creating duplicate Nouns and take most advantage of the work that has already done within the Library. In this way, contextually relevant information can be identified and presented around any given SKL Artifact. Furthermore, these methods can also help avoid the duplication of Nouns, Verbs, and SKL Artifacts, and thereby help maintain a clean and usable SKL Library.

In some embodiments, SKL Libraries can suggest relationships as well as the classifications for those relationships between any given Entities, as described elsewhere herein.

Further described, each Noun within an SKL Library can dictate and/or reference a one or more methods for the identification of said data type/Noun. For example, while a user is interacting with a given website, the SKL Library might have the information necessary to identify what type of data that website represents. SKL configurations can automatically look through the website's HTML for embedded information that might classify the page as a social profile or alternatively classify that the website is a social profile for a Person by matching the website's URL structure to existing configurations in the SKL Library. Once a given piece of data is identified as being a particular Noun, or a particular Noun from a particular Integration, the SKL Library will be able to match a variety of other SKL components that can work with the data in its existing environment. For example, if a user is looking at someone's LinkedIn® profile, the SKL Library can suggest a variety of existing Verbs (and/or other SKL Artifacts) that a user can easily use over that profile. For example, the user can elect to create a new, or enrich an existing, Contact in his/her SKDS with the data found on the LinkedIn page. The user can similarly choose to run a Verb that uses a separate Integration to find the email and other contact information for the person shown on the LinkedIn profile. In this way, relevant Verbs and other SKL Library Artifacts can be easily shown and/or recommended contextually as the user is working.

Some of these SKL Artifacts can be preinstalled or preconfigured to run automatically any time the user visits a person's LinkedIn® profile, so that the user's existing contacts are constantly being enriched and updated with data from their LinkedIn® profiles. Furthermore, as is described in more detail below, some of these SKL Artifacts, such as the LinkedIn® contact enriching Verb, can require payment from the user by the Verb creator.

In another embodiment, the analytics server might be able to identify the user's intent based on more than just the identification of what he/she may have in focus on the screen. For example, the analytics server may be able to draw more information from a user's SKDS such as his/her current role, project, and objective and start to recommend specific actions, Verbs, and other SKL Artifacts that may be useful to the user. For instance, if a user is reviewing a document that relates to a particular project and then opens a new spreadsheet while billing his time to the project. As a result, it can be assumed that the user's interaction with the spreadsheet is related to the project.

Using the various methods described herein, an analytics server, in conjunction with an SKL Library, can identify a user's electronic content and electronic context and then present potentially related and/or relevant Nouns, Verbs, Interfaces, Integrations, SKDS, etc. as shown in the figure below. Relevance can between SKL Artifacts and electronic content and/or electronic context can be established in a number of ways, including but not limited to graphical analyses, semantic analyses, activity analyses, and more. As described herein, relationships and recommendations can be synthesized, such as by analyses of text, images, videos, and more in order to establish semantic similarity, content similarity, activity similarity, etc.

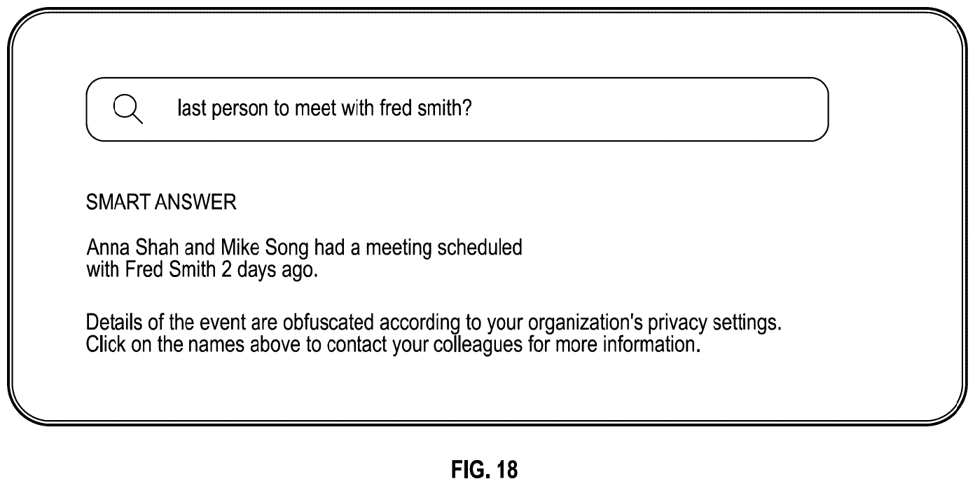

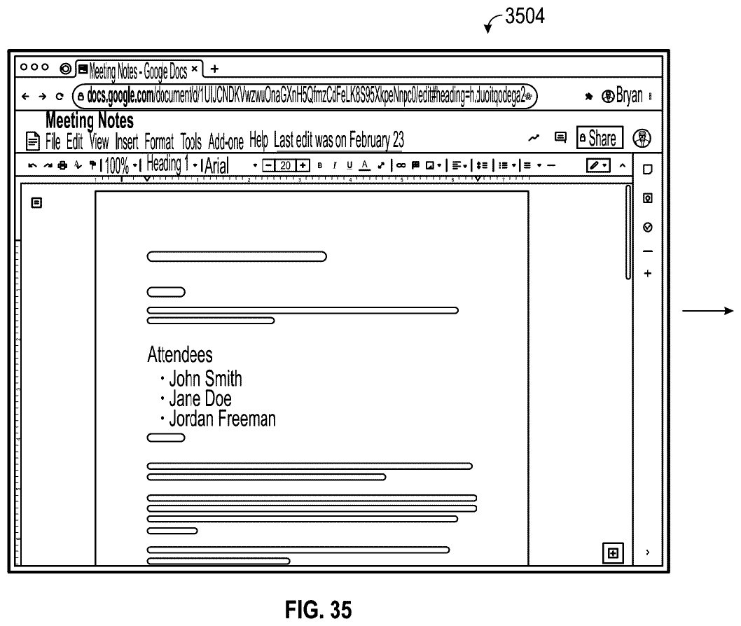

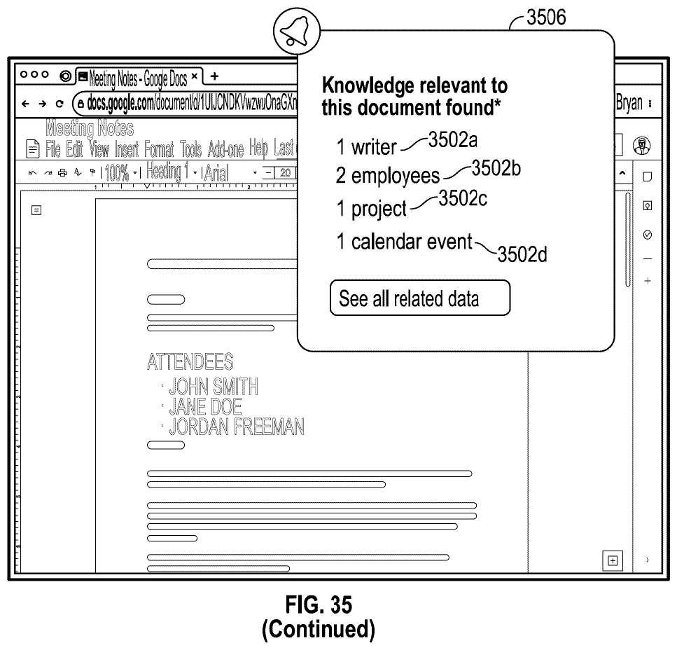

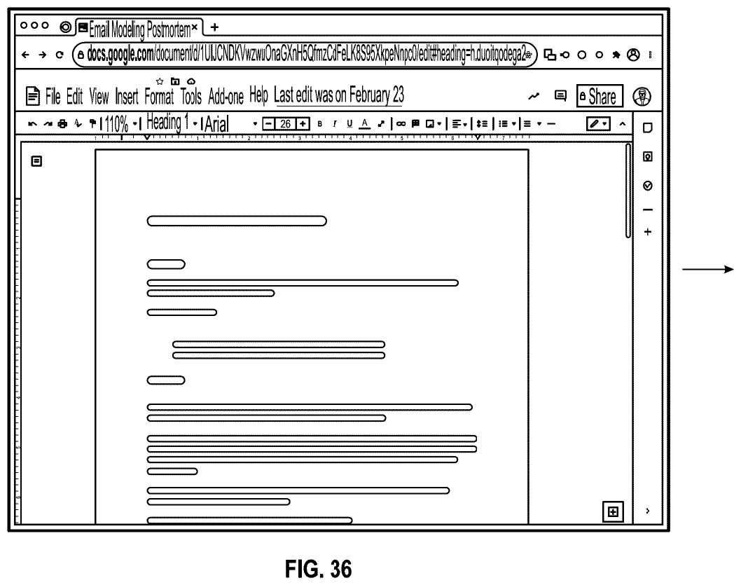

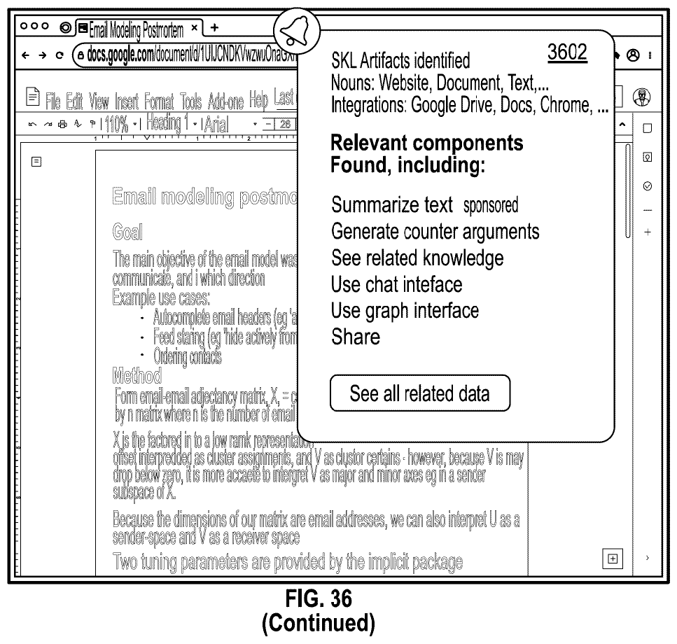

For example, FIG. 35 depicts a graphical user interface of an online word processor application 3504, according to an embodiment. In this example, the analytics server establishes that certain SKL Artifacts 3502a-d are included in the electronic content and therefore is able to present other relevant Artifacts that may add value to end users of the online word processor. In this non-limiting example, FIG. 36 illustrates some of the Nouns 3602 that the analytics server may automatically identify within electronic content include WEBSITE, DOCUMENT, TEXT, GOOGLE DRIVE, GOOGLE DOCS, and GOOGLE CHROME. Using an SKL Library, the analytics server is thereby able to identify related Verbs such as SHARE, SUMMARIZETEXT, GENERATECOUNTERARGUMENTS, and SEERELATEDKNOWLEDGE, as well as present other capabilities that the SKL Library can facilitate. Some of these related Verbs may be sponsored by a given provider (e.g., services like OpenAIR, Google Cloud Platform®, Azure®, Amazon Web Services®, etc. that may have been previously only accessible to developers and/or users with technical know-how) that wants to market certain capabilities to end-users directly based on the identified electronic content and/or electronic context. These capabilities may include exploring the data inside the document through a natural-language query such as the one shown on FIG. 18 where the user can ask questions about a document (and/or related Entities) or access more information, a graph-like interface where the user can explore relationships and similarities to other Entities in one or more SKDSs (e.g., SKL Libraries, private nodal data structures with productivity data and/or personal health information, etc.).

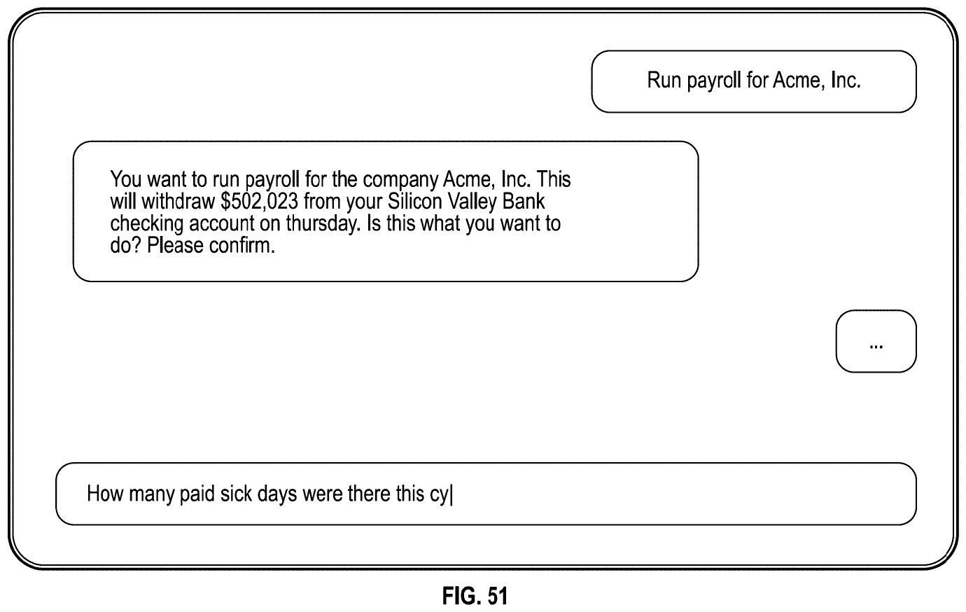

FIG. 51 shows a graphical user interface where a user is interacting with a large language model that is able to retrieve data (e.g., Entities, and information about and related to Entities) and execute capabilities defined through SKL (e.g., Verbs in a user's SKDS, in an SKL Library, etc.) in a chat-like interface, according to an embodiment. In this example a user is able to execute Verbs such as “run payroll” through natural language commands communicated conversationally. The user is further able to engage with the chat-like interface to ask for clarification, gather more information contextually, change parameters, and more. In some embodiments, the user is able to speak to the chat-like interface rather than type out questions, commands, responses, and the like.

In this way, SKL Libraries can be used to present contextually relevant data and capabilities to end-users. Some of these capabilities can be abstracted away from a variety of competing products such as text summarization services from Amazon Web Services®, Google Cloud Platform®. Azure®, etc. Certain providers may choose to pay the providers of certain analytics servers and/or SKL Libraries for a higher ranking on suggestions.

In some embodiments, a user is able to use other types of human-computer interaction interfaces such as haptic devices, brain interface, and the like to communicate with an SKL-powered system. For instance, a brain interface might be able to recognize certain intentions (e.g., language expressions, feelings, etc.) through monitoring brain signals and be able to find data and capabilities from SKDSs, Integrations, and/or SKL Libraries in order to contextually enable the user to access data and/or leverage

### Monetization and Management of SKL

As discussed herein, certain SKL Artifacts may require payment. For example, a user reading a long article may wish to use a text summarization Verb to help him/her understand the gist of what he/she is reading in a short amount of time. According to an embodiment, user of a SKApp (e.g., a web browser, a extension, etc.) may choose ahereinSUMMARIZETEXTherein Verb while reading the long article and be able to specify whether he/she wants to use a given Integration to summarize said text, such as Google® Cloud Platform's service, Amazon Web Services® service, OpenAI's® service, and so on. Several of these services require payment which can be facilitated via the Official Library. The Official Library may charge a processing and/or platform fee over whatever payment is made through the Official Library.

Furthermore, the developers that contributed the Schemas (e.g., Integrations, Nouns, Verbs, and/or Mappings) to the Official Library may also request compensation on any payment that uses their Schemas and/or SKL Artifacts. In this case, the platform fee can be distributed in part or in whole to all the contributors that contribute to the Official Library. This creates an incentive for people to contribute components to the overall system, thereby increasing the ability of any individual to build and customize software that solves an ever-increasing breadth of use cases.

In a non-limiting embodiment, all contributions to and usage of SKL Artifacts, including Nouns, Verbs, Mappings, Interfaces, and more may be tracked so that they can be properly attributed. The Official Library can distribute payments to contributors proportional to the amount of usage their Artifacts are receiving.

In another non-limiting embodiment, all contributions to SKL Artifacts can be maintained on a blockchain, and any payment logic can be embedded within smart contracts on said chain such that any payment related to and/or usage of SKL Artifacts can automatically distribute the payments to the corresponding contributors in a pre-established manner. In other words, the Official Library can establish a protocol to track and incentivize the contributions to, and development of, SKL. Furthermore, a decentralized autonomous organization (“DAO”) can be established to set the rules for how payments and incentives are distributed to stakeholders of the Official Library and ecosystem (e.g., the process to share revenue based on contributions, what the Official Library's commission is, etc.).

In some embodiments, there may be incentive structures to encourage people to contribute to this community, for example by tokenizing contributions, requiring that contributions are staked by something of value, and/or using a logic for evaluating the value of contributions.

In yet another embodiment, the SKL Library may also provide advertising opportunities such as the prioritization in the placement of Google Cloud's® text summarization service over Amazon's® text summarization service in the example herein. Given that the Official Library can become the central access point for software components that either use or are represented with SKL methods or Schemas, the Official Library may be considered as the marketplace of software components, including Nouns, Verbs, Integrations, Interfaces, and more. The Official Library can offer one or more interfaces to be able to access all the Artifacts it contains. For example, the Official Library GUI can help users search and browse for components and the Official Library API can help users search or access information in other ways that enable contextual access while they are working normally.

According to some embodiments, the SKL Libraries may also offer to organizations various managed, private SKL Libraries along in exchange for a subscription fee (e.g., software as a service, platform as a service, etc.). In this way, and as described elsewhere herein, an organization can accumulate private SKL Artifacts that can help them establish a competitive advantage over time by compounding their ability to reuse software components across needs, projects, and use cases.

### Low-Code and No-Code Composition

In a non-limiting example, an airline has a variety of different systems and databases that each hold historical and operational records related to flights, passengers, tickets, loyalty program statuses, stewardesses, pilots, and more. The airline wants to be able to easily create portals, interfaces, and/or apps that can easily access data regardless of where that data resides. In other words, it wants to create unified APIs for all of its data and software capabilities. Using SKL, it abstract away the various systems into one easily manageable ontology that allows it to search for all the flights that have been flown, are currently in the air or scheduled, along with all the passengers, bags, stewardesses, pilots, and more. This airline could do this within an SKL Library that allows them to create and edit Schemas in a low- or no-code way. In yet a third example, the Official Library might expose certain Verbs such as herein SUGGESTONTOLOGY or GENERATEONTOLOGY given a particular set of descriptions, data source Schemas, and/or other information such as desired use cases and/or user stories. These Verbs could in turn use artificial intelligence techniques, such as leveraging large language models, to propose the ontology the airline may need as well as the Mappings to all the necessary data sources.

Beyond unifying software capabilities, SKL can enable this airline to unify its data, for example by deduplicating and/or recommending deduplications and/or other relationships between people across databases, records, etc. This would improve the airline's ability to create and manage custom software that help provide holistic data, analyses, compliance, automations, and more.

The airline might then choose to create Mappings between its ontology and other existing Schemas in the Official Dictionary, such as other Nouns, Verbs, Interfaces, etc. As described herein, these relationships could be established and managed in a manual, semi-automatic, or fully-automatic way. As they create the SKL Schemas to represent and translate and/or transform data types (Nouns), capabilities (Verbs), Interfaces, Knowledge Apps, other data sources and systems (Integrations), Mappings, and more into a given ontology, they are all accumulated in a unified index of SKL components (e.g., an SKL Library). This Library of composable components would serve as the repository of “Lego® bricks” (so to speak) that can be customized and/or put together to make new SKApps, Verbs, automations, etc. according to the airline's needs.

Described further, the airline is then able to use their growing SKL Library of components to easily create automations such as a loyalty recognition program where they can choose which passenger(s) on a given flight to recognize and or give special treatment to based on data about each passenger's flight history, personal information, and more. Where previously this would have required a lot of complex logic tied to various data sources, SKL abstracts and simplifies the process through a semantic integration approach. The airline is then able to use any existing components from the Official Library to build their custom applications, automations, SKApps, etc.

In some embodiments, these SKL components can be compiled together by a developer building an application using custom code or manually using a code editor interface. In other embodiments, these components can be fit together using a no-code interface. Such an interface would allow non-developers to create new systems by combining and/or customizing components similar to popular no-code application and workflow builders. FIGS. 42-44 illustrate non-limiting embodiments of how Schemas can be parametrically altered to change Interface Components and FIGS. 25-28 illustrate how more easily usable graphical user interfaces can be added over Schemas to facilitate the ability of non-technical users to edit Schemas. Together these examples demonstrate how SKL Libraries could be used find various Schemas, combine them, and customize them in order to build sophisticated applications in no-code ways.

In yet another embodiment, a user is able to describe (e.g., through natural language, through comparison, through reference, etc.) the software and capabilities they want (e.g., an application that can consolidate all productivity data from file storage tools, communication tools, scheduling tools, and project management tools), the data they want the users to interact with (e.g., where productivity data includes files, messages, tasks, and people), how they want the data stored (e.g. where each user stores their data in a graph database locally on their Macbook® Pro running Apple® silicon), and how they interact with the application (e.g., and where the users can interact with the application using a search functionality and profiles for entities that look similar to LinkedIn profiles). In this non-limiting example, the SKL Library, and/or the analytics server processing the data, may be able to use a large language model (“LLM”) to find the SKL Schemas most relevant to the description. To do so, a developer may find or create a language model suitable for distinguishing between features of SKL Schemas. Then, a vector embedding may be created for each SKL Schema and those vectors inserted into a vector database. Next, it may process the description by generating one or move vector embeddings from the input text. The input embedding may then be used to query against a database of vectors representing each SKL Schema using a distance metric (e.g., Euclidean, Cosine, etc.) to collect relevant and/or similar Nouns, Verbs, Interfaces, SKDSs, SKApps, etc. from the Official Library (and elsewhere). The Schemas found most relevant may be combined into a fully working SKApp according to the description. This synthesis step could be performed by a large language model trained on vast amounts of code and possibly aided by some heuristics about SKL so that it can predict how a library like Standard SDK would be used to create the described application.

In the event that there are multiple options for components. (e.g., multiple ontologies, multiple interfaces, etc.) that can be chosen (e.g., by the analytics server) in the composition of the SKApp, then the AI system could either automatically make a decision, or prompt the user for additional input, feedback, and/or clarification.

In another embodiment, after receiving the description from the user, the system might generate new Nouns, Verbs, Mappings, Integrations, etc. using a large language model trained with data from SKL Libraries. The LLM might also use third-party data as part of its training set in order to improve the capabilities of the model in generating new components that have not previously existed in SKL Libraries.

In another embodiment, after receiving the description of the application from the user, the system may also query one or more SKL Libraries and/or other sources to collect relevant and/or similar Schemas and SKL components in order to generate entirely new Schemas and components using generative AI techniques, and then combine them into a cohesive SKApp.

Due to the potential modular, interoperable, and parametrically editable nature of SKL, a user creating software across any of these examples may use the output of any of these processes as a starting point for further editing of the software. In other words, a user may start programming a custom SKApp, then move it into the no-code/low-code graphical user interface builder mentioned herein to customize certain components. The user could then add in new features and functionality by describing the desired capabilities to an input (e.g., a chat interface) that can use a LLM to help generate new and/or combine existing components and add them to the SKApp. Any output of SKL Schemas that are used to create a SKApp could then be parametrically altered, tweaked, and customized after the fact according to the methods described above (e.g., through traditional programming and software development, through the configuration of Schemas as shown in FIGS. 42-44, through custom interfaces as suggested through FIGS. 25-28, some combination of these methods, etc.).

In these ways and more, SKL Libraries can be used to easily create and manage custom components, Schemas, SKApps, and more that can deliver complex, sophisticated, and powerful solutions through software.

### SKL App Frontend Frameworks

According to some embodiments, the SKL Interface Components may be defined through Schemas and configuration such that a front-end framework can enable application developers to contribute, reuse, and share UI components that are capable of being interoperable over many different data formats. This is referred to herein as the SKL Interface System, SKL Interface Framework, or Standard UI, and may consist of several parts.

First, a protocol for how applications may automatically translate data types into the particular formats required by UI components. This may be done using SKL Mappings. Second, a protocol for communication between UI components and their embedding application. Third, an open source registry where anyone may publish their UI components and Mappings for other people to discover and use. This is part of the Standard Knowledge Library.

### Mappings

According to some embodiments, upon receipt of a specific component to render and data conforming to a specific SKL Noun, the Interface Engine searches for a NOUNINTERFACEMAPPING, which relates the Interface Component and the Noun. This Mapping may be executed using an SKL Engine, and the response may be used to render the component. Optionally, if a Mapping is not found, the Engine may choose to pass the data directly to the component to be rendered as the fields used by the data may naturally match up with the properties expected by the component. To render the component, the Engine may either load the component's code from its soURCEURL property or recursively render the UI defined in its noDESPROPERty.

### Nodes Definition

According to some embodiments, Interface Components which do not require complex logic defined through code, may have their entire content specified through their SKL Schema in the nodes field. Many UI frameworks may include a set of built in “primitives.” For example, HTML may have a set of standard tags which are expected to be implemented in the same way by any HTML rendering engine such as “div,” “p,” “h1,” “h2,” etc. Likewise, the SKL Interface Framework may expect Engines to implement a standard set of primitive interface components. According to various configurations, these components—while not limited to—may include the following:

Container—defining a section which may contain a sub tree of other components.

Text—defining a block which contains a text which may be styled.

Image—defining a block which displays an image through a source URL.

These primitive components may be constructed as a tree of RDF nodes in RDF serialization. According to one embodiment using JSON-LD (context omitted for brevity):

```
    {
    . . .
    “https://skl.standard.storage/properties/nodes”: [
      {
        “(@type”: “https://skl.standard.storage/interface/Container,”
        “https://skl.standard.storage/properties/styling”: { . . . },
        “https://skl.standard.storage/properties/nodes”: [
          {
          “@type”: “https://skl.standard.storage/interface/Text,”
          “https://skl.standard.storage/properties/styling”: { . . . },
          “https://skl.standard.storage/properties/propertiesMapping”: {
            “(@type”: “rr: TriplesMap,”
            “rml:logicalSource”: { . . . },
            “rr:subjectMap”: { . . . },
            “rr:predicateObjectMap”: [ . . . ]
            }
          }
        ]
      }
    ],
    . . .
  }
```

As shown herein, in addition to a tree of sub-nodes, a Node may include properties specifying styling, and a property Mapping.

### Styling & Themes

According to some embodiments, a UI rendering engine may include a specific format or ontology of styling which may be applied to components within the system, for example, CSS within web browsers. Such styling formats as CSS may be constructed of rather simple key value pairs and may thus be translated easily between formats and languages. Thus, the styling field of a node may be written in a generalized styling format and translated by the SKL Interface Engine it is read by into the specific styling language used by the environment that a component is being rendered into (e.g., web browser vs. mobile app).

In one embodiment, the styling field includes styling rules written in the format required by a CSS-in-JS library (e.g., Emotion, Styled Components, etc.), built to be rendered in React® or another JavaScript® UI framework.

In another embodiment, the values of the styles defined in the styling field could use a special format to encode Design Tokens following a specification, such as that defined by the W3C Design Tokens Community Group. These values may be swapped out when the component is rendered based on a supplied theme, or “source” of those design tokens. For example, take the styling field defined within a component like so:

“https://skl.standard.storage/properties/styling”: {
“borderRadius”; “{size.radius.3x},”
“padding”: “(space.3x},”
“Box®Shadow”: “{shadow},”
“backgroundColor”: “{color.background.primary},”
“border”: “{border.normal},”
“display”: “flex,”
“alignItems”: “center,”
“cursor”: “pointer,”
“maxWidth”: “800px,”
“margin”: “0 auto {space.2x} auto”
}

Each value within the styling object which contains a value surrounded by curly brackets { . . . } denotes where a value should be replaced from the currently used theme. Using the Design Tokens specification, a dot within one of these sections of curly brackets, may denote accessing a nested property of an object. As such, the values for the tokens in the snippet herein would be able to be filled with values from the designTokens field of the following theme (shown in JSON-LD):

```
{
“(@context”: {
  “https://skl.standard.storage/properties/designTokens”:
{ “@type”: “@json”
}.
“@id”: “https://skl. standard.storage/data/LightTheme,”
“@type”: “https://skl.standard.storage/nouns/StylingTheme,”
“https://skl.standard.storage/properties/name”: “Light,”
“https://skl.standard.storage/properties/designTokens”: {
  “color”: {
  “$type”: “color.”
  “shadow”: { “$value”: “#00000014” },
  “text”: {
    “primary”: { “$value”: “#333333” },
    “secondary”: { “$value”: “#555555” }
    },
    “background”: {
    “primary”: { “$value”: “#FFFFFF” },
    “secondary”: { “$value”: “#F2F2F2” },
    “error”: { “$value”: “#fdb0ba80” }.
    “success”: { “$value”: “#88ef9080” },
    “warning”: { “Svalue”: “#ffde4080” }
  },
  “border”: {
  “primary”: { “$value”: “#a6a6a6” },
  “secondary”: { “$value”: “#BFBFBF” }
  },
},
“space”: {
  “$type”: “dimension,”
  “0x”: { “$value”:“0px” },
  “1x”: { “$value”: “5px” },
  “2x”: { “$value”: “10px” },
  “3x” : { “$value”: “15px” }
},
“size”: {
  “$type”: “dimension,”
  “0x”: { “$value”: “(space.0x)” },
  “1x”: { “$value”: “(space.1x}” },
  “2x”: { “$value”: “{space.2x}” },
  “radius”: {
  “0x”: { “$value”: “0px” },
  “1x”: { “$value”: “3px” },
  “2”: { “$value”: “5px” },
  }
},
“shadow”: {
“$type”: “shadow.”
“$value”: {
  “color”: “{color.shadow},”
  offsetX”: “Orem,”
  “offsetY”: “0.25rem,”
  “blur”; “0.5rem,”
  “spread”: “0rem”
  }
},
“border”: {
  “normal”: {
    “$type”: “border,”
    “$value”: {
      “color”: “{color.border.primary},”
      “width”: “1px,”
      “style”: “solid”
      }
    },
    “hover”: {
    “$type”: “border,”
    “$value”: {
    “color”: “(color.border.secondary},”
    “width”: “1px,”
    “style”: “solid”
    }
  }
  }
  }
}
```

According to an embodiment, the SKL Interface Engine may be responsible for resolving the theme styling for any component it renders. As shown in the snippet herein, a theme used by an SKL Interface Engine may itself be a Noun within the SKL framework. In this embodiment, an application developer or user of an application could choose to have several themes available to switch between. An application may hardcode a set of themes, or use an SKL Engine to find the available themes within a user's chosen Schemas and display them by name somewhere in the application's interface to choose between. Switching a theme would change the styling of the components rendered by the SKL Interface Engine in real time.

In other embodiments, styles may also be applied through a list of reusable labels attached to a predefined set of styles, such as CSS classes, specified statically in a field of an SKL Interface Component, or specified dynamically via a property that an SKL Interface Component accepts. In a non-limiting example below, an Interface Component's configuration may contain one of the following:
“https://skl.standard.storage/properties/classes”: “left-aligned thick-border medium-padding” “
https://skl.standard.storage/properties/classes”: [“left-aligned,” “thick-border,” “medium-padding”]

These additions and variations may be standardized within SKL, or left open to the Engine implementation. In the latter embodiment, it may be that only specific component configurations would be able to be used with specific SKL Interface Engines.

### Property Mapping

According to some embodiments, Mappings may not be included within a Schema, in other embodiments Mappings may be included within a Schema. In such an embodiment, these Mappings are meant to move properties from a higher-level set of data to a more specific subset. According to some embodiments, the property Mappings are simply selecting certain fields to use within nested primitive components down the tree of nodes. For example, in constructing the configuration for a Card component, the Card may include an outer Container component, with an image and some text inside. The SKL Interface Engine that will render a Card's configuration may include support for primitives for ‘Container,’ ‘Image,’ and ‘Text.’ As such, there may be a specification stating that the Image primitive component accepts a parameter called src for the URL of the image, and the ‘Text’ component has a parameter called contents for the text it will contain. The ‘Container’ component may render its sub-nodes inside of a wrapper element.

According to an embodiment, the ‘Card’ component may be called ‘imageSrc’ and ‘headerText.’ RML may be used to define the configuration so that ‘imageSrc’ and ‘headerText’ get used as the src and contents properties of the primitive Image and Text components respectively. The following is an example of the configuration used to implement the scenario described herein with various omissions for brevity:

```
{
  “@id”: “https://skl.standard.storage/data/cardInterface,”
  “@type”: “https://skl.standard.storage/nouns/InterfaceComponent,”
  “https://skl.standard.storage/properties/name”: “Card,”
  “https://skl.standard.storage/properties/parameters”: {
  “@type”: “shacl:NodeShape,”
  “shacl:targetClass”: “https://skl.standard.storage/nouns/Parameters,”
  “shacl property”: [
    {
    “shacl:datatype”: “xsd:string,”
    “shacl:maxCount”; 1,
    “shacl name”: “imageSrc.”
    “shacl:path”: “https://skl.standard.storage/properties/imageSrc”
    },
    {
    “shacl:datatype”: “xsd:string.”
    “shacl:maxCount”: 1,
    “shacl name”: “title,”
    “shacl:path”: “https://skl.standard.storage/
    properties/headerText”
    }
  ]
  },
  “https://skl.standard.storage/properties/parametersContext”: {
  “imageSrc”: {
  “@id”: “https://skl.standard.storage/properties/imageSrc,”
  “(@type”: “http://www.w3.org/2001/XMLSchema#string”
  },
  “headerText”: {
  “(@id”: “https://skl.standard.storage/properties/title,”
  “(@type”: “http://www.w3.org/2001/XMLSchema#string”
  }
  },
  “https://skl.standard.storage/properties/nodes”: [
  {
    “@type”: “https://skl.standard.storage/interface/Container,”
    “https://skl.standard.storage/properties/nodes”: [
    {
      “(@type”: “https://skl.standard.storage/interface/Image,”
      “https://skl.standard.storage/properties/propertiesMapping”: {
      “@type”: “mr:TriplesMap,”
      “rml:logicalSource”: { . . . },
      “rr:subjectMap”: { . . . },
      “rr:predicateObjectMap”: [
      {
        “(@type”: “rr:PredicateObjectMap,”
        “rr:object”: “https://skl.standard.storage/
        Mappings/frameObject,”
        “rr:predicate”: “rdf:type”
        },
        {
        “@type”: “rr:PredicateObjectMap,”
        “rr:predicate”: “https://skl.standard.storage/properties/src,”
        “rr:objectMap”: {
        “@type”: “rr:ObjectMap,”
        “rr:reference”: “imageSrc”
        }
        }
        ]
        }
      }
      ]
    },
    {
    “@type”: “https://skl.standard.storage/interface/Text,”
    “https://skl.standard.storage/properties/propertiesMapping”: {
    “@type”: “rr:TriplesMap,”
    “rml:logicalSource”: { . . . },
    “rr subjectMap”: { . . . },
    “rr:predicateObjectMap”: [
    {
        “(@type”: “rr: PredicateObjectMap,”
        “rr:object”: “https://skl.standard.storage/
        Mappings/frameObject,”
        “rr:predicate”: “rdf:type”
        },
        {
        “(@type”: “rr:PredicateObjectMap,”
        “rr:predicate”: “https://skl.standard.storage/
        properties/contents,”
        “rr:objectMap”: {
        “(@type”: “rr:ObjectMap,”
        “rr:reference”: “headerText”
        }
        }
        ]
      }
    }
  ]
}
```

As seen with the Container node, if any node within the tree does not specify a PROPERTIESMAPPING field, the SKL Interface Engine may be expected to pass all the properties supplied to it to any children it renders (the Image and Textcomponents in this case). The Engine may then perform the Mappings specified in the nested configuration for the Image and Text components and render each with the output of the Mappings. In this embodiment, more complex or larger interface components may be easily composed out of smaller or simpler building blocks through configuration alone.

### Source Definition

In yet another non-limiting embodiment, a component may instead specify a sOURCEURL field from which the source code of the component may be downloaded and run. Depending on the SKL Interface Engine used and the environment that Engine is rendering into, there may be restrictions on the components that may be rendered. For example, using an Engine that is built for rendering SKL Interface Components into web pages, an applicable component's source code might have to be a JavaScript module, served with the Content-Type: text/javascript header and include specially formatted configuration file (e.g., a package.json file in a node package module).

Upon encountering a component with a SOURCEURL, an SKL Interface Engine may download the component's source code, or retrieve it from a cache if it has downloaded the same version of the component before. As noted previously, the Engine may find and perform a Mapping to translate the supplied data into the format required as properties to the component.

### Registry

As noted previously, both the configuration of SKL Interface Components and their implementations in code (if they specify a sOURCEURL) may be made available in the SKL Libraries (e.g., the Official Library), according to some embodiments. In addition to documenting their configurations and uses, and showing examples and test cases, the Library may also act as a registry from which component configurations and implementations may be downloaded.

A major use case of the Official Library may be to facilitate individuals to install SKL Schemas into their personal SKDS so that applications they may access preferred component configurations, themes, and more. However, in other embodiments, the SKL Interface Framework may be used entirely independently of the rest of the Standard Knowledge ecosystem. An application may choose to construct and bundle its own set of custom Schemas for Interface Components, Themes, and Mappings, and use them with an SKL Interface Engine to build its user interface without using the registry nor building in compatibility with users' SKDSs.

### API Abstraction

According to some embodiments, general API conventions may have standardized and widely used specifications which serve as a bridge between the human and machine understandings of APIs. In these embodiments, these specifications are used for documentation and SDK code generation. SKL Engines may use OpenAPI specifications to dynamically send web requests to REST APIs based on an OpenAPI operation name. OpenAPI specifications may be used by users of Standard API to describe the API endpoints they wish to make available through a SKApp. This SKApp may be called Standard API. Once these are defined, Standard API may dynamically validate and authenticate incoming web requests according to the specification and perform Mappings to fulfill the request's operation and respond with a response also validate against the specification.

A user of Standard API may have an OpenAPI operation such as the one below (various omissions for brevity):

```
. . .
“/files/get_Metadata”: {
  “post”: {
  “summary”: “Files - Get Metadata.”
  “operationID”: “FilesGetMetadata,”
  “security”: [
    '{ “apiKey”: [ ] }
  ],
  “requestBody”: {
  “$ref”: “#/components/requestBodies/
  GetMetadataRequestBody”
  },
  “responses” : {
    “200”: {
    “$ref”: “#/components/responses/
    GetMetadataResultResponse”
    },
    “default”: {
    “$ref”: “#/
    “#/components/responses/
    GetMetadataErrorResponse”
    }
  }
  }
  }
  . . .
```

According to some embodiments, the Standard API server processing incoming requests on behalf of a user may match requests against the path and method defined in the configuration herein using regular expressions or simple string equality. If there is no configuration matching a request, the server may respond with a 501 HTTP error code to signify that such a method is not implemented. In some embodiments, a Standard API might keep a record of these requests in order to recommend that an administrator or developer using Standard API can create the Schemas and Mappings at a later point in time. In other embodiments, certain Mappings and or components may be automatically generated using one or more methods, as described elsewhere herein. Upon receipt of a matching request, the server may then verify the format and contents of the requests headers, query parameters, and/or body to ensure any parameters required in the specification have been supplied. If not, it may return a 400 HTTP error code signifying a bad request sent by the client. In some embodiments, if the data provided to the server is complete, and is just not in the correct format, the server might use certain techniques to restructure the query according to the correct format.

After matching and validating the request against an OpenAPI operation, the Standard API server may search the Schemas associated with the user's account to find one or more Mappings for the operation. In the majority of cases, a Mapping will execute a Verb or query for data from a database and return a response. After performing the Mapping(s) the server may then validate the retrieved response data, or lack thereof, against the OpenAPI operation's responses field. If the response data is not valid according to the specification, the server may respond with an internal server error with HTTP response code 500. Otherwise, the properly formatted response data may be encoded according to the specification and sent to the client.

While the embodiments herein use an OpenAPI specification to construct a REST API and dynamically handle requests, roughly the same procedure may be performed using specifications for other types of APIs. For example, a Web Services Description Language (WSDL) document may be used as an abstraction of a SOAP API. In this case, the SKL Engine matching and validating SOAP compliant messages to the server may have to parse the XWL of a WSDL document. Tooling may exist to parse and manipulate XML in most programming languages. Upon receiving a message, the Standard API server may match the message to an operation name defined in the WSDL document, validate the input parameters according to the operation definition, find a Mapping for the operation, perform the response, then validate and return the response.

In yet another embodiment, a similar procedure may also be performed for an Asynchronous API or an Event-Driven Architecture (EDA) via the AsyncAPI specification. Within an EDA, the Standard API server may act as a broker. As such, it may register or initialize an endpoint, websocket, or other connection mechanism to listen for events or messages from Producers when it starts up by reading the user's chosen AsyncAPI specifications. It then may implement an endpoint, websocket, or other connection mechanism for Subscribers to register their subscription per AsyncAPI defined channel. When a Subscriber connects, the Standard API server may keep track of their connection status and channels they have subscribed to by performing a Mapping which writes the Subscribers information into a persistent data store. Upon receipt of a message from a Publisher, the server may use the AsyncAPI specification to validate the existence of the channel the message was sent on and the format of the payload. It then uses a Mapping which queries a data source to translate the channel name into a list of Subscribers to send the event or message to. It may then send the event or message to all subscribers of the channel.

Even GraphQL, an alternate API format constructed of a type-based query language with its own Schema definition language, may be abstracted into a format that may easily be used by an SKL, according to another embodiment. GraphQL APIs may have the ability to introspect their Schema including types, query types, and mutation types. The result from the introspection query may be a JSON structure. Although this format may not be widely used by GraphQL API designers and engineers, it may be used by the Standard API server to dynamically match and validate GraphQL queries and mutations, and produce a response based on a Mapping. The Standard API system may create a system wherein an API's possible interactions may be defined through an abstraction and executed according to labeled business logic (called resolvers in GraphQL). However, Standard API may be more configurable and accessible to people with less technical expertise by replacing any custom, ecosystem-specific, or framework-specific code with SKL Schemas and Mappings.

### Mappings

According to some embodiments, once a web request or, in the case of an event-driven architecture, a message in a channel, has been matched and validated according to the API abstraction, the Standard API server may find and execute one or more SKL Mappings to perform an operation in a data source or to simply transform the data in some way. A Mapping for a Standard API operation may include a reference to the identifier of the operation as it exists in the API abstraction. For example, in some embodiments, a Mapping that is to be executed when processing a web request that matched with an operation in an OpenAPI specification may have a field whose value is equal to the operationID of the OpenAPI operation like so:

{
. . .
“https://skl.standard.storage/properties/operation”: “SearchEvents,”
. . .
}

According to some embodiments, once such a Mapping is found, it may be executed using an SKL Engine. As noted previously, Mappings may transform data, use constants, compare values, fetch data from other APIs, query databases, and more. According to some embodiments, a Standard API may translate between a request and a data store to perform the operation specified in the API abstraction.

Some data sources may have a specific query language that is used to send them procedures to execute. Thus, a Mapping may need to construct one or more queries, or otherwise inform a Standard SDK what query to perform.

One form of querying a data source is one in which queries are hard coded into the Mapping. In some configurations, when Mapping between a web request and a relational database, the R2RML ontology may be used to send a pre-constructed query to the database and translate the result. R2RML is the W3C standard to express customized Mappings from relational databases to RDF. A simple embodiment of an R2RML Mapping follows (prefixes omitted for brevity):

<#TriplesMap>
rr:logicalTable rr: sqlQuery “““SELECT ID, NAME
FROM EVENTS;”““ ;
rr:subjectMap [
rr:template “http://data.example.com/{ID}”,
rr:class Schema:Event;
];
rr:predicateObjectMap [
rr:predicate Schema:name;
rr:objectMap [ rr:column “NAME” ];
],

This embodiment may not be dynamic as it does not include any parameters from the request in the query. APIs commonly paginate the response, filter the retrieved entities, or write data to the database based on the parameters of the request. RML, a more general-purpose Mapping language based on R2RML, may be used to construct queries dynamically through conditional logic and/or string concatenation. For example, to add pagination to the query herein, the following RML Mapping may be used:

```
<#TriplesMap>
rml:logicalSource [
a rml: LogicalSource ;
rml:iterator “$” ;
rml:referenceFormulation <http://semweb.mmlab.be/ns/q#JSONPath> ;
rml:source “input.json”
];
rr:predicateObjectMap [
a rr:PredicateObjectMap ;
rr:objectMap [
  a rr:ObjectMap ;
  fnml:function Value [
  a fnml:Function Value ;
  rr:predicateObjectMap [
    a rr:PredicateObjectMap ;
    rr:object <http://example.com/idlab/function/concat> ;
    rr:predicate <https://w3id.org/function/ontology#executes>
  ],
  [
    a rr:PredicateObjectMap ;
    rr:object “SELECT ID, NAME FROM EVENTS LIMIT 40 OFFSET ”,
    rr:predicate <http://example.com/idlab/function/str>
  ],
  [
    a rr:PredicateObjectMap ;
    rr:objectMap [
    a rr:ObjectMap ;
    rml :reference “offset”
    ];
    rr:predicate <http://example.com/idlab/function/otherStr>
  ];
  ];
]:
].
```

This Mapping generates the query:
SELECT ID, NAME FROM EVENTS LIMIT 40 OFFSET {offest}

Where {offset} is equal to the offset field in the supplied input.json. The SKL Engine may execute this Mapping to get the dynamically created SQL query; it then may execute the query against the database and apply another Mapping to the response from the database to return as the response of the request. This method of string concatenation may be used to allow any part of a query to be parametrically defined.

Another alternative embodiment to generate queries dynamically is to create multiple Mappings which specify the correspondence between the data models of a data source and the RDF graph. This may make it so that the data sources may be queried as if they were RDF graphs using a query language like SPARQL.

In yet other embodiments, the same process may be used to translate requests to a Standard API server into other APIs and query languages such as REST, GraphQL, SOAP, or SPARQL.

### Dynamic API from Nouns

Instead of responding to web requests based on a predefined API specification such as OpenAPI, Standard APIs may also be configured dynamically, based on Noun and Verb Schemas. For example, a Standard API could be implemented to allow for a certain set of standard operations on entities of any type of Noun in a user's SDKS. To do so, according to a non-limiting embodiment, the Standard API server would accept requests according to a certain pattern. For example: HTTPS://EXAMPLE.COM/API/NOUN/{NOUN} where EXAMPLE.COM is the domain of the Standard API server and where {NOUN} is the name of the Noun data type of the entity(ies) a developer is sending a request about. In one REST API approach, this same URL can be used with multiple HTTP request types to create, read, update, or destroy entities (CRUD).

According to a non-limiting embodiment, a developer or application may create an entity conforming to the Noun by sending a POST request to the URL with a JavaScript object in the body of the request conforming to an entity of the Noun. Upon receiving the request, the Standard API Server would query the user's SKDS to obtain the Noun Schema with name matching the {NOUN} part of the path. If the Noun Schema cannot be found, the server may return an error to the developer and/or look for the Noun Schema elsewhere (e.g., the Official Library). If the Noun Schema is found, it can be used to validate the entity in the request body to ensure it is conformant to the Noun Schema. If it is not, the server may return an error to the developer. Otherwise, the Entity is inserted into the user's SKDS and a success response is returned to the developer.

According to a non-limiting embodiment, a developer or application can update an Entity conforming to the Noun by sending a PUT or PATCH request to the URL with an entity ID and any fields and corresponding values to update in the body of the request. Just like in the creation example herein, the server can validate the format of the data being updated against the Noun Schema and either return an error or update the entity in the user's SKDS accordingly.

According to a non-limiting embodiment, a developer or application can delete an Entity conforming to the Noun by sending a DELETE request to the URL with and Entity ID in the body of the request. No validation needs to occur for this operation, the server can simply delete the entity from the user's SKDS.

According to a non-limiting embodiment, a developer or application can obtain one or more Entities of the Noun data type by sending a GET request with the request body containing either (a) one or more IDs of Entities to obtain or (b) one or more field and value pairs acting as filters on the data that the server should return. In the first case, the server can simply query the user's SKDS for the Entities with matching IDs. In the latter case, the server may first validate that the Noun Schema contains all the fields included in the filters. If not, it can return an error to the developer. If all the queried fields are valid, the server can query the user's SKDS and return the matching entities.

According to another non-limiting embodiment, a Standard API server could support a GraphQL interface for which it would expose only one endpoint, but allow a set of queries and mutations corresponding to the CRUD operations described herein. Instead of using a predefined type system, the available types to query may be based on the Noun Schemas present in the user's SKDS. Likewise, standard GraphQL mutations may be made available for each Noun Schema, for example to create, update, or destroy an Entity. Instead of a pattern of URLs and HTTP methods, this GraphQL API would be interacted with according to a pattern of queries and mutations by Noun.

### Dynamic API from Verbs

In addition to creating endpoints for performing operations on entities based on their Noun data type, the API could also dynamically respond to endpoints to execute Verbs, according to a non-limiting embodiment. To do so, the Standard API server may accept requests according to a different pattern. For example: HTTPS://EXAMPLE.COM/API/VERB/{VERB} where EXAMPLE.COM is the domain of the Standard API server and where {VERB} is the name of the Verb a developer wants to execute. Upon receiving such a request, the Standard API server can search for the Verb Schema by the name of the Verb. As before, if the Schema or Schemas are not found, the server may return an error and/or try and find the missing Schema(s) elsewhere. Otherwise, the server begins performing the same steps as Standard SDK would to perform the Verb. In some embodiments, the Standard API server may use a Standard SDK to perform the Verb. The parameters of the Verb may be any data sent in the body of the request such as data encoded as multipart/form-data or as JSON which should conform to the Verb's parameters Schema. After executing the Verb, its standard return value will be returned in the response of the request to the developer.

### Authentication

In addition to controlling which Nouns and Verbs are accessible through API endpoints in a Standard API instance as described herein, a Standard API provider could offer the ability for the API to be secured via different authentication and authorization mechanisms. For example, one set of API endpoints through which consumers can read Entities that do not contain sensitive or personal information could be made public and not require any authentication or authorization. Alternatively, some endpoints which deal with Nouns that are more sensitive may require an Oauth2.0 access token to identify and authorize the consumer.

### Documentation

In order for developers to know how to use this dynamic API derived from the Schemas in a user's or developer's SKDS, the Standard API server can also serve a webpage with documentation derived from the data in a user's SKDS, and elsewhere (e.g., SKL Libraries, existing API documentation websites that are similar or relevant, etc.). For example, the documentation could describe a developer's ability to send a HTTP request with the method POST to HTTPS://EXAMPLE.COM/API/NOUNS/NOTE with title, body and tags parameters in the body of the request in order to create an entity of the Noun Note in the SKDS.

In other embodiments, API documentation can be generated locally by running a script which reads a user's SKDS, either from local files, a database running on the same computer, or from a remote server, such as a cloud hosted SKDS. The API documentation generated could be in the format of an open-source API documentation standard such as OpenAPI in YAML, XML, or JSON.

### No-Code API Builder

In some embodiments, as a user's SKDS is filled with more and more types of Nouns and Verbs, the Standard API server will automatically respond to endpoints for manipulating data of any Noun types and executing any Verbs that are existing in the Schema at the time of the API request. In other embodiments, the Standard API server may require users or developers to perform some action to “re-build” the API periodically to update it according to new or updated Nouns and/or Verbs. In other embodiments, the Standard API server may offer an interface (GUI or programmatic) for the user or a developer to customize which specific Nouns and Verbs should be available to interact with via the Standard API and which should not. Such an interface for selection of API endpoints could be marketed as a “No-code” API builder. The Standard API provider offering this service could also enable its users to create multiple versions of their API with different endpoints enabled for different sets of Nouns and Verbs. In this way, a developer using an SKDS could expose different read and write capabilities to different consumers.

According to a non-limiting embodiment, an analytics server could automatically generate Schemas from APIs and/or Documentation. As described elsewhere herein, certain machine-learning models could be trained and/or tuned with SKL Schemas in order to help with the creation and maintenance of said Schemas. For instance, an AI model may be trained with OpenAPI Schemas and their respective API documentation websites in order to help automatically generate or partially generate one given the other. In other words, given an OpenAPI spec, a certain AI model may generate a documentation website for that API. Similarly, given API documentation, a certain AI model may generate an OpenAPI spec. Furthermore, as described elsewhere herein, a certain AI model might be trained to help generate Mappings between other Schemas. In these ways, certain methods (e.g., using large language models) can be used to automatically generate and/or partially generate SKL Schemas given other types of information about Integrations and data sources (e.g., documentation about APIs on websites).

Similarly, according to some embodiments, and using the various methods described herein, API endpoints and/or documentation can be automatically and/or semi-automatically generated and/or manipulated by providing SKL Schemas. Furthermore, in some embodiments the server can combine Schemas and additional information from other data sources, such as SKL Libraries and public sources, in order to include descriptions of Schemas, dummy data for testing, and more. In this way, a Standard API is able to have documentation that is automatically or semi-automatically generated and/or maintained. Similarly, any changes to the API documentation could also be used to update and/or recommend changes to SKL Libraries and/or other SKL components.

In these ways, and more, Schemas may be automatically generated from information about Integrations (e.g., API documentation, discussion, Q&A forums, etc.). In these ways, and more, API endpoints and/or documentation may be automatically generated from Schemas and information about Schemas. In these ways, and more, API endpoints can be automatically generated from information about data sources.

Depending on the needs or requirements for a given Standard API, different Verbs, Schemas, and/or other configurations could be used. Different embodiments of Standard APIs could therefore include, but not be limited to, using a virtual database to query and merge data from multiple data sources into one endpoint, triggering a secondary process such as syncing data from multiple data sources into a given data store when a particular endpoint is hit, using a Standard SDK to query one data source at a time with the parameters provided by an endpoint, using Mappings to run hardcoded queries or queries built through string concatenation rather than using abstractions of data sources, and so on.

Similarly, certain other Verbs and capabilities may be added to Standard APIs, such as certain security services that help identify certain requests and traffic as potentially dangerous, certain performance and analytics services that monitor requests and help track of usage and latency, and so on. As described elsewhere herein, according to some embodiments, some of these various services and expansions on a Standard API SKApp may require payment, which could be processed through the Official Library and/or other SKL Libraries which host the various capabilities and extensions to the Standard API SKApp.

### Syncer

Standard Syncer (also referred to herein as the “Syncer”) is a non-limiting example of a SKApp which can ingest historical data and continuously monitor and/or listen for changes, additions to, or deletions of data (in near real time), from nearly any data source or Integration that Standard SDKs are compatible with (e.g., a REST API).

According to an embodiment, it is constructed of a queueing system, a database to store ingestion state, and a proprietary algorithm which reads SKL Schemas to determine how to sync data from each data source. The syncing algorithm goes through a series of parameterized steps in order to sync many different types of data from many different data sources in a scalable way.

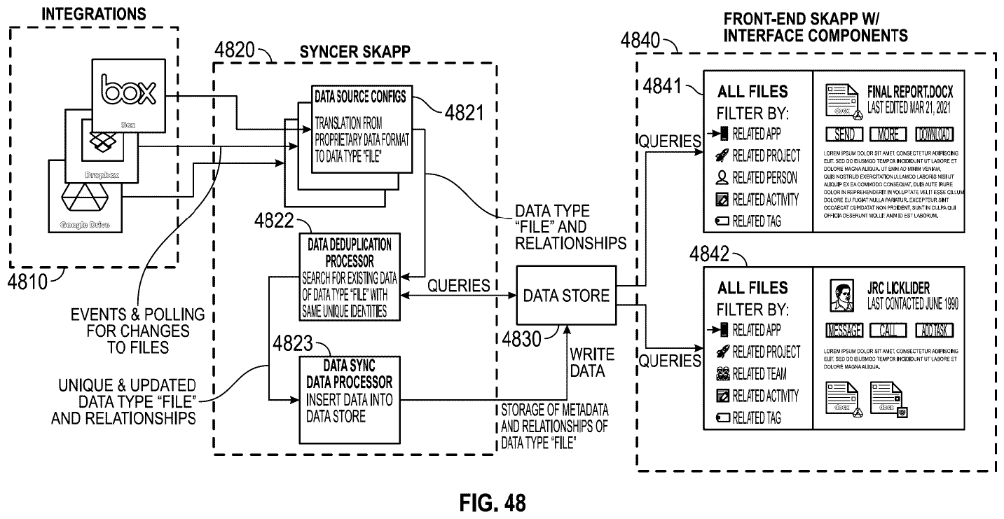

FIG. 48 illustrates a conceptual diagram of the Syncer SKApp 4820, according to an embodiment. In this example, the Syncer 4820 uses Schemas and Mappings related to three different file storage Integrations 4810 (e.g., data source configs) in order to transform the data from each API into the relevant Noun Schemas (e.g., FILE) and pass them through a data deduplication process 4822 which creates one or more CucIDs and/or Unique ID and/or Relevance Scores relative to other Entities in the SKDS 4830. As mentioned above, the generation of CucIDs and/or Unique IDs and the comparison of newly processed Entities have been to other existing Entities in the SKDS 4830 can be largely parameterized and configured through Schemas, as well as run in its own background process with its own set of workers in order to prevent the Syncing SKApp from potentially suffering from performance issues while Syncing large amounts of data. Once this step is complete, the Syncing SKApp can write or update the data 4823 corresponding to the newly synced Entities into or in the SKDS 4830. Ultimately, because the Entities are persisted in an SKDS along with their Schemas, various Interface Components 4841 and 4842 can be used interchangeably to view and interact with data as described elsewhere herein.

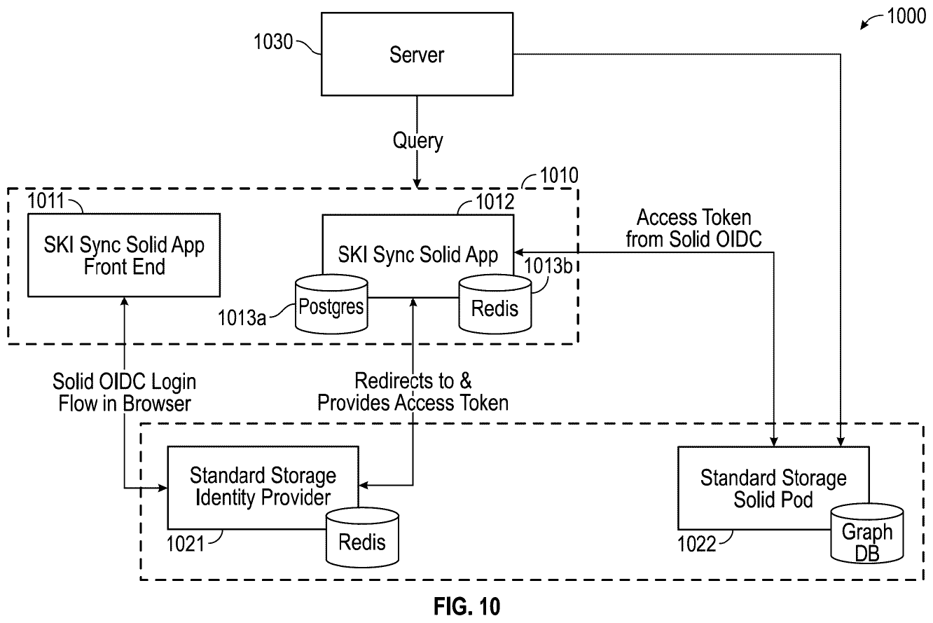

FIG. 10 illustrates a system architecture diagram of the Syncer, according to a non-limiting embodiment that follows the solid specification. In this example, the Solid-compliant Authentication Server 1021 provides users with WebIDs that can be used across any Solid App that implements the Solid OIDC authentication specification. This particular embodiment of the Authentication Server 1021 stores WebIDs and WebID profile information for users in a Redis database. The overall Syncer application 1010 then provides a front-end 1011 that lets users authenticate through Solid OIDC with the Solid-compliant Authentication Server 1021. Once authenticated, users are able to configure the Syncer backend 1012, which may write and read data from one or more databases 1013a-b in order to store information about which WebIDs are authorized to use the Syncer backend 1012, configurations and data from given users that don't have independent SKDSs, and more. In this scenario, the Redis database 1013b may be used to store information about subscriptions and the Postgres® database may be used to store Entities for users that do not have a Solid Pod. For users that do have an SKDS 1022, the Syncer backend 1012 may read and write Schemas, configuration, Entities, etc. to and from a user's SKDS 1022. A server or external application 1030 may either query the Syncer backend 1012 and/or the SKDS 1022 according to its needs.

According to the embodiments shown through FIGS. 22-24 and FIG. 50, a Standard Syncer can be configured in a variety of ways in order to solve for any of a variety of use cases as described elsewhere herein.

### SyncStatus

According to an embodiment, upon the receipt of a new user's account needing to be synced, the Syncer creates a record in the database called a SYNCSTATUS. It may include the following:
1. The URI of the account. An account here may represent any entity provisioned by a data source for a person or company which has some identifier (e.g., CueID, UID) in that data source (e.g., email address, username, API key, etc.) and may have a set of security credentials for the data source. Each account should have a corresponding SKL Schema from which one can access metadata, API security credentials, and configuration for how to sync the account.
2. Standard Syncer may also represent and work with public data sources, for which the account identifier and synced data could be shared across Standard Syncer users, or could be duplicated per user.
3. A reference to a user record. For example, a foreign key referencing the ID column of another table in the database. This separate table may hold internal metadata, profile information, and/or sales or subscription information for the user.
4. A link to the source of the SKL Schemas to use or a field containing the schemas themselves. The source of the SKL Schemas could point to files publicly accessible over the internet or to data stored in a private database. Schemas being accessed from an external source may be stored on a user's SKDS where they can be controlled and managed by the user. In such embodiments, the Syncer may also need to obtain and store authentication credentials like an access token retrieved via Solid OpenID Connect.
5. If a user does not require storage of their Schemas to be external, the user can choose to upload their preferred schemas via the Standard Syncer's API, or choose from a list of preconfigured sets of Schemas offered by the Standard Syncer and/or from the Official Library. In this case, the Schemas may be stored as JSON in a database.
6. In an alternate embodiment, all SKL Schemas could be managed and controlled by the Standard Syncer and be constructed on a case-by-case basis per user, customer, or client.
7. In an alternate embodiment, the Syncer could use a mixture of both pre-set SKL schemas managed by Standard Syncer and a set of SKL schemas configured and controlled by the user, either on an SKDS or other database or uploaded to the Standard Syncer server.
8. Initialized fields to store the state of the syncing process as the account is synced.

### Procedure

According to an embodiment, the Syncer can sync an account after initializing the information listed herein. Syncing begins either when the account is created or at the next regularly scheduled syncing interval which finds all accounts that have not started syncing and starts syncing them. The orchestration and syncing interval can be defined through Schemas as defined elsewhere herein (e.g., cron schedules, custom Verbs with triggers, etc.) As such, the choice of when to start syncing is configurable based on the integration and the use case of the user adding the account. For example, if an individual person using a productivity product which syncs their files and folders from a file storage tool, they may want to have synced entities displayed to them in a UI as soon as possible, even in real time as they are synced. Alternatively, if the user represents an organization which plans to use a Standard SDK to query for synced Entities only once per day, the configuration does not need to start syncing immediately and can wait for the next syncing process scheduled to happen once per day.

According to an embodiment, syncing works by executing a series of steps that correlate with the types of Nouns and Verbs exposed via the API of the data source. The set of steps exist as configuration on each integration associated with an account but may also be overwritten by an individual account's configuration. The Syncer may loop through the steps in the order that they appear in the account or integration configuration.

According to an embodiment, the Syncer may execute the following procedure to sync an account:
1. Initialize the parameters for the step. The account related to the SYNCSTATUS may include a set of configurations for the step. These parameters may include some default parameters to use when syncing that step and information about what type of organizational structure the Syncer needs to parse and iterate over for that step in that particular account. The parameters are saved in the SYNCSTATUS.
2. Queue a background job to execute the step asynchronously. This is done in order to not block the current process of the Syncer server for an extended period.
3. Retrieve the saved parameters for the step from the SYNCSTATUS.
4. Call the SYNC Verb using a Standard SDK with the parameters, the identifier of the step, and the account as arguments. The identifier of the step may be the URI of an SKL Noun. The SYNC Verb is a NOUNMAPPEDVERB that gets paired with a Mapping, called a VERBNOUNMAPPING, to translate its parameters into another Verb to call and return the response of. This allows a single Verb to be called with the name of the step and it may automatically execute one or more other, more specific, Verbs to obtain the data required for the step.
5. Get the results from executing the SYNC Verb
6. If the current step's configuration and/or the response from calling the SYNC Verb specifies that not all the data for the step has been retrieved due to limitations of or a special organizational structure used by the data source's API, the Syncer may:
a. Update the state and/or the parameters for the current step saved in the SYNCSTATUS;
b. Queue a new background job to continue the step;
c. Do this repeatedly until all data for the step has been synced.

Examples of the limitations or special organizational structures certain data sources might have are:

A certain user wants the Syncer to sync all the events from a ticketing service in the Atlanta metro area happening in the next 3 months, of which there are more than 1000. The API endpoint of the ticketing service only allows developers to retrieve a maximum of 100 events at a time. Its API endpoint responds with a current page number and the number of total events across. The Verb to GETEVENTS, called as a result of the mapping from the EVENTS Noun (the label of the step) and the special SYNC NounMappedVerb, maps the ticketing service's API response into a boolean value called HASNEXTPAGE which indicates to the Syncer whether it should increment the PAGE parameter and continue syncing the current step.

In another non-limiting example, a data source API may use a cursor or token-based pagination instead of a page number. In this case, the response from the SYNC Verb would include a TOKEN field if there is more data available, or no token if not. If the token is present, the Syncer may continue syncing the current step. It not, it moves on to the next step.

In another non-limiting example, a data source's API requires requests for certain resources to include a parameter derived from another resource in their API. For example, the APIs of some file storage tools may not offer an endpoint to retrieve files and folders from anywhere in the hierarchical tree of files stored in that tool. Instead, the endpoint may require specification of an identifier of a parent folder, which the endpoint will only retrieve the direct descendants of. Thus, the Syncer must recursively iterate through the folder structure, keeping track of all the subfolders it “sees” when syncing a parent and syncing them once all of the parent's direct descendants have been processed. To do so, the SYNCSTATUS can have a special field (e.g., RECURSEON), which informs the Syncer how to filter the results of the SYNC Verb to get the resources which should be recursed on for the current step. These filtered resources are added to a RECURSELIST field held in the SYNCSTATUS state to await processing. When determining if the Syncer should continue the current step, the RECURSELIST is checked for resources. If available, the first resource in the RECURSELIST may be set as a parameter in the SYNCSTATUS for the current step according to a recursoArgument configuration held in the SYNCSTATUS. A new background job is queued to continue the step with the new parameters. In another non-limiting example, a user may require syncing all their messages from a workplace chat app. The API of the chat app, however, only allows queries to obtain messages from the API by the identifier of the chat they are in. To achieve this, the Syncer may sync using a layered approach. First, the step's initial parameters to the SYNC Verb are mapped to a Verb which gets a list of all chats the user has access to.

If a field called SUBSTEP is set in the SYNCSTATUS configuration, the Syncer sets a STEPSUBPARAMS field which holds parameters for the sub step including the name of the sub step (in this case a URI for the Message Noun), a SUBLIST field to hold all the chats needing their messages synced, and the first chat in the SUBLIST set as a parameter according to a SUBSTEP ARGUMENT configuration. Until the SUBLIST has been exhausted, the Syncer continues on the same step using the STEPSUBPARAMS when calling the SYNC Verb to sync messages within each chat. While syncing using STEPSUBPARAMS, the SYNC Verb's response may include page- or cursor-based pagination information which should be used according to the same procedure listed above, with the exception that it is added to the STEPSUBPARAMS instead of the normal PARAMS for the parent step. Once the SUBLIST is empty, the STEPSUBPARAMS are removed from the SYNCSTATUS and syncing continues with the normal PARAMS for the step if needed according to the presence of page or cursor-based pagination information in the original request for chats. A slightly modified procedure could be used in cases where a top-level resource has multiple types of sub resources which need to be synced. In this case, the configuration could be altered to have an array of SUBSTEPS, rather than a single SUBSTEP.

The Syncer may be made to parametrically sync many different organizational structures of data such as flat lists, tree structures, networks, tables (list of lists), etc. These configurations may be included per account or per integration so that the organizational structure and the resulting method of syncing are not defined per Noun, but rather as a relationship between a Noun, or some other attribute of the data, and an account and/or integration.

The Syncer may determine what steps to take according to the configuration of the integration of the account. In one embodiment, the procedure begins by initializing the parameters and queuing a new background job to run the next step. It continues in this way until there are no steps left to sync. If there are no steps left, the Syncer may mark that the SYNCSTATUS has completed syncing, stores the timestamp of when it completed, and deletes any state it had used while syncing.

### Continuous Sync

According to some embodiments, the configuration for the account, or the account's integration, associated with a SYNCSTATUS may also specify that it should be synced upon a repeating schedule and/or some other trigger(s).

According to a non-limiting embodiment, the schedule configuration can be specified as a time-based interval using a format like cron, or just an integer representing a duration in a specific unit of time such as of milliseconds. A Syncer could use a queuing system backed by a persistent cache to handle execution of the schedule on which the account will be synced. In this scenario, the queuing system would execute a job on the schedule that would create the Syncer object and tell it to sync the account. This may make it so that the Syncer may not have to keep track of or check the configured schedule on which an account should be synced. Rather, it just syncs when told to.

According to another embodiment, the Syncer can have a polling schedule of its own. A job could be configured check for accounts that need to be synced on a particular schedule (e.g., every 10 minutes). The SYNCSTATUS which references the account will either be checked against to find out if the account has not yet been synced, or if the account has completed syncing previously but the minimum time interval between re-syncs has been met and thus the account should be synced again. If either of these cases is true, the account gets synced by the Syncer.

### Verbs

The SYNC Verb may have a special Mapping which translates the request to sync into another Verb according to the parameters SYNC is called with. The resulting, more specific Verb can be one which maps to many different types of operations including, but not limited to: (1) web request sent to a REST API or GraphQL API; (2) a SQL query sent to a relational database; (3) a Cypher query sent to a graph database; (4) a SPARQL query sent to a SPARQL endpoint; (5) a CSS selector to execute via JavaScript to get data from a webpage; and (6) a JavaScript function to get data from a webpage.

Similar methods and processes to the ones described herein could be used for other types of Integrations in order to enable the Syncer to query and/or interact with in other ways.

### Deduplication

According to some embodiments, once Entities from multiple data sources and/or accounts have been, or are, being synced by the Syncer into a database or cache (e.g., a relational database, an SDKS, or otherwise) they may be de-duplicated. Deduplication may be based on a number of configurable parameters and processes.

One embodiment of deduplication is using a unique identifier already existing in the synced data. For example, the APIs of some file storage tools may return a unique MD5 or SHA hash of the contents of files within the metadata of the file. If two of these hashes are equal for files obtained from different data sources or accounts, the files may be the same and can be deduplicated. Likewise, for a user or company syncing data about people using the Syncer, certain APIs might include those persons' social security number. If two people entities from different data sources or accounts have the same social security number, they may be deduplicated. According to some embodiments, these special deduplication fields can be added as a configuration on Nouns so that a deduplication service can query for and deduplicate entities of many different types parametrically.

As described elsewhere herein, sometimes a Cue ID or unique identifier does not exist within the synced data but can be derived by applying some processing, transformation, or calculation on the metadata of synced entities. For example, when syncing files and folders from a variety of data sources as described above, one data source does not include a unique hash of the file contents in their API. If the data does, however, contain the contents of the file as a string, it can be run through a hash calculating algorithm and thus have a unique hash to compare it with other files. Alternatively, if the data does not include the contents of the file as a string, the deduplication process can be configured to use the DOWNLOADFILE Verb to retrieve the contents of the file from the file storage tool's API so that it can calculate a unique hash of its contents. The entire process of downloading the file contents then calculating its hash could be configured into one composite Verb for example called DOWNLOADANDCALCULATEMD5HASH.

As described elsewhere herein, in some cases certain Entity types may require analyses and/or comparisons across multiple fields to find likely duplicates. One method to do this is by using a vector comparison algorithm such as cosine similarity, euclidean distance, or hamming distance. In order to calculate these similarity scores, each entity of a particular Noun type has to have a vector representation created for it, either upon human created features, or using a vector embedding algorithm run over certain fields of the entities. Once vectors are created, statistical algorithm like k-Nearest Neighbor can be applied over the features to find the most likely duplicates. The configuration for the Noun in question may include a field denoting the minimum similarity score for automatic deduplication.

### Ontology

According to some embodiments, the configuration described above used to sync data forms a syncing ontology that can be described via a semantic web language and serialized as an RDF. Thus, a Standard SDK or a SKApp built to sync data may be written in any programming language. Thus, the same sets of configurations can be shared between, and used by, many different users regardless of their syncing “engine”.

### Non-Limiting Use Cases

SKL, like HTTP, may be used for an almost infinite number of use cases. Various alternative non-limiting examples of use cases follow.

### Universal File Browser

According to some embodiments, an application may display to users all their files and folders across integrated applications (e.g., Dropbox®, Google Drive®, OneDrive®, etc.).

For example, according to some embodiments, the application may contain code which uses SKL to recursively request and copy the Metadata of all files and folders within a user's accounts regardless of what service they exist in so that it may display and index them. This application may work with the “File” and “Folder” Nouns, Verbs like “getFilesInFolder,” “Move,” “Copy,” “Download,” and use Mappings that translate between those Verbs and each file storage tool's API.

In some embodiments, the application may also offer options to move and copy files between Integrations or download a file regardless of where it may be stored. Rather than building custom processes that interface directly with each file storage tool's API, the developer may create custom processes (i.e., Verbs) that use other relevant SKL standard Verbs (e.g. “Move,” “Copy,” “Rename”). When the user or developer wants to support an additional integration, all he/she may need to do is add an additional translation/Mapping between the standard Verb and the new Integration. Since these Mappings are configurations and not code, there may be no need to change the programming of or otherwise repackage the universal file browser application in order to support the new Integration. Additionally, since any custom logic and interface is built to work with standard Nouns, the new Integration may be built and deployed in hours rather than weeks.

Since this file browser may be made to represent and interact with the standard “Files” Noun, it may also easily represent other Files that might come from different types of integrated application. In some embodiments, these may include files that might be attached to or referenced in integrated email and messaging tools (e.g., Gmail®, Slack®, etc.) and Files that are attached in project management tools (e.g., Asana®, Monday.com®, etc.).

### Centralizing Customer Information

In yet another embodiment, a marketing team wants to see consolidated profile information about each of their customers but the data is spread across multiple software tools. The team may use SKL to map each software tool's representation of their customers to the standard “Customer” Noun, matching data on known identifiers such as email address, and phone number to create a more complete picture about each customer.

According to some embodiments, the “Customer” Noun entities could be mapped to the “Person” Noun so that other SKL components (e.g., Interfaces, Verbs, etc.) that work with “Person” could automatically work with data that is persisted as type “Customer.” For example, an Interface Component like a profile card that is built to show a Person's name and other basic info in specific places could automatically work with data stored as the “Customer” Noun without anyone having to write code to map the “Customer” directly to the profile card Interface.

### Centralizing Health Information

According to another embodiment, a healthcare patient wants to build up and maintain his/her own consolidated electronic health record (EHR) with data from multiple providers in a simple, secure, and decentralized way. This person may want to: (1) easily compile a comprehensive historical digital record of his/her health at any time, (2) have control of his/her health data, for example by storing it in a dedicated and isolated database in the cloud or on their own device, and having the ability to change storage providers at any time, (3) manage and easily provide or revoke third-party access to data in their personal EHR (e.g., to a provider, family member, pharmaceutical company, etc.), and (4) build and/or leverage a fully-integrated no-code and low-code patient-facing applications and workflows. This may enable the healthcare patient to avoid having to refill similar forms every time he or she visits a doctor or other healthcare provider. It would also empower a provider to offer more holistic healthcare by having a more complete view of the patient's health history.

According to some embodiments, an SKL may work as the glue that connects health-tech services across various providers in order to allow the consolidation of health data. It may enable translations between data (e.g., those defined through the FHIR data standard such as “Patient”) and a variety of platforms. Furthermore, if existing platforms have software integration, data processing, and/or other useful services that a developer/user may want to leverage, then they may be mapped to the corresponding SKL Nouns and Verbs in order to make those services accessible in a modular way. SKL could serve as the dictionary/library of compatible services and components built by a variety of developers.

An ecosystem where every patient has a personally-owned EHR could enable a variety of monetizable services, such as ones that (a) help patients manage payments, insurance claims, prescriptions, etc., (b) run an anonymizing service that compiles health data and sells it to pharmaceutical/research companies, (c) provide privacy-conscious health recommendations (pharmaceuticals, providers, diet, exercise, etc.), (d) offer ML-based services that may be run over patient test results for augmented diagnoses, (e) establish a cross-platform “platform” for personal health devices and wearables to connect to, (f) and more. In various embodiments, these monetizable services could be built using SKL components and logic.

### Centralized Health Data on a Blockchain

According to some embodiments, a person's unified health data could be stored in a variety of different ways, such as in a private database on someone's private device, in SOLID pods, in centralized servers, on a blockchain, and more. If the data is stored on a blockchain, smart contracts could be leveraged such that any given person could choose to share their data with research and pharmaceutical companies in a way that may trigger certain responses, including but not limited to automatic payments, micropayments, notifications, feedback, and suggestions when relevant discoveries are made over that data, and/or other scenarios.

### Unified API for Warehouse Management Systems

According to another embodiment, a company that builds warehouse automation robots wants to integrate with a variety of warehouse management systems. Rather than building a series of one-to-one integrations between their software system and the various warehouse management systems, they may establish or use existing SKL Mappings and map the translations for the various third-party warehouse management systems and the desired Nouns and Verbs (e.g., “Order,” “Product,” “Pick,” etc.).

### Interoperable and Distributed “Metaverse”

According to another embodiment, several different “metaverses” may be offered by a variety of providers. A given user may want to use different metaverses for different purposes, such as to interact with different social groups, for fun vs. work, etc. As the user builds up his or her equity (e.g., his/her avatar's capabilities, acquired items, friends, contact lists, etc.) in each metaverse, he/she may want to avoid vendor lock-in and be able to take his/her friend list, user preferences, etc. to a different metaverse. Given that each metaverse was developed independently by various software providers, the data and capability associated with the user in that metaverse may be represented in proprietary formats. In order to help the user maintain control of his/her data, and to facilitate the sharing of data across metaverses (and other ecosystems and mediums), SKL and its various methods could be used.

For example, basic information about a user, such as contact lists and achievements could be translated to and from proprietary formats into Nouns that the user can control. Moreover, certain items, such as clothing items, hair styles, etc. could also be stored according to Standard Nouns. Mappings could then be used to translate the data to each metaverse's proprietary format whenever the user wants to interact with, through, or in that metaverse. Moreover, in the event that exact translations are not possible (e.g., one metaverse support SWORD items and a second metaverse does not) certain approaches could be used to find approximate matches. For instance, relevance scores (e.g., using machine-learning and/or artificial intelligence models) could be used to find Entities that most closely resemble one another across both metaverses.

### Simplified Privacy and Security Assessments and Certifications

According to some embodiments, developers may build software that is secure and that follows regulatory requirements with minimum effort and cost. SKL may offer pre-certified and tested components of software, like SKDSs, Interface Components, Verbs, and Mappings. These components may be offered as packages, infrastructure, APIs, etc. to other developers/companies as SOC-2 compliant, HIPAA-compliant, GDPR-compliant, CCPA-compliant, able to access Google® restricted scopes, etc.

Due to various embodiments of SKL, developers may use composable software elements that may be “clicked” together like building blocks to facilitate third-party development of custom applications. Developers may also add custom code and components that may be run on third-party infrastructure. SKL may offer a streamlined way of having these third-party developers reach compliance and get any third-party built/run software properly certified (e.g., for Google® restricted scopes) and tested (e.g., pen-tests) by only requiring that their new components be tested. In this way, in some embodiments, SKL may allow these third-party components to reach certification and compliance in a simpler and faster way.

### Contextual Intelligence

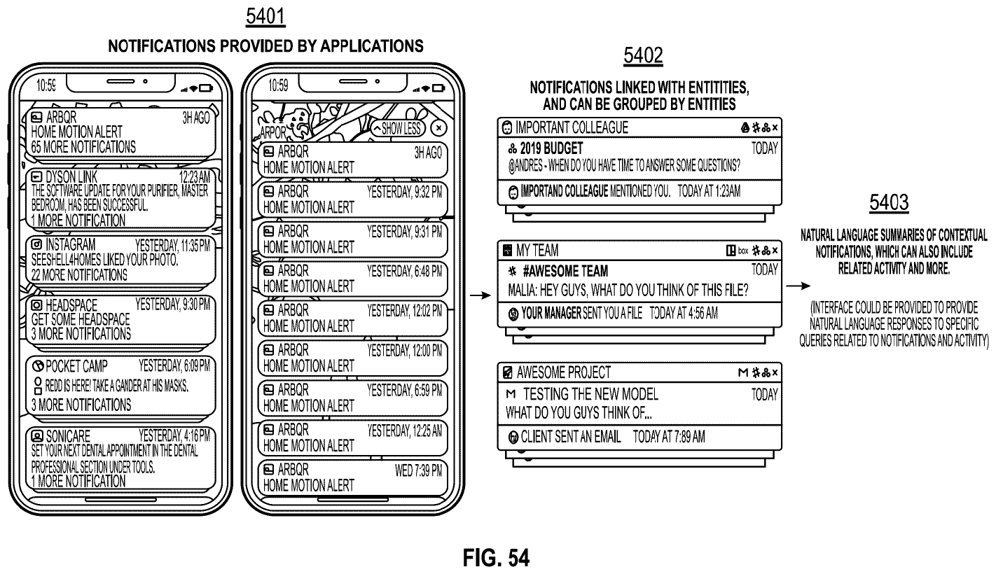

FIG. 54 illustrates a series of steps that a SKApp may take in order to contextualize and then synthesize natural language summaries of notifications from various different data sources, according to an embodiment. At step 5401, various integrations are programmed to provide a user (e.g., an account, a device, etc.) with notifications specifically related to a given application. At step 5402, a SKApp that is configured to accept notifications from the various applications (e.g., Integrations) periodically receives the notifications (and/or events and/or logs representing other users' activity) and generates CueIDs and/or Unique IDs for the incoming activity-related data (e.g., Entities) and/or links them to the relevant Entities in an SKDS. In this way, the SKApp is able to provide the user different ways to interact with activity, to understand what other users (e.g., people, collaborators, automated processes, etc.) are doing and what is new. The user and or the SKApp may determine that certain Entities and or activity are relevant to the user and/or to the user's electronic content and/or electronic context and provide information about the new relevant activity, grouped and ranked according to these determinations. At step 5403, the SKApp may generate natural language summaries of activity and/or notifications that are relevant to a user, to a user's electronic content, and/or to a user's electronic context. In some embodiments, the user may also use alternate interfaces to engage with a SKApp that can synthesize activity and notifications (e.g., via a chat-like interface like FIG. 51, via a smart question-answering interface.

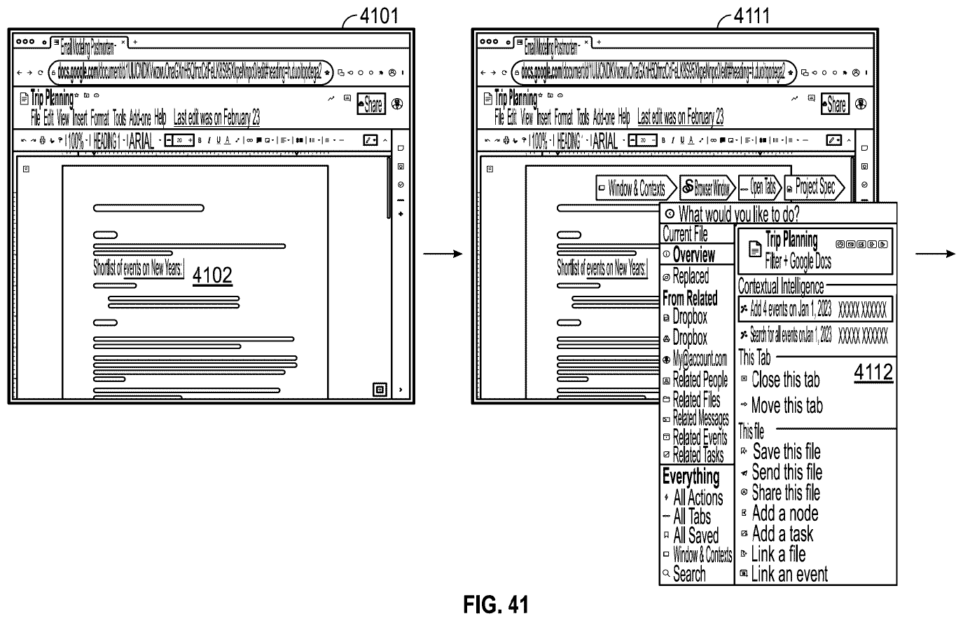

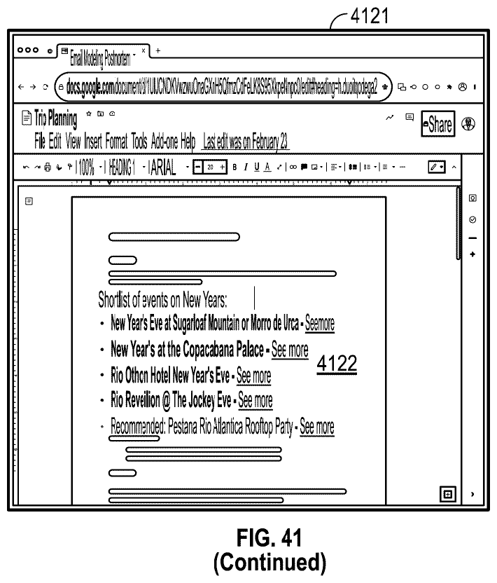

FIG. 41 shows a series of graphical user interfaces where a SKApp may provide contextually useful information and capabilities to an end user based on electronic content and electronic context. In this example, a user is working in a word processing application as shown in the graphical user interface at step 4101. As the user writes certain information that suggests that they are looking for information that may reside in their SKDS the SKApp may determine, with a certain confidence score, that the user might benefit from additional information. If the confidence score is high enough, the SKApp may highlight, or otherwise communicate, the identified opportunity for contextual augmentation. At step 4111, the user may elect to investigate the suggested contextual augmentation by opening Interface Component 4112. Here the interface component 4112 is letting the user know that it has identified four relevant events from their private data sources and information shared with them across Integrations. The Interface Component 4112 may also show other suggestions such as the ability to do a more thorough search including public sources. The user is therefore easily able to get the information they need and even auto-populate the identified Entities as shown at step 4121. At this point, the SKApp can automatically fill in the data corresponding to relevant Entities in one or more SKDSs as well provide links to view more information about those Entities. In some embodiments, the SKApp may also offer other types of capabilities and recommendations such as suggested links to purchase tickets the events.

In some embodiments, the SKApp may also recommend Entities from sources that are not owned by the user (e.g., public sources, company source, shared premium knowledge-bases, etc.). This personalization can help the user discover new information that may be relevant. In some cases, these recommendations can be sponsored advertisements.

FIG. 38 illustrates components of an electronic workflow management system 3800. The electronic workflow management system 3800 may also be referred to herein at the electronic workflow management system. The electronic workflow management system 3800 may include an analytics server 3810, an administrator computing device 3820, user computing devices 3840a-e (collectively user computing devices 3840), electronic data repositories 3850a-d (collectively electronic data repositories 3850), and third-party server 3860. The above-mentioned components may be connected to each other through a network 3830. The examples of the network 3830 may include, but are not limited to, private or public LAN, WLAN, MAN, WAN, and the Internet. The network 3830 may include both wired and wireless communications according to one or more standards and/or via one or more transport mediums.

The communication over the network 3830 may be performed in accordance with various communication protocols such as Transmission Control Protocol and Internet Protocol (TCP/IP), User Datagram Protocol (UDP), and IEEE communication protocols. In one example, the network 3830 may include wireless communications according to Bluetooth specification sets, or another standard or proprietary wireless communication protocol. In another example, the network 3830 may also include communications over a cellular network, including, e.g., a GSM (Global System for Mobile Communications), CDMA (Code Division Multiple Access), EDGE (Enhanced Data for Global Evolution) network.

The electronic workflow management system 3800 is not confined to the components described herein and may include additional or alternate components, not shown for brevity, which are to be considered within the scope of the electronic workflow management system 3800.

The analytics server 3810 may generate and display a graphical user interface (GUI) on each user computing devices 3840 within a network 3880. The analytics server 3810 may also display the GUI on the administrator-computing device 3820. An example of the GUI generated and hosted by the analytics server 3810 may be a web-based application or a website.

The analytics server 3810 may host a website accessible to end-users, where the content presented via the various webpages may be controlled based upon each particular user's role. The analytics server 3810 may be any computing device comprising a processor and non-transitory machine-readable storage capable of executing the various tasks and processes described herein. Non-limiting examples of such computing devices may include workstation computers, laptop computers, server computers, cell phones, and the like. While the electronic workflow management system 3800 includes a single analytics server 3810, in some configurations, the analytics server 3810 may include any number of computing devices operating in a distributed computing environment to achieve the functionalities described herein.

The analytics server 3810 may execute software applications configured to display the GUI (e.g., host a website), which may generate and serve various webpages to each user computing device 3840 and/or the administrator computing device 3820. Different users operating the user computing devices 3840 may use the website to generate, access, and store data (e.g., files) stored on one or more of the electronic data repositories 3850. In some implementations, the analytics server 3810 may be configured to require user authentication based upon a set of user authorization credentials (e.g., username, password, biometrics, cryptographic certificate, and the like). In such implementations, the analytics server 3810 may access a system database 3850d configured to store user credentials, which the analytics server 3810 may be configured to reference in order to determine whether a set of entered credentials (purportedly authenticating the user) match an appropriate set of credentials that identify and authenticate the user.

As described herein a file refers to contained data available to at least one operating system and/or at least one software program. A file may contain data, such as text, video, computer program, audio, and the like. Furthermore, a file can also refer to a path associated with data. For example, a file, as used herein, can refer to a traditional file or folder on a local machine, a shortcut to a file/folder on a different machine, and/or a reference to a file/folder in an email message. Another non-limiting example of a file may include a reference to the location of a file/folder by website URL or file/folder path, a file/folder that only exists online or is not traditionally saved to a local machine's normal file. The path may not be accessible through the main system's file browser (e.g., Google Docs®, Evernote Notes®, and the like) that are not typically accessible through a computer's Windows Explorer or MacOS Finder unless explicitly downloaded to a folder in a different format that might lose either functionality or context such as related content and comments). In some configurations, the analytics server 3810 may provide an application native to the user computing devices 3840 or other electronic devices used by users where users may access the native application using the user computing devices 3840 or any other computing devices (e.g., personal electronic devices) to generate, access, store, or otherwise interact with data stored onto the electronic data repositories 3850. The native application may be any application that is directly in communication with the analytics server 3810. For example, the native application may be a mobile application, cloud-based application, universal GUI, and/or virtual/cloud-based “desktop” where users (upon being authenticated) can access, interact with, and manipulate data stored onto the electronic data repositories 3850.

In some configurations, the analytics server 3810 may generate and host webpages based upon a particular user's role within the electronic workflow management system 3800 (e.g., administrator, employee, or the employer). In such implementations, the user's role may be defined by data fields and input fields in user records stored in the system database 3850d. The analytics server 3810 may authenticate each user and may identify the user's role by executing an access directory protocol (e.g., LDAP). The analytics server 3810 may generate webpage content, access or generate data stored in the electronic data repositories 3850, according to the user's role defined by the user record in the system database 3850d. For instance, a user may be defined as a lower level employee who may not be authorized to view all related content to a particular sensitive file. Therefore, the analytics server 3810 may customize the GUI according to the user's authentication level. Furthermore, the analytics server 3810 may customize the GUI according to a user's role (e.g., function type). For instance, the analytics server 3810 may customize the GUI based on whether a user is a designer or an account manager.

In operation, when instructed by the administrator-computing device 3820 and/or any user-computing device 3840, the analytics server 3810 may execute various scanning and crawling protocols to identify and map data stored onto each electronic data repository 3850. As described herein, the analytics server 3810 may also execute various predetermined protocols to generate unique identifiers for the above-described files/data, identify related files, create a nodal data structure, periodically retrieve (e.g., pull data or collect data that is pushed) the electronic data repositories, update the nodal data structure, and display related files and context information on the above-described GUI. In some implementations, the analytics server 3810 may incorporate the GUI into a third-party application, such as a third-party email application or a file sharing/management application while preserving the “look and feel” of the third-party application.

In some configurations, the analytics server 3810 may compare unique identifiers included in the metadata of each file. For instance, a file may have metadata that includes unique identifiers associated with elements related to the file (e.g., email, tasks, storage location, and the like). In some embodiments, the analytics server 3810 may use these unique identifiers to determine whether the file is related to any other files.

User computing devices 3840 may be any computing device comprising a processor and a non-transitory machine-readable storage medium capable of performing the various tasks and processes described herein. Non-limiting examples of a user-computing device 3840 may be a workstation computer, laptop computer, tablet computer, and server computer. As depicted in FIG. 38, the user computing devices 3840 may each be operated by a user within the network 3880. In a non-limiting example, the network 3880 represents an internal network and/or collection of computing devices connected within an entity. For instance, network 3880 may represent all computing devices operated by all employees of a company. User computing devices 3840 may be internally interconnected via an internal and/or private network of the network 3880 (not shown). For instance, a company's intranet or any other private network may connect all the company's computing devices. In FIG. 38, user-computing devices 3840 are interconnected within the network 3880 (e.g., belong to the same company).

Even though the depicted user computing devices 3840 are within the same network (e.g., network 3880), it is expressly understood that the services provided by the analytics server 3810 may not be limited to computers within the same network. For instance, the analytics server 3810 may scan files accessible to one or more user computing devices that are not interconnected and are not within the same network. In some other embodiments, the analytics server 3810 may only monitor a customized and/or predetermined portion of the computing devices 3840. For instance, the administrator-computing device 3820 may customize a list of user computing device 3840 and their corresponding electronic repository 3850 to be monitored by the analytics server 3810.

Each user computing device 3840 may access one or more electronic data repositories 3850 to access (e.g., view, delete, save, revise, share, send, communicate around, and the like) data stored onto the one or more electronic data repositories 3850. For instance, user-computing device 3840a may access data within a local database 3850a. User computing device 3840b and 3840c may access a shared database 3850b. User computing device 3840d may access a cloud storage 3850c. Furthermore, user-computing device 3840e may access a database operationally managed by the analytics server 3810, such as the system database 3850d. The network 3880 may also include the third-party server 3860 where one or more user computing devices 3840 utilize the third-party server 3860 to access, store, and/or manage data. An example of the third-party server 3860 may be an email server, a third party (or homegrown) electronic file management server, a public website for hosting and sharing specific file types (e.g., YouTube® for videos, Behance® for graphic files, and LinkedIn Slideshare® for presentations), or any other server used to access and/or store data files.

In some configurations, data accessible to the user computing devices 3840 may be stored in a distributed manner onto more than one electronic repositories. For instance, one or more files may be stored onto a blockchain accessible to the user computing devices 3840 where the blockchain comprises multiple distributed nodes storing data onto disparate electronic repositories. The analytics sever 3810 may retrieve a public or private blockchain key associated with each user and/or each user computing device 3840 to access the blockchain and monitor data stored onto the blockchain.

Even though different user computing devices 3840 are depicted as having, access to different electronic data repositories 3850, it is expressly understood that in different embodiments and configurations, one or more user computing devices 3840 may have access to a combination of different electronic repositories 3850. For instance, user-computing device 3840a may utilize the third-party server 3860 and the local database 3850a to store data. In another example, user-computing device 3840c may utilize database 3850b, cloud storage 3850c and the third-party server 3860 to access files/data. For the purpose of brevity, different combinations of different user computing devices 3840 having access to different electronic data repositories 3850 are not shown.

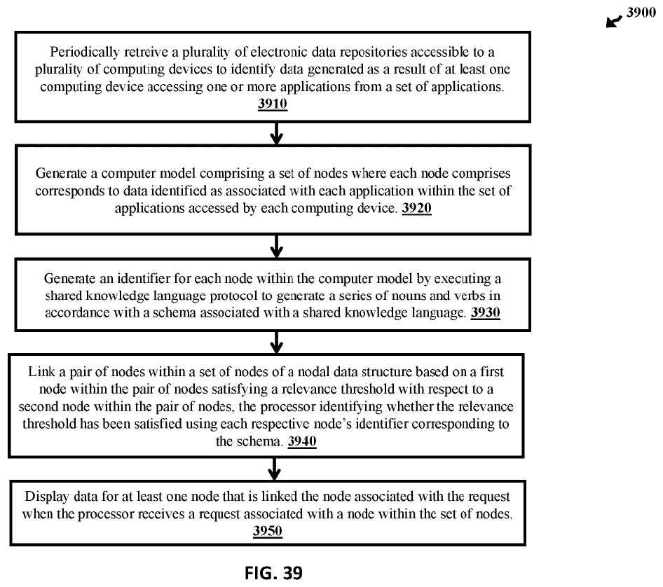

FIG. 39 illustrates a flow diagram of a process executed in an electronic workflow management system, in accordance with an embodiment. The method 3900 includes steps 3910-3970. However, other embodiments may include additional or alternative execution steps, or may omit one or more steps altogether. In addition, the method 3900 is described as being executed by a server, similar to the analytics server described in FIG. 38. However, in some embodiments, steps may be executed by any number of computing devices operating in the distributed computing system described in FIG. 38. One or more user computing devices or an administrator-computing device may, locally perform for instance, part or all the steps described in FIG. 39. Furthermore, even though some aspects of the method 3900 is described in the context of a web-based application, in other configurations, the analytics server may display related data in a mobile application or an application native to the user's desktop.

At step 3910, the analytics server may periodically retrieve a plurality of electronic data repositories accessible to a plurality of computing devices to identify data generated as a result of at least one computing device accessing one or more applications from a set of applications.

The analytics server may require all users to create accounts and grant permission to the analytics server to periodically monitor files accessible to each user and/or computing device operated by each user. In some configurations, the analytics server may provide a web-based application displaying various prompts allowing each user to grant the analytics server permission to periodically monitor all files accessible and/or revised by each user. The web-based application may provide at least five monitoring functionalities: 1) files saved on any electronic data repository accessible by each user; 2) each user's email communication; 3) each user's chat/messaging activity; 4) each user's task management or project management; and 5) each user's calendar events.

During the account registration process, the web-based application may display one or more prompts allowing each user to connect his or her email accounts, messaging tools, task management tools, project management tools, calendars, organizational or knowledge management tools (e.g., Evernote®, Atlassian Confluence®, etc.), other collaborative tools (e.g., Basecamp®, Smartshect®, etc.) and/or electronic repository systems (e.g., local database, cloud storage systems, and the like) to the analytics server. The prompt may also include one or more text input fields where each user can input identification and authentication credentials for his email accounts, messaging tools, electronic repository systems, and/or third party applications, such as project management tool, time tracking applications, billing, issue tracking, web accounts (e.g., YouTube®), online applications (e.g., FIGMA, ONSHAPE, GOOGLE DOCS, and the like). For example, a user may enter his email address and password in the input fields displayed by the analytics server. Upon receipt, the analytics server may use the authentication credentials to remotely login the above-described portals and monitor all files accessible and/or revised by each user and/or all files saved on the electronic data repositories.

Upon receiving permission and/or authorization from users, the analytics server may retrieve data from the one or more electronic data repositories accessible to each user. The analytics server may execute a scanning or crawling protocol where the analytics server crawls different databases to identify all files accessible to each user.

As discussed above, an electronic repository may represent any electronic repository storing files that are accessible to one or more computers within an entity or a network. Non-limiting examples of an electronic repository may include a database, cloud storage system, third-party shared drives, third-party application as described above, internal file transfer protocol (FTP), and internal or external database operated by the analytics server, email storage, HR systems, accounting systems, customer relationship management (CRM) systems, and the like.

The analytics server may, upon receiving permission from one or more computing devices periodically scan the above-described electronic repositories and identify one or more files stored onto these electronic repositories. For instance, an administrator of an entity may grant permission to the analytics server to retrieve data (e.g., scan all repositories accessible to all computers within the entity).

Upon identification of each file, the analytics server may search data associated with the identified files and may re-create an activity timeline for each user. The activity timeline may present historical data associated with each file and each user. For instance, when the analytics server identifies a file (e.g., Sample.doc), the analytics server may further identify a history of Sample.doc by analyzing said file's history (e.g., revision, communication, and access history of the file). As a result, the analytics server may create a timeline that indicates every interaction (e.g., file generation, revisions, modification, and the like) with Sample.doc.

In some configurations, the analytics server may retrieve the file history and other related data (e.g., context data) using an application programming (API) interface in communication with the electronic data repositories. For instance, the analytics server may be prohibited from accessing a third-party shared drive. In those embodiments, the analytics server may use an API configured to communicate with the third party shared drive to identify and monitor files. The analytics server may further use a similar protocol to determine whether a file has been revised/modified. For instance, the analytics server may cause an API to connect/sync with a third-party document sharing application. The analytics server may also cause the API to transmit a notification for each instance that a file, stored on the third-party document sharing application, is accessed and/or revised by a user.

In some configurations, third-party service providers of shared document drives may not allow the API to transfer detailed data regarding file revisions. For instance, third-party service providers may only transmit a notification that a file has been accessed and/or revised by a user. However, the API notification may not contain the revision (e.g., change of text, formatting, and the like) to the file. In those embodiments, the analytics server may remotely access the shared drive, using credentials obtained from the user during the account registration process, obtain a copy of the file, and compare the file to a previous version.

The analytics server may also include the API notification in the metadata profile of each identified file. For instance, the analytics server may receive an API notification that a first user has shared File X with a second user on a third-party document sharing application. The API notification may not include any specific data regarding the content of File X because the analytics server may be prohibited from retrieving a copy of File X. The analytics server may include the document sharing activity in the metadata of File X (within the nodal data structure described herein), which may include a timestamp of the document share and data associated with the first user and the second user. As a result, the analytics server may reconstruct an activity timeline for File X that includes information on how File X was shared (e.g., medium and timestamp) and different users who interacted with File X.

In another example, user 1 may share File X with user 2 using a third-party file management application. Using an API connect to the third-party file management application, the analytics server may receive a notification that File X was shared between two users at a certain time. The API notification may not include user identifiers and may not identify the sender or the receiver of File X. The third-party file management application may also notify user 1 and/or user 2 regarding the file sharing. For instance, the third-party file management application may send an email to user 2 informing user 2 that user 1 has shared File X with user 2. The email may also include an identifier associated with File X (e.g., URL of File X). Because the analytics server has access to emails of user 1 and user 2, the analytics server can identify that user 1 has shared File X with user 2. The analytics server may then include the file path, timestamp of the email, and timestamp of the file share, in the File X's metadata file. In some configurations, the analytics server may create a node for the email and/or the file path (e.g., URL) included in the email.

At step 3920, the analytics server may generate a computer model comprising a set of nodes where each node comprises corresponds to data identified as associated with each application within the set of applications accessed by each computing device. Each node may represent a vector that includes various information discussed herein.

The analytics server may create a computer model comprising a nodal data structure (or data graph) where each node represents an identified file. The analytics server may store the nodal data structure in the system database (or any other electronic data repository, such as a cloud bases storage, local/internal data storage, distributed storage, blockchain, and the like) described in FIG. 38.

The nodal data structure may be a complete map of all the files identified in step 3910. Each node may also contain metadata further comprising historical (e.g., context) data associated with the file, such as the generated unique identifier of the file, title, mime type, file permissions, comments, and the like. The metadata may also indicate a revision history associated with each file. For instance, the metadata may include timestamp of every revision for each file, a unique identifier (e.g., user ID, IP address, MAC address and the like) of the user and/or the computing device who accessed and/or revised the file, and the like. Other context data may include, but not limited to, email identifiers (e.g., unique email identifiers, sender identifier, receiver identifier, and the like), tasks associated with the files, user identifiers, mime type, collaboration information, viewing permission, title of each file, and the like.

The metadata may also include context information associated with each file. For instance, the metadata may include email/chat communication that are related to each file. In another example, if the analytics server determines that a file has been transmitted via an email or other electronic communication protocols (e.g., referenced or attached in an email message, referenced in a chat session, and the like), the analytics server may include a transcript of the electronic communication (e.g., body of the email) in the node, as metadata. The analytics server may index each node based on its associated metadata and make each node searchable based on its metadata.

The analytics server may compare the unique identifiers for of all the files identified in step 3910. When the unique identifiers of two or more files match, the analytics server may link the nodes representing the two or more files in the above-described nodal data structure. A link (or edge) may connect similar or associated nodes within a nodal data structure such that the analytics server may retrieve context metadata more efficiently. Edges can be directed, meaning they point from one node to the next, or undirected, in which case they are bidirectional. The analytics server may use different directed or undirected edges to link different nodes. Edges between nodes can be given special classifications, including but not limited to “copy,” “version,” “parent,” “child,” “derivative,” “shared email,” “shared task,” “shared tag,” and “shared folder.” The analytics server may also combine relevant metadata from related files and display to the client (e.g., files A and B are copies of each other, and file B is attached in an email message. When user previews file A, the email message for file B can be displayed). As described herein, the analytics server may use the links to identify a latest version of a related family of files.

Referring now to FIG. 40, nodal data structure 4000 represent a nodal structure created based a set of identified files and related nodes connected via different edges. As depicted in FIG. 40, the analytics server identifies 17 files and creates a node for each file (nodes 4010a-i and nodes 4020). For instance, node 4010b represent a pdf file stored locally on a computer of an entity (e.g., computer within a network of computers); node 4010h may be a PowerPoint Open XML file stored on a cloud storage accessible to another computer within the same network. As described above, each node may include an indication of a location where the file is stored. For instance, node 4010e may represent a DOCX file stored in a local database. Therefore, node 4010e may include metadata comprising a path of the DOCX file to the local database. Additionally, as described above, multiple nodes may be linked together. For instance, links 4030a-h connect nodes 4010a-i that represent related files. Furthermore, because the analytics server identifies that nodes 4020 are not related, the analytics server does not link nodes 4020, as depicted in FIG. 40. As described above, a “file” may also refer to a path associated with data. For instance, a file may refer to the underlying data regardless of where the data is stored and/or hosted or the application needed to view the data. For instance, a file may include a link (directing a user to view the underlying file). The file may only exist as on online file and may only be accessible through an internet browser or mobile application, and in some cases, it may not be able to be downloaded to a local machine without some type of conversion (e.g., Google Docs® or Google Slides® only exist online, but can be downloaded as DOCX or PPTX).

A path may specify a unique location of a file within a file system or an electronic data repository. In some configurations, a path may point to a file system location by following the directory tree hierarchy expressed in a string of characters in which each component of the string, separated by a delimiting character, represents a directory. In some configurations, the analytics server may use a uniform resource locator (URL) to identify each file's stored location. For instance, when a file is stored onto a cloud storage or when a file is stored onto a third-party shared drive, the analytics server may include a URL of the file in the nodal data structure.

In some configurations, and as described above, the nodal structure may not include the identified files and may only comprise nodes representing file locations (and other metadata) and edges representing how different files are related. For instance, instead of storing multiple files (and possibly multiple version of the same file and/or related files) the analytics server may only store the nodal data structure in a local or external database. In this way, the analytics server may conserve significant storage space because storing a representation of a file requires significantly less storage capacity than storing the file itself. Furthermore, as described herein, identifying relationships (and executing various protocols to identify context, relationship or other related data for each file) is much less computationally intensive when performed on the above-described nodal data structure than executing the same protocols on the files themselves. In this way, the analytics server may conserve significant computing and processing power needed to provide file management services. As a result, the analytics may deliver results in a faster and more efficient manner than provided by conventional and existing file management methods.

As depicted, the nodal data structure 4000 may include all data associated with users' workflow. For instance, the wild the nodes described above represent different files, nodes 4040a-e may represent workflow components generated because of users' work. For instance, the node 4040a corresponds to organization chart generated based on customer relationship management (CRM) software solution (internal or third party solution). The node 4040b may correspond to new employees hired where the data is generated based on an applicant tracking system software solution (internal or third party solution).

The node 4040c may correspond to one or more tasks associated with one or more employees. For instance, an organization may use an internal or third party software solution to help employees execute various tasks efficiently. The analytics server may identify the tasks I may generate a node for each task. Accordingly, the analytics server may identify that one or more tasks may be related to one or more files and/or work components within the nodal data structure 4000.

The node 4040d may correspond to a contact within a contact list of an employee/user. The analytics server may scan various software solutions (internal and/or external) and may identify contacts associated with each user/employee. The analytics server may then generate a node for each contact accordingly. As described herein, the analytics server may then identify that a contact is related to another node that may represent a file and/or a workflow component within an organization. The node 4040e respond to one or more messages generated and transmitted among users, such as emails or any other messages (chat applications).

As depicted, the analytics server may not differentiate between files stored on data repositories accessible to one or more users and workflow components generated/accessible to the users. The analytics server may execute various analytical protocols described herein to identify related nodes and may use edges to link or merge the related nodes. For instance, the analytics server may use edges 4050a-c to connect related work component nodes. The analytics server may also use age 4060 two connect node 4040c (workflow component) to the node 4010d, and indirectly connect node 4040d to nodes 4010a, 4010b, 4010e, 4010c, 4010h, and 4010i.

Referring back to FIG. 39, the analytics server may periodically retrieve the plurality of electronic data repositories, to monitor updated data associated with users and their activities. The analytics server may periodically retrieve data (e.g., scan the electronic repository as discussed herein). In some configurations, the frequency of data retrieval may be predetermined or may be adjusted by an administrator in accordance with an entity's needs. For instance, an administrator may require the analytics server to scan the electronic data repositories every week, day, or multiple times per day depending on their unique needs and data sensitivity.

In some configurations, the analytics server may only retrieve data from the electronic data repositories in response to receiving a notification or a trigger from another server, such as an email message, a third party API or a data management server operationally in communication with a data repository. The analytics server may use application-programming interfaces and/or web hooks to achieve the above-described results. For instance, as described above, the analytics server may utilize various APIs to monitor the identified files. Therefore, the analytics server may receive a notification, from an API, that a file has been revised. In some embodiments, the API may transmit details of the revisions (e.g., user name, timestamp, and the like). In some other embodiments, the API may not be configured or authorized to transmit such detailed data. In those embodiments, in response to receiving the notification from the API indicating that a file has been revised, the analytics server may further scan the electronic repository (or other repositories, such as email, third-party applications, and other repositories) on which the file is stored. As a result, the analytics server may retrieve revision details associated with the revised file.

At step 3930, the analytics server may generate an identifier for each node within the computer model by executing a shared knowledge language protocol to generate a series of nouns and verbs.

As discussed herein, the computer model may include a set of nodes and each node may include data generated as a result of each user's interactions with different applications or any other activities conducted by the users. For instance, a node may correspond to any action (or a series of actions) performed by one or more.

As discussed herein, data corresponding to user activities may be transformed using schemas discussed herein, such that the data is made into a uniform and common (e.g., SKL). In order to do so, the analytics server may perform various methodologies discussed herein to generate nouns and verbs from actions performed by users (e.g., data corresponding to different nodes). As a result, each node may include (e.g., as metadata) an SKL that is common among all nodes. Accordingly, activities conducted by a user may be transformed, such that the transformed data does not depend upon the user, application, and/or the source of the application. Therefore, the transformed data may be uniform and only focus on the underlying activity (e.g., regardless of which application was accessed, which user accessed the application, which platform was used, or which electronic data repository/source was accessed). This data, application, source agnostic approach allows activity across different applications platforms to be unified, such that the data for different nodes can be compared against each other. For instance, activities corresponding to a first node related to accessing a spreadsheet can be compared with a second node related to a social media platform browsing history.

At step 3940, the analytics server may link a pair of nodes within a set of nodes of a nodal data structure based on a first node within the pair of nodes satisfying a relevance threshold with respect to a second node within the pair of nodes, the processor identifying whether the relevance threshold has been satisfied using each respective node's identifier.

The analytics server may, for each instance of the server detecting a related file to the first file, merge the first node where the merged first node corresponds to a context data of related files (e.g., storage location and a timestamp of the related file to the first file and context data of the first file). In response to identifying a revision or a modification to a file, the analytics server may revise the nodal data structure accordingly. For instance, as described above, the analytics server may identify that a file has been revised or modified by a user within the network. The analytics server may then update the metadata associated with the node and the respective edge representing the revised file with revision/modification data. For instance, the analytics server may update the node metadata with a user identifier, timestamp, content of the revision, and other historical data. When the analytics server identifies a revision of the file, the revised file is no longer a “copy” of the original file. Therefore, the analytics server updates the metadata of the revised file from “copy” of the original file to a “version” of the original file.

In some configurations, the analytics server identifies related files based on their context data stored onto one or more nodes representing each respective file. For instance, in some embodiments, the analytics server may update or revise the nodal data structure by generating new nodes and/or edges. For instance, when the analytics server discovers that a user has attached a file in an email communication, the analytics server may generate a node that represents the email communication. The analytics server may then update the node's metadata with information associated with the email communication (e.g., timestamp, email body, email address, sender user identification, receiver's user identification, and other context data described herein).

In some configurations, if the email communication includes other files or web links, the analytics server may create individual nodes for other related files. For instance, and referring to FIG. 40, node 4010d represents email communication between two users where one user attached a pdf file represented by node 4010b. Furthermore, in the email represented by node 4010d, the user also attached a document represented by node 4010e. As depicted in nodal data structure 4000, the analytics server may also link the above-described nodes using edges 4030b and 4030e. As a result, the analytics server may continuously and iteratively update the nodal data structure. Therefore, the nodal data structure is a dynamic computer model, which adapts to user interactions.

In some configurations, the analytics server may combine metadata from multiple related nodes into a single metadata file. Instead of each node having a separate metadata file, the analytic server may create a single metadata file associated with a file where the metadata file contains all metadata associated with all (or a given subset of) related nodes. For instance, if File A is related to Files B-F, the analytics server may create a single metadata file and combine metadata associated with Files A-F. Upon identifying additional related files (or other related data, such as tasks, messages, and the like), the analytics server may update the metadata file accordingly.

In some configurations, the analytics server may augment the metadata file using public data. For instance, in addition to retrieving data from the electronic repositories described herein, the analytics server may also retrieve data from publicly accessible repositories (e.g., public websites or other publicly accessible data). When the analytics server identifies a public file related to an identified file, the analytics server may augment the identified file's metadata file. For instance, the analytics server may identify a video file stored locally onto a user's computer. The analytics data may then determine that the identified video is similar to a video publicly shared on a website (e.g., YouTube®). Consequently, the analytics server may augment the identified video's metadata file using data associated with the publicly share video (e.g., URL of the video).

As described above, the analytics server may use two methods to merge two nodes where the two nodes represent two related files (e.g., copies of the same file, and/or files that have been determined to be related). First, the analytics server may create a new node for the newly discovered related file and may link the nodes together. Second, the analytics server may combine the metadata of the newly discovered file with the original file (e.g., create a single metadata file and combine all metadata corresponding to context information of the related file to the original file). The analytics server may also use one or both of the above-described methods when merging two nodes.

At step 3950, the analytics server may display data for at least one node that is linked the node associated with the request when the processor receives a request associated with a node within the set of nodes.

Upon retrieving the identified node, the analytics server may retrieve all related nodes and metadata associated with the identified nodes and/or the related nodes within the nodal data structure. The analytics server may analyze the metadata retrieved and identify all related files (including a latest version of the requested file). For instance, the analytics server may retrieve all timestamps for all nodes related to a node representing the requested file. The analytics server may then compare all timestamps to identify the latest version of the requested file. The analytics server may also identify relationships between files by determining relationships between different nodes representing those files. These relationships (identified related nodes) may be displayed on the GUI viewed by the user. For instance, when a user accesses a file, the analytics server may identify the original file, different copies, versions, derivative, shared tasks, shared comments, shared emails, shared tags, and shared folders that are associated with the file.

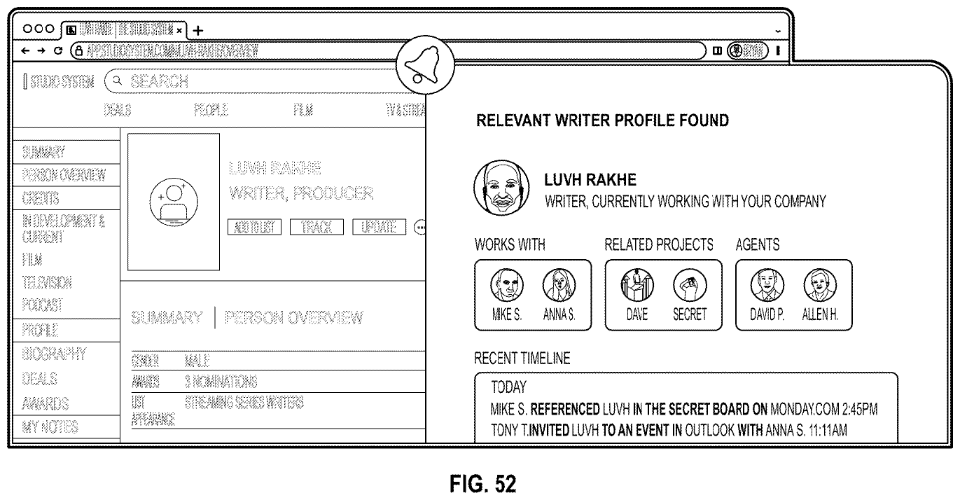

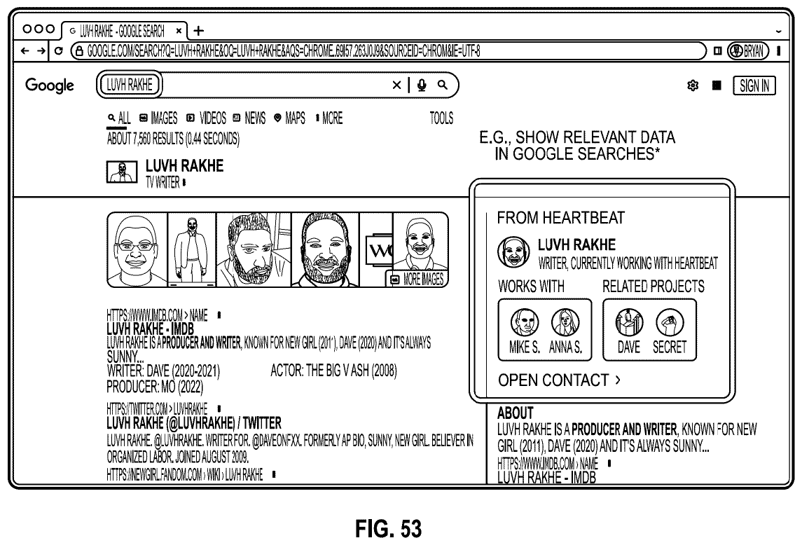

In some embodiments, such as depicted in FIGS. 52-53, the relevant data may be displayed on a web browser while the web browser is directed towards an electronic search page.

For instance, as depicted, a user may search for Luvh Rakhe in a search engine. In addition to displaying the search results (provide by the search engine), the analytics server may display a prompt (e.g., pop-up window) that displays data retrieved from the nodal data structure.

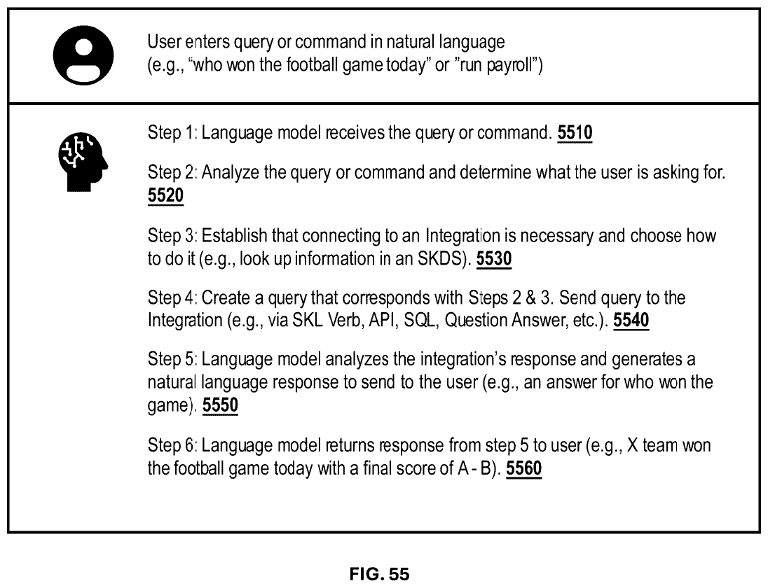

In some other embodiments, artificial intelligence systems like a large language model may facilitate the interaction with systems and data by using SKL Schemas. For instance, FIG. 55 illustrates a detailed process flow for handling natural language queries or commands using a language model integrated with a schema-driven semantic mesh. The process begins when a user inputs a query or command in natural language, such as “who won the football game today” or “run payroll”.

In Step 5510, the language model receives this input. Step 5520 involves the model analyzing the query or command to determine the user's intent. This analysis may include parsing the input, identifying key entities and actions, contextualizing the request (e.g., with the conversation history, the user's history or preferences, electronic content and/or context, etc.), and the like.

In Step 5530, the language model determines whether there is a need for external data as well as selects the appropriate method to retrieve it (e.g., querying an SKDS, interacting with API through a Verb or other integration interface Schema). The language model has the ability to interface with various data sources through the analytics server and the schema-driven semantic mesh.

In Step 5540, the language model formulates a query based on its analysis and the chosen data retrieval method. This query is then sent to the appropriate Integration, which could be via an SKL Verb, API call, SQL query, or other methods.

In Step 5550, the language model processes the response from the Integration. It analyzes the retrieved data and formulates a natural language response that addresses the user's original query or command. In Step 5560, this response is returned to the user in a natural, conversational format.

Using the methods and systems described herein, data collected can be transformed using various methods discussed herein (e.g., schemas of SKLs). Using the SKLs, various nodes within the nodal data structure can be analyzed and relevant nodes can be linked. Using the SKLs, various linked or similar nodes can be identified and de-duplicated a well.

SKL Schemas can also be used to configure various APIs. For instance, an API can be configured using SKL Schemas and transmit data to one or more processors, such as the analytics server. In some embodiments, an API (e.g., third party API) may be mapped to generate data according to SKL Schemas instead its own third-party proprietary data structures. The analytics server may also generate (e.g., using a language model) SKL Schemas and components from data traditionally provided third-party APIs such as documentation, SDKs, and OpenAPI schemas. In another example, a third-party API may be hosted by the analytics server.

In yet another example, the analytics sever, Standard SDK, and/or some other tool can measure the usage of and provide varying level of tracing for certain components and systems (e.g., API endpoints, user interface components, etc.) through the interactions of various systems with the schemas that represent those components. Similarly, requiring that access to systems and applications go through schemas, users and organization can more effectively manage their security and compliance needs across systems. For instance, users can create policies (e.g., access control lists or ACLs, role based access controls or RBAC, attribute based access controls or ABAC) and relate them to Nouns, Verbs, User Interfaces, Properties, etc. such that the analytics server, an SKDS, Standard SDKs, etc. always validate access controls and permissions as part of every call. In this way, users and organizations can establish and manage zero-trust ecosystems using schemas-driven ecosystems.

The methods and systems described herein can also allow a processor to generate abstractions of SKL Schemas and/or Entities conforming to those Schemas that correspond to an event or a series of events. For instance, after collecting raw data that corresponds to a user's interaction with an application, or notifications that correspond to activity from other users, the analytics server may transform the data into a activity events according to an SKL Schema. The analytics server may then generate a semantic summary of one or more users' activity.

The methods and systems described herein can also allow a processor to identify and/or generate relevant SKL Schemas from and/or with the aid of external data sources such as one or more SKL Libraries. For instance, an application may be able to identify, access, download, and/or install Schemas from an SKL Library in order to support an integration with a given application. In some cases, the application may identity and use these Schemas automatically and/or semi-automatically. The application may also upload Schemas and artifacts to the SKL Library in an automated and/or semi-automated way. In another example, a user of an SKL Library, such as a developer or an application, may provide certain parameters, such as certain integrations, nouns, verbs, interface, etc. of interest, to the Library or Libraries in order to get a packaged set of Schemas back from the Library or Libraries that best match the capabilities that the user specified. In other words, the user can specify what types of data (Noun) they want to work with, what integrations they would like to connect to, what types of interfaces they want to use to represent the data, and then the Library can find the best Schemas and provide them to the user in a clean package. The user may also provide the Library with certain requirements in natural language and the Library or Libraries may use the requirements to identify and return the best Schemas and SKL components. In some cases, the Library may also generate new Schemas to meet the requirements using certain methods, such as a large language model trained with SKL Schemas.

As illustrated in FIG. 41, the methods described herein can also be used to provide users of SKApps with recommendations/marketing/advertising for other cases not related to components of SKL Libraries. For example, a user could opt-in to see advertisements when certain conditions are met with electronic content and/or context. In other words, if a user is working in a document and interacting with a certain data type such as LIVEEVENTS, CONSUMERPRODUCTS, SOFTWARE the user may determine that they want a processor/application to provide them additional recommendations and/or advertisements that are relevant to what they are doing. For example, if a user is writing a shortlist of potential vacation ideas, an SKApp could provide them with privacy-conscious recommendations or sponsored recommendations that are contextually aware and relevant to the other ideas that the user is writing. In some cases, one or more recommendation SKApps could get anonymized data related to the users' electronic content and/or context in order to find similar Entities from external sources which could be mapped to relevant Nouns in the SKL Library.

The methods described herein can be used to provide users recommendations/marketing/advertising of Verbs/Interfaces/other components rather than whole applications. In other words, today, users may be commonly served advertisements and/or recommendations for a given app in an mobile app store. Using the methods described herein, users could be provided with recommendations and/or advertisements related to a given type for a modular and composable software component (e.g., user interface, capability, etc.). For instance, when a user is looking at engaging with an email to purchase an AI-powered text processing solution, the analytics server could recommend one or more components to the user that offer similar capabilities. For instance, the analytics server could offer the user existing SKApps or specific components (e.g., a SUMMARIZETEXT Verb) in their organization's SKDS that they could use independently. The analytics server could similarly and alternatively offer the user relevant components (including Nouns/data types, Verbs/capabilities, user interfaces, compliance policies, etc.) that would allow the user to easily “compose” a new SKApp to match his or her exact requirements. This composition could be facilitated with AI-augmented tools and processes, such as intelligent copilots and conversational interfaces, as described herein.

The methods described herein can be used to provide financial incentives to contributors of Schemas, Mappings, and other SKL components that can then be used by end-users of SKApps. For instance, a user paying the provider of a software capability such as text summarization through an SKL SUMMARIZETEXT Verb can contribute a fee (e.g., a processing fee and a Mappings fee) to the SKL Library and to the user or users of the Library that contributed the Schemas necessary to offer and/or support that capability through SKL.

In some implementations, the SKL systems and methods described herein may be implemented into a computing infrastructure that includes one or more artificial intelligence (“AI”) and/or machine-learning models/architectures for processing a natural language user query received by a user device, generating a unique data query to be executed in a database of abstracted data, reviewing results from the executed data query, and the like. An analytics server executing a machine-learning model (referred to herein as a Personalized Response Engine (“PRE”)) may utilize the schema-based SKL components described herein to generate one or more personalized elements (e.g., responses) to present to the user based on the original user query and/or any follow-up modifications to the user query from the user. For example, various embodiments exist in which the PRE may access the SKL framework to retrieve personalized data and provide personalized responses to user queries. In at least one non-limiting embodiment, the PRE may be used in the context of a destination management organization (“DMO”) to provide personalized recommendations to users through a graphical user interface embedded within the DMO platform (e.g., website). In some embodiments, the personalized recommendations are in response to users' queries regarding events/locations related to the DMO. For ease of understanding and description, the methods and systems of the PRE are described herein in the context of a DMO, however, it is understood that the functionalities of the PRE described herein may be extended to be applied in various contexts outside of a DMO.

The PRE is implemented in a computing infrastructure and may receive inputs of a user query in natural language syntax, process the natural language syntax queries by parsing the the query into one or more search elements, automatically generate one or more search parameters to include in a data query to execute in an SKL information database, determine relevant nodes within the database that are linked to the user and correspond to the various generated search parameters, and/or present the relevant nodes in natural language syntax to the user, such as through a graphical user interface.

The PRE may be implemented in at least two embodiments, though the PRE may be implemented in fewer or more embodiments without detracting from the scope of the descriptions herein. In a first embodiment, the PRE may be a virtual assistant with whom a user can converse in natural language syntax through text or audio input into a user device associated with the user. For example, the user may converse with the PRE when implemented as a chatbot on a website or other graphical interface and presented on the user device. In some embodiments, the user device may converse with the PRE vocally. In such implementations, the PRE may be communicably coupled to a microphone or other auditory sensor to receive auditory signals. The user may pass to the PRE relevant data associated with an upcoming trip or plans, such as anticipated time frame, favorite activities, favorite foods, weather, driving times, etc. When the user device passes a user query to the PRE, the PRE can access this previously passed data to generate customized data queries. For example, the user device may pass information in natural language syntax about an upcoming user trip, including the dates of the trip and the location. The user device then passes the query, “Are there good Italian restaurants?” Without context, the user query is overly broad. However, with the previous context of the date and location of the user's upcoming trip, the PRE is able to generate one or more data queries to the SKL Platform based on the user's query, but narrowed by the previous context. In some embodiments, the previous context is stored within the user's personal nodal data structure (e.g., SKDS).

In a second non-limiting embodiment, the PRE may generate a browsable list (e.g., a list of things to do at a location) shown as cards, on a map, and/or in a timeline. The list may either comprise of results related to a person's conversation with the PRE and/or personalized recommendations based on contexts derived from the user profile and/or device. For example, the user device may access an aquarium website in which the PRE is embedded. Without a prompt from the user, the PRE may present dynamically updated information about the aquarium (and/or nearby venues/events) in one or more cards displayed on the website. For example, the user device accessing the website may be associated with a user with three children. Further, the user may have a home address in the proximity of the aquarium. This data is stored in the user's nodal data structure and accessed by the PRE in response to receiving an indication of the user device accessing the aquarium's website. The PRE determines, based at least on the user's address and relation to the three children (as determined by the nodal links in the nodal data structure), that the user may be interested in a family season pass to the aquarium. The PRE presents a dynamically updated card with information related to an aquarium family pass. The dynamically updated card may include a URI (e.g., a URL link) to purchase the family pass, as well as integrated capabilities/verbs (e.g., “purchaseTicket”) that allow the analytics server and conversational agent to facilitate the purchasing of family pass using the information from the user's personal nodal data structure.

These two embodiments (e.g., responding to user-specific queries and providing unprompted curated data) may be implemented separately or in combination within a computing platform to aid the user in deciding what to do, visit, and experience at their destination, and/or share with friends.

In alternate similar embodiments (e.g., responding to user-specific queries and providing unprompted curated data), users might use users might be searching for prescriptions, medical procedures, consumer goods, software packages, files, customer information, and other types of data.

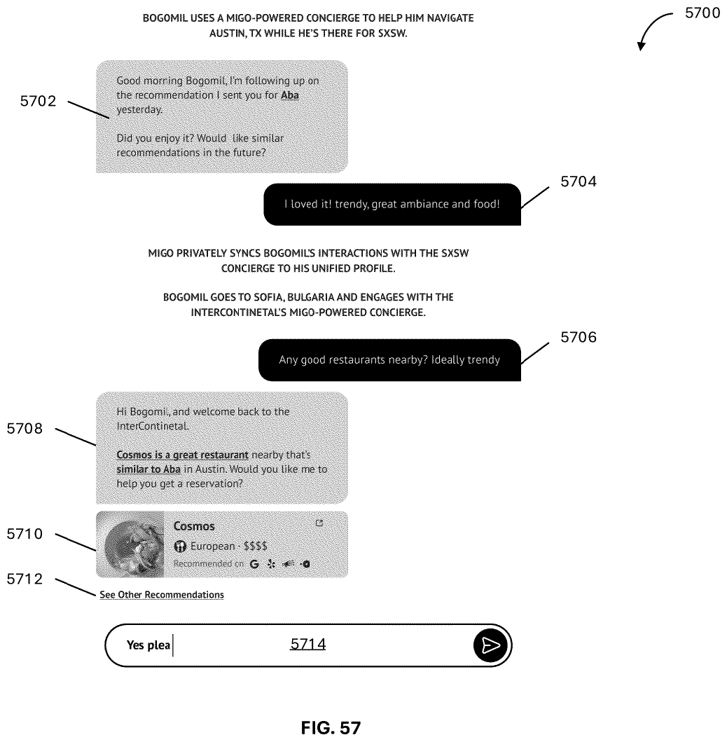

In the non-limiting DMO embodiment, the PRE may be implemented in a dedicated PRE website to curate user-specific content based on data within the SKL platform, such as shown generally in FIGS. 57-70. To curate user-specific content, the PRE may have access permission to one or more knowledge graphs (e.g., nodal data structure). For example, the PRE may have access to a unified nodal data structure comprising of information and links from first- and/or third-party content and data sources. This unified nodal data structure may form the destination's “single source of truth.” The unified nodal data structure may be a schema-driven semantic mesh (i.e., SKDS) in some embodiments.

The unified nodal data structure may dynamically change over time as new data is provided from the first- and/or third-parties. On top of the unified nodal data structure, the PRE has the ability to configure specialized indexing and APIs based on the SKL framework to access additional information within and without the unified nodal data structure. The PRE may be configured with recommendation APIs, with personalized results of things to do for each individual user of the PRE, as well as any other applications the destination, or their members/partners (to whom they supply the API), may build. As described herein, and in at least one non-limiting embodiment, the PRE may include a chatbot that functions as a website's “virtual assistant.” Though the PRE is executed as the website's virtual assistant, it may also be used to configure additional chatbots for other applications and/or websites. The PRE virtual assistant may also be configured to be integrated into other interfaces such as third-party apps and websites (e.g., iOS® Apps, Metaverse experiences, the SKL Platform configuration pages, etc.), text, and WhatsApp®. In addition to the general SKL Platform interface for configuration, exploration, and/or syncing of unified nodal data structures, the PRE may also have access to a specialized data management interface tailored to editing, organizing, and/or curating specific types of data such as events, venues, restaurants, and other attractions. Beyond the context of DMOs, a dedicated PRE platform may be used to edit, organize, and/or curate any type of data found in the SKL platform, including any Nouns and/or Verbs, as described herein.

In some embodiments, the PRE platform may be executed on a separate Standard Storage Cloud Service account, graph, and API per implementation. In some embodiments, each implementation may have its own set of SKL Schemas and syncing configuration to sync data from databases internal to the hosting platform (e.g., the DMO), as well as third-party sources (e.g., venues, ticket websites, etc.). The Standard Storage Cloud Service account includes a vector database to index data for semantic queries and recommendations. User account and usage data may either be stored in the unified nodal data structure or a separate database, such as PostgreSQL, for each implementation.

The PRE chatbot may be hosted on a server, which may be the same as or separate from the Standard Knowledge Cloud Service Server. The server hosting the PRE chatbot exposes a web-socket endpoint to which clients can connect in order to begin a conversation, for example, in a dedicated website or messaging application, such as shown in FIG. 57 and described below. In at least some embodiments, the PRE chatbot stores previous response history in a database and re-loads it into the chatbot prompt whenever a new connection is made for an account, thus allowing continuity between chat sessions. To do so, the chatbot server may have access to the database storing user accounts.

According to a non-limiting embodiment, the front-end of the PRE platform may be a single-page React application that uses the API of the nodal data structure to retrieve content, configurations, and/or recommendations for the browsing view and update the Graph with information about users and their browsing history. It can also use a chatbot server API to send and receive messages for the virtual assistant and save conversation history. The PRE website can be served on one or more domains, for example, as a subdomain of a client website as a white-label solution.

According to another non-limiting embodiment, the front end could be a React application that uses the API of a Standard Knowledge Graph (i.e., the nodal data structure) to retrieve and/or update data from various Integrations and to update data entities that users edit. Various components of the PRE front end (e.g., virtual assistant, map, etc.) may be included as components on third-party websites. For example, the PRE front end may be included in a third-party website as an HTML component using an <iframe> tag to embed the PRE front end directly into the website.

Turning to FIG. 57, a PRE front-end implementation (e.g., a chatbot 5700) is shown. As described, the PRE chatbot of FIG. 57 may be integrated into a third-party website, such as a DMO website, or it may be integrated with an messaging service (e.g., iMessage or WhatsApp via Twillio) and accessed via third-party messaging application. As described herein in the context of the SKL Platform, a user's interactions with applications and data across a computing environment are collected and stored as Nouns and Verbs in a unified user profile, referred to herein as the user's nodal data structure. The collected data may be stored in a nodal data structure associated with the user and accessible by the PRE to generate curated recommendations for the user. In an example, a user's experience with Brand A across multiple applications and websites may generate a “brand experience” specific to the user in relation to Brand A. This individualized experience is stored as links in the user's nodal data graph between various Nouns and Verbs. These links may be accessible to a PRE server associated with Brand A (e.g., a server hosting Brand A's website and/or the PRE) through one or more SKL APIs.

In another non-limiting embodiment, a user interacting with various wearables, hospitals, medical systems, insurance providers, etc. may similarly have data associated with a given medical condition consolidated across fragmented systems via their nodal data structure.

Referring back to FIG. 57 in a non-limiting embodiment, the PRE chatbot 5700, being generated and modified by a PRE server, provides a user-specific prompt 5702 to a user device based at least on previous context between the user device and the PRE, such as through the chatbot 5700. The user-specific prompt 5702 includes data related to past PRE-user interactions in which the PRE provided the user device a recommendation the day before. The user-specific prompt 5702 provides an inquiry of whether or not the user enjoyed the recommendation, to which the user device responds with response 5704, indicating that the user did enjoy the recommendation and provides additional details as to why, citing the great ambiance and food along with the trendy atmosphere. Through the use of SKL APIs, the PRE may modify the user's nodal data graph based on this input, providing links between the user and the past recommendation with the associated positive response.

After this interaction, the user may access the PRE chatbot 5700 in a separate website into which a PRE chatbot 5700 is integrated. In the example of FIG. 57, the user travels to Sophia, Bulgaria, and accesses the PRE chatbot 5700 to inquire about restaurants in user query 5706. The PRE chatbot 5700 may access the user's nodal data graph and select a personalized recommendation to the user device at response 5708 based on the user's response to a previous response or conversations with the PRE chatbot 5700 and the user's interactions stored in the nodal data graph. In addition to response 5708, the PRE chatbot 5700 may include a link 5710 to access a link to the recommended restaurant's website. Additionally or alternatively, the chatbot 5700 may include other recommendations 5712. The other recommendations 5712 may include a link to additional recommendations related to the user's query 5706.

In some embodiments, the analytics engine can search for and select User Interface schemas that are best suited for the type of data or action that is associated with the query response intent. For instance, along with a request for data, the PRE chatbot may also request a URI associated with a user interface component that is well suited to display the data or actions embedded in the expected response. In some embodiments, the PRE chatbot may have pre-existing knowledge of available components and can make that determination without a query. In this embodiment, along with a response, the PRE chatbot 5700 can select and render the selected User Interface component 5710 along with the corresponding data and actions mappings (which can be defined with SKL or other methods).

The user device interacts with the PRE chatbot 5700, in at least one embodiment, through the input field 5714. The user device transmits natural language text in the input field 5714. The PRE may receive the natural language input and, through the use of large language models, parse relevant portions of the input into one or more search elements to understand the user query. Upon processing the natural language query, the PRE chatbot 5700 executes a machine-learning model to generate a data query to execute within the SKL Platform to retrieve user/location data related and/or associated with the user's query.

The PRE chatbot 5700 executes the generated data query and retrieves the relevant data based on links between the search parameters of the data query and nodes within the user's nodal data structure. Upon receiving the relevant data from the nodal data structure, the PRE chatbot 5700 executes a machine-learning model to generate a natural language response that is personalized to the user, based at least on the user query and the retrieved nodal data graph data related to the user.

In some embodiments as mentioned above, the PRE chatbot 5700 may also choose, render, and/or configure user interface components as part of the response. For example, in choosing, rendering, and/or configuring the user interface, the PRE chatbot 5700 assesses context surrounding the request, including, but not limited to, the type of device, operating system, and available input methods, to determine the most appropriate UI. The PRE chatbot 5700 considers user preferences, such as theme choices, font sizes, and languages, along with the specific needs of the application, which can range from single-screen displays to multi-windowed interfaces. In some embodiments, the user preferences are stored in the user's nodal data structure.

The PRE chatbot 5700 may use one or more rendering frameworks and/or libraries such as React, Angular, or Qt to render the interface. Using these frameworks/libraries, the PRE chatbot 5700 renders UI elements that can be displayed correctly across different devices/services. The rendering engine then converts these high-level descriptions into pixels on the screen, managing layout, animation, and visual effects.

As PRE chatbot 5700 renders the response in a graphical user interface, the system dynamically adjusts layouts based on screen size and orientation, making sure the interface remains functional across different devices. It also incorporates accessibility features like screen readers or adjusted color contrast and configures the UI to match the user's regional settings, such as language or date format.

The PRE chatbot 5700 may, in some embodiments, continuously monitor user inputs, such as clicks or swipes, and adjusts the UI accordingly. In some cases, the UI may adapt over time based on user behavior, offering shortcuts or modifying layouts to better suit the user's habits. Additionally or alternatively, the PRE chatbot 5700 may also choose SKL Verbs and present them as graphical elements within the user interface to enhance the capabilities of the response (e.g., using User Interface components using VerbUserInterfaceMappings). For example, when displaying relevant, personalized responses to a user's natural language query, the PRE chatbot 5700 may include a graphical element associated with an SKL Verb to interact with the personalized response in some way, such as making a reservation at a restaurant that is presented to the user by the PRE chatbot 5700.

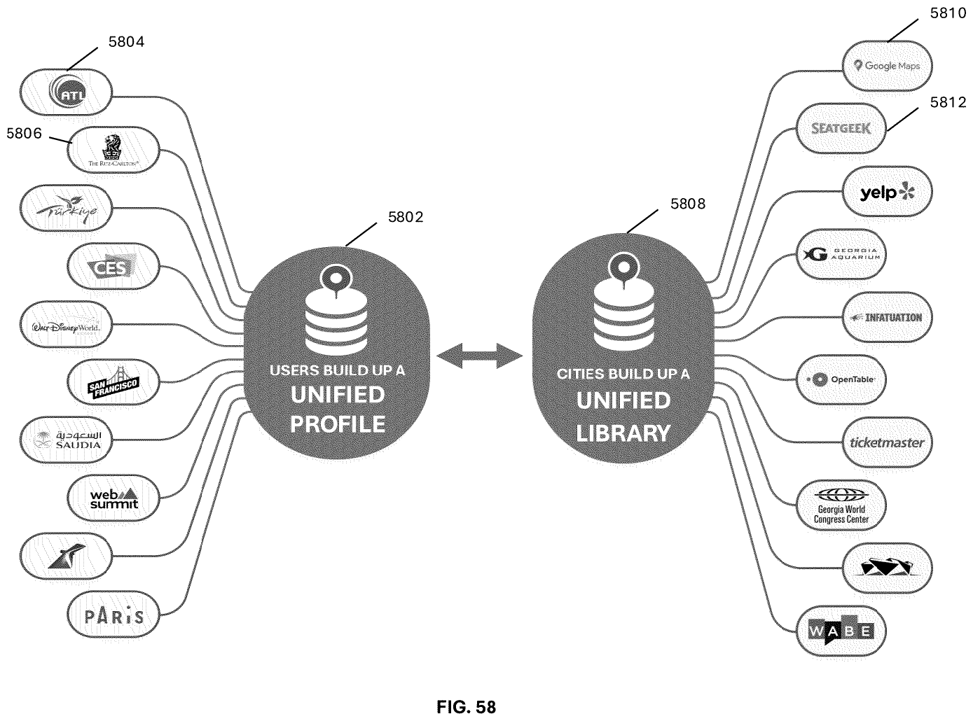

The PRE chatbot 5700 may be implemented across computing platforms and/or infrastructures to provide a consistent user experience across channels. Though the underlying APIs to connect to the SKL Platform may be the same across platforms, different platforms/infrastructures may customize the PRE chatbot 5700 (e.g., with branded skins) to provide slightly different experiences. In so doing, the PRE provides a consistent functionality based on attributes like unified user profile, or a given brand profile, as shown in FIG. 58, while allowing personalization by implementing entities (e.g., the DMO).

As described, the PRE may be implemented to provide personalized recommendations to individual users across a range of computing platforms by accessing each user's nodal data structure and retrieving relevant links between Nouns within one or more nodal data structures. In additional and/or alternative embodiments, the PRE may also provide curated content for a specific entity based on the entity's nodal data structure (a “unified library”). In this way, the entity may have greater control over what data is curated for the user by selectively developing the entity's nodal data structure with nodal links to trusted sources (either publicly trusted or privately trusted, based on the user's nodal data graph) to be used for data retrieval.

FIG. 58 illustrates a computer model including at least a user's nodal data structure 5802 and an entity's nodal data structure 5808 that can be utilized by the PRE to generate customized responses to a user's query with specifically curated content from an entity. The unified user's nodal data structure 5802 represents a unified profile of a user with user-specific interactions/connections to various companies, such as company 5804 and/or company 5806. These interactions/connections represent positive/negative/neutral interactions between the user and the brand. For example, the interaction may include indications of a visit to a theme park, an online order return, a customer service complaint, a purchased good, a website visit, a social media post, a geolocation check-in, etc. These data, linked through the SKL framework, are accessed by the chatbot 5700 to curate personalized responses to user queries.

Likewise, FIG. 58 illustrates an entity's nodal data structure 5808, which may represent a unified library of the entity (e.g., a company or brand), which may similarly define links between various Nouns and Verbs within an SKL Platform which represent the entity's trusted data sources, such as company 5810. In this way, the PRE may access both the user's nodal data structure 5802 and the entity's nodal data structure 5808 to provide personalized content for the user, based on curated data sources selected by the entity. Both the user's nodal data structure 5802 and the entity's nodal data structure 5808 may be generated, modified, and/or removed as described herein. In a non-limiting embodiment, the entity's nodal data structure may include data links to various third-party data sources that are either static or dynamically updated. Thus, the entity's nodal data structure 5808 may be dynamically updated as the linked sources are updated, providing a low-maintenance data library of trusted sources to draw from in curating content. In the DMO example, the entity's nodal data structure 5808 may be linked to a ticket vendor 5812. The ticket vendor 5812 may dynamically update its data to reflect upcoming events with respective dates and costs. Each event may be stored as a Noun in the ticket vendor's 5812 own nodal data structure. The event Noun may have additional linked components such as available seats, costs, dates, etc. The entity's nodal data structure 5808 may access the ticket vendor's data 5812 to retrieve data associated with the upcoming events. Thus, when a user device inputs a user query inquiring about upcoming events into a PRE chatbot integrated into the entity's website, the PRE may access the entity's nodal data structure to access the ticket vendor's 5812 data and curate it for the user.

By providing an integrated PRE chatbot 5700, third-party platforms are able to provide machine-learning curation of data with trusted data. Likewise, users are able to build their unified profiles without being locked into a specific platform, while still building personalized, direct relationships with brands they trust.

In a non-limiting embodiment, the PRE may use data within a user's unified profile (e.g., the nodal data structure) to provide recommendations of data from a second nodal data structure (e.g., a company's nodal data structure) without sharing user data with the company. For example, the PRE may provide a curated response to the user's device by removing identifying details about a user prior to accessing the company's nodal data structure.

In a non-limiting embodiment, the PRE may receive a user query from a user device. The user query may come from an SMS text, a website, a messaging service (e.g., WhatsApp®), a phone call, a brain-computer interface, etc. The PRE receives the user query through the SKL (e.g., through one or more SKL APIs) and transforms the received user query into parameters that can be used to query the nodal data structure. For example, the PRE may use one or more machine-learning frameworks to interpret the user query to transform the audio, detect reading from the brain-computer interface, etc. into parameters. The parameters may be queries for semantic search, SQL queries, SPARQL queries, and/or other database searching methods.

Upon accessing the user's nodal data graph based on the generated parameters, the PRE retrieves a subset of nodes and/or links from the nodal data structure that satisfy the query parameters and are therefore relevant to (e.g., correspond to, associated with, etc.) the user's query. The PRE creates, structures, retrieves, etc. a URI (e.g., a URL) that can be used to access data associated with the subset of nodes and/or links from the nodal data structure. The PRE can optionally evaluate the results (e.g., using one or more machine-learning methods) to identify the best answers for the user's initial request, summarize the results, perform additional analyses on the results, and so on.

The PRE sends the URI with the subset of information back to the user device (e.g., via the original channel that the user sent the message). The user device can optionally share the URI with other user devices that, depending on the permissions/settings associated with the URI (e.g., default settings), can then access the information directly via the URI.

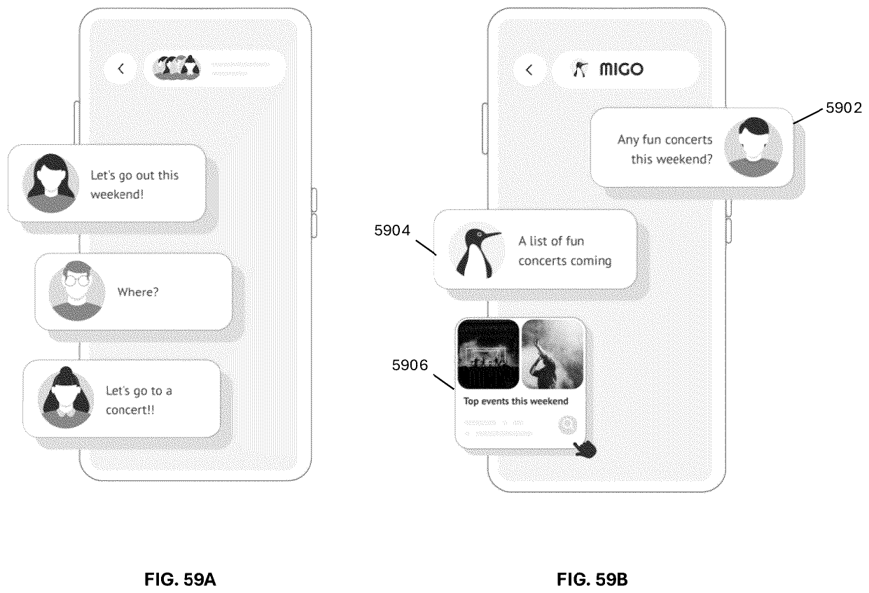

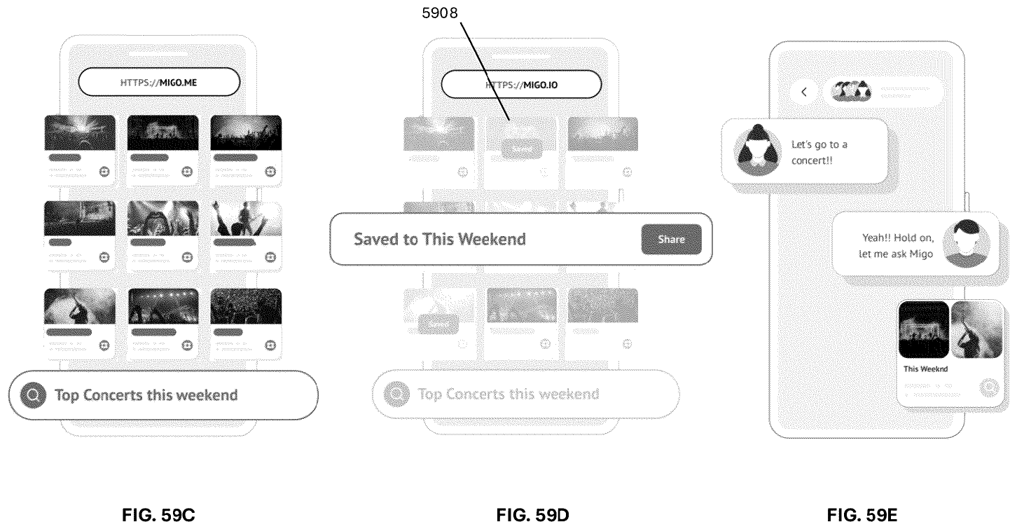

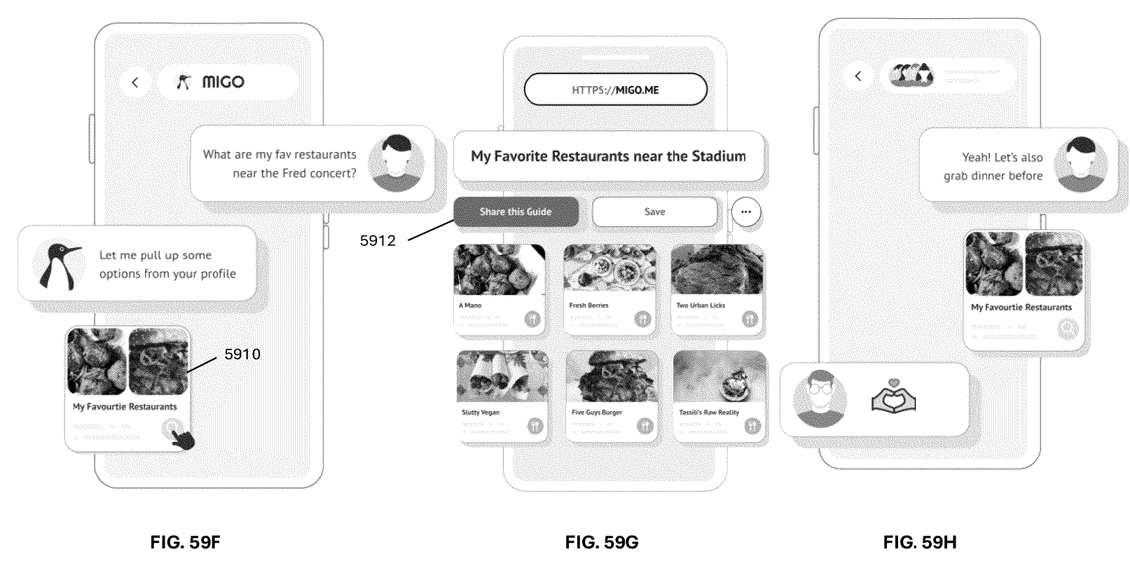

FIGS. 59A-59H illustrate an exemplary embodiment of the PRE being executed by an analytics server to provide a personalized response to a user's query. Though the PRE is described herein as performing one or more computer-implemented processes, it is understood that an analytics server that hosts the PRE may be described as performing/executing the methods and systems described herein. FIGS. 59A-59H show a graphical user interface in which a user device interacts with a large language model that is able to retrieve data (e.g., Nouns, Verbs, Integrations, Schema, Entities, etc.) and provide personalized information defined through SKL (e.g., Verbs in a user's SKDS, in an SKL Library, etc.) in a chat-like interface, according to an embodiment. In this example a user device requests information, such as “any fun concerts this weekend?” through natural language commands communicated conversationally. In some embodiments, the user device transmits voice audio to the chat-like interface rather than text questions, commands, responses, and the like.

In this way, SKL Libraries can be used to present contextually relevant data and capabilities to end-users. Some of these capabilities can be abstracted away from a variety of competing products such as text summarization services from Amazon Web Services®, Google Cloud Platform®, Azure®, etc. Certain providers may choose to pay the providers of certain analytics servers and/or SKL Libraries for a higher ranking on suggestions.

In some embodiments, a user is able to use other types of human-computer interaction interfaces such as haptic devices, brain interface, and the like to communicate with an SKL-powered system. For instance, a brain interface might be able to recognize certain intentions (e.g., language expressions, feelings, etc.) through monitoring brain signals and be able to find data and capabilities from SKDSs, Integrations, and/or SKL Libraries in order to contextually enable the user to access data.

In some embodiments, the PRE is able to access contextual data of a user not directly shared with the PRE, such as previous messages, such as shown in FIG. 59A, to create individualized recommendations for the user. FIG. 59B illustrates the PRE's context-relevant recommendation 5904 based on the user's natural language query 5902 and user's underlying nodal data structure (e.g., where the user is located currently and what type of music the user enjoys). For example, the PRE may determine that the user was previously messaging with Jane, John, and Sarah about going to a concert. The PRE may generate queries for Jane's, John's, Sarah's, and the user's respective nodal data graph to select a recommendation curated for the group as a whole, such as by suggesting a concert that each group member may appreciate, based on their previous interactions which are stored as data in the nodal data graph.

The PRE may return the context-relevant recommendation 5904 and provide a URI 5906 (e.g., an URL shown as a card) to the user. In some embodiments, the user device is able to curate, modify, or otherwise alter the subset of returned information (and/or the summaries, the analyses etc.) before deciding whether or not to take other actions such as collaboration or sharing.

If the user device selects the personalized response (e.g., the URI), the PRE may present additional information related to the personalized response, such as shown in FIG. 59C. Additional information may include ticket vendor information, a list of top concerts, etc. As shown in FIG. 59D, the user device may save the personalized response or a subset of information from the personalized response, such as recommendation 5908.

In FIG. 59E, the user device is shown sharing the selected recommendation with the other user devices. This selection may be saved as data in the user's nodal data structure with corresponding Nouns and Verbs, such as described herein. In other embodiments, other actions may be taken according to the Verbs available (e.g., “findSimilar”, “findTickets”, “getArtist”, etc.) In some embodiments, the user device might query the PRE for information that is based on private information associated with the user, rather than public information available generally. This user's private and/or public (or some mixture thereof) information might be stored, indexed, and/or updated in his/her nodal data structure using methods described elsewhere herein.

FIG. 59F illustrates an embodiment in which the user device requests the PRE to access and provide a subset of information that is private to the user. The PRE follows a similar process as described above by searching the user's nodal data structure with the corresponding query parameters generated by the PRE. As shown in FIG. 59F, the user query includes a request to know which of the user's favorite restaurants are near the chosen concert (as chosen in FIG. 59D). Because the user is requesting a response related to personal information (e.g., the user's favorite restaurant), and not public information (e.g., what concerts are coming up), the PRE may need to access personal data within the user's private nodal data structure. The PRE generates user-query specific search parameters for a data query and curates a personal response 5912 based on the user device's query.

In response to a selection of the personal response 5910 by the user device, the PRE may generate a URI that can be shared and accessed by third parties that don't have access to the user's nodal data structure. In this case, the analytics server can for example create a URL for a subset of private information and change the access rights to the corresponding entities in the nodal data structure automatically or by prompting the user device, such as shown in FIG. 59G. This PRE-created subset of information is presented to the user device with a prompt to share 5912 the response. Upon a selection of the prompt to share 5912 by the user device, the PRE-created URI is shared with the group, as shown in FIG. 59H. In some embodiments, the user is then able to share the subset of information via any channel. In other embodiments the URI might include information that has been customized, processed, analyzed, summarized, etc. after being retrieved form the nodal data structure in automated, semi-automated, and/or manual ways.

In some embodiments, where the subset of data being returned is public, the analytics server may also return a URI or URL that corresponds with the public search results without having to generate a new “container,” “guide,” or node that the subset of information can be accessed through.

The PRE, as executed by the analytics server, may execute one or more distinct processes. These processes may include, but are not limited to, suggesting and answering questions about things to do; provide personalized recommendations of things to do (e.g., that can be viewed as cards in sections by type or category, on a map, in a timeline view, etc.); provide information about nodes and related information from other nodes within a nodal data structure (e.g., see more information and related information around restaurants, hotels, places, users, etc.); help save things to do so the user device can access or come back to later (e.g., independently, via a recommendation/reminder prompted by the analytics server, etc.); use at least two users' nodal data structures/preferences/profiles to generate one set of recommendations that best matches the preferences of the at least two users. For example, in one non-limiting embodiment the PRE may evaluate the at least two user's profiles to identify patterns, similarities and/or differences between those two users, and the like. In another embodiment, the system could generate two lists of recommendations for each user and then evaluate for similarities between those two lists in order to generate a third list that can be shared with the group of users through transmitting the recommendation to a user device associated with each of the group of users.

The PRE may additionally or alternatively generate, automatically, a list of recommendations of entities (restaurants, events, things to do, etc.) from the nodal data structure based on a user's profile/history/preferences/nodal data structure. In at least one non-limiting embodiment, this could be triggered by time (e.g., on a weekly basis). In other non-limiting embodiment, this could be triggered by one or more the users.

The PRE may also track a user's activity and help them access recently viewed data, provide searching capabilities (e.g., a time range filter to results both through conversation with the chatbot and via the interface, a distance filter to results both through conversation with the chatbot and via the interface, etc.) and/or help the user device share and save (and manage shared and saved) personalized response from the PRE across channels and platforms.

According to a non-limiting embodiment, there may be a website in order to help users browse personalized recommendations of things to do, see details about things they click on, view their saved things, and view recently viewed things. According to the embodiment, the default view of the browsing section is a list of personalized recommendations that are displayed in titled rows of cards according to category, type, or other contextual filters. For example, some category sections may include: “Sporting Events,” “Vegan Restaurants,” or “Comedy Clubs.” Other contextual sections may include: “Trending in Buckhead,” “New and Popular,” or “Gems for You.” Sections for “Saved” and “Recently Viewed” may also be included. In some embodiments, the order of sections will be ranked according to the user's interaction history (e.g., what they have viewed and saved).

In some embodiments, users can also switch to other types of User Interfaces, such as a map view, a timeline, a calendar view, a WYSIWYG view, and more. In map view, a set of their top recommendations may be pointed out with pins on a map, in a timeline view they could be organized by time, and so on. In some embodiments, as mentioned above, the analytics server may determine the best User Interfaces on behalf of the user and render the data in the selected User Interface. The analytics server may use a recommendations algorithm to rank entities/information shown in browsing view. Furthermore, the analytics server may rank entities according to their proximity to the user's current location, supplied location of interest, or otherwise. In timeline/calendar view users can see events or other things to do on a calendar based on their start and end times or other temporal information. The calendar can be switched between day, week, and month time scales. At any time, the user device may filter their results in the browsing section by time, proximity to a location, type, category, or to only see their saved or recently viewed items.

As described herein, the PRE may use large langue models (“LLMs”) to provide personable, talkative, and friendly conversation to the user device through one or more user interfaces (e.g., text fields, audio, etc.). As discussed above, the PRE may provide data related to events, attractions, venues, and restaurants near a destination and answers any questions the user device may transmit to the PRE. However, the PRE may also, in some embodiments, provide personalized prompts to help the user home in on things to do by prompting the user device to add details about what the user's interests are, how many people the user is traveling with, what their time frame is, etc. The PRE can also provide answers to general questions such as the weather, driving times, etc. When presented inquiries such as, “what is a delicious Italian restaurant within 10 mins from me?” or “what are some events happening this weekend?” the PRE may request clarification (if warranted) and respond with a list of results, including a name, location, and date (if applicable) for each. At times, the PRE may include prompts based on a previous response and/or context on current or previous user device interactions. For example, the PRE may access content on the user's device (e.g., computer screen) to determine what the user most recently was viewing or is currently viewing. This provides the PRE with context to the user query and aids prompt the user. In an embodiment, the user may be accessing a restaurant's website when accessing the PRE with a user query. Prior to the user inputting a query, the PRE may determine that the user is viewing the restaurant's website and offer a prompt based on this contextual information, such as “what time are you planning on cating dinner tonight?”

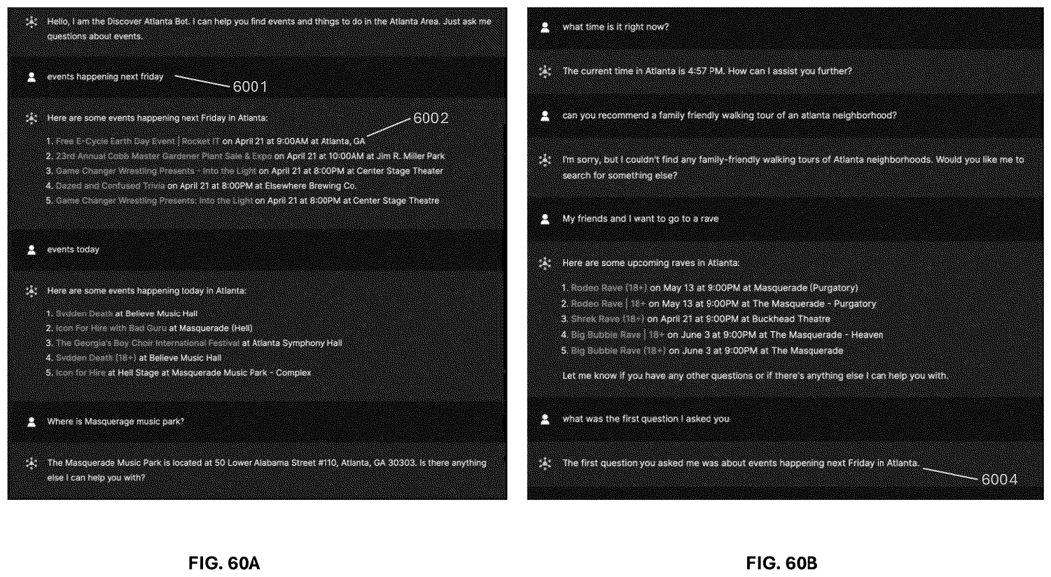

In at least one other non-limiting embodiment, as shown in FIG. 60A, a personalized response 6002 to a user query 6001 may be displayed in a chat history of the PRE. The personalized response 6002 may be linked such that when selected by the user device, the PRE provides additional information or links to details about the result in the browsing section of the interface. This behavior of the link clicks may be customized (e.g., open a specific URL in a new tab, navigate the current page to a different URL, etc.) such that when the PRE is integrated into a third-party website, it can be used to navigate to that website (given that the website is a source for the Knowledge Graph and its URLs are indexed with the SKL Platform). The PRE may be able to access specific details about recent conversation history, and a general summary of less recent conversation, such as shown in personalized response 6004 of FIG. 60B.

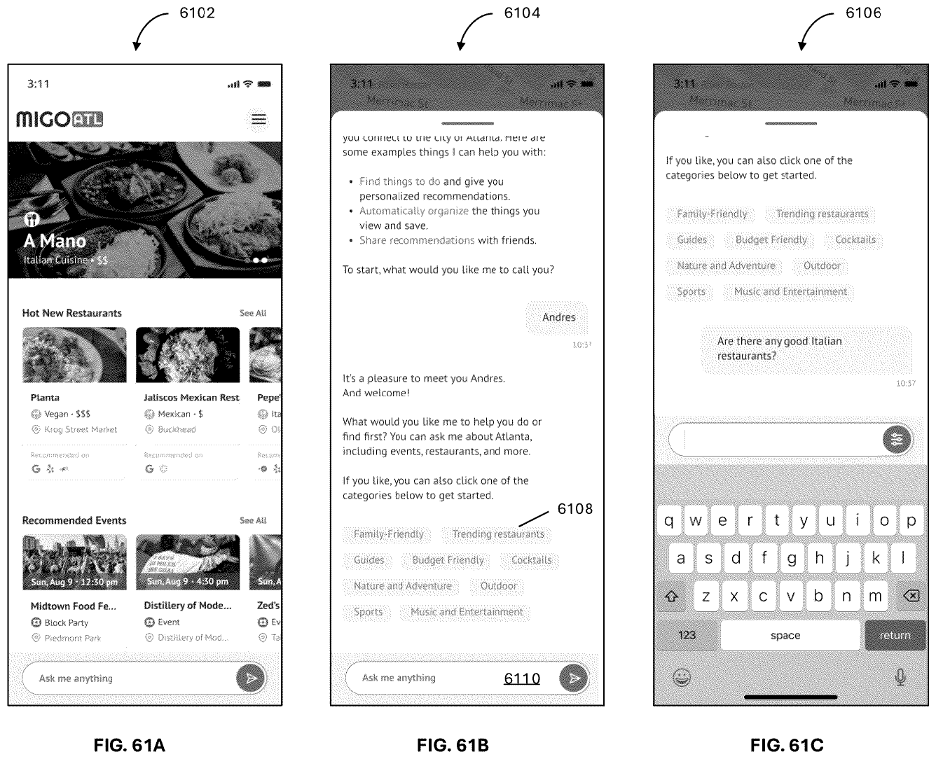

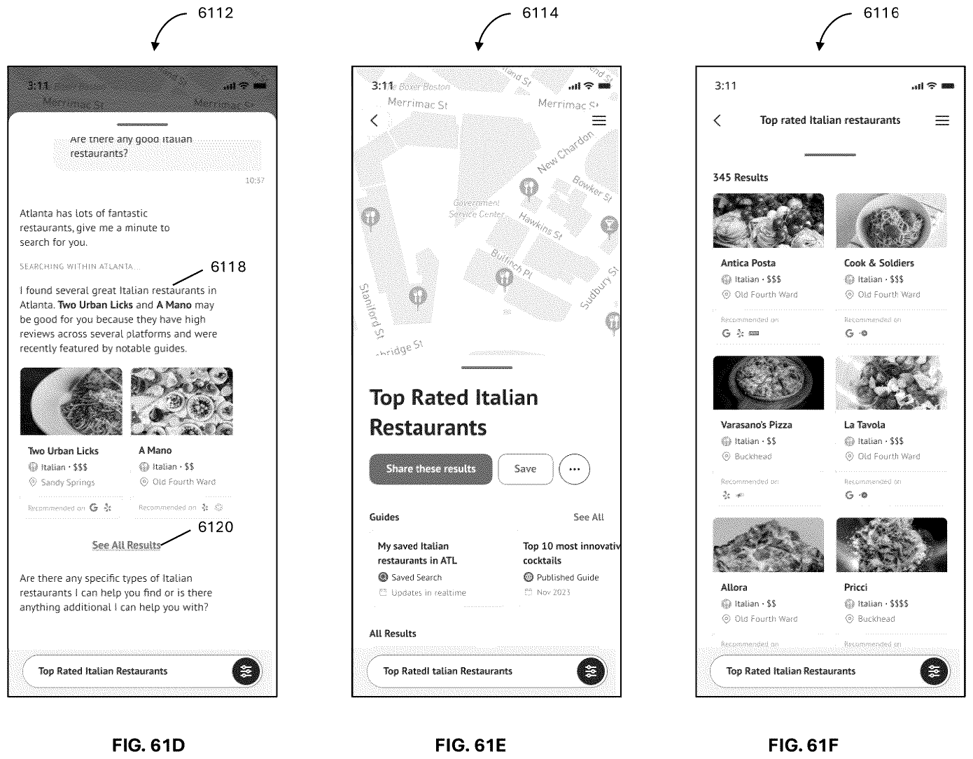

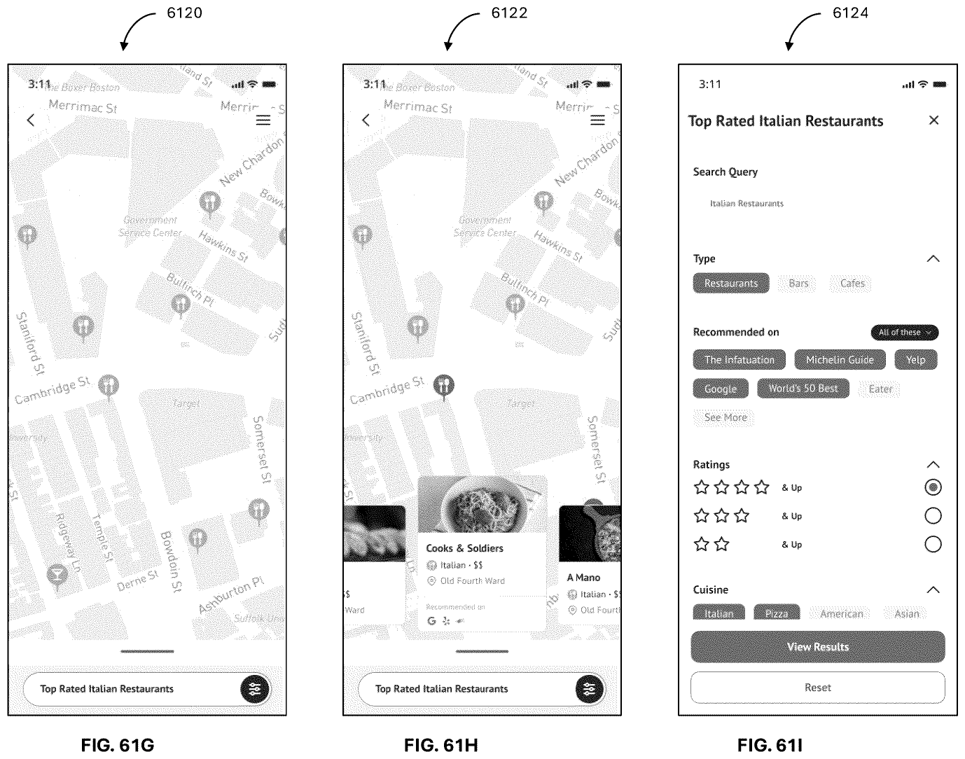

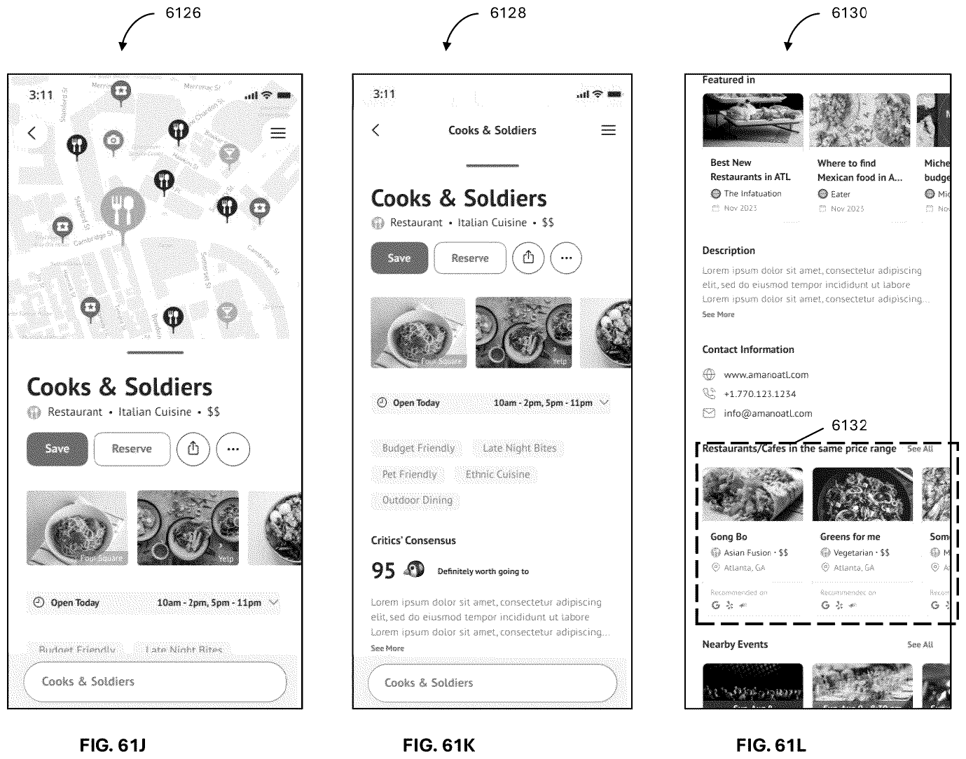

As shown in FIG. 61A, an interface 6102 displays a list of recommendations personalized for the user displayed based on the user's previous interactions, location, preferences, metadata, as stored in the user's nodal data structure. In some embodiments, the PRE presents the user with personalized recommendations without a prompt and/or query from the user, such as shown in FIG. 61A. In some embodiments, the PRE provides a user the option of searching, navigating, and/or interacting with a nodal data structure through natural language queries and answers. The nodal data structures may be the user's own nodal data structure or a public nodal data structure, such as an enterprise's nodal data structure which represents the enterprise's connections as data links in the SKL Platform. As described herein, the PRE may utilize natural language syntax processing based on large language models and/or machine-learning models to understand the user's inputs to the PRE through, for example, a chatbot, as shown in interface 6104 of FIG. 61B. As shown in interface 6104 of FIG. 61B, the PRE may prompt the user device for information based on contextual data received by the PRE. As shown in FIG. 61B, the PRE prompts the user device with one or more options 6108. The user device may select the option 6108 to provide the PRE with contextual information to generate parameters of the data query. The user device may also input into the text field 6110 a user query, such as “are there any good Italian restaurants?” as shown in interface 6106 of FIG. 61C.

As shown in FIG. 61D, the PRE presents for display a personalized response based on the user's query as input into the user device. The PRE may pass “Italian” and/or “restaurant” as data query parameters to search a nodal data structure associated with a location near the user (e.g., Atlanta, Georgia). The PRE queries, for example, an Atlanta nodal data structure based on the generated parameters. The PRE receives an indication of one or more nodes within the nodal data structure with attributes that satisfy the data query. The PRE may execute one more machine-learning models to review the one or more nodes to determine which to present to the user.

In some embodiments, the PRE can use a large language model to structure a search query based on the user's natural language query. It can then perform a search based on the search query. The PRE may review the results in a secondary review with an artificial intelligence agent/large language model.

In an embodiment, the PRE uses the large language model to interpret the user's question by identifying key components like entities, actions, and the overall intent of the query. It then uses contextual understanding to clarify any ambiguities, such as determining specific time frames or other relevant details. The large language model maps the interpreted elements to the corresponding fields and tables in the database, translating the natural language query into a structured query language (SQL) statement or another appropriate format. This query is then validated and refined to ensure it matches the user's intent and the database schema based on the SKL Platform. Afterward, PRE executes the generated query, and the large language model formats the returned data into a user-friendly format, such as a table, graph, card, map, and/or text. If the user device provides additional input or asks follow-up questions, the large language model can iteratively adjust the query to refine the results.

As shown in interface 6112 of FIG. 61D, the PRE returns two personalized responses to the user's query. These two personalized responses may be the most relevant responses to the user based on satisfying relevancy threshold based on individual data linked between the user's nodal data structure and the restaurant's nodal data structures. In some embodiments, when the first set of search results is returned, they can be instantly rendered while the PRE continues to do a secondary evaluation of the response to verify that they satisfy a relevance threshold with respect to the user's query and the user's nodal data structure.

By selecting the interactive element 6118, the PRE causes the user device to present interface 6114, which displays a more complete list of relevant responses, as shown in FIG. 61E. Additionally and/or alternatively, the results may be displayed as cards (as shown in in interface 6116 of FIG. 61F) and/or maps (as shown in interface 6120 of FIG. 61G), and/or a combination of both (as shown in interface 6122 of FIG. 61H).

As shown in interface 6124 of FIG. 61I, the user device may modify the user query with various filters and or options to further inform the PRE of the user's preferences. The PRE may use the updated user information to update the search query parameters for the SKL Platform. The user device can modify the exact search query that the PRE generated (including text and filters) based on the user's question/request to the chatbot.

### Detail View

As shown in FIGS. 61J-61L, an info card (e.g., as shown as interface 6126 of FIG. 61J and interface 6128 of FIG. 61K) with details about the item may be displayed either as an overlay on the browsing side of the interface, or potentially in an info-box in the chat when a user interacts (e.g., selects, clicks, etc.) a result provided by the PRE. The card will show different information depending on the type of the item (event vs. restaurant vs. attraction, etc.). The exact information shown may be retrieved from the nodal data structure of the relevant entity (e.g., the recommended restaurant).

Additional recommendations 6132 based on the user query may be presented by the PRE, as shown in interface 6130 of FIG. 61L. These additional recommendations may be presented based on monetized ad spaces and/or links in the nodal data structure between the two recommendations (e.g., restaurants in the same price range and/or of the same genre).

In some embodiments, if the detail view is displayed in overlay, below the essential actions and details about a thing to do, there may be sections of related things to do. For example, these sections may include “Restaurants near this venue”, “Other events at this bar”, or “Other similar Events.” If the user device is presenting a map (as shown on interface 6126 of FIG. 61J), these related data may be displayed on the map with different colored pins than the selected item or normal results.

Once a user selects an entity from the search results, the analytics server can continue to show the search results, as well as add additional related events, things to do, restaurants, attractions, etc. that might be related to the user and/or the electronic content/entity being looked at (i.e., it can bring in electronic context). The user can see an entity in map view, detail/cards view, etc. and see info about the node and related nodes.

The PRE may additionally/alternatively provide context pulled in from several sources (e.g., a “Crowd Review” for an overview of public reviews/feedback and “Critics Consensus” for a summary/overview of professional critics). The PRE may also present information from related/recommended nodes below (e.g., electronic content/context based on the nodal data structure and the user's inferred intent).

### Sharing

Any item viewed in the browsing section of the interface can be shared via email or text. In addition, things to do which include temporal information such as an event start and end times can be added to the user's calendar.

### Related Content, Context, and Information

In some embodiments, the PRE can provide related content and context around a given piece of information. Such information may include events, tours, attractions, parks, restaurants, bars, cafes, venues, hotels, apartments, etc. With each information, additional data may be presented, such as food/activities nearby, other related entities/recommendations that have vector similarity within the SKL framework.

In some embodiments the PRE may follow up with a user in a chat regarding a previous response provided to that user, recommendations provided by the PRE to the user device, analyses and conclusions the PRE independently reaches, and so on.

For example, in a non-limiting example, the PRE may establish that the user visited a given concert and attraction in a city based on the user's activity in one or more locations/channels/websites/Integations/etc. In this example, the PRE may send a text, send a notification, initiate a phone call, and/or otherwise prompt the user for a response that may include feedback on what the user liked and/or didn't like about certain experiences. The PRE may also request images, videos, audio files, other types of recordings, health data, and so on from the user device as part of this follow up. The PRE may then automatically analyze the data provided by the user in order to add it into the nodal data structure, or to otherwise modify the nodal data structure, thus generating new or modified links between data.

In another non-limiting example, the analytics server may transmit a prompt to the user device that queries the user what he/she thought of a given experience, what he/she liked or disliked about it, how he/she would rate the experience, and if he/she would like to receive recommendations for similar experiences. The responses that the PRE receives from the user device may be automatically added and linked by the PRE to the corresponding nodes in the nodal data structure as additional context that the PRE may access in future queries. Furthermore, the PRE may also use the information to improve retrieval and/or recommendations when responding to other user devices, and so on. In such embodiments, the user's feedback to the PRE's prompts may be used to train the one or more machine-learning models executed by the PRE.

In some embodiments, the user device might send data to the PRE. The PRE may then establish whether the data should be used to modify the nodal data structure. For instance, the user may simply send the PRE the name of a restaurant, the website for a museum, a copy of a train ticket, a calendar invite/event, readings of the user's health data during a period of time, or some other piece of information without additional context. In these cases, the PRE may evaluate the user's history, nodal data structure, and/or other data in order to establish what to do next. The PRE may opt to prompt the user device for more information before performing an action on behalf of the user, such as updating the nodal data structure, checking a museum's open hours, and/or some other action.

In a non-limiting example, the user device may transmit a social media post featuring a restaurant to the PRE via a direct message within that social network. Using the methods described herein, such as using the SKL Platform, the PRE can receive the message from the user device and identify the node or nodes that may correspond with the information sent via the social message, such as nodes for the sender, for the social media post's author, for the restaurant being referenced, and so on. The PRE may also create new nodes for the social media post, for the content of the post (e.g., any media shared), and so on. The PRE may then follow up with the user establishing its understanding of the information shared and/or requesting additional information, clarification, direction, etc. from the user. For example, the PRE may inform the user that it has saved the sent post in the user's nodal data structure, and related the post to nodes corresponding with the post's author, the restaurant, the city, etc. The PRE may additionally provide information associated with those nodes that were linked with the node representing the post, such as informing the user that the restaurant is a highly rated restaurant across multiple publications. The PRE may also prompt the user with next steps that may likely match the user's intent, such as whether he/she wants to be reminded of this restaurant at a future time, save it to their favorites, add a note about it, follow the restaurant's social profiles, find available times for a reservation, see the menu, find the poster's other social channels, and so on.

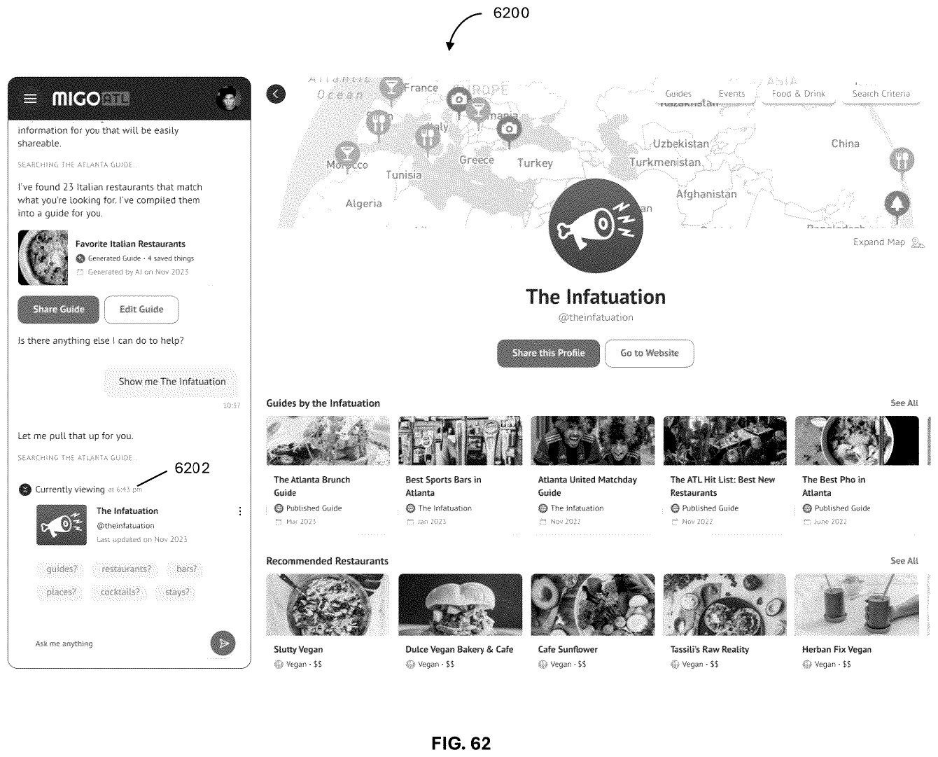

Turning now to FIG. 62, whenever a recommendation, location, event, entity, etc. is selected by the user device, the PRE, may in some embodiments provide one or more follow up prompts to the user device to assist the user gather relevant data associated with the selection, such as shown in interface 6200 at element 6202.

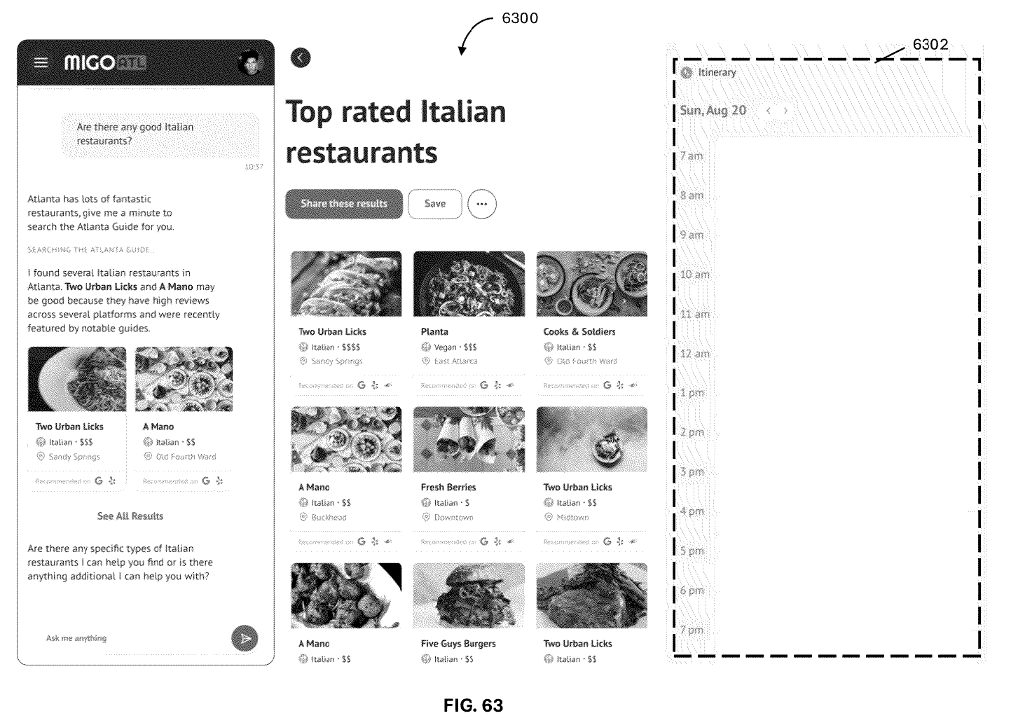

Turning now to FIG. 63, in some embodiments, there is a “Trip Planner” mode in which the PRE can help a user plan a specific itinerary of things to do and places to go for a specific time frame. The “Trip Planner” mode may include, for example, a calendar element 6302 in interface 6300. In some embodiments, the PRE may retrieve data from the nodal data structure to automatically place in the calendar element 6302. For example, the PRE may include dinner reservations, flights, etc. into the calendar element 6302 to aid the user in planning an itinerary. The PRE may also place recommendations into the calendar element 6302 based on linked data in the nodal data structures. For example, the user's dinner reservation may include a location Noun in the SKL framework. The location may be linked to an event center nearby that is presenting a performance that the PRE recommends to the user based on the determined proximity to the dinner reservation.

### Personalization

In some embodiments, when a user first accesses the PRE (e.g., when creating a user profile), the PRE may prompt the user for personalization data, such as with a prompt, “Choose some topics you're most interested in.” The PRE may list one or more types of user preferences, such as “Sporting Events,” “Chic Restaurants,” “Cafes,” “Pop Concerts,” “Outdoor Events,” etc. Upon receiving an indication from the user of a personalization preference, the PRE may modify the user's nodal data structure by creating/modifying one or more links between nodes such that the PRE can make additional connections between future recommendations and the user.

In some embodiments, users can integrate/connect/provide existing tools, software, data that they already have or use in order to prepopulate their profiles (e.g., their nodal data structure) and thereby inform personalization, recommendations, etc. The PRE might identify relevant information in the “integrated data” such as musicians, sports teams, sports players, songs, restaurants, ticket purchase receipts, restaurant booking confirmations, amount of money spent on restaurants or concerts, amount of time spent in certain restaurants, search histories for art shows, etc. The PRE might then modify the nodal data structure using the methods described elsewhere herein, including by updating information about a user's preferences potential relevance scores between a given user and certain categories, types of information, types of communication and engagement, etc.

For instance, a user device can download private data from tools such as Instagram®, Netflix®, credit card statements, etc. and upload to an associated nodal data structure. The PRE may process the information from these systems in order to populate and modify the nodal data structure for a given user. In a non-limiting embodiment, the user's nodal data structure may able to directly integrate tools/devices such as Spotify®, Gmail®, YouTube®, their mobile phone's location, etc. to let the PRE process information from these systems and populate, modify, or otherwise alter the nodal data structure for the given user.

In another non-limiting embodiment, the PRE and/or the user profile uses other methods such as scraping, crawling, screen capturing/recording, etc. to access information from tools like Google Maps®, Ticketmaster®, Eventbrite®, Instagram®, etc. as a way of exporting or otherwise creating lists of favorites that can be shared with the analytics server.

The PRE may be provided access permissions from the user device to process information from messages, questions, booking requests, images and media, ratings, etc. and establish relationships between such user-provided data and the nodes that correspond to the provided information.

In a non-limiting example, the user device may present a query to the PRE regarding the limitations on types of bags that people can take into the Mercedes Benz Stadium in Atlanta, Georgia. The PRE queries a nodal data structure associated with the Mercedes Benz Stadium to search this information. In the event that no answer is available (e.g., it is not in the nodal data structure or this no nodal data structure), the PRE may then opt into looking for this information elsewhere (e.g., using pre-approved SKL Verbs to look up information from a third-party data source).

The large language models and machine-learning models of the PRE may be managed via the SKL Library of Verbs, Nouns, User Interfaces, and/or other types of schemas and data (e.g., prompts, data sets, models, etc.). The large language model can be trained by the PRE to use certain Verbs/Nouns/User Interfaces/etc. known in the SKL Library, and/or to process the user's input to search for potentially relevant Verbs from the library in real-time and then choose what Verb or Verbs from the SKL Library to utilize to retrieve relevant data to present in a personalized response to the user.

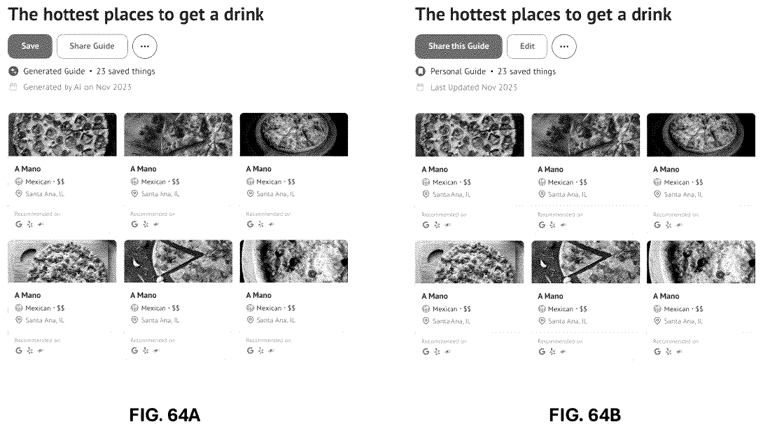

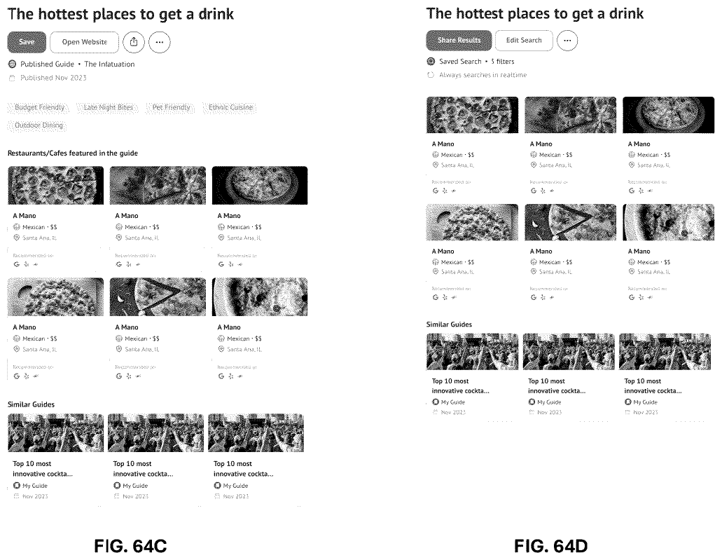

The PRE can output various personalized recommendations based on the same query, based on the underlying nodal data structures of the user requesting the data. For example, FIGS. 64A-64D illustrate four unique embodiments of groupings of entities. FIG. 64A illustrates a “Generated Guide” in which the PRE executes a machine-learning model to automatically create a list (and potential order, itinerary, commentary, etc.) of entities based on a set of criteria or a prompt (e.g., “The hottest places to get a drink”). FIG. 64B illustrates a “Personal Guide” in which one or more user devices lead the creation of the list (and potential order, itinerary, commentary, etc.) of entities through the use of various filters, prompts, etc. The “Personal Guide” may be generated privately (e.g., by a single user device) and/or collaboratively (e.g., by more than one user device). FIG. 64C illustrates a “Published Guide” in which one or more user devices publish a list (and potential order, itinerary, commentary, etc.) of entities (e.g., publicly online). FIG. 64D illustrates a “Saved Search” in which a saved set of search criteria on a nodal data structure is presented.

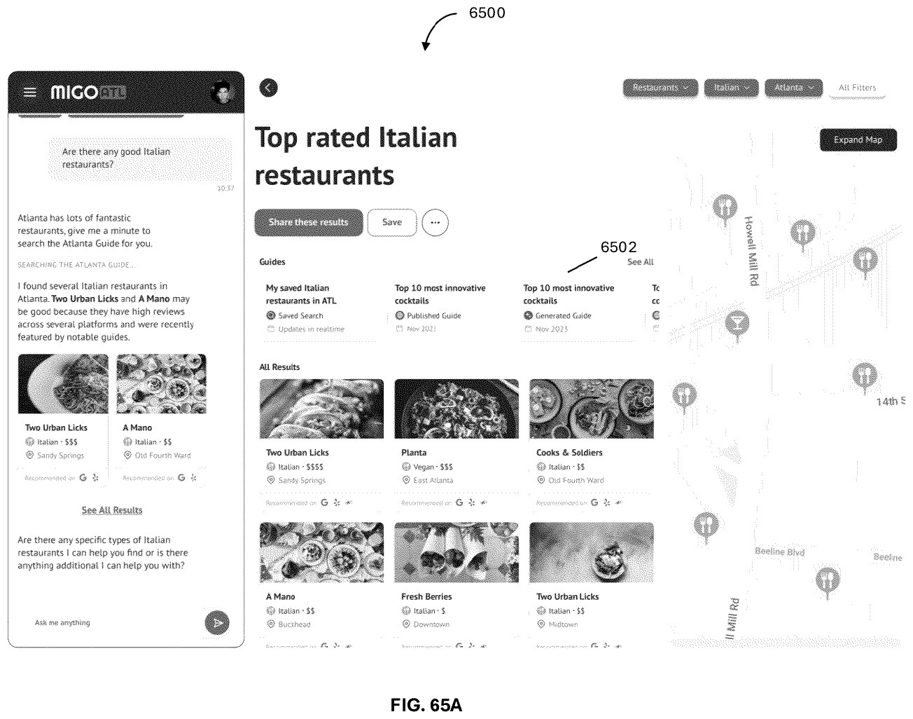

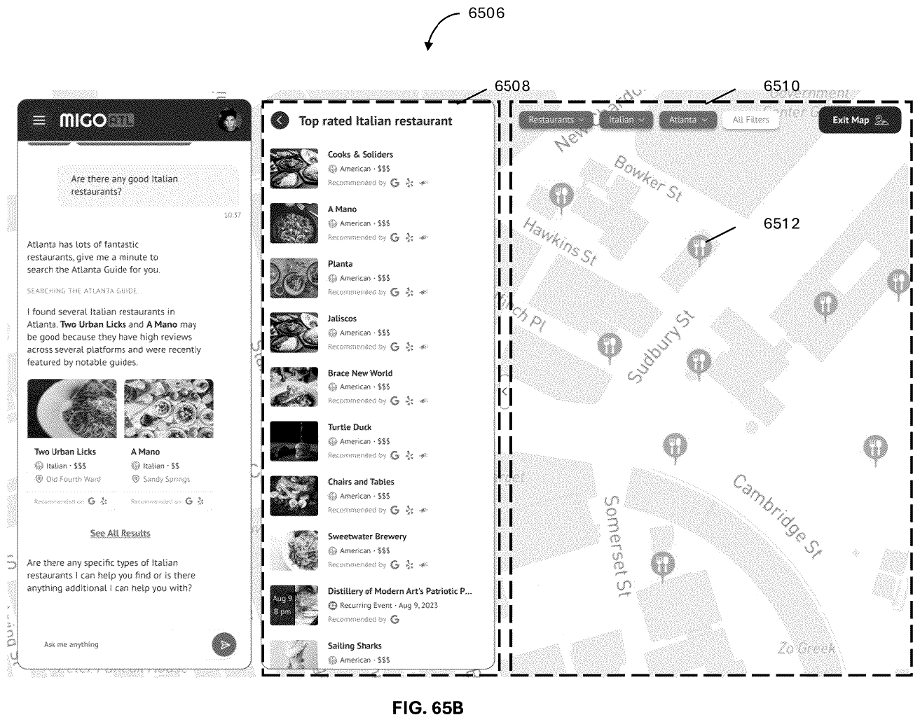

FIGS. 65A and 65B illustrate two alternative views of a personalized response. FIG. 65A illustrates interface 6500 in which the personalized response from the PRE is displayed in a card view, where each recommendation is presented as a standalone card 6502 with relevant data presented thereon. The relevant data may be retrieved from the nodal data structure and/or a third-party library. FIG. 65B illustrates interface 6506 in which the personalized response from the PRE is displayed as a list 6508. Similar to the cards of interface 6500, the list of interface 6506 displays multiple personalized recommendations with associated data. In both instances, a map view 6510 may also be visible with corresponding geographical markers 6512 for each recommendation.

In some embodiments, the user device can upload/send data (e.g., media) to the nodal data structure through an authorized channel (e.g., website, text message, social media direct message, mobile app, etc.). The PRE may relate the provided data to one or more corresponding nodes within the nodal data structure using the methods described herein.

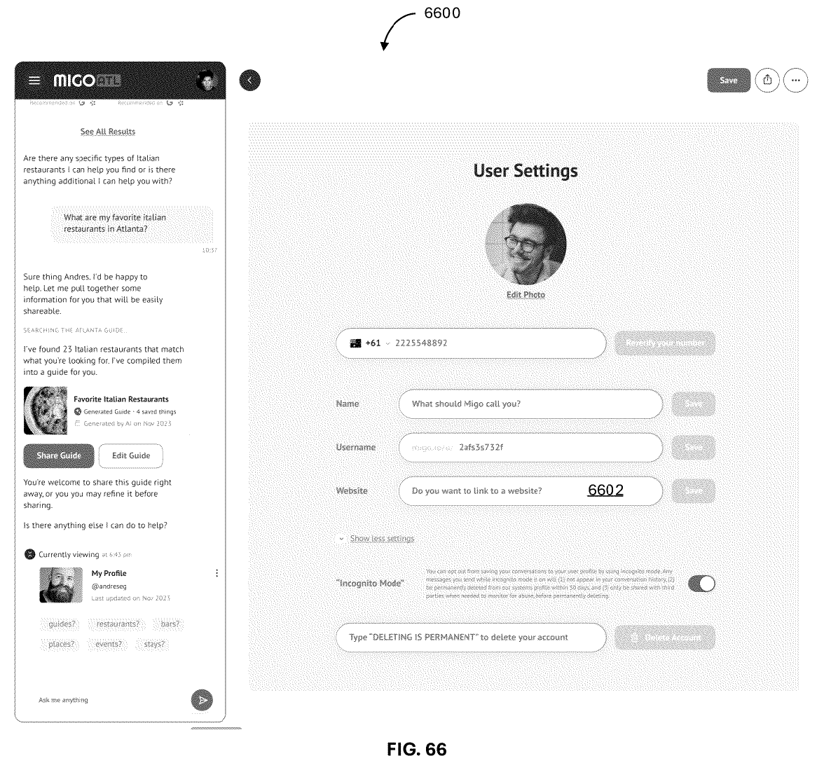

In some embodiments, the user device may control the access to and/or usage of data (e.g., by following solid protocol, Role Based Access Controls, Attribute Based Access Controls, or other methods described herein) within the framework of the PRE. For example, the user device may access a user profile associated with the user and allow or deny access to certain data associated with the user (e.g., nodes with the nodal data structure). For example, a user might want to put more restrictions on financial or medical data. In addition to denying access, the user device may also add other sources of data to their profiles (e.g., integrate a music application to add their favorite musicians and music preferences, add a streaming profiles, link an email account, messaging applications, etc.). By adding additional data to the nodal data structure, the user device provides additional context to the PRE for generating more accurate personalization for the user, as the nodal data structure increases in personalization. FIG. 66 illustrates an example interface 6600 in which a user profile is displayed. In some embodiments, the user device may link one or more external services (e.g., email, messages, etc.) at the interactive graphic 6602.

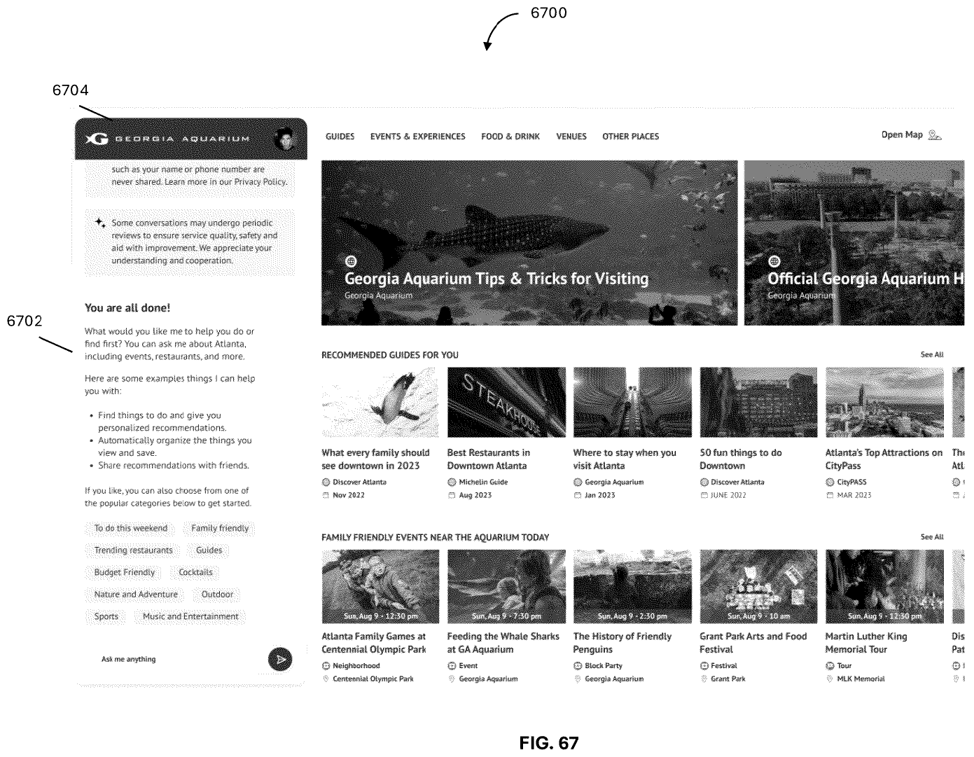

For FIG. 67 illustrates an embodiment in which the PRE is integrated into a third-party platform interface 6700. The interface 6700 may include third-party branding 6704 of the PRE. For example, a branded chatbot 6702 is integrated into interface 6700, allowing the user to view main content of the interface 6700 while still accessing the personalized PRE.

As described herein, the analytics server (e.g., analytics server 3810 of FIG. 38) may execute one more machine-learning models of the PRE to execute one or more software processes that perform various types of data analysis of the SKL and associated Schema, which may include executing the one or more machine-learning architectures containing various layers and functions for processing a natural language syntax user query received by a user device, generating a data query to be executed in a databased of standardized abstraction of data, reviewing results from the executed data query, and the like. These software routines and operations may define various layers, models, and functions of the machine-learning architecture and cause the analytics server to apply various machine-learning structures or techniques, such as a Gaussian Mixture Matrix (GMM), neural network (e.g., convolutional neural network, deep neural network), and the like. The analytics server may execute any number of machine-learning architectures having any number of layers, though for case of description the analytics server executes a single machine-learning architecture.

The machine-learning architecture may operate logically in several operational phases, including one or more of a training phase, an optional enrollment phase, and a deployment phase (sometimes referred to as a “test phase” or “testing”). Some embodiments need not perform the enrollment phase for developing certain components of the machine-learning architecture. The analytics server receives input data corresponding to the particular operational phase of the machine-learning architecture, include training data records during the training phase, enrollment data records during the enrollment phase, and newly initiated data records during the deployment phase. The analytics server applies certain layers of the machine-learning architecture to each type of transaction signal during the corresponding operational phase. In some embodiments, the analytics server receives inputs other than data.

In some implementations, the analytics server may include one or more input layers to ingest data when executing the machine-learning architectures. For example, the analytics server may be communicably coupled to the database to receive data (e.g., training data, historical data, etc.) to be used in training and/or deploying the analytics server.

During a training phase, the analytics server receives training data, including training labels (e.g., metadata) and historic data records, such as previous recommendations and user responses. In some cases, the analytics server generates various simulated training data records. The layers of the machine-learning architecture may extract various training features and training feature vectors from the entries of the training data. During training, the analytics server applies and tunes the various components of the machine-learning architecture on these training feature vectors. The analytics server applies the various layers of the machine-learning architecture on the training features to predict various features or outcomes associated with the training records.

Loss layers or another aspect of the machine-learning architectures determine a level of training-error (e.g., one or more similarities, distances, etc.) between the predicted output and labels or other data indicating the expected output (e.g., expected vectors; expected classifications; expected risk scores; expected authorization routes). The loss layers or another aspect of the machine-learning architecture adjusts the hyper-parameters until the level of error for the predicted outputs satisfy a threshold level or error with respect to expected outputs. The analytics server then stores the hyper-parameters, weights, or other aspects of the particular machine-learning architecture, thereby “fixing” the particular component of the machine-learning architecture.

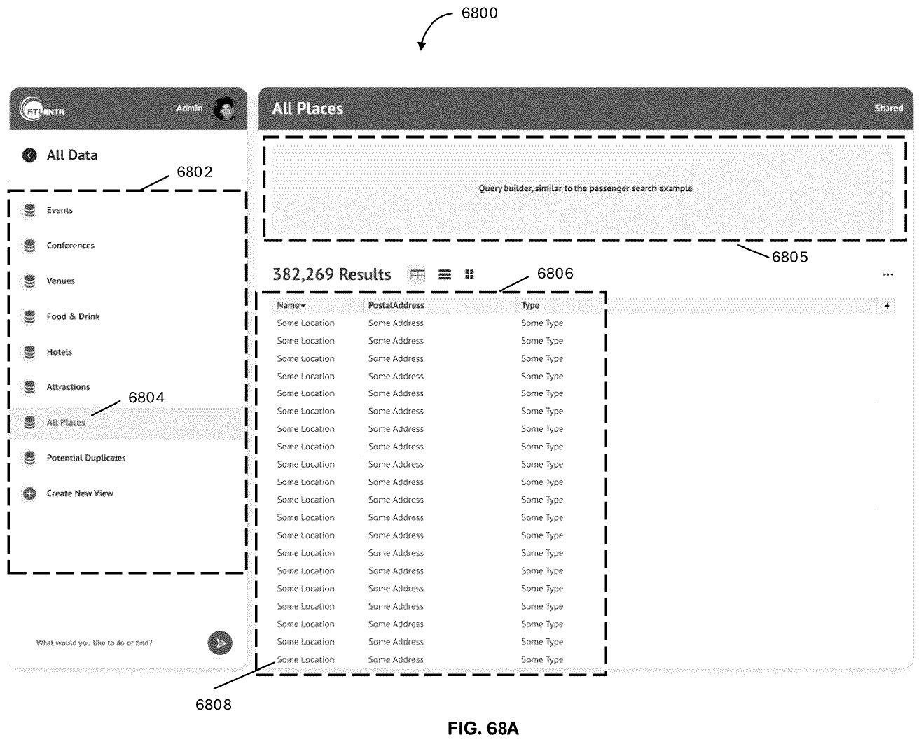

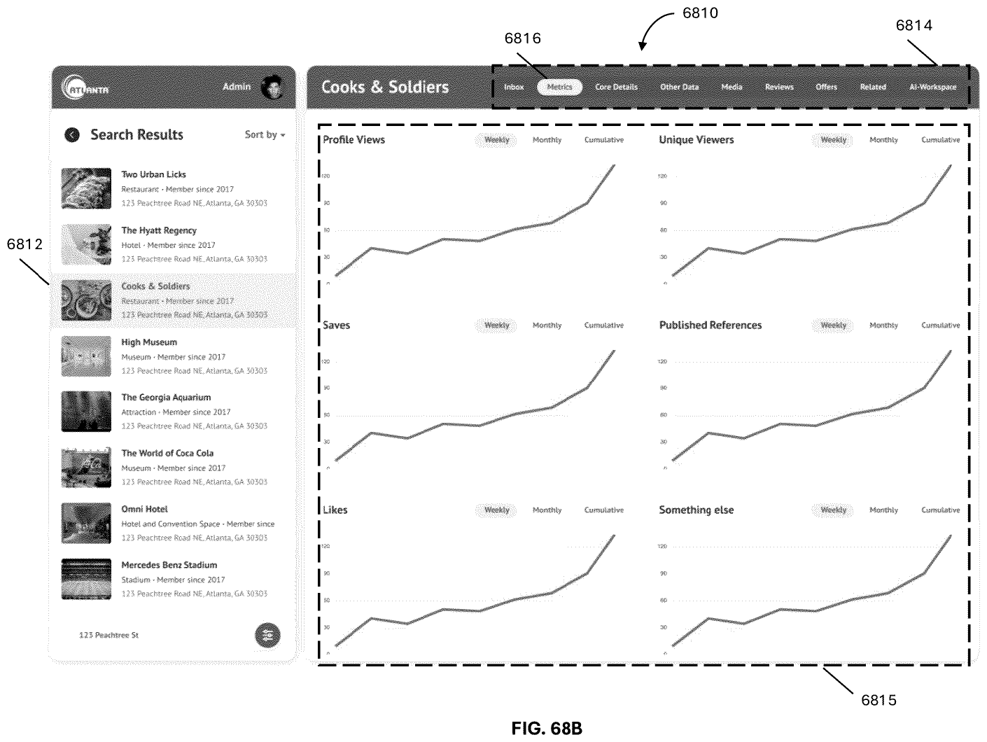

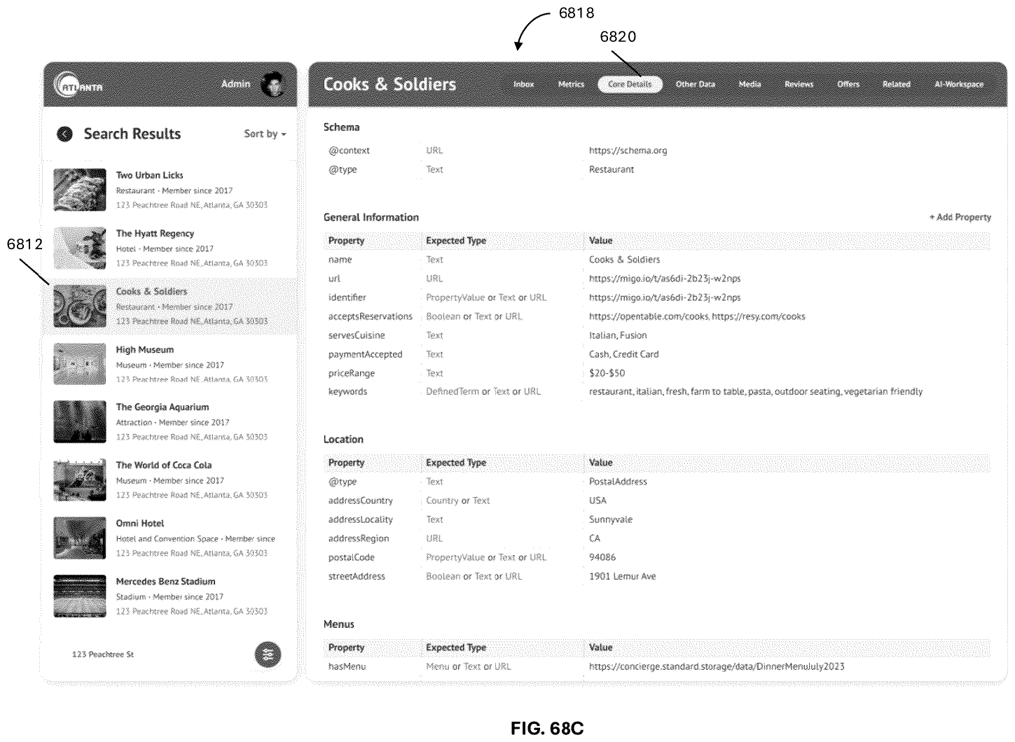

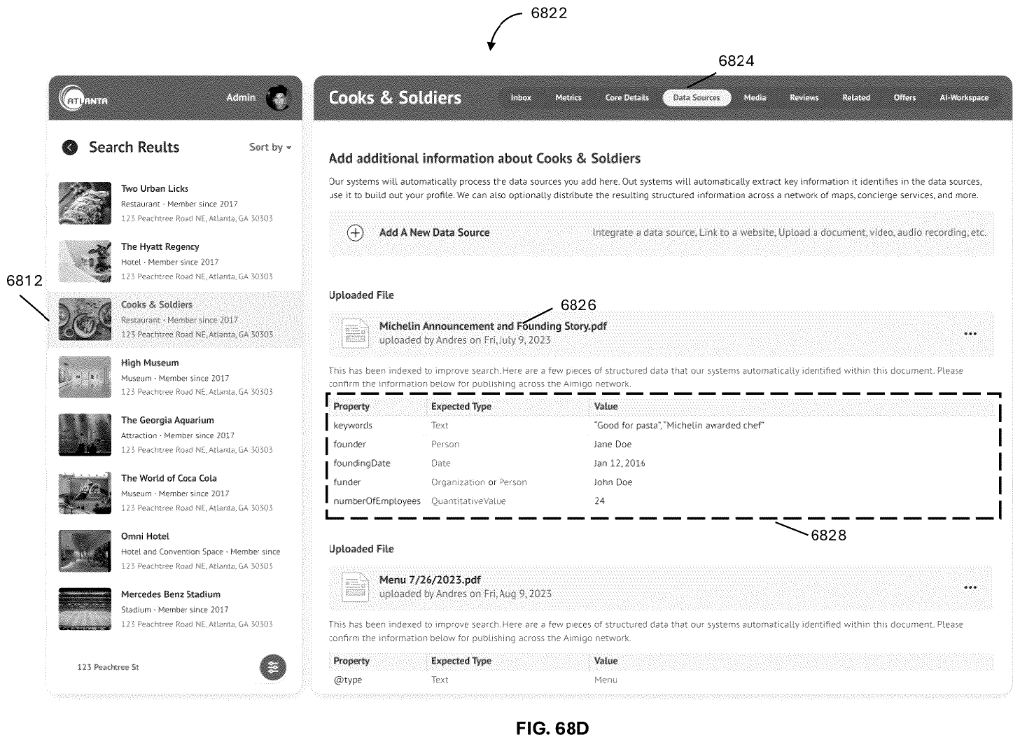

Turning now to FIGS. 68A-68D, a non-limiting embodiment of an interface view of an entity's nodal data structure. FIG. 68A illustrates an interface 6800 for viewing data linked within an entity's nodal data structure. Element 6802 provides a general listing of various Noun databases, such as “Events,” “Conferences,” “Venues,” etc. By selecting “All Places” 6804, a list of all places within the nodal data structure are presented in a table 6806. The table 6806 presents each place within the nodal data structure with its associated name, postal address, and type (e.g., restaurant, park, bar, etc.). The interface 6800 may also include a query builder 6805, in which a user may input a natural language syntax query. As described herein, the analytics server may receive the natural language syntax query inputted into the query builder 6805 and generate a query to execute within the nodal data structure. The returned data based on the generated query may be filtered to be shown in the table 6806.

A selection of location 6808 may cause the interface 6800 to display interface 6810 of FIG. 68B. The location 6812 of FIG. 68B may correspond to the location 6808 of FIG. 64A. The interface 6810 may include data filters 6814 with various filtering options to select to display various data within the SKL framework of the nodal data structure associated with the selected location 6812. The data filters 6814 may include, for example, Metrics 6816, Core Details, Other Data, Media, Reviews, Offers, etc. When selected, each of the data filters may present the relevant data in the content element 6815. For example, when the metrics 6816 filter is selected, various metrics associated with the selected location 6812 may be presented. Metrics may include profile views, unique views, saves, published references, likes, etc.

In FIG. 68C, core details 6820 is selected and relevant data is displayed on the interface 6818. Data associated with core details 6820, and thereby presented upon its selection, may include various general Nouns, such as Schemas, General Information of the location 6812, Location Data, Menus, etc. Each of the general Nouns may include sub-Nouns. For example, the General Information Noun may include sub-Nouns such as “Name,” “URL,” “Identifier,” “Accepts Reservations,” etc. These sub-Nouns may be common across all or some of the various locations within the nodal data structure and used to link between entities and other Nouns, as described herein.

In FIG. 68D, Data Sources 6824 is selected from interface 6822. As in FIGS. 68B and 68D, the selection of the filter results in a filtered selection of data associated with the location 6812. For example, with respect to Data Sources 6824, various sources from which the data for the location 6812 was retrieved is presented. This may include uploaded files 6826 and extracted data 6828 from the uploaded files 6826.

A unified database interface of FIGS. 68A-68D, representative of the entity nodal data structure 5808 of FIG. 58, allows an entity to manage the data within the nodal data structure 5808, further providing opportunities to curate the data to maintain a look and feel of a brand as desired. This may include reporting of information across channels, managing different personas and profile types for entities, project management capabilities, and more.

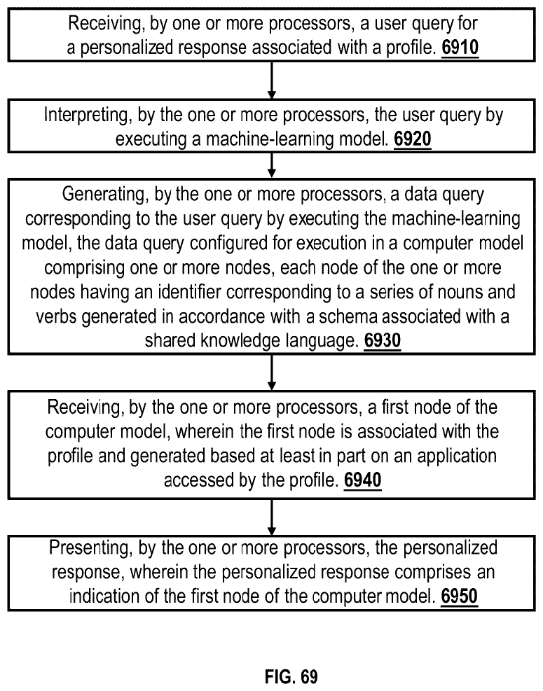

FIG. 69 is a flowchart of an example method for providing personalized recommendations/responses to a user device. At step 6910, one or more processors may receive a user query for a personalized response associated with a profile. The system may detect and capture the user's input from a user device, which may be, for example, text in natural language syntax. However, the user input may additionally include voice commands, gestures, images/videos, touch gestures, haptic feedback, handwriting, facial expressions, and/or brain-computer interfaces. The user's query may be linked to a specific user profile with an associated nodal data structure, which may contain detailed information about the user's preferences, past interactions, behaviors, and other relevant data. The processors may not only receive the query, but may also associate it with this user profile/nodal data graph to ensure that the response generated is tailored to the individual's specific needs and context. The linkage between the query and the profile allows the system to access and consider the user's unique data while interpreting the query, thus not only personalizing the final response, but personalizing the interpretation of the query.

At step 6920, one or more processors interpret the user query by executing a machine-learning model. As described, in some embodiments, the query may be written in text form in natural language syntax. The received input (e.g., user query) undergoes preprocessing, where the text may be tokenized, normalized, and/or encoded into a format the model can understand. The preprocessed query is then fed into a large language model where the model applies deep neural network architecture to understand the context and meaning of the query. Using patterns learned from training data, the model interprets the query by analyzing the words in relation to each other and the overall context. In some embodiments, the large language model may be trained, in part, on one or more user nodal data structures, such that the system can capture context for the user query from the user's own past data and interactions.

At step 6930, the one or more processors may generate a data query corresponding to the user query by executing the machine-learning model, the data query configured for execution in a computer model comprising one or more nodes, each node of the one or more nodes having an identifier corresponding to a series of nouns and verbs generated in accordance with a schema associated with a shared knowledge language.

Once the model has interpreted the meaning of the user query based on the received input, the system generates a data query that may comprise, for example, one or more search parameters and/or elements for applying to one or more nodal data structures (e.g., the user's nodal data structure and/or a DMO's nodal data structure when the user query relates to the destination of the DMO). The system extracts relevant keywords and key phrases that represent the interpreted core of the query. For instance, if the query is about the health benefits of green tea, the model might generate keywords such as “green tea,” “health benefits,” and “antioxidants.” Additionally, the model can create search parameters to refine the search, such as filters for date ranges, specific content types, or geographical locations, ensuring that the search results are relevant and timely. The model may also generate search keywords associated with the user's nodal data structure. For example, if the user is noted as being vegetarian or having insomnia within the user's nodal data structure, the system may further include a key term for “vegetarian” or “insomnia” in the data query. To further enhance the search, the model may generate synonyms or related terms, broadening the scope to include relevant concepts or alternative phrases. Combining these keywords, phrases, and parameters, the model generates a detailed search query based in the SKL framework, as described herein. If the model has access to a user profile associated with the user, it may also tailor the search terms and parameters to align with the user's preferences, ensuring the results are personalized.

As discussed herein, the computer model may include a set of nodes and each node may include data generated as a result of each user's interactions with different applications or any other activities conducted by the users. For instance, a node may correspond to any action (or a series of actions) performed by one or more.

As discussed herein, data corresponding to user activities may be transformed using schemas discussed herein, such that the data is made into a uniform and common (e.g., SKL). However, it should be understood that the SKL may additionally or alternatively allow the representation of various data types as they appear in the source, as well as providing “unified” abstractions (e.g., semantic layer/unified data and capability model). The SKL allows point to point connections as well as one to many connections in a standardized way as described in FIG. 1C. In order to do so, the analytics server may perform various methodologies discussed herein to generate nouns and verbs from actions performed by users (e.g., data corresponding to different nodes). As a result, each node may include (e.g., as metadata) an SKL that is common among all nodes. Accordingly, activities conducted by a user may be transformed, such that the transformed data does not depend upon the user, application, and/or the source of the application. Therefore, the transformed data may be uniform and only focus on the underlying activity (e.g., regardless of which application was accessed, which user accessed the application, which platform was used, or which electronic data repository/source was accessed). This data, application, source agnostic approach allows activity across different applications platforms to be unified, such that the data for different nodes can be compared against each other. For instance, activities corresponding to a first node related to accessing a spreadsheet can be compared with a second node related to a social media platform browsing history. In some embodiments, the analytics server may crawl/browse/search the internet and/or relevant databases for information. This information may then be presented to the user in the personalized response. In at least some embodiments, the natural language query may be parsed to identify keywords/phrases that may be used by the one or more processors to navigate the internet/databases.

At step 6940, the one or more processors receive a first node of the computer model, wherein the first node is associated with the profile and generated based at least in part on an application accessed by the profile. Upon running the data query with the generated search parameters, the system identifies one more nodes with the one or more nodal data graphs that are relevant (e.g., satisfy a threshold of relevancy with respect to the search parameters) to the data query. The system then executes the large language model to generate a response that includes data linked to the received one or more nodes. The system may post process the generated response for coherency and formatting. At step 6950, the one or more processors of the system present the personalized response, wherein the personalized response comprises an indication of the first node of the computer model. As shown in FIGS. 57-68D, the system may present the response in a format that the system received the user query. For example, if the system receives the user query as text from a front-end chatbot, the system may return the personalized response to the user in text at the front-end chatbot. However, the system may return the answer in any number of formats distinct from the received format. For example, the system may respond in spoken language in response to a written query, and/or vice versa.

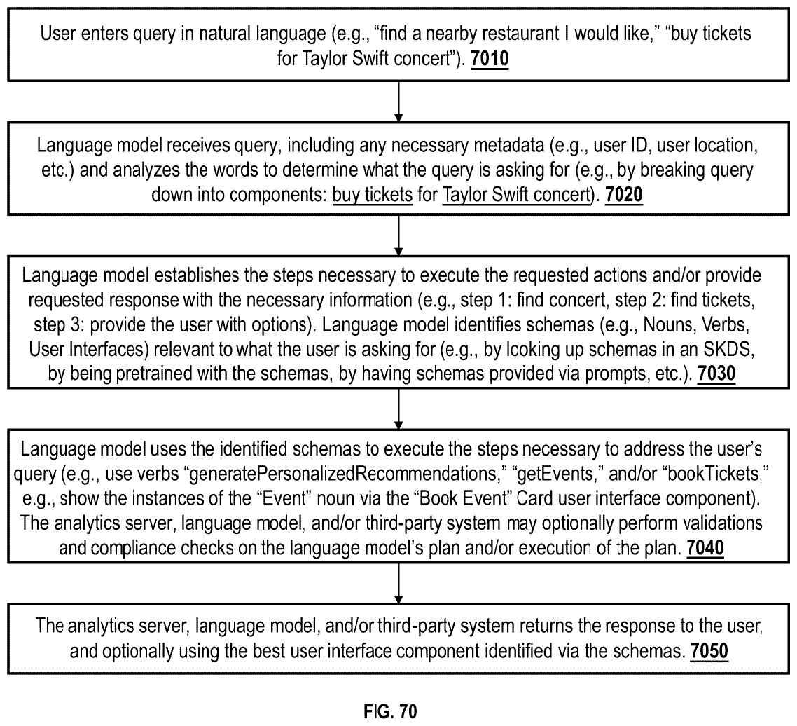

FIG. 70 illustrates a flowchart of another exemplary, non-limiting process for handling a user query and generating a personalized response, corresponding to the methods and systems described herein. The process may include the steps 7010, 7020, 7030, 7040, and/or 7050. While FIG. 70 illustrates the process as including steps 7010, 7020, 7030, 7040, and 7050, it is understood that the process may include more, less, or alternative steps than those shown in FIG. 70 without departing from the scope of the description herein. This process may, in some embodiments, demonstrate how the system interprets natural language input, leverages schemas and a computer model with nodes to identify and execute relevant actions, and provides a personalized response, including dynamically composed and configured user interfaces, based on the user's profile and query context.

Step 7010 may include receiving a natural language query at a user device, such as “Find a nearby restaurant I would like.” or “Buy tickets for Taylor Swift concert.” The natural language query may be inputted as text, vocal commands, gestures, brain signals, etc.

At step 7020, one or more processors receive the natural language query and input the natural language query into a large language model for interpreting natural language. The one or more processors may also receive or retrieve any necessary metadata (e.g., user ID, user location, user's favorite airline, user's trusted news sources, user's accounts, etc.). The one or more processors execute the large language model to analyze the words of the natural language query (whether as text or vocal commands) to determine what the query is asking for (e.g., by breaking query down into components: “buy tickets” and “Taylor Swift concert”). This process may include, for example, parsing the query into component parts and then applying the component parts to the large language model, either in part or whole.

At step 7030, the one or more processors, through executing the large language model, establish the steps to execute the requested actions and/or provide requested response with the necessary information (e.g., step 1: find concert, step 2: find tickets, step 3: provide the user with options). The one or more processors then identify relevant schemas (e.g., Nouns, Verbs, Integrations, User Interfaces) relevant to the user query (e.g., by looking up schemas in an SKDS, by being pretrained with the schemas, by having schemas provided via prompts, etc.). For example, in at least one non-limiting embodiment, the one or more processors may execute the large language model to establish the steps of looking up a website for Ticketmaster and use a YipYip-like functionality (e.g., a chatbot or automated assistant that helps with various tasks) to execute a “getTickets” functionality to access and purchase tickets via the website, versus purchasing tickets via an API.

At step 7040, the one or more processors, through executing the large language model, use the identified schemas to execute the steps necessary to address the user's query (e.g., use verbs “generatePersonalizedRecommendations,” “getEvents,” and/or “bookTickets,”). This may include operations such as generating personalized recommendations, retrieving event data, or booking tickets. For example, the one or more processors may identify instances of the “Event” noun via a “Book Event” Card user interface component. The one or more processors, large language model, and/or third-party system may optionally perform validations and compliance checks on the language model's plan and/or execution of the plan. In some embodiments, the one or more processors may use machine learning models (e.g., language and/or vision models) to search, understand, and navigate various pages on websites (e.g., an Integrations' website rather than API using a browser or headless browser) and perform the requested actions using front-end driven techniques or other methods described herein.

At step 7050, the one or more processors, the large language model, and/or third-party system returns the response to the user, and optionally using the best user interface component identified via the schemas. The one or more processors, after determining the relevant information and/or actions presents the relevant information and/or actions to the user, for example, on the user device. The one or more processors determine a graphical interface format to present the user. In some embodiments, the graphical interface format may include graphical elements, indicators, prompts, data, attributes, etc.

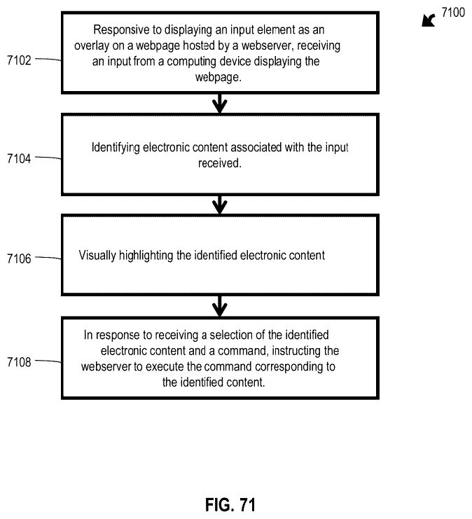

FIG. 71 displays a method executed by the analytics server that allows a user to search and/or navigate electronic content displayed or that can be displayed (e.g., using a headless browser) on a computer. For instance, the analytics server may execute the method 7100 to allow users, including “AI-based-user” such as large language model powered system, to navigate a website using their keyboard and without needing to use any other input devices/elements, such as a mouse. The analytics server, as used herein, may include a browser extension, any code running on the user's computer (implemented by the analytics server or a third party), etc. This code and/or related configuration could also be semi-self-generating (e.g., as it learns from user behavior to do new types of searches and/or selections).

In some embodiments, the term “user” as used herein can also refer to an AI-based user or “agent” capable of performing tasks on behalf of a human user. These AI-based agents, such as those powered by large language models, can process information to appear to “think” or “reason” in ways that mimic human cognitive processes. For instance, when navigating the web, an AI agent can utilize ARIA (Accessible Rich Internet Applications) labels, HTML structure, and/or other semantic elements to understand and interact with a webpage in a manner similar to a human user. The AI agent can interpret these elements to make decisions, such as selecting the most relevant content or determining the best user interface component to present. Moreover, the AI agent's decision-making process can be dynamic and adaptive, learning from user behavior and past interactions to improve its ability to perform complex tasks autonomously. This capability allows the AI-based user to efficiently navigate electronic content, perform searches, and make selections without the need for traditional input devices, such as a mouse, thus enhancing the overall user experience and accessibility by allowing the agent to perform more complex tasks made up of smaller steps with general expressions of intent.

The method 7100 may describe the analytics server acting on a “webpage hosted by a webserver.” The webpage could also be hosted on the user's personal computer (e.g., local files opened in the browser with the file://protocol). Moreover, the methods and systems described herein are not limited to webpages. They also apply to any electronic content (e.g., it could be an NSView in an iOS app, an Apple TV Markup Language document, WPF or XAML document for windows desktop applications, etc.).

These methods and systems also apply to speech input which gets translated into text then follows the same process as keyboard text input. They also apply to other forms of human-computer interaction devices such as cameras, haptic input devices, and brain scanning devices that allow the translation of user generated inputs into text commands and/or parameters.

At step 7102, the analytics server may, receive an input from a computing device displaying a webpage responsive to displaying an input element as an overlay on the webpage hosted by a webserver.

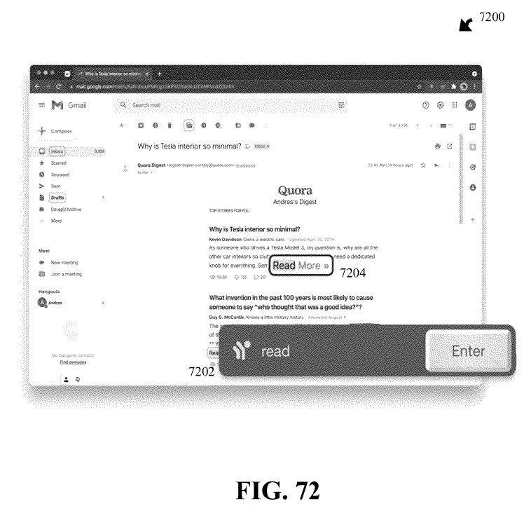

Referring now to FIG. 72, a non-limiting example of a website and the overlay is provided. The analytics server may display a graphical element on the user's computer. The graphical element may be controlled by the analytics server through a browser extension. For instance, the user may download the browser extension and, as a result, the analytics server may display the graphical element on the user's computer. Alternatively, the computing device's operating system or the browser application may have the graphical element and analytics server included, thereby removing the need for an extension. Regardless of the exact configuration, the analytics server may display the graphical element as an overlay over the electronic content being displayed on the user's computer. The graphical element may include an input element, as depicted in the graphical element 7202 displayed as an overlay to the webpage 7200. The graphical element 7202 may also include the “enter” button indicating that the user would like to proceed with searching for the inputted term. In other words, the primary command for the graphical element 7202 is “enter” or “select.” The graphical element 7202 allows the user to input a desired term (e.g., “read” as depicted in FIG. 72).

Even though certain aspects of the present disclosure describe and depict a graphical element having an input element that is displayed throughout the process, in some configurations, the graphical element may be dormant and hidden from the user (e.g., operating as a background process). For instance, the graphical element may not be displayed, however, the analytics server may be monitoring the user's key stokes (or other input devices such as a microphone) to identify any input received from the user. In that way, the same services described herein (e.g., method 7100) can be provided without obfuscating the user's view of the electronic content (e.g., webpage 7200).

The input element is not limited to alphanumerical strings and characters inputted by the user using a keyboard. In alternative embodiments, the user may input the desired terms using audio input elements or other input elements, such as eye-controlled input elements, special keyboards, sip and puff (SNP) input devices, and the like.

In some embodiments, the user may use voice commands for their input. In those embodiments, the analytics server may utilize a voice recognition protocol to identify the voice command received from the user.

In some embodiments, the analytics server may use translation services to allow a user to input commands in one language and convert them into commands in the detected language used by the webpage and select results accordingly. This is particularly relevant for webpages or web browser which do not offer translation of the text on a webpage.

Referring back to FIG. 71, at step 7104, the analytics server may identify electronic content associated with the input received. Using various methods and systems described herein, the analytics server may analyze the electronic content and determine one or more parts of the electronic content that correspond to the input received at step 7102.

In a non-limiting example, when a user types in the input element provided by the analytics server (e.g., search bar on a webpage or the graphical user interface 7202), the analytics server recursively scans through the webpage's document object model (DOM) node tree to find all DOM nodes which match the user's query. As used herein, the DOM is an interface that treats HTML or XML documents as a tree structure, where each DOM node is an object of the document. DOM also provides a set of methods to query the tree and/or alter the structure or style. Therefore, a DOM node is different than the nodes described in relation to the nodal data structure discussed herein.

Whether a DOM node matches the query or not may be determined by detecting if any text within the DOM node includes the user's query or if an attribute of the DOM node includes the user's query. The analytics server may use this method of scanning DOM node attributes hidden to the user to identify buttons and/or actions displayed on the webpage which, for example, only display an icon and no text (e.g., based on the buttons functionality rather than text displayed on the button or action). Not all attributes of a DOM node may be relevant to the user's query or relevant to be used by the analytics server executing the method 7100. Thus, the analytics server may only search a specific list of attributes per DOM node based on its tag name. These tag data may be found in files associated with the webserver hosting the electronic content being displayed on the user's computer. For instance, the analytics server can analyze JSON files and execute corresponding code to analyze DOM nodes, such as the following:

```
{
  “A”: [“title”, “aria-label”, “href”],
  “INPUT”: [“name”, “placeholder”, “value”, “aria-label”],
  “SELECT”: [“name”],
  “TEXTAREA”: [“name”, “placeholder”],
  “BUTTON”: [“name”, “aria-label”],
  “DIV”: [“title”, “aria-label”, “data-tooltip”],
  “SPAN”: [“title”, “aria-label”, “data-tooltip”]
}
```

In addition to matching nodes against the user's exact query (e.g., input received in step 7102), the analytics server may also match the input received against synonyms of the user's query, as well as other words and phrases with similar meaning. In this way, the user who has expressed their intention in a slightly different manner may still see results generated by the analytics server, even though the webpage may not include the exact term inputted by the user. For instance, a user may input “trash” where the user would like to “delete” a file and where the webpage uses the term “discard” to mean the same thing. In this way, the analytics server may identify the user's intention and identify the text “discard” within a DOM node or a DOM node's attributes.

The analytics server may use a precompiled synonym library or a word similarity algorithm (e.g., word2vec libraries, sentence2vec libraries). Alternatively, the analytics server may use one or more configuration files (generated by the analytics server or a third party) per URL host (e.g., webserver) with synonyms specific to that host. Effectively, each configuration file can be thought of as mapping to an “App” used in the browser (e.g., mail.google.com for Gmail, news.ycombinator.com for Hacker News). More specifically, the analytics server may choose from various configuration files related to a specific URL host, depending on what specific website the user is viewing. For example, the analytics service might use different configuration files when the user is viewing his email inbox, when he is reading an email, and when he is writing an email draft. In some embodiments, the specific configurations may be identified by the attributes of the webpage the user is viewing, such as attributes of the webpage's full URL, attributes of the webpage's header, or attributes of the webpage's page source (e.g., inside the head tags, using schema.org information).

Some embodiments may consider configuration files based on other criteria, such as the identification of a particular unit of work on the webpage or the identification of a certain type of functionality on the webpage, rather than only the URL host the webpage belongs to. For example, various email tools are likely to offer similar functionality and use similar terms. These various email tools may therefore also have a high likelihood of successfully sharing the same configuration file(s) across URL hosts. In this way, if a particular configuration file is missing for a URL host, then the analytics server might be able to rely on generic configuration files for “email” tools, or even configuration file(s) from other “email” tools with specific URL host data.

In some embodiments, the analytics server may ask the user to provide the missing information in order to best understand what types of actions are important. In other words, the analytics server may ask a user to provide a “word” or “description” and to correlate them with specific action(s) and/or interactions(s) that he would like the analytics server to simulate and/or provide via the graphical input 7202. The user may, for example, provide the necessary configuration file(s), be guided through a no-code set-up wizard for a given webpage that relates an action with one or more words, and the like.

After finding all DOM nodes corresponding to (e.g., matching) the user's query, the analytics server may filter those nodes down to only those which are likely to be able to be selected or otherwise acted upon by the user. The analytics server may use various factors to identify this subset of the DOM nodes. The following is a non-limiting list of factors used to determine whether a DOM node that has been identified as corresponding to the user's query is able to be selected or otherwise acted upon:
If the DOM node's tag name specifies that it's a button, link, or input;
If any of the DOM node's attributes specifies that it's a button, link, or input; or
If the DOM node matches an additional selector defined in the configuration file (e.g., under the additional_button_selectors config).

Using various scoring algorithms, the analytics server may score each of the matched buttons, links, and inputs (e.g., corresponding to the DOM nodes identified within the webpage), which will be selected. The analytics server may use these scores to determine which DOM node is the “best”, or most relevant, matching DOM node that will be selected first. Of course the “best” matching DOM node is highly contextual based on several factors. For instance, a DOM node's score may be increased if:
the match was made through text on the screen vs. a hidden attribute of the node, the match was made through the user's exact query vs. a synonym,
the match is visible on the screen to the user vs. not visible,
any words in the match's fields start with the user's query vs. just including the query,
any words in the match's fields are in the user's query and are in a list of “relevant words” in the configuration file, or
The node matches one of the selectors in the list of “relevant selectors” in the configuration file.

Each of the above-described factors may have a related weight which determines how much it effects the DOM node's score.

Using the above-described methods and schemes, the analytics server may determine which identified DOM nodes is “better” than other identified DOM nodes.

At step 7106, the analytics server may visually highlight the identified electronic content. Once the matching buttons, links, and inputs (corresponding to identified DOM nodes) are found and sorted according to their respective score, the analytics server may visually highlight the corresponding content on the electronic content displayed on the user's computer. For instance, the analytics server may add a selection box around each node and focus and automatically scroll to the one with the highest score. Referring now to FIG. 72, when the user enters “read,” the analytics sever displays the box 7204 around “read” displayed on the webpage 7200.

In some embodiments, a user can then press the tab key (e.g., or any other preconfigured key) to move through the matches. For instance, if the analytics server has identified five instance of “read” within the webpage 7200, the user may be able to navigate through all choices.

Additionally or alternatively, the analytics server may use the HTML structure to return results related to a given query that does not necessarily match the query's exact terms. For example, a group of related buttons that are contained in the same HTML element (e.g., a div or container), could be selected and toggled through by their association to each other, given that at least one of the results matches the query with some level of relevance. This type of selection could be provided through configuration for a given webpage type (e.g., by domain, by type, by some combination of multiple attributes, by a custom classifier, etc.)

Referring back to FIG. 71, at step 8008, the analytics server may, in response to receiving a selection of the identified electronic content and a command, instruct the webserver to execute the command corresponding to the identified content.

The analytics server may receive a selection of the visually highlighted content and a corresponding command. As a result, the analytics server instructs the webserver to execute the command. For instance, and referring back to FIG. 72, the user can press the enter key to click or focus the selected button, link, or input (e.g., box 7204). As a result, the analytics server activates the hyperlink depicted within the box 7204 and directs the user to the corresponding new webpage.

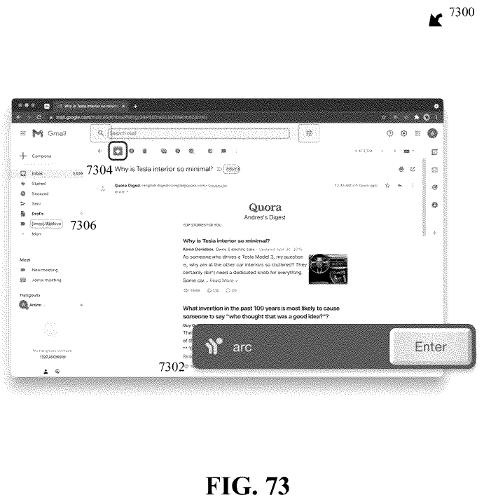

FIG. 73 depicts a second non-limiting example. In this embodiment, the analytics server displays the graphical element 7302 as an overlay on the webpage 7300 using a browser extension (not shown). When the user inputs “arc” (using the keyboard or by speaking “arc” into a microphone), the analytics server identifies two DOM nodes that correspond to the boxes 7306 and 7304. As depicted, the box 7304 corresponds to a button and not the word archived as the box 7306. When the user interact with the “enter” button of the graphical element 7302, the analytics server instructs the webserver to activate the archive button and archive the email displayed on the user's computer.

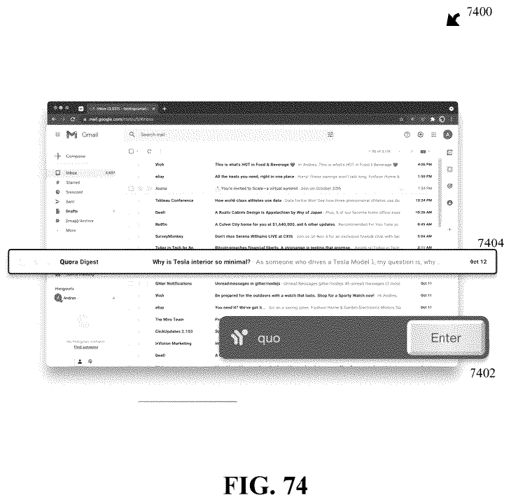

FIG. 74 depicts yet another non-limiting example. In the depicted example, the user is viewing the webpage 7400, which is a list of emails received or that is associated with a user's account. When the user inputs “quo” into the input element of the graphical element 7402, the analytics server highlights the identified content (e.g., displays the content 7404 as larger than the rest of the content within the webpage 7400). When the user interacts with the “enter” button, the analytics server instructs the webserver to open that selected email.

Additionally, the analytics server may combine the method 7100 described herein with speech recognition protocols to allow users to navigate most webpages without a mouse or other input elements. To achieve this result, the analytics server may execute the following steps:

In some embodiments, the analytics server may use a Web Speech API to identify the user's voice commands. For instance, when the user audibly inputs a command, the analytics server may open a search bar, such as the graphical element discussed herein. For instance, when the user says “YipYip,” the analytics server opens the search bar and actively listens to the user to receive an input. For instance, the analytics server receives an input from the user and identifies the input using one or more speech recognition protocols.

The analytics server may use the methods and systems discussed herein to identify the content and visually highlight the identified content. Then the analytics server may actively listen to the user, such that the user can navigate through the highlighted content to make a selection. For instance, the user may say “Yip Yip next” to select a next match or say “Yip Yip last” to select a previous match.

When the user is satisfied with the selection, the user may say “YipYip select” to press enter and the analytics server may instruct the webserver to execute the corresponding command for the selected content.

Using the methods and systems described herein, the analytics server may provide an assistive technology to help people with disabilities as they are no longer required to use a mouse to interact with the web. Using the methods and systems described herein, a user can navigate any website on a television or remote display using a remote (using only auditory commands). Using the methods and systems discussed herein, a user can navigate the web in virtual or augmented reality settings where a mouse and/or keyboard are not always the best human-computer interaction methods.

In other embodiments, other technologies could also be combined with the method 8000 to improve the search and selection, such as computer vision, optical character recognition, and similar algorithms/processes to identify objects and text on a website, screen, or otherwise captured via a camera or sensor (e.g., in the real world) and then be able to select elements in images/videos/3D scenes regardless of whether they have the necessary text.

In another embodiment, the analytics server may also execute a natural language processing/understanding protocol to understand the user who is inputting their command in natural language. As a result, the analytics server may identify the elements on the screen that match some relevance threshold regardless of whether it is a direct keyword match. Users could then select (or perform some other action) on said element. For instance, the user may say “send an email to my wife” and the analytics server identifies the corresponding front end elements to press in the necessary sequence and can look up the necessary information for who the user's wife is from the nodal data structure or other database. Similarly, the user may say “let's move to the second option” and the analytics server identifies the “second option” and commands the webserver to navigate to the corresponding webpage.

In some embodiments, the analytics server may automatically identify the types of data being shown on a given website, as well as the functionality provided on that website (e.g., be able to identify that the electronic content is showing the compose page for “email” tool). Non-limiting examples of this include looking for classifying information within the webpage's page source (e.g., the webpage could provide the necessary configuration itself so that no external files are needed, via for example schema.org schemas and schema.org actions), looking for certain keywords and/or similarities with other known webpages (e.g., by looking at the metadata in the webpage's head tags, looking at the DOM, etc.), and the like.

In another embodiment, the analytics server may use machine learning techniques to optimize the selection process such that the correct element is selected more quickly. The analytics server may train a model to determine which highlighted content is more suitable for a particular user. For example, the trained model may determine that most users select a particular element on pages having a particular attributes (e.g., pages with Y attributes) when performing queries regarding a certain topic (e.g., queries having X attributes).

In another example, the trained model may determine that users looking at pages that have a certain attribute attributes (e.g., content that corresponds to a file, message, task, etc.) tend to request a certain type of actions (e.g., usually input a request that has a determinable attribute) on these types of elements (having some determinable attributes).

In some embodiments, the analytics server might take one or more screenshots of the webpage and use computer vision techniques to classify what the page is, what functionality it offers, what data types are visible on screen, and/or to find closeness of similarity with other applications and data types that have existing configuration files.

In some embodiments, the analytics server might leverage existing libraries of commands for certain applications and operating systems to execute commands that a user types. In other words, the analytics server could use configuration files from external systems (e.g. AppleScript) in order to execute commands in certain applications.

In some embodiments, the analytics server might use alternate methods for tracking events and/or changes to files on one or more system including, but not limited to, periodically polling for changes in the necessary systems, using kernel subsystems (like “inotify” on Linux and “kqueue” on FreeBSD/MacOS), using eBPF (e.g., to run filesystem notification and file watching programs like git), leveraging observability frameworks like OpenTelemetry and other tools like Webpack (e.g., features like Watch and WatchOptions) and Skaffold to monitor various systems, and using technologies similar to Visual Studio's Spy++ (e.g., to identify all windows and UI elements that make up a given application).

The methods and systems discussed herein also apply to other types of actions beyond “selecting.” For example, other commands may include “copy,” “print,” “save,” “send,” “comment,” “add task,” “go to next post,” and the like. These actions can all be done within each system/website or in a nodal data structure described herein.

Furthermore, the actions and interactions can be used to interact with data from more than one system, application, operating system, database, website, and the like. In this way the user (human or machine) can select elements on the page and relate the underlying data to other data, such as: (1) existing data in other applications and tools like a third-party CRM, task manager, messaging tool, electronic health record, warehouse management system, etc.; (2) newly created data of various types such as a note, task, message, comment, @ mention, drawing, etc. that can be primarily stored in the nodal data structure, (3) and more.

As described above before, user actions can be tracked and used to establish edges between nodes in the nodal data structure. The analytics server may, for example, track copy-paste actions and establish back links and sources across the data being copied from and the data being copied to. This can be done by tracking keyboard shortcuts, tracking front end elements that are being clicked on, tracking the clipboard, etc. Similarly, other actions such as “open link,” “move,” “print,” or “save as” can be tracked using similar methods, including front end components. Actions such as these and others that are unique to particular applications (e.g., creating a reference within one excel to second excel file, adding an AutoCAD block in one file with information that exists in another file, adding source material in Adobe After Effects) are able to be used to establish edges between nodes, as well as label the edges (e.g., “source,” “related,” “output,” etc.) depending on the action being taken.

For instance, if a user is navigating the web and clicking through various links, the analytics server can keep a record of where the user navigated from when he got a particular website so that the user is always able to see where the user came from last time the user looked that the website, the link the user clicked, and where the user went from here.

For instance, the methods described herein may also be used to track what a user is doing through traditional means, such as by normally interacting the graphical user interfaces provided by each website, application, operating system, etc. If a user is printing a webpage to “save as” a PDF (or otherwise “saving as” from any given application) the analytics server may be able to track that the user is “saving as” using a variety of methods such as tracking what elements are being clicked on, using computer vision and/or optical character recognition to identify that the save dialogue is open, etc. For example, a user clicking on a “print,” “save as,” or “export” button within an application could be tracked as described herein and that action could be used as a trigger by the analytics server. The analytics server could then watch for any newly created files and automatically establish a relationship with a specific classification between the node representing the file, website, etc. that is open within the tracked application and the node corresponding to the newly created file. In this example, the file that was open may be automatically related as the “source” or “parent” of the newly created file that may have been identified via tracking a second system other than the open application such as the computing device's local file system. Ultimately, the analytics server is able to automatically relate the file being saved with the data being viewed.

For instance, if a user is using video editing software such as Adobe After Effects or Adobe Premier, then the user usually has to import source videos. Today, if those source videos get moved after they have been added to After Effects or Premier, the video editing file stops being able to render the edited video in the editor. Using a system like the one proposed here, the user (and Adobe After Effects) would be able to keep track of where that file was moved to and show the user the location via the nodal data structure.

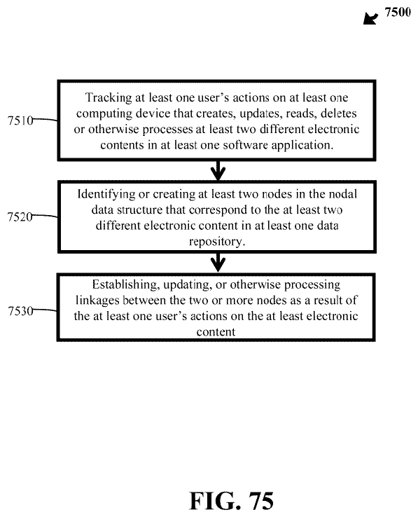

FIG. 75 displays a method executed by the analytics server that tracks user actions to automatically establish, update, delete, classify, reclassify, and otherwise manage relationships between nodes in the nodal data structure. For instance, the analytics server may execute the method 7500 to automatically track a user's actions on a computing device in order to automatically manage the relationships between nodes that correspond to the electronic content the user is interacting with. The analytics server, as used herein, may include a browser extension, a locally installed application, an operating system, any code running on the user's computing device (implemented by the analytics server or a third party), any code running on a remote server that is able to track electronic content, etc.

Using the method 7500, the analytics server may establish a baseline by tracking user actions across different electronic contents. As used herein, electronic content may refer to any content that is outputted for a user and/or can be interacted with by the user. Non-limiting examples of electronic content may include units of works (as discussed herein), software tools, objects, units of work/nodes, and the like. The analytics server may then create links on the corresponding nodes (e.g., link the back-end nodes corresponding to the relationships identified). In some embodiments, the content monitored and tracked may belong to different data sources and/or data repositories.

Other non-limiting examples of electronic content may include units of work (e.g., a document, an image in a document, an event, comments on a document, revisions to an email). Therefore, electronic content may refer to anything that can be interacted with by a user, such as a part of a string of text within a document, the contents of a cell within a spreadsheet, an email message, a doctor's note on a patient record, part of a record/row in a SQL database, and the like.

In some embodiments, the electronic content may be the nodal data structure itself. For instance, a user (e.g., an administrator) may interact with the nodal data structure or may expressly designate certain content as related.

The method 7500 may describe the analytics server monitoring actions on at least two different electronic contents in at least one software application. In a non-limiting example, the analytics server may monitor one or more actions that interact with two files within one file storage system, may monitor one or more actions that interact with two files in two file storage systems, may monitor interactions on two different electronic contents stored within one file in one application, may monitor one or more actions that interact with data in an email message and with data on a news website, and/or may monitor one or more actions that interact with data in one spreadsheet in a web application and data in a second spreadsheet on the same web application.

At step 7510, the analytics server may use any of the methods described herein to monitor user activity on at least one computing device and infer relationships between data that the user is interacting with. The analytics server may automatically establish, update, delete, classify, reclassify, and otherwise manage relationships between nodes in the nodal data structure that corresponds with the data the user is interacting with.

In some embodiments, the analytics server may monitor user actions across multiple computing devices in order to infer relationship. For example, the analytics server may track a user may send data from one computing device (such as a computer) to a second computing device (such as a mobile phone) using protocols that don't leave easily accessible records (such as AirDrop, Apple's close-range wireless communication protocol) and automatically create relationships between the data on the first computing device and the data on the second computing device.

The following is a non-limiting example of an implementation of the method 7500. A user viewing a certain email message in a mobile app clicks on a link that opens a page to buy a consumer product in a second mobile app. In this example, the link in the email message does not match the page that was opened in the app (e.g., due to the email using a tracking link, due to the mobile app using different URLs, etc.) and the mobile device has an application installed that allows the analytics server to monitor electronic content. Despite the mismatched link and URL between the email and product page, and because of the ability to monitor electronic content, the analytics server is able to track that this product page was opened as a result of the user clicking a link in the email message and therefore establishes a link between a node representing the email message and a node representing the product. The analytics server may classify that linkage between the email node and the product according to the action, which in this case could be “user navigated to/from”. If that linkage and classification already exists, the analytics server might also increase a count associated with that classification from “1” to “2” since this would be the second time a user is navigating to that product from the email. In this way, the analytics server can automatically manage relationships between nodes according to various configurations and monitored actions. Whenever a user (e.g., the user or a system acting on behalf of the user) interacts with that product in the future, the analytics server will also be able to also access information from the email message (e.g., should it be contextually relevant).

In some embodiments, the application installed on the mobile device could monitor electronic content in a similar way to method 7100. In this example, the user would elect to open the link to the product from the email message via an input element (e.g., input element 7202) as described in method 7100, which enables the analytics server to know exactly what operation was done on what. The analytics server can then continue tracking the electronic content of the mobile device through until the operation is completed (e.g., the desired page finishes loading) and then proceed to establish or otherwise update a back-end linkage(s) between node(s) corresponding to the electronic content identified at step 7104 and nodes corresponding to newly loaded or identified electronic content.

In an alternate embodiment, the application installed on the mobile device is monitoring electronic content and doesn't require having to start with method 7100. In this example, the user would elect to open the link to the product from the email message by simply clicking on it rather than by opening a separate input element (e.g., input element 7202). Because the analytics server is not being directly provided with the desired action in this scenario, it could resort to monitoring the electronic content automatically (e.g., by creating and comparing caches of electronic content). For instance, when the user clicks on the link in the email message, the analytics server may track the action performed (e.g., by listening for Mouse Event or Message Event, which are types of Events in the webpage's DOM) and thereby establish or update linkages between nodes associated with changes in the electronic content.

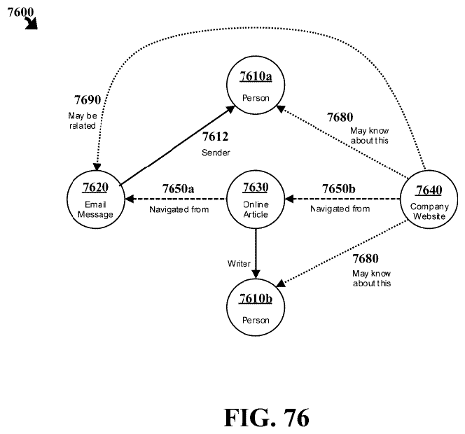

FIG. 76 shows an embodiment of the nodal data structure 7600 representing several units of work that a user is interacting with. The nodal data structure 7600 includes nodes for an email message 7620 that was sent to the user by a person 7610a, an online article 7630 that was written by a second person 7610b, and a company website 7640 that the user is currently viewing. In this example, the analytics server may have created nodes representing each unit of work as the user interacted with each unit of work. In other words, there may not have been any connection to the various systems using backend processes such as API connections. Instead, the analytics server may have identified the necessary information to build the nodal data structure from the information available in the electronic content (e.g., it may have identified that the online article 7630 was written by person 7610b by looking at the schema.org information). The nodal data structure 7600 may be represented through various data structures including but not limited to relational databases, NoSQL databases, object-oriented databases, graph databases, decentralized databases, and blockchains.

Referring back now to FIG. 75, at step 7520, the analytics server may identify what the actions the user is performing on electronic content are and identify (and update) existing nodes or create new nodes in a nodal data structure (e.g., the nodal data structure 7600) that correspond to units of work in the electronic content. The nodal data structure 7600 also includes edges between nodes. These edges may have metadata such as classifications (e.g., duplicate, source, manager, etc.) with certain confidence scores, other relevancy scores, and more. In this example, edge 7612 specifies that the person 7610a was the sender of email message 7620, and edge 7614 specifies that online article 7630 was written by person 7610b. In some embodiments, each edge and related metadata may be represented as a node with type “relationship” that is connected to other nodes in the nodal data structure. The analytics server may read, create, update, and delete any nodes and other information in the nodal data structure as necessary to properly maintain an accurate record of the units of work and/or electronic content being represented.

In some embodiments, the analytics server may also use and/or manage additional data structures to help compare the similarities of various nodes, including but not limited to, vector databases, matrices, and the like.

The nodal data structure 7600 shows how the analytics server may have monitored the user's actions and identified that the user clicked a link in the email message 7620 that opened online article 7630. Many email messages today have links have that go through tracking URLs before taking the user to the desired content. These tracking URLs, for example, can make it more difficult to relate linked content with the email message simply by indexing the contents of the email. Similarly, several social platforms (e.g., LinkedIn) transform links through link “shorteners” that may obfuscate the actual URL of any given webpage shared through that platform. Regardless of these obfuscated links, the analytics server may establish a relationship between email message 7620 and online article 7630, for example, by monitoring the user's activity and identifying that the online article 7630 opened after the user clicked the link in email message 7620, and before the user performed any other meaningful subsequent action. The analytics server is therefore able to automatically establish the edge 7650a between the corresponding nodes and additionally add metadata to the edge 7650a specifying that the user navigated to online article 7630 from email message 7620 and that email message 7620 references online article 7630. Similarly, when the user clicks a link in online article 7630 that takes the user to company website 7640, the analytics server may establish edge 7650b.

In this way, the analytics server may track user behaviors in order to establish edges 7650 between email message 7620, online article 7630, and company website 7640. The analytics server is then able to establish relationships and recommendations between company website 7640, person 7610a, person 7610b, and email message 7620 using the various methods described herein.

Referring back to FIG. 75, at step 7530, the analytics server manages relationships between nodes through tracking the user's actions. Existing data correlation methods are unlikely to be able to easily recognize these relationships, thereby losing the potential value that the structured and interrelated data may offer. For example, the analytics server could contextually present related information from any of the linked nodes at any future point in time when the user visits or searches for the company related to the company website 7640.

In some embodiments, the analytics server may use additional methods to evaluate the nodes and/or the nodal structure and establish or modify relevance scores and classifications between the various nodes in order to most effectively present useful data to the user. For example, the analytics server and/or related configuration could have self-learning aspects such that it may independently learn and/or infer that certain actions suggest certain classifications of edges and/or that certain actions may provide more useful relationships and classifications than others. Several of these methods are described elsewhere herein.

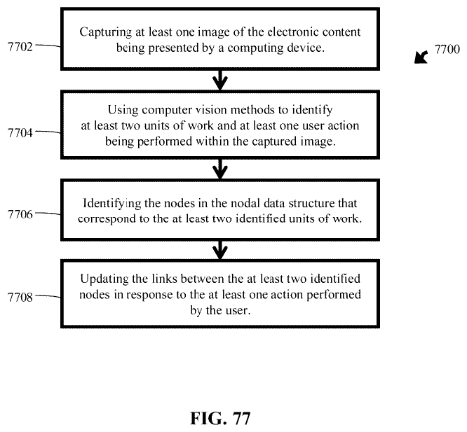

FIG. 77 illustrates an alternate method executed by the analytics server to automatically establish, update, delete, classify, reclassify, and otherwise manage relationships between nodes using computer vision techniques. In other words, the analytics server may execute the method 7700 to automatically track a user's actions on a computing device using computer vision techniques and then automatically manage the relationships between nodes that correspond to the electronic content the user is interacting with. The analytics server, as used herein, may include a browser extension, a locally installed application, an operating system, any code running on the user's computing device (implemented by the analytics server or a third party), any code running on a remote server that is able to track electronic content, etc.

The method 7700 may describe the analytics server capturing at least one image of the electronic content being presented. The “capturing” may be done by other systems not encompassed within the analytics server. Furthermore, a computing device could capture information from non-digital sources and transform it into electronic content thereby enabling analog sources to be considered electronic content once it is captured by a computing device. In other words, the data being captured does not need to be an “image” and could be one or more videos, one or more audio recordings, and other information formats which are generally for human interaction rather than direct machine processing (e.g., a 3D scan of a 3D printed object, a picture of a printed newspaper, etc.).

At step 7702, the analytics server may capture the electronic content and prepare it for use in step 7704. The capturing and preparation may be performed by the analytics server or a third-party system. In various embodiments, the analytics server may use the users computing device, a remote server, and/or multiple computing devices in order to perform the various methods described herein.

At step 7704, the analytics server may use computer vision methods, including but not limited to classification, object detection, and optical character recognition to identify units of work within the electronic content. The computer vision methods may be performed by the analytics server or a third-party system in order to identify open applications, images, files, text strings, URLs, file paths, locations, people, and more such as which applications are in focus, which buttons are being clicked on, what data are being selected, etc.

At step 7706, the analytics server may read, identify, and/or create, nodes in the nodal data structure that correspond to the units of work identified in step 7704. If a given unit of work is identified in the electronic content through step 7704 but a corresponding node is not identified in the nodal data structure, then the analytics server may create a new node.

In some embodiments, the analytics server may search for similar nodes in the nodal data structure that may not be exact matches to an identified unit of work, by for example creating a vector of the identified unit of work and finding similar vectors. In some cases, if the relevance threshold falls within a certain tolerance, then the analytics server may consider them to be duplicates and thereby create a representation of a de-duplicated entity (e.g., unit of work) in the nodal data structure.

In some embodiments, the analytics server may also use alternate methods for determining similar nodes, by for example using alternate hashing functions such as perceptual hashing and locality-sensitive hashing to create unique values for various similar inputted units of work. For example, when two similar images that are passed through the same perceptual hashing algorithm end up with the same hash, they may be recalled by the analytics server according to that shared hash.

At step 7708, the analytics server may read, create, update, delete, or otherwise process the edges between the identified nodes according to an action performed by the user that interacts with the nodes' corresponding units of work, by for example, using the various methods described herein (e.g., if a user copies data from one node to another, then the one node is related as a source to the other). Through this step, the analytics server may, for example, update relevance scores, classifications and certainties, as well as change other metadata related to the edge between two nodes.

The following is a non-limiting example of an implementation of the method 7700. A designer is working on a computing device that has software installed that continuously records video of everything the designer is doing. As the designer starts working, the designer clicks on a file on the desktop that in turn opens a 3D modeling application. Due to the video recording of the user's screen that is presented by the computing device, the analytics server is able to use computer vision techniques to identify that a file (e.g., the first unit of work) was opened (e.g., the first action) in a 3D modeling application (e.g., the second unit of work). The first unit of work might be identified by the name and its placement on the computers' desktop and the second unit of work might be identified by the applications logo on the computing devices dock/taskbar. The analytics server might therefore be able to determine that the first unit of work is related to the second unit of work because of the first action performed by the user.

For example, the designer might decide to embed (e.g., the second action) a second file (i.e., the third unit of work) within the first file (e.g., the first unit of work). As before, the analytics server may use computer vision techniques to identify that the designer is clicking the “embed” button, and then to identify the file and path (e.g., shown in the file selection overlay) that identifies the third unit of work and thereby establish a link (and the corresponding classification and score) between the first and third units of work.

In some embodiments, entities identified in the captured video of electronic content could be used to create and manage the nodal data structure without additional external inputs. This could be done by, for example, isolating the pixels for each entity and creating an MD5 hash or a vector representation of the pixels that correspond to each identified unit of work. The analytics server could use these hashes, objects, and/or representations to identify relevant nodes and manage the nodal data structure accordingly.

In some embodiments, optical character recognition could be used together with pixel data to create more sophisticated representations of the units of work for identification and retrieval within and from the nodal data structure.

In some embodiments, the nodal data structure could be augmented by data gathered through other processes (e.g., back-end syncing processes). This would allow the analytics server to use computer vision techniques to establish words and representations as described above and then find similar images, words, and/or representations of units of work that might exist within the nodal data structure and that may have been created through other means.

The following is a second non-limiting example of an implementation of the method 7700. A physician is meeting with a patient for an annual physical. During the appointment, the physician is writing notes on an analog notepad and speaking with the patient. In this example, a computing device captures audio and transforms the captured audio into electronic content at step 7702. At step 7704, the analytics server might use natural language processing techniques to identify the doctor's name, the patient's name, and other specifics related to the conversation such as medications and tests being discussed. At step 7706, the analytics server could identify the related nodes for each entity being discussed and establish or update linkages between them accordingly. In other words, if the doctor and the patient are discussing a specific blood pressure medicine (e.g., Perindopril), then the analytics server might look up the corresponding node and create a linkage between the node representing the medication and the node representing consultation between the patient and the doctor. It might similarly classify the relationship of the linkage as “medication discussed”. Similarly, if the doctor and the patient discuss specific exams, or if the doctor suggests the patient visit a particular cardiologist, then the analytics server may create and or edit the necessary nodes and edges to match the action performed (e.g., speaking).

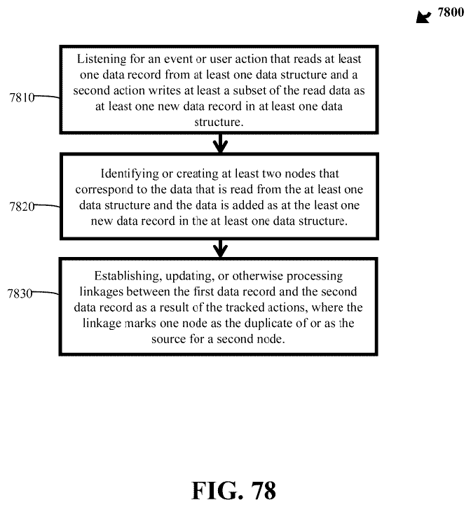

FIG. 78 displays a method executed by the analytics server to automatically establish, update, delete, classify, reclassify, and otherwise manage relationships between nodes when a user copies data from somewhere to somewhere else. In other words, the analytics server may execute the method 7800 to automatically track a user's actions on a computing device using a variety of techniques and then automatically manage the relationships between nodes that correspond to the electronic content the user is interacting with to establish one node as the source for a second node. The analytics server, as used herein, may include a browser extension, a locally installed application, an operating system, any code running on the user's computing device (implemented by the analytics server or a third party), any code running on a remote server that is able to track electronic content, etc.

The analytics server may identify one user action and the corresponding nodes for that first action that reads data before proceeding to identify the second action that writes the read data at some future point in time. In other words, if the analytics server is monitoring for events such as “save as,” “print,” and “export,” and for some reason is unable to determine where the given file was exported to, then the analytics server could automatically establish that a record in the currently open file's node that a second (as of yet unknown) file was exported from the currently open file (e.g., at a specific date and time, from a specific location, from a specific application that expects certain mime types, etc.). Therefore, at some future time, when the analytics server is able to monitor, index, or otherwise process the source of the exported file, it is able to compare the attributes of the newly discovered file with the attributes of the expected source. Should the analytics server establish that there enough of a relevance score between the expected file and the newly identified file it could automatically establish the link or recommend the link to a user for manual confirmation.

In some embodiments, the analytics server may identify a node associated with a copied content. The analytics server may then continuously track and see where the copied content was pasted. Upon identifying where the content was pasted, the analytics server may identify a node for the content (e.g., application) in which the copied content was pasted.

At step 7810, the analytics server may monitor the user's computing device for actions that read data from one place and that then write the read data to a second place corresponding to the user's electronic content. In other words, the analytics server is listening to actions that are commonly referred to as “copy/paste,” “cut/paste,” “move,” “export,” “print,” “save as,” “render,” “compile,” “import,” “place,” “embed,” “insert block,” “create cell reference,” and more.

At step 7820, the analytics server may identify at least two nodes, or create new nodes as necessary, in nodal data structure that correspond to the identified units of work in the electronic content as described herein.

At step 7830, the analytics server may read, create, update, delete, or otherwise process at least one relationship between the at least two nodes (the edge) such that the edge specifies that one node is either the duplicate of or a source for at least one other node, according to the specific action performed.

In alternate embodiments, the analytics server may identify one node at time, so long as the two nodes are identified before step 7830, such that the analytics server is able to establish the necessary relationship between the two or more identified nodes at step 7830.

The following is a non-limiting example of an implementation of the method 7800. A user is reading a Dwell news article on a computing device that uses one or more methods to track what the user is doing and what electronic content the computing device is presenting. When the user performs a “copy to clipboard” action on an image of a house in the Dwell news article on this computing device, the analytics server is able to identify that a “copy” action was performed, regardless of whether that monitoring was done through the method 7100, through monitoring keystrokes/keyboard shortcuts, through monitoring the mouse, through monitoring other events on the computing device, or otherwise. In this example, the analytics server may then identify the node or nodes that correspond with the electronic content (and/or electronic context) and the data that was copied. The analytics server may create a cache or hold that information in memory until the next “paste from clipboard” action is recognized. Once the user decides to paste that image into a PowerPoint presentation, the paste action is recognized and the analytics server establishes or modifies a linkage between the two or more corresponding nodes in the nodal data structure (e.g., the Dwell article and the PowerPoint presentation). The analytics server might also classify that one node (e.g., the Dwell article) is a source for a specific slide or asset (e.g., a third node) in the second node (e.g., PowerPoint presentation).

Then, after some time passes, the user may receive a text message to a real-estate listing on Zillow from someone. When the user opens the webpage, he may notice that the same image that he copied into the PowerPoint presentation is also shown on the Zillow listing. It is also likely however that because significant time may have passed, the user may no longer remember this image. Using the methods described herein, the analytics server may identify that this image is in the electronic content, establish a link between the real-estate listing's node and the image's node, and thereby be able to show relevant information to the user such as the Dwell article and the PowerPoint presentation. Similarly, whenever the user looks at the Dwell article, he may be able to see that the text message, the message's sender, the Zillow page, and more could be useful and relevant contexts. Furthermore, should attach the PowerPoint presentation into a message to send to someone in the future, the analytics server will be able to recommend the user that send the related text message as someone who may be a likely intended recipient.

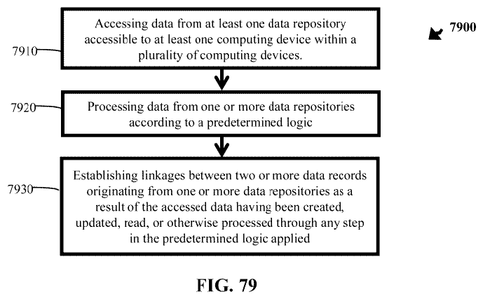

FIG. 79 displays a method 7900 executed by the analytics server to automatically establish, update, delete, classify, reclassify, and otherwise manage relationships between two or more nodes in the nodal data structure when a computing device accesses data and processes it according to a predetermined logic (e.g., logic determined through an ETL or ELT tool, through an RPA tool, etc.) regardless of whether a human actor is involved in the process. In other words, the analytics server is able to automatically manage edges between nodes based on actions that may be performed by automated users or actors.

At step 7910, the analytics server recognizes that a certain computer process is accessing data from at least one data repository. This access may be tracked by, for example, adding code to monitor preconfigured automations, by tracking access to records at the database level, and/or otherwise. In some embodiments, the analytics server may be accessing the data itself. In other embodiments, the analytics server may be monitoring other systems' that may access of the data.

At step 7920, the analytics server either processes or monitors one or more systems that may process the data accessed at step 7910 according to predetermined configuration or automation. In some embodiments, the processing may not be fully predetermined, but may instead rely partially or wholly on techniques that may be variable or continuously optimized, such as self-learning methods.

At step 7930, the analytics server reads, creates, updates, deletes, classifies, and/or otherwise processes edges between nodes in the nodal data structure that correspond to the data that was read at step 7910 and that was processed at step 7920. As in the other examples, the edges and the metadata associated with the edges are influenced by the actions being performed at step 1820.

The following is a non-limiting example of an implementation of the method 7900. In this example a computing device is autonomously accessing data from a data repository according to configuration determined in a robotic process automation (RPA) platform that the analytics server is integrate with. Therefore, once a certain trigger (e.g., a new employee is added to the HR system) meets the criteria to kick off an automated process (e.g., create all the accounts in all the necessary software tools for the new employee), the RPA platform automatically performs the automation in a way that is monitored by the analytics server. The analytics server is, as with previous examples, then able to use the monitored actions to automatically establish relationships between the various components of electronic content. In this scenario for example, the analytics server may be able to create a node for the new employee that corresponds that includes all of the accounts and related that were created by the RPA platform for that employee. The analytics server is able to do this all without having to integrate with any of the various tools that the employee accounts were made in because it was able to monitor the actions of the RPA platform. Also as before, the analytics server is then able to leverage these nodes, edges, and/or attributes in order to deduplicate data, otherwise link relevant record, more effectively classify relationships, and contextually present relevant data and actions.

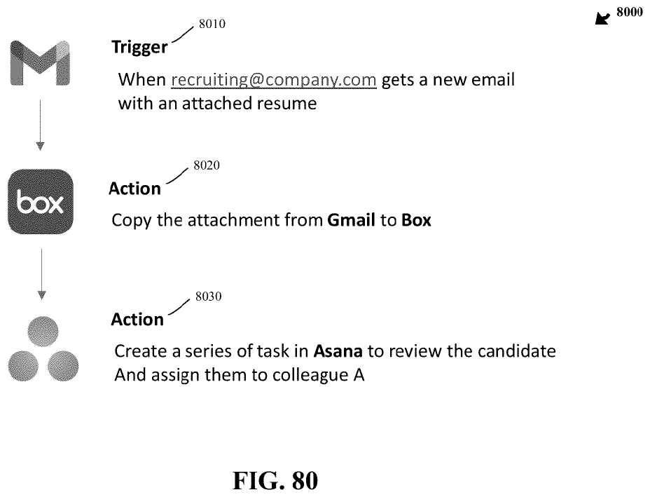

FIG. 80 illustrates operational steps for a non-limiting example of workflow automation 8000 between third-party applications that can be established, (e.g., with a robotic process automation or “RPA” platform), wherein actions are performed automatically by a system rather than a human user (step 7920). In this example, the analytics server may also track actions performed by non-human users such as systems of other software performing actions on data. For instance, the analytics server could integrate with automation tools such as Zapier, Microsoft Power Automate, Tray.io, IFTTT, and other tools that are used to copy, move, or otherwise transform data across and within tools and datasets (or offer automation features within itself, such as scraping data from websites using a headless browser, or facilitating connections to third party APIs, and more), and then automatically track, establish, and update relationships in the nodal data structure based on the actions or automations taking place. For instance, if a connected email account receives an email including a resume, then an automated system could be used to copy and organize that resume within a file storage system, as well as create a record of a task to review said file within a different task management tool. In this case, regardless of whether the file is added or referenced in the task management tool, the analytics server would be able to relate the file in the file storage system, the message in the email service, and the task in the task manager together simply by the actions performed on them.

Alternate embodiments could include the use of any mixture of front-end actions performed by a user (such as selecting a button on the screen) and back-end actions (such as receiving a notification about an email via API endpoints) in order to establish and update the relationships in the nodal data structure.

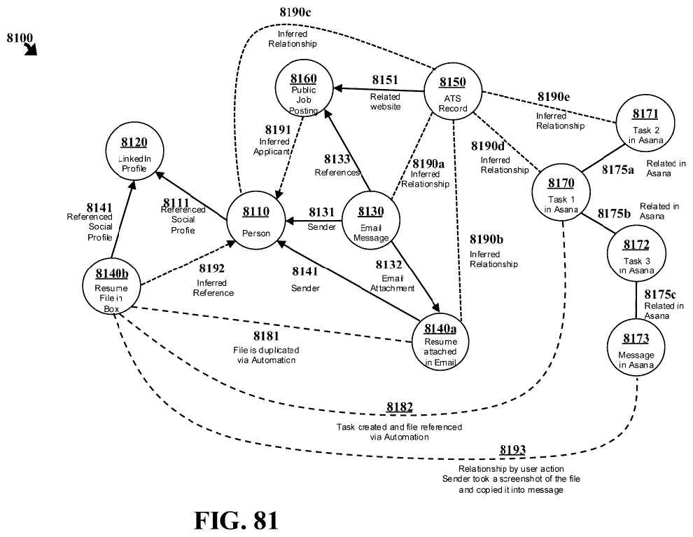

FIG. 81 shows an embodiment of the nodal data structure 8100 with several nodes representing several units of work after a series of interactions from a human user and after the preconfigured automation 7900 (discussed in FIG. 79) has run. In this example, a person 8810 has applied to public job posting 8160 by sending an email message to recruiting@company.com with her resume 8140a attached and a reference to the job posting website 8160. As described herein, the analytics server creates and/or updates the nodes for each unit of work establishes and/or manages the corresponding edges 8133, 8131, and 8132 between those nodes. The analytics server also establishes, as described elsewhere herein, an edge 8191 with a certain relevance score between public job posting 8160 and person 8810 and adds a classification recommendation to it with a certain level of certainty. The analytics server similarly infers, as described elsewhere herein, an edge 8141 with a certain classification (e.g., file permission, with type “email attachment sender”) between the email attachment 8140a and person 8810. The analytics server similarly creates a node for the job posting record 8150 identified in the applicant tracking system and creates an edge 8151 between the ATS record 8150 and the public job posting website 8160, as well as inferring additional edges 8190a and 8190b between ATS record 8150 and 8130 and 8140a. Since the ATS record 8150 is related to three nodes 8130, 8140a, and 8160 that are all related to person 8110, then the analytics may also establish an edge 8190c with a certain relevance score between ATS record 8150 and person 8110.

In some embodiments, the analytics server may treat or classify relationships established or inferred via actions performed by automations differently than relationships established or inferred via actions taken by humans. Similarly, in some embodiments, the analytics server may treat or classify relationships established or inferred via actions taken by an artificial-intelligence-driven system differently than relationships established or inferred via actions taken by humans or automations. For example, the analytics server may establish edges based on actions taken by humans with higher relevancy scores than edges based on automations, which may have relevancy scores higher than actions taken by artificial-intelligence-driven systems. The hierarchy of relevancy scores described above is provided for example purposes only, and it should be understood that additional or alternative scales may be used without departing from the methods and systems described herein. By way of example, in some embodiments, the edges established based on actions taken by artificial-intelligence-driven systems may have higher relevancy scores than those edges established based on automations. When the user sent the email message 8130, the conditions for trigger 8010 to start the automation 8000 were met, which then proceeds to perform action 8020 and copy the attached resume 8140a from the email service to a specific folder in a cloud storage tool as a new file 8140b. In this embodiment, this causes the analytics server to automatically establish a node corresponding 8140a as a duplicate of a node corresponding to 8140b and allows the analytics server to skip any processing that may be otherwise necessary for the deduplication of both nodes (e.g., creation of MD5 hash for each file) by instead relying on an edge 8181 that specifies the two nodes 8140a and 8140b are duplicates. The analytics server may then create unified or de-duplicated node that encompasses both 8140a and 8140b. The analytics server may still do additional processing on and/or analyses of the file 8140, and may thereby recognize that the contents of the file include the URL of a LinkedIn profile 8120, the name and email of person 8110, as well as other information (e.g., bio, work experience) that matches the data on the LinkedIn profile 8120. According to this analysis, the analytics server may therefore be likely to establish the edges 8111, 8141, and 8192 between the appropriate nodes.

At step 8030, the automation 8000 proceeds to create task 8170 in a project management tool and reference the file 8140 from the task 8170. Again, since the analytics server is tracking or performing the automation, then it may establish edge 8182 between nodes that correspond to the task 8170 and to the file 8140.

The project management tool may encompass other relevant units of work independent of the automation 8000, such as other tasks 8171 and 8172 as well as a message 8173. The analytics server may create and manage nodes 8171, 8172, and 8173 as well as the corresponding edges 8175 between them. In this embodiment, the user also took a screenshot of file 8140 which was sent via message 8173, thereby enabling the analytics engine to relate the nodes 8140 and 8173 via the edge 8193. The analytics server may also reasonably infer potential relationships, classifications, relevance scores, and more (such as the inferred edges 8190d and 8190e) between task 8170, and the other nodes that were created through this automation or that are related to the nodes created through this automation.

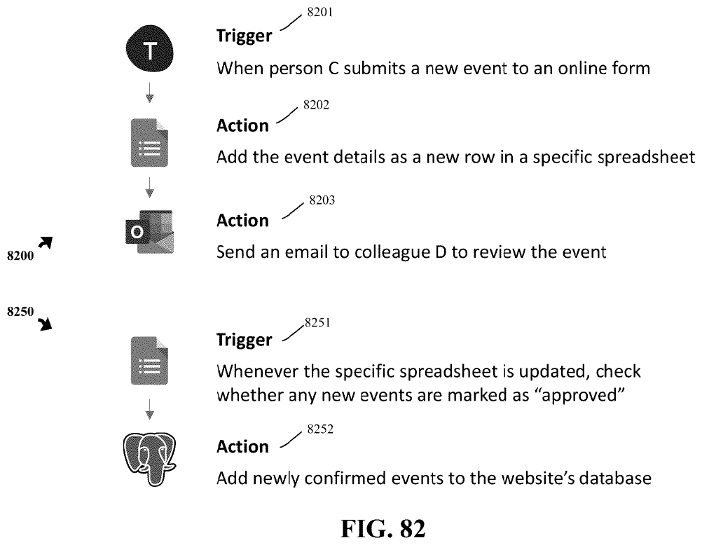

FIG. 82 illustrates the operational steps for two related workflow automations 8200 and 8250 that read and/or write data from and/or to third-party applications via, for example, REST API endpoints associated with each third-party application, according to an embodiment. In this example, one or more users has preconfigured a series of automations that monitor third party sources for certain events that meet the criteria of the defined triggers. In other words, the user has defined (e.g., through configuration) two automated processes that use a computing device or a processor or a server (e.g., the analytics server) to monitor events and changes to data across third-party systems (such as Typeform and Google Sheets) in order identify when certain events match the criteria of predefined triggers 8201 and 8251.

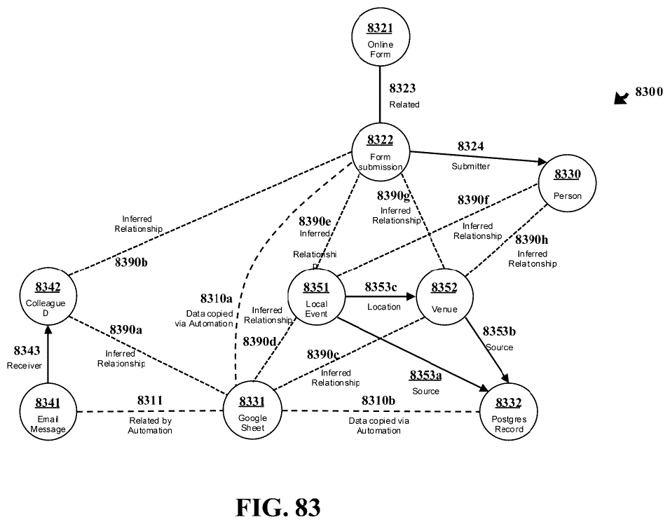

Referring now to FIG. 83, which illustrates a nodal data structure, according to an embodiment related to the workflow automations 8200 and 8250. The collective purpose of the automations 8200 and 8250 is to identify when a new “Local Event” 8351 is submitted via a public-facing “Online Form” 8321 (e.g., built and published with Typeform) and to add the information from the submitted form 8322 into other systems according to the predetermined logic. In other words, the automation 8200 takes data from the submitted form 8322 and adds it into Google Sheet 8331 and the automation 8250 takes data from the Google Sheet 8331 and adds it as a record 8332 in a Postgres database.

A key innovation and improvement over traditional systems (e.g., robotic process automation systems) is that the analytics server may use the methods described herein (e.g, method 7900) to automatically create and update the nodes and relationships between nodes in the nodal data structure 8300 by monitoring the actions done through automation 8200 and automation 8250. The following paragraphs describe how the analytics server monitors automations 8200 and 8250 in order to create, manage, and/or improve the nodal data structure.

According to the non-limiting embodiment, Typeform has been preconfigured to send a message to the analytics server every time someone creates a new form submission 8322 through the Online Form 8321. When the analytics server receives this message from Typeform, it may compare the message with the existing set of configurations to determine which account, and which automation process should be started if any. In other words, at step 8201, the analytics server can identify that the received message corresponds with a specific Typeform account and a specific Typeform form (i.e., the Online Form) and it can use that information to find and access the configuration for the workflow automation 8200 and proceed as configured to step 8202.

As with the other examples and embodiments described herein, the analytics server may create nodes to represent the online form 8321, the form submission 8322, and the person 8330 that submitted the form. The analytics server is also able to establish that the form 8321 and the submission 8322 are related and thereby create and manage the edge 8323 between the nodes accordingly. Similarly, the analytics server can create the linkage 8324 between the form submission 8322 and the form submitter 8330, and classify it accordingly (e.g., person 8330 submitted form submission 8322).

At step 8202, the analytics server is configured to gather information from the form submission 8322 and to use that information to create a new row in the Google Sheets spreadsheet 8331. Because the analytics server is able to monitor the automation process it is able to use method 7900 to establish or otherwise manage linkages between the corresponding nodes. In this case, the analytics server may create a relationship 8310a between Google Sheet 8331 and form submission 8322. Moreover, the analytics server may classify that form submission 8322 is a source for Google Sheet 8331 via the edge 8310a.

At step 8203, the analytics server is configured to send an email message 8341 to a specific person known as colleague D 8342. As before, the analytics server may use the methods described herein to update the nodal data structure accordingly and to create nodal representation of the email message 8341 and person 8342, as well as the relationship 8343 between them. Furthermore, by monitoring the automation, the analytics server is able to establish an otherwise potentially missing linkage 8311 between the email message 8341 and the person 8342. The analytics server may also create and/or modify the attributes, properties, and/or classification on the relationship 8311. The analytics server may also create and/or modify measures of how relevant certain nodes are to one another and/or measures of confidence for certain attributes or classifications for any given edge (e.g., edge 8311).

The person 8342 might be responsible for verifying that the Local Event 8351 that was submitted by a “stranger” 8330 via form submission 8332 is appropriate for publishing on the public Local Calendar Events website. The email message 8341 might have been providing person 8342 with notice that a new event needed to be manually reviewed and approved before it could be published on the public website of Local Events. At this point the automation 8200 ends and the subsequent automation 8250 is not started until the person 8342 (or someone else) approves the newly created record in the Google Sheet 8331 for publishing on the public website. In the meantime, by establishing edge 8311, the analytics server is able to find and/or establish potentially relevant relationships that may have otherwise been missed (e.g., inferred relationships 8390a and 8390b), and can, for example, help the person 8342 easily access relevant data from the nodal data structure (e.g., Google Sheet 8331 and form submission 8322) contextually around electronic content (e.g., when person 8342 opens email message 8341).

Step 8251 is then triggered once a given row in the Google Sheet 8331 is marked as approved for publishing (e.g., by person 8342) and the pursuing action step 8252 is started. In this step 8252, data from the Google Sheets spreadsheet 8331 is automatically copied into a Postgres database that feeds the public website of Local Events and the corresponding Postgres record(s) 8332 are created (according to the databases schema).

Furthermore, because the analytics server may be monitoring the Postgres database, then the analytics server may also automatically identify new created entities in the database corresponding to the newly created Local Event 8351, and other related data such as the Venue 8352 for the Local Event. The analytics server may then create corresponding nodes 8351 and 8352 that reference the Postgres record(s) 8332 as a source and establish the corresponding edges 8353a, 8353b, and 8353c. The analytics server is then able to leverage all of the existing relationships that may have been created through the automations 8200 and 8250 (as well as other existing relationships created through other means) to recommend or otherwise create or update relationships 8390a-8390h between nodes 8351 and 8352 and other nodes in the nodal data structure.

These inferred edges 8390a-8390h can then be used by the nodal data structure to, for example, present contextually relevant information from any linked node to around any other of linked node identified in users' electronic content. For example, some alternate embodiments could include the use of nodes and linkages established by either or both front-end actions performed by a user (such as selecting a button on the screen) and/or back-end actions (such as receiving a notification about an email via API endpoints) in order to establish and update the relationships in the nodal data structure 8300.

In alternate embodiments, there can be more than one server coordinating the automations such that workflow automation 8200 is done through a server controlled by Typeform and workflow automation 8250 is done through a server controlled by Google. Similarly, in yet another embodiment, step 8202 could be configured and run through Typeform's servers and then step 8203 could be managed through a third-party robotic process automation service (e.g., Zapier). In this way the automations can be performed by multiple services so long as the analytics server is able to integrate with or otherwise monitor the automations and data interactions in order to properly and accordingly manage the nodal data structure.

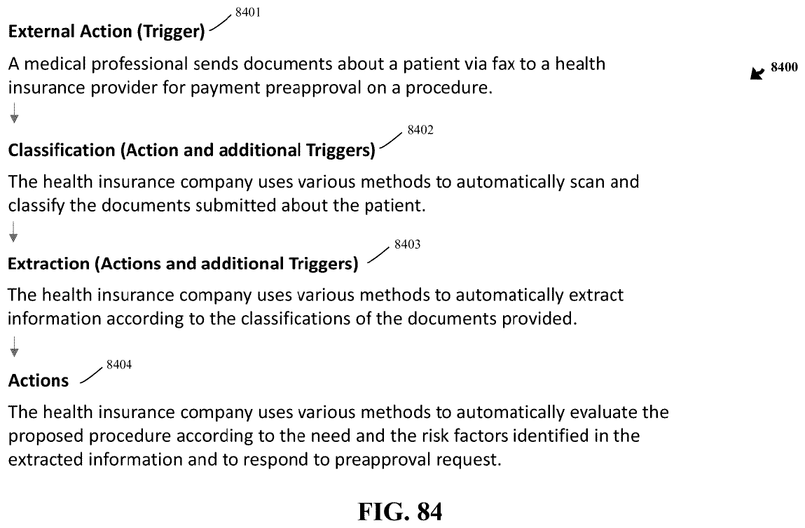

FIG. 84 illustrates operational steps for an intelligently automated workflow, according to an embodiment. This non-limiting example illustrates how automated workflows can be more sophisticated and not have to rely on “if this, then that logic” that is dependent on the capabilities of external data sources and integrations. In other words and for example, rather than having to define the configuration for an automation in a way that relies on the availability of the REST API endpoints of certain external data sources, applications, and/or systems (e.g., Dropbox API), automations may be configured such that they are abstracted away from the data sources and are able to determine logic in other ways (e.g., custom logic that can be applied to all “Files” in a nodal data structure that includes “Files” from Dropbox and Google Drive, rather than having to define logic specifically for “Dropbox Files” or “Google Drive Files”).

By enabling abstractions away from data sources and enabling automation logic to be defined in other ways, some embodiments also enable more sophisticated automation logic flows than would otherwise be possible. In turn these more sophisticated logic flows can enable more varied types of relationships to be automatically established and/or managed within nodal data structures.

The high-level definition of automation 8400, for example, demonstrates potential alternate workflows and alternate ways to augment nodal data structures by tracking events. This example describes a common process for prior authorizations of payments by healthcare payors or insurers. Typically, these methods involve a medical professional mailing or faxing documents about an insured patient to that patient's health insurance provider in order to get approval for a prospective procedure or treatment. These documents typically include a wide variety of documents including handwritten notes, medical histories, structured forms which the health insurers require to make a determination on whether to preapprove payment for the given procedure. Being able to configure more sophisticate logic flows like the method described in automation 8400 may enable more streamlined processing of preapproval claims by the health insurer.

At step 8401, for example, an external action (e.g., where a medical professional, such as a hospital employee, sends documents about an insured patient to the health insurance provider via fax) can be used as trigger to start a series of sophisticated logic flows that make up automation 8400.

In some embodiments, some of these sophisticated logic flows may involve human input, such as the validation of certain information when automatically generated confidence or relevance scores are not high enough. For example, at step 8402, several methods, including machine learning techniques, could be used to automatically classify the types of documents (e.g., form, invoice, prescription, test results, reports on biometric data, hand-written notes, a specific type of questionnaire, etc.) and to establish some level of confidence as to the classification of each document. Part of the configuration defined in step 8402 may include the types of documents and the models that the analytics server may use to classify the documents, as well as the confidence score thresholds that must be met in order for the automatic classification to happen. In the event that certain documents don't meet those thresholds, the analytics server may present those documents and the recommended document types to a human user for confirmation/approval. These manual interventions could in turn be used to improve the automated scoring done (e.g., by reinforcement learning) such that over time, the automation improves in quality.

As the analytics server classifies the documents received, the analytics server could then trigger a variety of different actions according to the various classifications and properties that the analytics server may have identified at step 8402. In other words, the analytics server could use the information and analyses gathered and evaluated at step 8402 to trigger different actions at step 8403 according to, for example, various configurations, models, and/or logic (e.g., logic specific to each type of document, logic specific to the type of expected data within each file type, etc.). A document that contains mostly handwritten text may require different methods for data extraction, than a document that includes a spreadsheet of previous procedures and payments to the hospital. At step 8403, various methods can be used to extract the data according to the configuration that may have been set up.

At step 8404, the analytics server may use a variety of methods to validate data, to add the extracted information to the nodal data structure, to access relevant data from the nodal data structure without permanently saving the patient's personal identifiable information (PII), to evaluate strings of text for named entities (e.g., medications, illnesses, conditions, hospitals, doctors, etc.), to perform other methods of data extraction or evaluation (e.g., to use other NLP or NLU methods to identify whether the hospital has provided enough information, to evaluate X-Rays to determine the likelihood of risk for a given condition and/or necessity for a given procedure), and/or other methods to further analyze and/or process the extracted data.

Importantly, and as with other embodiments, because the analytics server is monitoring the automation 8400, the analytics server is also able to automatically establish linkages between nodes that are representative of data that is read, created, edited, deleted, or otherwise processed through the automation 8400. For example, the analytics server may create linkages between the node that represents the hospital and the node that represents the medical professional that sent the documents, and all the other nodes created, modified, or otherwise processed through the automation, including nodes for: the documents, data extracted from the documents, analyses done over the data extracted from the documents, etc. The analytics server may also determine that different the relationships between nodes may have different relevancy scores, different types of relationships, different levels of confidence in those relationship classifications, etc.

In some embodiments, a user (e.g., a doctor, an “AI agent”) may include certain notations (e.g., “#X”, “[[X]]”, “//X//”, “//person//X//”, “//project//Y//”, “//treatment//Z//”, and the like) in documents, emails, handwritten notes, and more that the analytics server may be specifically configured to identify when accessing, syncing, or otherwise processing data using the various methods described herein. Whenever the analytics server identifies the specified notation, whether through front-end or back-end processes, the analytics server may initiate a particular action or automation. For instance, a TV executive at a production studio that is constantly hearing pitches in short meetings is supposed to also be taking meeting notes and adding them to the company's project tracker or CRM. In practice however, this TV executive is often on the road while taking meetings and therefore finds that taking notes by hand on actual paper or in emails messages (that are then sent to executive assistants to organize into the CRM as needed) is much easier.

While certain methods may be used to identify references to units of work within the contents of other units of work (e.g., named entity recognition, facial recognition, etc.), there are certain cases where the identification of what must be organized and how it must be organized or linked may be more nuanced. For example, if there this production company has a project for a tv show called “Sequoia,” it may be unclear to the analytics server whether a reference to “Sequoia” corresponds to the national park, to the venture capital firm, to the film project, etc. The analytics may be able to infer the correct relationship and linkage through surrounding context clues (e.g., surrounding text, related nodes to the unit of work which includes the reference, etc.) as discussed elsewhere herein. However, the analytics server may not always be able to automatically infer and establish the correct linkages.

Therefore, a user might want to create, use, or modify a specific notation that the analytics server can use to identify which node to link the current unit of work to. For instance, when the TV executive is writing notes in an email message, the TV executive might also write a specific notation somewhere in the email that helps the analytics server properly link the nodes representing the email (the current unit of work) and the node representing the Sequoia TV show (the desired units of work to link to). In other words, the analytics server may be configured (at any time) to recognize certain patterns in strings of text and to perform certain actions according to certain configurations that dictate how the text should be parsed and meaning drawn from the parsed text. In the Sequoia example, the TV executive might write “//link-ref:Sequoia//type:tv show//” at the bottom of the email message to help the analytics server understand that any references to the word “Sequoia” in the email should be linked with the node that corresponds to the “Sequoia” tv show. This type of logic could, for example, be programmed into or configured within one or more steps (e.g., steps 8402, 8403, 8404) of the automation example 8400.

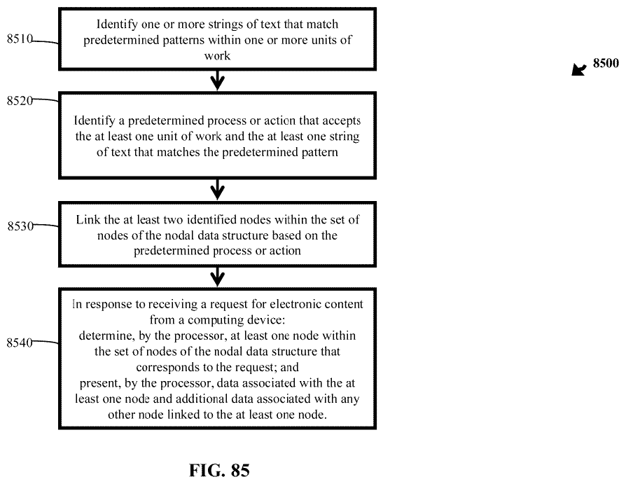

FIG. 85 illustrates operational steps of a method for triggering automations and inferring content relationships, in accordance with an embodiment. As with several of methods described herein, method 8500 is described as being executed by the analytics server, though other embodiments may employ other processors discussed in U.S. patent application Ser. No. 17/7707,7888, which is incorporated by reference herein.

At step 8510, the analytics server identifies one or more strings of text that match predetermined patterns within one or more units of work. A units of work may be processed by analytics server via front-end methods (e.g., by monitoring the DOM on a given website, using computer vision methods, other methods described herein, etc.), back-end methods (e.g., periodically scanning one or more data repositories, receiving data via webhooks, other methods described herein, otherwise monitoring data repositories, etc.), and/or otherwise. As described in the U.S. patent application Ser. No. 17/7707,7888 and elsewhere herein, several methods may be employed to identify and match strings of text to certain predetermined patterns for text strings (e.g., using regular expressions, using other parsers, using indexers for search, using vectors, using NLP methods, etc.). The configurations for expected or accepted text string patterns or notations may be stored in the nodal data structure, in the code for analytics server, or elsewhere.

At step 8520, the analytics server identifies the predetermined process or automation that expects the one or more text string patterns that were identified at step 8510 and uses the configuration determined by the identified process or automation to evaluate how to draw meaning from the text string. For example, “//link-ref:Sequoia//type:tv show//” may be matched to a process called “link-ref” which may be meant to only match any references to “Sequoia” within the selected unit of work with a different node in the nodal data structure that is of type “tv show” and that has the name “Sequoia.” In this way, the analytics server is identifying a predetermined process or action that accepts the at least one unit of work and the at least one string of text that matches the predetermined pattern, and is identifying at least two nodes within a set of nodes of a nodal data structure that correspond to the at least one unit of work and the at least one string of text. In some embodiments, as with other methods, if a given node doesn't already exist within the nodal data structure in a usable way, the analytics server may create, edit, modify, delete, or otherwise process the node (e.g., as part of the management of the nodes and edges within the nodal data structure which happen when the analytics server may modify any nodes or edges).

In some embodiments, identified notations and patterns can also be used as triggers for automations or specific actions beyond only linking data. For example, a user might configure an automation called “add-todo” that creates a new task in a specific project management tool that references the identified unit of work. In other words, a user reading something on social media might leave a comment on a post that lists several long articles that the user is interested in reading at some point in the future. The comment the user creates may include a string of text that follows a predetermined notation that the analytics server will process at some future point in time. Continuing with this non-limiting example, when the analytics server processes the user's comment, it may parse relevant data from the string of text included in the comment which follows a predetermined notation in order to use that relevant data as inputs for a custom automation defined elsewhere. Further describing this example, the user's comment on the social post might include a string of text along the lines of//auto: add-todo//title: read articles//due: Nov. 11, 2022//. In this case, the analytics server may identify that this is a specific notation that should be processed in a specific way and look up the automation called “add-todo”. Upon identifying the “add-todo” automation, the analytics server might use the automation's methods to create a task in a given project management tool called “read articles” due on “Nov. 11, 2022”. Because the analytics server is also monitoring this “add-todo” automation, the analytics server would also be able to automatically link the social post with the created task (regardless of whether that step was included in the automation) so that the user may easily reference the desired reading list shown within the social post when looking at the newly created task.

In some embodiments, users may include more than one string of text within one unit of work (e.g., within one email message or within one document) that is mean to match and trigger more than one action, automation, or linkage with other nodes by the analytics server. In other words, a single email might include multiple (e.g., a//add-todo//and a//link-ref//) notations for the analytics server to process.

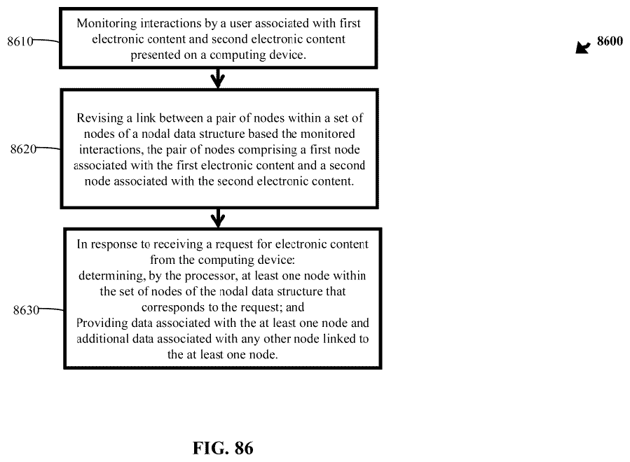

At step 8530, the analytics server executes the predetermined action, process, or automation identified at step 8520 with the data parsed from the at least one matched string of text and the at least one unit of work in which the string was of text was found. As a result, the analytics server establishes linkages between the at least two identified nodes (the node of the unit of work and the node parsed from the string of text) within the set of nodes of the nodal data structure based on the predetermined process or action. In some embodiments, the analytics server may revise an existing link, as discussed in FIG. 86.

In some embodiments, the patterns that are identified in step 8510 don't have to be strings of text. The analytics server might be able to recognize other types of patterns such as audible patterns (e.g., “YipYip link with Sequoia the tv show”), haptic patterns, other types of visual patterns, 3D patterns, patterns that incorporate changes over time, and the like. In these embodiments, the analytics server would use the pattern and the configuration defining how the relevant data can be drawn from the identified pattern in order to perform the desired action as described at step 8530 (e.g., such as linking the node identified at step 8520 for a unit of work with the a node corresponding to the TV show Sequoia, which may have been made clear through data embedded in the identified pattern).

In some embodiments, there may still be ambiguity after attempting to link nodes through notations as described in method 8500. In these scenarios, the analytics server not be able to establish a linkage with enough confidence and may therefore resort to creating a recommended relationship that may need to be manually confirmed as described elsewhere herein.

At step 8540, the analytics server may, in response to receiving a request for electronic content from a computing device: determining, by the processor, at least one node within the set of nodes of the nodal data structure that corresponds to the request; and providing/presenting, by the processor, data associated with the at least one node and additional data associated with any other node linked to the at least one node.

As discussed in the U.S. patent application Ser. No. 17/7707,7888, which is incorporated herein, the analytics server may receive requests and display the additional data corresponding to linked nodes as well as the requested information.

In a non-limiting example, when the user is writing a new email (e.g., initiates an email application or a messaging application) with the subject line of similar to “Sequoia show,” “Sequoia episode 5,” “Sequoia cast,” etc., the analytics server may display a prompt providing a suggestion of other emails, articles, and references that have been linked by identified notation/pattern with the node corresponding to the Sequoia TV Show.

FIG. 86 illustrates operational steps for inferring content relationships, in accordance with an embodiment. Even though aspects of the method 8600 are described as being executed by the analytics server, other embodiments may employ other processors discussed in U.S. patent application Ser. No. 17/7707,7888, which is incorporated by reference herein.

At step 8610, the analytics server may monitor interactions by a user associated with first electronic content and second electronic content presented on a computing device. The analytics server may monitor user interactions conducted by various users. The analytics server may monitor how users interact with various content outputted by the analytics server and/or a third-party server. As discussed herein, electronic content may refer to any data or representation of the data that can be interacted with by a user. For instance, the electronic content may refer to an application (e.g., email application) or a website that is displayed on a user's computer. The content may also refer to a file, data associated with a file (e.g., revision history of the file a timestamp of when the file was created), or the content of a file itself (e.g., a text string within a document).

In some embodiments, the analytics server may monitor how the user interacts with multiple contents (or units of work or applications) at the same time. For instance, the analytics server may monitor how a user interacts with a social profile website hosted by a third-party server (e.g., first content) and an email application (e.g., second content). The user may copy and paste contact information of a friend (e.g., Andres) from the website into an email message to a colleague (e.g., Adler) that has a subject line of “Trip to New York.” Accordingly, the analytics server monitors how the user interacts with the email application (e.g., what, how, and when the email is sent and the content of the email) along with how the user interacts with the third-party-hosted website (e.g., what content was copied and pasted into the email).

In some embodiments, monitored interactions may correspond to the user's interactions with an overlay that has been provided by the analytics server, such as the overlays discussed herein (e.g., the overlays shown in FIG. 72-4, several of the overlays in U.S. patent application Ser. No. 17/7707,7888, etc.).

At step 8620, the analytics server may revise a link between a pair of nodes within a set of nodes of a nodal data structure based the monitored interactions, the pair of nodes comprising a first node associated with the first electronic content and a second node associated with the second electronic content.

Using the interaction monitored in the step 8610, the analytics server may create new linkages and relevancies within the nodal data structure. For instance, and continuing with the example discussed above, one or more nodes corresponding to the “New York Trip Planning” email may not be related to one or more nodes corresponding to Andres (e.g., the website). However, because the user copied Andres's information from the first content (e.g., website) and pasted it within an email that was titled “New York Trip Planning,” the analytics server links the corresponding nodes (linking the website and the email). Moreover, because the website is associated with a node related a contact node (e.g., Andres) and because the email is associated with an unclassified node called “New York Trip,” the nodal data structure may be revised, such that Andres is at least relevant to the New York Trip and the underlying nodes within the nodal data structure are linked.

In some embodiments, the analytics server may link the nodes as a result of identifying interactions multiple users (e.g., predetermined number of a number that satisfies a threshold) that indicate a relevance. For instance, the analytics server may link Andres and “New York Trip” only when more than three users have interactions that indicate a possible relevance.

Using the methods and systems described herein, the analytics server may create new links between nodes that were previously unlinked. Additionally or alternatively, the analytics server may revise a link that was previously created. Therefore, two nodes may have been previously linked together; and using the methods discussed herein, the analytics server may revise the link. For instance, two nodes may be linked together indicating that an employee is connected with a prospective client and may include contact information of the prospective client. Moreover, using the methods discussed herein and based on user interactions, the analytics server may revise the same link and indicate that the prospective client is also related to the employee because they are both attending a conference in future.

At step 8630, the analytics server may, in response to receiving a request for electronic content from the computing device: determine at least one node within the set of nodes of the nodal data structure that corresponds to the request; and provide data associated with the at least one node and additional data associated with any other node linked to the at least one node.

The analytics server may receive requests and display the additional data corresponding to linked nodes as well as the requested information.

In a non-limiting example, when the user is writing a new email (e.g., initiates an email application or a messaging application) with the subject line of similar to “New York Trip Planning,” the analytics server may display a prompt providing a suggestion of Andres's contact information. Additionally or alternatively, the analytics server may use an API to provide the data to a computing device and/or a server.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be a computer-implemented method in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable medium or processor-readable storage medium. The steps of a method or algorithm disclosed herein may be embodied in a processor-executable software module, which may reside on a computer-readable or processor-readable storage medium. A non-transitory computer-readable medium or processor-readable media includes both computer storage media and tangible storage media that facilitate transfer of a computer program from one place to another. A non-transitory processor-readable storage media may be any available media that may be accessed by a computer and include a set of instructions that when executed cause one or more processors to execute one or more of the methods and systems described herein. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

We claim:

1. A computer-implemented method comprising:
receiving, by one or more processors, a user query for a personalized response associated with a profile;
interpreting, by the one or more processors, the user query by executing a machine-learning model;
generating, by the one or more processors, a data query corresponding to the user query by executing the machine-learning model, the data query configured for execution in a computer model comprising one or more nodes, each node of the one or more nodes having an identifier corresponding to a series of nouns and verbs generated in accordance with a schema associated with a shared knowledge language;
receiving, by the one or more processors, a first node of the computer model, wherein the first node is associated with the profile and generated based at least in part on an application accessed by the profile; and
presenting, by the one or more processors, the personalized response, wherein the personalized response comprises an indication of the first node of the computer model.

2. The computer-implemented method of claim 1, further comprising:
receiving, by the one or more processors, a second indication indicative of a context associated with a computing device associated with the profile;
determining, by the one or more processors, a second node of the computer model, the second node associated with the context displayed by the computing device;
generating, by the one or more processors, a personalized prompt based on the second node, wherein the personalized prompt is a second output of the machine-learning model; and
presenting, by the one or more processors, the personalized prompt.

3. The computer-implemented method of claim 1, wherein the computer model further comprises a nodal data structure of a set of nodes where each node corresponds to data identified as associated with each application within a set of applications accessed and used by each computing device, each node having an identifier corresponding to a series of nouns and verbs generated in accordance with the schema associated with the shared knowledge language, wherein the series of nouns define one or more types of data and the series of verbs define one or more software processes, the computer model transforming the data generated as a result of at least one computing device accessing and using one or more applications from the set of applications into a series of nouns and verbs using the schema.

4. The computer-implemented method of claim 1, wherein the user query is provided in a natural language syntax.

5. The computer-implemented method of claim 1, further comprising:
executing, by the one or more processors, the machine-learning model to review one or more search results from the data query; and
selecting, by the one or more processors, a search result from the one or more search results that satisfies a threshold.

6. The computer-implemented method of claim 1, wherein generating the data query further comprises:
parsing, by the one or more processors, the user query into one or more search elements; and
determining, by the one or more processors, one or more search parameters associated with the one or more search elements.

7. The computer-implemented method of claim 5, further comprising:
responsive to receiving a selection of the personalized response, generating, by the one or more processors, a second query based on the search result, wherein the second query is associated with the personalized response;
querying, by the one or more processors, the computer model based at least on the second query;
receiving, by the one or more processors, a second node linked to the first node of the computer model; and
presenting, by the one or more processors, a second personalized response, the second personalized response corresponding to the second node.

8. The computer-implemented method of claim 1, wherein at least one node of the one or more nodes represents contextual data associated with a previous response.

9. The computer-implemented method of claim 1, wherein the personalized response further comprises a verb from the shared knowledge language, the verb associated with the first node of the computer model.

10. The computer-implemented method of claim 1, further comprising:
generating, by the one or more servers, the personalized response by:
determining, by the one or more servers, a user interface format for displaying the personalized response; and
rendering, by the one or more servers, a user interface with one or more graphical elements representing the first node of the computer model.

11. The computer-implemented method of claim 1, further comprising:
executing, by the one or more processors, a machine learning agent to perform one or more actions within a computing environment, wherein the one or more actions correspond to the first node indicated in the personalized response.

12. A system comprising:
one or more processors; and
a non-transitory computer-readable medium having a set of instructions that when executed, cause the one or more processors to:
receive a user query for a personalized response associated with a profile;
interpret the user query by executing a machine-learning model;
generate a data query corresponding to the user query by executing the machine-learning model, the data query configured for execution in a computer model comprising one or more nodes, each node of the one or more nodes having an identifier corresponding to a series of nouns and verbs generated in accordance with a schema associated with a shared knowledge language;
receive a first node of the computer model, wherein the first node is associated with the profile and generated based at least in part on an application accessed by the profile; and
present the personalized response, wherein the personalized response comprises an indication of the first node of the computer model.

13. The system of claim 12, wherein the set of instructions further cause the one or more processors to:
receive a second indication indicative of a context displayed by a computing device associated with the profile;
determine a second node of the computer model, the second node associated with the context displayed by the computing device;
generate a personalized prompt based on the second node, wherein the personalized prompt is a second output of the machine-learning model; and
present the personalized prompt.

14. The system of claim 12, wherein the computer model further comprises a nodal data structure of a set of nodes where each node corresponds to data identified as associated with each application within a set of applications accessed and used by each computing device, each node having an identifier corresponding to a series of nouns and verbs generated in accordance with a schema associated with a shared knowledge language, wherein the series of nouns define one or more types of data and the series of verbs define one or more software processes, the computer model transforming the data generated as a result of at least one computing device accessing and using one or more applications from the set of applications into a series of nouns and verbs using the schema.

15. The system of claim 12, wherein the user query is provided in a natural language syntax.

16. The system of claim 12, wherein the set of instructions further cause the one or more processors to:
execute the machine-learning model to review one or more search results from the data query; and
select a search result from the one or more search results that satisfies a threshold.

17. The system of claim 12, wherein the set of instructions further cause the one or more processors to:
parse the user query into one or more search elements; and
determine one or more search parameters associated with the one or more search elements.

18. The system of claim 16, wherein the set of instructions further cause the one or more processors to:
responsive to receiving a selection of the personalized response, generate a second query based on the search result, wherein the second query is associated with the personalized response;
query the computer model based at least on the second query;
receive a second node linked to the first node of the computer model; and
present a second personalized response, the second personalized response corresponding to the second node.

19. A system comprising:
one or more processors; and
a non-transitory computer-readable medium having a set of instructions that when executed, cause the one or more processors to:
receive a user query for a personalized response associated with a profile;
interpret the user query by executing a machine-learning model;
generate a data query corresponding to the user query by executing the machine-learning model, the data query configured for execution in a computer model comprising one or more nodes, each node of the one or more nodes having an identifier corresponding to a series of nouns and verbs generated in accordance with a schema associated with a shared knowledge language;
receive a first node of the computer model, wherein the first node is associated with the profile and generated based at least in part on an application accessed by the profile; and
present the personalized response, wherein the personalized response comprises an indication of the first node of the computer model.

20. The system of claim 19, wherein the computer model further comprises a nodal data structure of a set of nodes where each node corresponds to data identified as associated with each application within a set of applications accessed and used by each computing device, each node having an identifier corresponding to a series of nouns and verbs generated in accordance with a schema associated with the shared knowledge language, wherein the series of nouns define one or more types of data and the series of verbs define one or more software processes, the computer model transforming the data generated as a result of at least one computing device accessing and using one or more applications from the set of applications into a series of nouns and verbs using the schema.
